(19) United States
(12) Patent Application Publication
(10) Pub. No.: US 2012/0238923 A1
(43) Pub. Date: Sep. 20, 2012

(54) Repositioning Device, Garment, and Posture Molding Method and Training Instruction Method Using Them

(76) Inventors: Tetsuhiro Yamashita, Kobe (JP); Yoshihiro Chijimatsu, Kobe (JP); Takeshi Ogino, Osaka (JP); Kenjiro Mori, Osaka (JP)

(21) Appl. No.: 13/186,022

(22) Filed: Jul. 19, 2011

Related U.S. Application Data
(62) Division of application No. 11/111,949, filed on Apr. 22, 2005, now abandoned.

(30) Foreign Application Priority Data
Oct. 24, 2002 (JP) 20020309422
Sep. 29, 2003 (JP) PCT/JP03/12456

(51) Int. Cl. A61H 1/00

(52) U.S. Cl. 601/46

(57) ABSTRACT

A repositioning device and a garment (101), to be used in daily activities or exercise, correct one's posture to a proper ideal one and create superior body balance. A posture molding method and a training instruction method utilize the repositioning device and the garment. The repositioning device contains a vibration generator inside a case. From the vibration generator, vibratory stimulation is provided to the skin on a human body surface, thereby promoting neurotransmission in muscles. The garment (101) is equipped with point stimulation parts (10a) and/or surface stimulation parts (10b) for promoting facilitation and inhibition of neurotransmission in muscles, respectively. In molding a posture or giving training instructions, a practitioner/trainer utilizes the repositioning device and the garment (101) to facilitate and/or inhibit neurotransmission in muscles.

This application is a continuation of International Patent Application No. PCT/JP03/12456 filed Sep. 29, 2003, which claims priority to Japanese Patent Application No. 20020309422 filed Oct. 24, 2002, of which the contents of each are incorporated herein by reference in their entireties

### TECHNICAL FIELD

This invention relates to repositioning devices and garments which can correct a person's posture to a proper ideal posture by their use in daily activities, exercises, etc. The invention also relates to posture molding methods and training instruction methods using these repositioning devices and garments.

### BACKGROUND ART

In the process of human growth, the brain of a baby develops, first and foremost, fundamental neurotransmission networks for basic movements of body parts, such as hands and feet. The next step, which also starts in the infancy, is to develop neurotransmission networks concerning asymmetrical and unequal movements (e.g. right-handedness or left-handedness). On earth, we live and grow up under gravity, while maintaining the laterality (inequality between the right part and the left part of the body). Eventually, it is difficult for us to keep superior body balance and an ability to support the body equally in anteroposterior, side-to-side and twisting movements. To put it differently, a human being perceives relative positions of the body parts by usually unconscious proprioception. Proprioception itself is inaccurate with respect to body balance and body support ability mentioned above. Hence, strictly speaking, the muscles and skeleton which develop with proprioception are not perfectly equal but unequal.

In daily activities, muscular power of the whole body weakens with age. Therefore, in order to maintain a healthy life, we should continue moderate exercises, thereby preventing weakening of muscular power and keeping superior body balance. If a man habitually relies on inaccurate proprioception, some muscles weaken and impose heavier loads on other muscles and joints. As a result, he may develop lumbar pain, joint pain or other impairment, and in a worst case, may be bedridden.

Regarding the youth whose muscular power is not yet deteriorated, it is still necessary to strengthen muscles to an advanced level and to create superior body balance and excellent body support ability, for accomplishment of prominent athletic performance. For this goal, they may keep on doing exercises beyond a certain intensity or a certain range of motion of joints, or doing intensive training by relying on proprioception. As a result of such wrong exercises or training, however, some muscles and joints may be overloaded and injured in the end.

Conventionally, deficit in body balance is treated by proprioceptive neuromuscular facilitation (PNF). In PNF, application of stimulation to ineffective muscles facilitates neurotransmission in these muscles and helps recovery of body balance. To stimulate muscles, a practitioner or a trainer instructs a patient to perform lengthening contraction (eccentric exercises) of desired muscles. As an alternative, a skin surface is brushed or rubbed otherwise over a desired muscle.

However, even when neurotransmission in muscles is facilitated in the conventional manner, it takes a considerably long time until correct post-repositioning movement is settled as extrapyramidal exercise which depends on usually unconscious proprioception (until pyramidal exercise shifts to extrapyramidal reflex exercise). Accordingly, facilitation of neurotransmission in muscles must be continued for a long period until correct movement is effected by proprioception. Regrettably, if a patient quits the repositioning treatment halfway, he returns to the previous manner of exercise movement which depends on inaccurate proprioception, causing recurrence of the same injury.

If inaccurate proprioception is settled stubbornly, the repositioning effect disappears quickly. Even though neurotransmission in muscles may be facilitated for a while after repositioning, a patient soon tends to resume the previous manner of exercise which depends on inaccurate proprioception. In this situation, neurotransmission in muscles has to be facilitated frequently. If there is a long interval between treatment sessions, he returns to the previous manner of exercise which depends on inaccurate proprioception, causing recurrence of the same injury.

Thus, when a person gets injured due to deficit in body balance, the patient needs not only frequent repositioning treatment in an initial stage of treatment, but also long-term treatment for complete recovery. Having said that, repeated visits to the practitioner are bothering and costly.

Apart from PNF, there are other manners for preventing muscle weakening and improving muscular power, including a variety of exercises such as walking, running and swimming, as well as sport-specific training. In addition, training devices utilizing electrical muscle stimulation (EMS) have been suggested. Such training devices apply a low-frequency electric current to the human body via a pad which is attached to the skin surface of a human body. The electric current causes shortening (concentric) contraction of muscles, thereby strengthening muscular power.

As described, the conventional training devices for strengthening muscular power are based on electrical stimulation. Hence, for some users who have a pacemaker or other medical equipment implanted in the body, the training devices have a risk of troubles by resonating with the medical equipment. Similarly, if a metal part is embedded in the body (e.g. while fractured bones are fixed by a plate), there is a possibility of heat generation and electric burn.

Further regarding the above conventional training devices which apply a low-frequency electric current to the human body, a pad has to be attached to the body surface by a gel. If the pad is not properly attached, electricity may flow across the skin surface and gives pain to the user. Besides, it is laborious and uncomfortable to attach the pad by using a gel. In particular, a person with sensitive skin is poisoned by gel or pad materials.

Furthermore, the above conventional training devices induce muscular contraction in response to electrical input. However, if they are used at an unsuitable intensity, the user feels a strong muscle cramp or may even end with myorrhexis or moderate muscle strain when a muscle contracts during exercise. In daily activities and exercises, the devices give a light load to muscles and are unlikely to cause injury during constant length (isometric) contraction. On the other hand, during shortening (concentric) contraction, muscles are overloaded by their inherent contraction as well as the device-assisted contraction, so that the muscles are likely to suffer from myorrhexis or muscle strain. Furthermore, during lengthening (eccentric) contraction, which is always accompanied by shortening contraction of muscles (i.e. muscle contraction induced by operation of the EMS), muscles receive maximum loads and are vulnerable to more serious injuries. What is more, the user feels increased constraint and reduced mobility in muscles, losing smoothness and efficiency in movement. Thus, the devices adversely affect user's activity if they are used in daily activities or exercises.

In the case of the conventional training devices, a low-frequency current radiates from a pad. Hence, stimulation cannot be pinpointed to a desired muscle alone.

The conventional training devices are said to strengthen muscular power by electrically stimulating shortening exercises of muscles. However, such exercises are passive and performed only by muscles in a limited area where a low-frequency current diffuses via a pad, in contrast to active exercises (e.g. running, swimming) which involve mutual interaction of many muscles in the whole body under the influence of gravity. Thus, the conventional devices strengthen only limited muscles, irrespective of the influence of gravity which is critical in keeping body balance. This factor increases a fear of worsening body balance.

In the case where injury results from deficit in body balance, a loaded muscle or joint is assisted by application of taping or by using a supporter, with a view to keeping body balance and body support ability. In addition, if a person knows through experience which muscle or joint is loaded, he applies taping or uses a supporter in advance as a preventive measure.

In this regard, many attempts have been made to prevent injuries (muscle strain, and rupture or damage of ligaments and tendons) by supporting a part of muscles and assisting joint support power, without restricting muscle movements during exercise. Clothes proposed therefor are arranged to apply gentle pressure to certain muscles and strong pressure to their adjacent edges, or to apply gentle pressure to central parts of the elbow or knee joints and strong pressure to their periphery (see Patent Document 1, as an example).

<Patent Document 1>

Japanese Patent Laid-open Publication No. H8-117382 (JP 8-117382 A)

Nevertheless, the above-mentioned conventional taping, supporter, clothes and the like are designed to apply strong pressure to muscles to be moved actively, so that muscle tone of such muscles decreases. Although the conventional clothes are originally intended to provide an effect of fixing a joint and assisting muscular power, these items fail to do so.

Specifically speaking, when we receive severe stimulation (e.g. bruise) to our skin or muscle, we touch and stroke the injured area by a hand in an attempt to reduce or suppress the pain quickly, because we instinctively know this action does soothe the pain. In fact, Margaret Rood proves that stroking (brushing) and other stimulation can reduce pain. Another actual effect of stroking (brushing) is suppression of excessive sweating. To give an example, kimono fitters or the like experimentally learn that sweating is suppressed by tightening an obi (a belt) and a himo (a cord), and they put this into practice. As understood by these phenomena, surface-like pressure or touch (as opposed to point-like pressure or touch) on the skin is found to have effects of suppressing sympathetic nerves and exciting parasympathetic nerves. Further, regarding promotion of blood circulation, it is known that stroking on the skin surface can stimulate parasympathetic nerves, can dilate blood vessels, and can increase the blood flow in muscles. This phenomenon is often observed when muscles receive surface pressure or touch. To give an example, for treatment of stiff neck or the like, manual therapy (lymphatic massage, etc.) is done to increase blood flow in muscles and to decrease their muscle tone. Theoretically, Margaret Rood calls these phenomena “closing of the pain gate”. According to this theory, when muscles or skin receives stimulation by stroking (brushing), the stimulation is transmitted by a neural pathway of innocuous C fibers, and causes presynaptic inhibition or reduction of primary afferent depolarization. Besides, these phenomena are said to reduce pain and decrease muscle tone. It is further known that the effect is optimized when stimulation is applied to a functional skin area which corresponds to a skin segment or a muscle segment.

In light of this theory, the above-mentioned conventional taping, supporter and clothes are concerned with improper muscles or skin and provoke over-relaxation of nerves and muscles. Eventually, those conventional items decrease the joint support power by muscles and inhibit smooth joint movement which is effected by muscle contraction. In contrast, an object to be achieved by the product of this invention is to improve balance ability and athletic performance ability in the whole body during exercise, by applying a muscle/nerve facilitation technique to a location where muscle tone is so high as to inhibit smooth movement. Thus, this object is significantly different from the one intended by the conventional taping, supporter, and clothes.

Further, the conventional clothes are designed to assist joint support power of certain muscles by strongly pressing adjacent edges of these muscles. Therefore, if a healthy person wears such clothes during exercise, the strongly supported muscles do not receive a full load imposed by the exercises, so that the person cannot be rewarded with a sufficient exercise effect. In other words, the support power of the conventional clothes absorbs a load which should be imposed on muscles. After all, even when a person performs exercise in correct movements, the support power of the clothes assists and bears part of a load which is generated by correct movements and should be imposed on muscles.

In fact, because the conventional clothes are designed to support joints and muscles at an injury-prone area, a person in such clothes may be able to keep his body balance and body support ability to some degree. However, while such clothes are used for exercise, there is a difference between the load imposed on muscles and joints which are supported by the clothes and the load imposed on muscles and joints which are not supported by the clothes. Hence, if a person wears such clothes and performs exercise harder, the supported muscles/joints and the unsupported muscles/joints will show an increasing difference in exercise effects. Eventually, the clothes will worsen body balance and body support ability.

As mentioned, the conventional clothes are further designed to assist joint support power by gently pressing central parts of the elbow or knee joints and strongly pressing their periphery. Nevertheless, the original function of a supporter is merely to stop anteroposterior and side-to-side sway of a joint. It is true that occurrence of injury can be reduced by suppressing sway at a joint. However, as for the pain which results from a vertical load (an antigravity action) during exercise, the conventional clothes have neither an effect of suppressing sway of a joint nor an effect of assisting joint support power for the following reasons. At the knee joints, it is difficult to generate a drag force while they receive positive and negative forces during exercise (to effect an antigravity action), except for increasing the internal pressure to the knee joints (by giving such a strong pressure as to disable extension and flexion of the knees). Hence, an appliance for assisting the joint support power has a limited effect. Basically, exercise-related injuries are induced by sway and displacement of joints relative to their joint axes while the joints are subjected to a constant vertical load. Further, because joints are destined to serve two conflicting functions: flexibility and toughness, such a severe fixation of joints is impossible. Namely, the only means for curing or avoiding injuries is to shift the vertical load to other joints or to remove the vertical load from the joints themselves. To summarize, when a vertical overload on the knee joints is attributable to an extreme forward leaning posture which results from ankle joint-concentrated exercise (i.e. the ankle strategy-based manner of exercise, to be detailed later), it is impossible to alleviate knee joint injuries without reducing such vertical overloads. Besides, the conventional appliance which merely assists the knee joints cannot cure or avoid injuries. For the reasons mentioned above, the conventional clothes and the like can never decrease the load on the intraarticular soft tissues (articular disk, etc.) at the knee joints.

Additionally, the above conventional clothes are designed to support joints and muscles where injuries are likely. In fact, these joints and muscles are the ones which are actually injured and not the ones which trigger injuries. Hence, use of the conventional clothes is not a fundamental solution to prevent injury.

Apart from the use of the taping, supporter and clothes as above, trainers give athletes training instructions for improving their athletic ability without injury. Generally, a trainer watches athlete's movements and corrects his defects, or lets him prepare for activities by training overloaded muscles as mentioned above.

According to this conventional training instruction method, even if a trainer watches athlete's movements and corrects his defects, the advice is worthless unless the athlete performs accurate movements consciously (as pyramidal movements) at all time. If the advice is forgotten, he returns to his previous extrapyramidal movements which depend on inaccurate proprioception. For those who enjoy sports, since it is usually impossible to receive training instructions personally and at all time, they have difficulty in performing accurate movements consciously (as pyramidal movements). Hence, they cannot throw away their previous extrapyramidal movements which depend on inaccurate proprioception, or cannot go on with correct movements. Even if someone is lucky enough to have his problems spotted personally and frequently, it still takes a considerable time to carry out correct movements consciously (until proprioceptive neuromuscular facilitation, PNF, is completed, or until controlled mobility is acquired). Needless to say, even after a person has finally managed to carry out correct movements consciously, it takes a further considerable time until the correct movements are settled as extrapyramidal movements which depend on usually unconscious proprioception (until the correct movements shift from pyramidal movements to extrapyramidal reflex movements).

In the above conventional training instruction method, a trainer also lets an athlete prepare for activities by training loaded muscles as mentioned above. Although the thus strengthened muscles may be more resistant to injuries, this process cannot create superior body balance and body support ability for realizing injury-free movements (flexible movement and controlled mobility).

### DISCLOSURE OF THE INVENTION

The invention is made in light of the situations described above. An object of the invention is to provide repositioning devices and garments which can correct a person's posture to a proper ideal one and which can create superior body balance by their use in daily activities, exercises, etc., and also to provide posture molding methods and training instruction methods using these repositioning devices and garments.

A garment of the invention for solving the above problems is equipped with at least either of a point stimulation part or a surface stimulation part. With a proviso that muscles involved in antigravitational exercise are classified into groups, according to the degree of muscle tone which is affected by postural difference and by laterality-related difference in neurotransmission, the point stimulation part is formed at a location corresponding to a skin surface within an area ranging from an origin to an insertion of at least one muscle selected from the muscle groups, and with a person wearing the garment, the point stimulation part facilitates neurotransmission in the at least one muscle. The surface stimulation part is formed at a location corresponding to a functional skin area of at least one muscle selected from the muscle groups, and with a person wearing the garment, the surface stimulation part inhibits neurotransmission in the at least one muscle.

A posture molding method of the invention for solving the above problems is a method for molding an ideal posture. With a proviso that muscles involved in antigravitational exercise are classified into groups, according to the degree of muscle tone which is affected by postural difference and by laterality-related difference in neurotransmission, this method involves: providing a point stimulator and/or a surface stimulator at a location corresponding to a skin surface within an area ranging from an origin to an insertion of at least one muscle selected from the muscle groups. In this method, the point stimulator promotes facilitation of neurotransmission in the muscle and raises awareness of the muscle, and the surface stimulator promotes inhibition of neurotransmission in the muscle and decreases awareness of the muscle.

Also proposed is a training instruction method of the invention for solving the above problems. With a proviso that muscles involved in antigravitational exercise are classified into groups, according to the degree of muscle tone which is affected by postural difference and by laterality-related difference in neurotransmission, this method involves: allowing a person to perform exercise while providing a point stimulator and/or a surface stimulator at a location corresponding to a skin surface within an area ranging from an origin to an insertion of at least one muscle selected from the muscle groups. In this method, the point stimulator promotes facilitation of neurotransmission in the muscle and raises awareness of the muscle, and the surface stimulator promotes inhibition of neurotransmission in the muscle and decreases awareness of the muscle.

A repositioning device of the invention for solving the above problems is composed of a case applicable to a human body surface and having a hollow chamber therein, and one or more pieces contained in the case. A space for permitting rolling and bouncing movements of the one or more pieces is defined in the hollow chamber of the case. The one or more pieces vibrate the case by rolling and bouncing inside the hollow chamber in response to body movements. The case is made in such a size as to secure a space for generating such vibrations in the space inside the hollow chamber, to provide vibratory stimulation to a part of the skin corresponding to a human body surface to which the case is applied, and to facilitate neurotransmission in at least one muscle at the part.

Another repositioning device of the invention for solving the above problems is composed of a case applicable to a human body surface, a vibration generator arranged to generate vibrations in a range of 3 Hz to 5 MHz, a power source for supplying power to the vibration generator, and a controller for controlling generation of vibrations by the vibration generator. Vibrations from the vibration generator reach the human skin surface to which the vibration generator is applied. The case is made in such a size that the vibrations facilitate a muscle at a part of the skin corresponding to a human body surface to which the case is applied.

<Laterality-Related Difference in Neurotransmission and Postural Difference, Regarding Anti-Gravitational Exercise>

The human brain has established neurotransmission circuits for processing asymmetrical unequal movements such as right-handedness and left-handedness. With keeping such unequal factors, the human brain perceives relative positions of body parts by usually unconscious proprioception. Since the muscles, skeleton and the like develop with proprioception, they are not perfectly equal but unequal in a strict sense. In fact, laterality affects all parts of the body.

In addition to the influence of laterality, a human being living on the earth is engaged in exercise or work by maintaining a standing, sitting or any other posture under gravity, and permanently needs to generate an anti-gravity force for acting against the gravity. Without the anti-gravity force, no movement would be possible. A group of muscles which are selected reflexively and dominantly in the antigravity state are comprehensively called antigravity muscles, most of which are extensors. The antigravity muscles are affected not only by laterality as mentioned above, but also by ethnic group, lifestyle, inheritance, and many other factors.

Let us give an example. While standing with eyes closed, those who perform exercise in a forward leaning posture tend to lean forward and to support their weight toward the toes (typical to Mongoloids or nonathletic people), whereas those who perform exercise in a backward leaning posture tend to lean backward and to support their weight toward the heels (typical to Latin Americans or athletically skilled people). Next, suppose that these people stand on one leg, with eyes closed. In the forward-leaning group (typical to Mongoloids or nonathletic people), right-handed people tend to support the weight at the lateral side of the right toe (when standing on the right leg only) or the medial side of the left toe (when standing on the left leg only), and left-handed people tend to support the weight at the lateral side of the left toe (when standing on the left leg only) or the medial side of the right toe (when standing on the right leg only). On the other hand, in the backward-leaning group (typical to Latin Americans or athletically skilled people), right-handed people tend to support the weight at the lateral side of the left heel (when standing on the left leg only) and the medial side of the right heel (when standing on the right leg only), and left-handed people tend to support the weight at the lateral side of the right heel (when standing on the right leg only) and the medial side of the left heel (when standing on the left leg only).

FIG. 1 depicts an average exercise posture of Japanese or nonathletic people (right-handed), who support the weight at the lateral side of the right toe and the medial side of the left toe. Regarding body balance and body support ability in this posture, the body is strongly controlled and supported by the posterior muscles of the left lower leg, the anterior muscles of the left thigh, the upper part of the left abdominal muscles, and the right upper trapezius. Their body is more strongly controlled and supported by the posterior muscles of the right lower leg, the anterior muscles of the right thigh, the upper part of the right abdominal muscles, and the left upper trapezium. During anti-gravitational exercise, the above-mentioned muscle groups notably increase muscle tone. The left-handed people show a symmetrical pattern.

In contrast, FIG. 2 depicts an average exercise posture of Latin Americans or athletically skilled people (right-handed), who support the weight at the lateral side of the left heel and the medial side of the right heel. Regarding body balance and body support ability in this posture, the body is strongly controlled and supported by the anterior muscles of the right lower leg, the posterior muscles of the right thigh, the posterior part of the right gluteal muscles, the lower part of the left abdominal muscles, and the left erector spinae. Their body is more strongly controlled and supported by the anterior muscles of the left lower leg, the posterior muscles of the left thigh, the posterior part of the left gluteal muscles, the lower part of the right abdominal muscles, and the right erector spinae. During anti-gravitational exercise, the above-mentioned muscle groups notably increase muscle tone. The left-handed people show a symmetrical pattern.

Considering the fact that the degree of neurotransmission can be weak or strong in connection with laterality, high-tone muscles during antigravitational exercise are distributed differently among the forward-leaning right-handed, the forward-leaning left-handed, the backward-leaning right-handed, and the backward-leaning left-handed. Additionally, in practice, point stimulation or surface stimulation for facilitating or inhibiting muscular nerves is applied to muscles which act in opposed manners to the above-mentioned muscles which control and support the body.

Whether forward-leaning right-handed, forward-leaning left-handed, backward-leaning right-handed, or backward-leaning left-handed, we perceive relative positions of body parts by usually unconscious proprioception (i.e. by postural reflex). In FIGS. 80-87, muscles are classified into four categories (Very strong, Strong, Weak, Very weak) according to the degree of muscle tone during antigravitational exercise, separately for each of the forward-leaning right-handed, the forward-leaning left-handed, the backward-leaning right-handed, and the backward-leaning left-handed.

Regarding FIGS. 80-87, the degree of muscle tone is indicated in four ranks (Weak, Very weak, Strong, Very strong) for the following reason. First and foremost, a person is roughly classified as right-handed or left-handed. Next, turn to the limbs, and take an arm as an example. Then, we can see that even one arm has two flows of muscles (i.e. radial and ulnar), either of which is dominant over the other. Therefore, the terms “right-handed” and “left-handed” are too rough to represent actual degree of muscle tone. The above-defined four ranks are meant to cover strong muscles and weak muscles on the dominant side of the body as well as strong muscles and weak muscles on the non-dominant side of the body. In this context, very strong muscles and strong muscles locate on the dominant side of the body, the former being more active than the latter. Weak muscles and very weak muscles locate on the non-dominant side of the body, the latter being less active than the former and being the weakest in a muscle group at a certain area of the body.

FIGS. 88 and 89 classify muscles and joints into two categories, in connection with antigravitational exercise performed in an ideal posture. The first category encompasses major muscles and joints concerning antigravitational exercise, and the second category covers auxiliary muscles and joints which assist and work in coordination with the major ones.

With respect to the terms used in FIGS. 80-89, extensors mean multiarticular muscles and monoarticular muscles which act against the gravity and which move joints to extended positions. Flexors mean multiarticular muscles and monoarticular muscles which act against the gravity and which move joints to flexed positions. Rotators are concerned with axial rotatory movement of shoulder joints, hip joints and the like, and effect inward or outward axial movement relative to the trunk.

<Multiarticular Muscles and Monoarticular Muscles>

Muscles listed in FIGS. 80-89 are classified as multiarticular or monoarticular.

Joints are categorized according to their degree of freedom. Joints with three degrees of freedom are the most functional, joints with two degrees of freedom are the second most functional, and joints with one degree of freedom are the least functional. Shoulder joints and hip joints are representative of three-degree-of-freedom joints. Axial movements at these joints include not only anteroposterior and side-to-side movements, but also diagonal and rotatory movements. In contrast, knee joints which have one degree of freedom merely control and support anteroposterior axial movements. Because movements of joints need to satisfy the conflicting opposite requirements, i.e. high flexibility and strong support power, some are meant to be highly flexible and others are to be strongly supportive. In this connection, muscles act on these joints and create body balance and body support ability (by correct antigravity muscle activities).

The multiarticular muscle acts on two or more joints mentioned above.

The monoarticular muscle acts on a single joint mentioned above.

<Three-Dimensional Activities of Agonists and Antagonists in the Anatomical Position>

Now, three-dimensional joint-muscle activities are discussed in view of the anatomical position. For the following explanation, we should understand the three planes in the anatomical position as used in the medical literature: a sagittal plane, a frontal plane, and a horizontal plane. A smooth manner of exercise results from three-dimensional joint-muscle activities which are constituted on these three planes.

To discuss the three-dimensional activities, it is necessary to divide muscle activities into agonistic activity in which muscles are facilitated or antagonistic activity in which muscles are inhibited. In addition, muscles need to be classified into those mainly engaged in moving the body or those mainly engaged in supporting the body. This classification is required because three-dimensional muscle activities of inhibitory muscles include control of strongly facilitated acting muscles and also include support of antagonistic muscle activity which is antagonistic to the agonistic activity.

To start with, we briefly describe antigravitational exercise in two dimensions, considering the degrees of neurotransmission related to laterality (e.g. right-handedness or left-handedness) as well as the exercise posture such as a forward-leaning posture and a backward-leaning posture. In this regard, exercise is constituted with four types of muscle activities which are distinguished by their functions (see FIG. 3): agonistic muscle activity which is the most active activity (hereinafter simply mentioned as “agonistic muscle activity”), antagonistic inhibitory muscle activity which is the second most active activity and which is antagonistic to agonistic muscle activity (hereinafter simply mentioned as “antagonistic muscle activity”), supportive muscle activity which is the third most active activity and which helps agonistic muscle activity (hereinafter simply mentioned as “supportive muscle activity”), and accessory muscle activity which assists this supportive muscle activity which in turn helps agonistic muscle activity (hereinafter simply mentioned as “accessory muscle activity”).

However, exercise should not be interpreted merely from a two-dimensional point of view. In order to achieve an efficient manner of exercise, exercise has to be understood and developed from a three-dimensional point of view. For example, FIGS. 4 and 5 schematically represent thigh muscle activities during flexion and extension of the hip joint. (Here, the right thigh is taken as an example.) Concerning a muscle group involved in linear (forward) movement alone, the thigh muscle activities are constituted with as many as eight muscle activities including the four different types of muscle activities (agonistic muscle activity, antagonistic muscle activity, supportive muscle activity, and accessory muscle activity) at an upper section and a lower section of the thigh, respectively.

Further, muscle activities in a part of the body are discussed on a little greater scale, in connection with joints. The four types of muscle activities are closely and coordinately related to movements of joints which locate above and below the muscles. For example, FIGS. 6 and 7 schematically represent muscle activities around the gluteal region during flexion and extension of the hip joint. In addition to the eight muscle activities at the thigh mentioned above, there are four more muscle activities above the hip joint (agonistic muscle activity, antagonistic muscle activity, supportive muscle activity, and accessory muscle activity). Now, it should be remembered that the joints have to realize two conflicting opposite functions: flexibility and supportability. Therefore, the joint-muscle activities involving the hip joint are constituted not only with a combination of four types of muscle activities (agonistic muscle activity, antagonistic muscle activity, supportive muscle activity, and accessory muscle activity), but also with complex muscle activity which imparts rotatory support power in order to make the muscle activities more effective (see FIG. 8).

Next, muscle activity in a part of the body is discussed on a smaller scale. In fact, subdivided muscle activities as mentioned above occur in a single muscle. Take biceps femoris, one of the hip joint extensors, as an example. Biceps femoris has a long head which is a multiarticular muscle and a short head which is a monoarticular muscle. The long head concerns extension of the hip joint as well as flexion of the knee joint which coordinately assists the hip joint extension. The short head has a monoarticular supportive function, thus assisting the agonistic activity. Subdivided muscle activities at the posterior part of the thigh (biceps femoris, in particular) may be also learned from the fact that Japanese or nonathletic people often suffer from injury (muscle strain, etc.) at the short head of biceps femoris which acts like a monoarticular muscle. This injury is closely related with their ankle strategy-based manner of exercise, which is a typical behavior of Japanese or nonathletic people as detailed later. Further, at quadriceps femoris, when actions and muscle strength are not balanced between medial/lateral muscles or between multiarticular/monoarticular muscles, the imbalance is said to trigger such symptoms as represented by external patellar subluxation syndrome due to abnormal Q angle. A cause of such symptoms is known to be discoordination of joint activities below the hip joints, the knee joints and other joints therebelow, as well as the relationship of strength between vastus medialis and vastus lateralis of quadriceps femoris. Although asymmetrical activity in human being does not necessarily develop into such diseases, a slight problem or instability associated with asymmetrical movements of muscles and joints may be a potential cause of injury during exercise.

As explained, the whole body performs smooth and elegant exercise by skillfully controlling complicated asymmetrical movements such as anteroposterior, side-to-side, twisting, and other movements. The necessity of facilitation and inhibition for guiding such asymmetrical muscle activity toward a correct axis will be readily understood.

<Ideal Exercise Posture>

An ideal exercise posture requires following important elements. With a person sitting on a chair, draw a line from the parietal region to the point where the bottom end of the ischial bone touches the chair, and take this line as the fundamental axis for joint/muscle movement. In connection with this axis, the shoulder joints, hip joints and vertebrae joints perform flexion/extension, internal rotation/external rotation, and adduction/abduction to the limit of the maximum ranges of joint motion and muscle motion. As for the actions of joints in the lower legs below the knees and in the forearms beyond the elbows, they should supplement the ranges of joint motion and muscle motion at the shoulder joints and the knee joints, thereby enhancing efficiency of the above-mentioned joint actions (of the shoulder joints, hip joints and vertebrae joints) and ensuring their maximum actions. In FIGS. 88 and 89, muscles and joints are classified as major muscles/joints, and auxiliary muscles/joints. For proper and efficient performance, actions of joints and muscles should be corrected in the manner indicated in FIGS. 88 and 89. Having said that, it should not be forgotten that the human being has “laterality” as represented by the dominant hand and the dominant leg, and “posture” which is defined as forward leaning or backward leaning. Hence, each person performs individual muscle activities in a certain posture (FIGS. 80-87). Roughly speaking, we determine one's laterality by the dominant hand (i.e. right-handed or left-handed). In addition, for more correct interpretation of “laterality”, we actually use the following standards: well-facilitated (dominant) and unfacilitated (non-dominant), or sufficiently active on reflex (dominant) and insufficiently active on reflex (non-dominant).

Hence, actions of joints and muscles should be corrected according to an ideal posture as indicated in FIGS. 88 and 89, with “laterality” and “posture” being taken into account.

For realization of an ideal exercise posture, let us define two manners of exercise. For one, the ankle strategy-based manner of exercise is dominated by the knees or ankles. For another, the hip strategy-based manner of exercise is dominated by the hip joints. For example, according to the ankle strategy-based exercise activity, a person stands in a forward leaning posture, with the center of gravity toward the toes, just as senile gait or the like. On the other hand, according to the hip strategy-based exercise posture, a person stands in a backward leaning posture, with the center of gravity toward the heels, as typically seen among athletically skilled people, etc.

In the forward leaning posture, a person's weight is borne on the toes, and hence the body needs to be supported by the entire soles. This situation promotes actions of extensors (the plantarflexion muscle groups) at the ankle joints, so that the ankle strategy-based manner of exercise which is principally effected by the ankles becomes the core of exercise. Then, in order to keep the trunk balanced, some muscles of the whole body increase muscle tone (e.g. mainly the trapezius, the upper abdominal muscles and their periphery, the anterior muscles of the thighs, and the posterior muscles of the lower legs). If these muscles become stronger, they aggravate the forward leaning posture, whereby the ankle strategy-based manner of exercise is consolidated and habitualized. As a characteristics of the ankle strategy-based manner of exercise, the trunk receives a force from a base of exercise later than the ankles. In this case, the fulcrums of exercise are the ankle joints, the application points of force are the posterior muscle groups of the lower legs which act as agonists, and the points of action are the soles. Regrettably, this is not an efficient manner of exercise. As a consequence, activities of extensors at the hip joints fail to exert their full function, and the main function of the trunk activity is reduced to an auxiliary role of keeping the balance. Eventually, no matter how the hip joints and the trunk act to assist, promote and emphasize exercise, their activities are meaningless. This is why aged people move slowly and cautiously, with short walking strides. For the same reason, while nonathletic people try to make up for their poor trunk balance, they suffer from hypertonicity (unnecessary strain) and deterioration of athletic ability (poor athletic skills) during exercise.

Conversely, in the backward leaning posture, a person's weight is borne on the heels. Hence, the soles do not have to support the body by the part of the soles, and muscle groups around the ankle joints are not stimulated. Consequently, the ankle joints no longer serve as the points for supporting body balance (As the plantarflexor groups do not receive nervous stimulation and hence are not hypertonic, their antagonists, i.e. ankle joint extensor groups, cannot be active, either.), and other joints have to bear the force from the base of exercise. In this case, the force shifts to the knee joints and the hip joints which constitute the free lower limb and the pelvic girdles. Owing to their low (one) degree of freedom, the knee joints cannot perfectly cover multidirectional movements by their own function (because the knee joints can control only anterioposterior balance around axes of joint movement). Hence, the force needs to be transferred from the knee joints to the hip joints which have three degrees of freedom, which inevitably brings about the hip strategy-based manner of exercise. With respect to the hip strategy-based manner of exercise, one of its characteristics is to promote cooperation between the trunk extension function (the erector spinae is a major trunk extensor) and the lower limb movement. This manner of exercise sets the fulcrum of exercise at the center of gravity, stabilizes the trunk and enables integrated exercise. Further, the moment of motion is equally distributed to the upper and lower limbs, and muscular power generated at the trunk is properly transmitted to the upper and lower limbs. Thus, this manner of exercise improves athletic ability remarkably.

In a smooth exercise, a rotatory power must be generated by the upper limbs and the trunk around a correct axis, and then must be transmitted to the lower limbs. Because exercise is based on the principle of leverage which concerns three points (a point of application, a point of action, and a fulcrum), the trunk has to serve two functions as the point of application and the fulcrum. To perform these two functions smoothly, the trunk strengthens the fulcrum by rotation. (A twist increases an axis support power, as is the case where one wrings a wet towel or the like.) Thus, for a smooth exercise, the entire trunk must serve three different functions as a fixing surface, a supporting surface and an exercise surface by using a rotatory power. In the meantime, the trunk must allow rotatory movements at the hip joints and the shoulder joints, from which the power is transmitted to the limbs. In this manner, sequential transmission of power is indispensable for a smooth exercise. Furthermore, with respect to a manner of exercise which involves complex rotatory movements (e.g. a pitching motion), sequential transmission of power must be repeated by two, three, or more rotations during each motion. It is known that such rotations are effected not in a single direction but in alternate directions, namely, right-to-left and left-to-right, and inwardly (an internal spiral motion) and outwardly (an external spiral motion) relative to the body. The most ideal performance of exercise is embodied when these multidirectional rotations (a tornado motion) occur around an exercise axis of the trunk. Besides, this ideal performance of exercise imposes a minimum load to non-rotatory joints (those with one or two degrees of freedom).

With respect to Japanese, nonathletic people, and aged people, their pelvis tends to tilt forward. Therefore, their exercise is principally led by the ankle joints (the ankle strategy-based manner of exercise), so that muscular power generated during exercise is lost significantly. In addition, they have difficulty in exerting rotatory power in the above-described manner and cannot give stable performance. On the other hand, the pelvis of Latin Americans and athletically skilled people is in an upright position. In this state, their exercise is principally led by the hip joints (the hip strategy-based manner of exercise), so that loss of muscular power generated by the whole body (the upper body, in particular) is minimized (because the fulcrum locates substantially at the center of the body). Furthermore, they smoothly perform the above-mentioned rotational exercise, and a load to be imposed on joints which have a fewer degree of freedom is reduced.

Therefore, if a person leans forward in an average exercise posture, the posture needs to be brought backward and transformed to a posture for embodying a correct hip strategy-based manner of exercise. Conversely, if a person leans backward in an average exercise posture, the posture should be brought forward and transformed to a posture for embodying a more correct hip strategy-based manner of exercise. Once a correct hip strategy-based manner of exercise comes to form the core of exercise, such exercise can awaken and strengthen dormant muscles which usually do not control, support or act strongly, and can also reduce the stress to overloaded muscles which usually control and support strongly. As a consequence, one's exercise posture can be molded or transformed into an ideal exercise posture.

It should be also noted that the ankle strategy-based manner of exercise and the hip strategy-based manner of exercise as described above are significantly affected by hand dominance (right-handed or left-handed), leg dominance, and the like. For example, in the case of right-handed people whose average exercise posture is dependent on the ankle strategy, a right-side-loaded forward leaning posture is dominant at the lower limbs. Since this posture puts a heavier load on the lateral side of the right toe, the body needs to be supported on a surface along the lateral side of the right toe. This situation promotes actions of the extensor group (the plantarflexor group) at the right ankle joint, so that the core of exercise is the right-shifted, ankle strategy-based manner of exercise which is principally led by the right ankle. Then, in order to keep a balance, some muscles of the whole body increase muscle tone (e.g. the left trapezius, the upper part of right abdominal muscles and their periphery, the anterior muscles of the right thigh, and the posterior muscles of the right lower leg). If these muscles become stronger, they aggravate the right-side-loaded forward leaning posture, whereby the right-shifted, ankle strategy-based manner of exercise is consolidated and habitualized. As a characteristics of the right-shifted, ankle strategy-based manner of exercise, the trunk receives a force from a base of exercise later than the ankles and in a shifted manner. In this case, the fulcrum of exercise is the right ankle joint, the application point of force is the posterior muscle group of the right lower leg which acts as an agonist, and the point of action is the right fifth toe. Regrettably, the power for exercise is lost considerably at the left foot/leg and the medial side of the right toe. As a consequence, activities of extensors at the left and right hip joints fail to exert their full function in a mutually balanced manner, and the main function of the trunk activity is reduced to an auxiliary role of keeping the balance in a right-shifted manner. Eventually, no matter how the hip joints and the trunk act to assist, promote and emphasize exercise and side-to-side balance, their activities are meaningless.

In contrast, in the case of right-handed people whose average exercise posture is dependent on the hip strategy, a left-side-loaded backward leaning posture is dominant at the lower limbs. Since this posture puts a heavier load on the lateral side of the left heel, the body needs to be supported on a surface along the lateral side of the left heel. While the weight is borne by the left heel, the left sole does not have to support the body by the entire part of the sole, and a muscle group around the ankle joint is not stimulated. Consequently, the left ankle joint no longer serves as the point for supporting body balance (As the plantarflexor group does not receive nervous stimulation and hence is not hypertonic, its antagonist, i.e. an ankle joint extensor group, cannot be active, either.), and other joints on the left side of the body have to bear the force from the base of exercise. In this case, the force shifts to the left knee joint and the left hip joint which constitute the free lower limb and the pelvic girdle. Owing to its low (one) degree of freedom, the knee joint cannot perfectly cover multidirectional left-sided movements by its own function (because the knee joint can control only anterioposterior balance around an axis of joint movement). Hence, the force needs to be transferred from the left knee joint to the left hip joint which has three degrees of freedom, which inevitably brings about the left-shifted, hip strategy-based manner of exercise. With respect to the left-shifted, hip strategy-based manner of exercise, one of its characteristics is to promote cooperation between the trunk extension function (the erector spinae is a major trunk extensor) and the lower limb movement. This manner of exercise sets the fulcrum of exercise at the center of gravity on the left side of the body, stabilizes the trunk and enables integrated exercise. Further, the moment of motion is equally distributed to the upper and lower limbs, and muscular power generated by the upper limbs is properly transmitted to the lower limbs (although shifted to one side of the body). Thus, this manner of exercise improves athletic ability remarkably. Nevertheless, this manner of exercise emphasizes activity only on the left side of the body, and power generated in the right lower limb is unlikely to be consumed efficiently. Hence, there arises a need for facilitating and activating the right lower limb. In other words, loss of exercise efficiency is minimized when the hip strategy-based manner of exercise is molded correctly, with the left-side-loaded posture being modified and muscle activities on the right side of the body being facilitated.

As mentioned above, Japanese and nonathletic people (right-handed) lean forward and to the right in an average exercise posture. Compared with Japanese and nonathletic people, Latin Americans and athletically skilled people (right-handed) lean backward and to the left in an average exercise posture. Thus, from an ideal exercise posture, the center of gravity in right-handed Japanese and nonathletic people is offset forwardly and to the right, whereas that in right-handed Latin Americans and athletically skilled people is offset backwardly and to the left.

Hence, habitual exercise in either posture reinforces certain muscles which strongly control and support body balance and body support ability. Namely, Japanese and nonathletic people who lean forward in an average exercise posture will develop the trapezius, the upper abdominal muscles and their periphery, the anterior muscles of the thighs and the posterior muscles of the lower legs. It should be noted that such development is affected by their laterality (right-handedness or left-handedness) as well as their posture. Latin Americans and athletically skilled people who lean backward in an average exercise posture will develop the erector spinae, the lower abdominal muscles and their periphery, the gluteal muscles (gluteus maximus, in particular), the posterior muscles of the thighs and the anterior muscles of the lower legs. Similarly, such development is affected by their laterality (right-handedness or left-handedness) as well as their posture.

By way of example, FIG. 9(a) illustrates a typical right-handed Japanese or nonathletic person who leans forward in an average exercise posture. As described above, development of trapezius stands out in this person. Besides, right-handedness causes nerves on the right side of the upper body to be facilitated more than those on the left side. Hence, the right trapezius appears to be developed remarkably, to a somewhat greater extent than the left one. Below the trapezius, the latissimus dorsi lies as one of back muscles, but usually the latissimus dorsi does not develop well in Japanese and nonathletic people who lean forward in an average exercise posture. Further, right-handedness severely hampers development of the left latissimus dorsi, in comparison with the right one on the dominant side. Hence, among the back muscles, the right latissimus dorsi appears to develop better than the left one, and the right trapezius appears to develop better than the left one. However, this statement addresses the upper section (the trapezius) and the lower section (the latissimus dorsi) separately, by simply making a comparison between the left and right sides of the upper section and a comparison between the left and right sides of the lower section. If conditions of both muscles are compared altogether on both sides of the spinal column, the most developed is the right trapezius, the second most developed is the left trapezius, the third most developed is the right latissimus dorsi, and the least developed is the left latissimus dorsi. This comparison reveals differences in muscle development from a two-dimensional point of view and differences in the state of nervous facilitation as mentioned above. Apart from these muscle groups, similar imbalance of muscle development is found in the frontal and lateral parts of the body. In this respect, a rotational movement around the spines (such as batting and pitching motions in baseball) can be compared to that of a spinning top. Referring to FIG. 9(b), a body which shows unbalanced muscle development cannot be a truly concentric spinning top. Rotation of a non-concentric spinning top is unstable and cannot last for long.

Turning next to FIG. 10(a), if a forward leaning posture during exercise is compared to a spinning top, the spin axis of this spinning top does not align with the gravity axis for exercise in a forward leaning posture. Misalignment of these axes hinders smooth rotational exercise activity. In contrast, according to an ideal manner of exercise, the spin axis of the spinning top aligns with the gravity axis for exercise, as shown in FIG. 10(b). Alignment of these axes assists smooth rotational exercise activity.

Let us mention some of the factor which results in misalignment of the spin axis of the spinning top and the gravity axis for exercise. It is partly due to asymmetrical muscle activity in the body and imbalance of muscle weights (e.g. For right-handed people, muscles on the right side develop better.) as illustrated in FIG. 9, and partly due to a probable exercise posture as illustrated in FIG. 10. Namely, for smooth rotational exercise activities, it is necessary not only to correct the forward leaning posture to a neutral one but also to neutralize asymmetrical body balance (to an equally symmetrical state in which body parts extend concentrically from the axis). As understood from running and throwing motions, exercise is significantly related with rotatory power generated by the body. The most efficient smooth exercise can be achieved by a rotatory motion or motions effected around a correct trunk axis. Nevertheless, exercise principally led by the knees and ankles (the ankle strategy-based manner of exercise) cannot embody smooth rotational exercise around a correct trunk axis, because the ranges of mobility of these joints are too limited to generate sufficient rotatory power. In contrast, owing to the rotatable hip joints, exercise principally led by the hip joints (the hip strategy-based manner of exercise) can easily perform smooth rotational exercise. In the hip strategy-based manner of exercise, movements of the knees and ankles are required as a secondary role for assisting and reinforcing rotational exercise at the hip joints. To summarize, as far as the ankle strategy-based manner of exercise is concerned, it is difficult to acquire an ideal manner of exercise.

Taking these two conditions into consideration, it can be said that an ideal exercise posture requires symmetrical body balance and the hip strategy-based manner of exercise which relies on hip joint activities. When both requirements are satisfied, exercise can be performed most efficiently and smoothly.

<Molding of an Ideal Exercise Posture>

As a specific manner to form an ideal exercise posture and to correct unequal body balance between the left and right sides of the body, the forward leaning posture should be brought backward, whereas the backward leaning posture should be brought forward. For this purpose, it is required to identify and strengthen unbalanced joints and muscles which deviate from an ideal exercise posture. In addition, muscles in any part of the body need to be taken into consideration in anterior/posterior, superior/inferior, left/right, and agonistic/antagonistic relationships, and to be strengthened in all direction of their movements.

As already mentioned, joints have one, two or three degrees of freedom. With respect to the lower limbs, joints to be strengthened are the hip joints which locate near the center of gravity and which can move diversely. With respect to the free upper limb and the shoulder girdles, joints to be strengthened are the shoulder joints which locate near the gravity axis and which can move diversely. (Note that both the hip joints and the shoulder joints are ball-and-socket joints capable of moving in multiple directions.) Additionally, the dominant hand and the dominant leg should be taken into account as discussed above.

Muscles to be strengthened are mainly those acting on the hip joints and the shoulder joints, and muscle groups which constitute the gravity axis. Distribution of those muscles is asymmetrical. Because the three-degree-of-freedom joints can provide axes of movement in various directions, muscular power can be exerted to some degree even when movement occurs around a non-ideal axis. However, if the three-degree-of-freedom joints are supported in an ideal manner of exercise, with muscle tone of insufficient supportive muscles being increased and that of excessively supportive muscles being decreased, then the exercise posture can be more ideal. To be specific, even when a hip joint moves only in one direction, it receives forces from multiple directions and muscles involved in this movement are asymmetrical. Therefore, these muscles need to be corrected properly for higher efficiency. Nevertheless, this explanation for the hip joint does not necessarily apply to the shoulder joint. At the free lower limb and the pelvic girdles, movements of the hip joints occur on the pelvis which is fixed on the spinal column and serves as a supporting surface. On the other hand, the shoulder joints serve as a core of exercise at the free upper limb and the shoulder girdles, and their joint activity is composed of coordinated movements of the scapulae and the shoulder joints. In a forward leaning posture, increase of muscle tone of the trapezius causes the scapulae to elevate backwardly and hampers movement of the scapulae, thereby inhibiting smooth movements of the shoulder joints.

Thus, since hypertonicity of the trapezius hampers movement of the scapulae, reduction of its muscle tone is vital for smooth exercise. For this requirement, it is necessary to increase awareness of muscles (particularly, gluteus maximus) whose activity is promoted while the pelvis is at an upright position, and to acquire body balance and body support ability for allowing independent movements of the trunk and the free upper limb/the shoulder girdles.

Now, let us make a brief remark about the trapezium. With respect to its vertically antagonistic activity relative to the latissimus dorsi, the trapezius acts around the spinal column as the central axis. To put it simply, the trapezius is adjusted downward and backward, and controlled, by the latissimus dorsi. Japanese and nonathletic people particularly need such muscle activity because their erector spinae and spinal column (to be the core and the fulcrum) do not work well and also because their body balance is maintained by the trapezium. In this respect, they should develop the erector spinae as well as muscles below the middle section of the back, should choose these muscles either consciously or unconsciously (i.e. on reflex), and should make them function fully. For this purpose, Japanese and nonathletic people must cure the manner of exercise which solely depends on the free upper limb and the shoulder girdles and must also reduce hypertonicity thereat. (While movement of the scapulae is hampered, upper limb movement is performed by arms alone.) As mentioned earlier, Japanese and nonathletic people take a forward leaning posture and cannot use the muscle groups relevant to such exercise fully and consciously. For these people, the above-mentioned muscle activity is extremely difficult.

Hence, for smooth performance of exercise in the upper body and the free upper limb/the shoulder girdles, it is vital to correct the position of the lower body relative to the whole body.

In order to reform, correct and strengthen the exercise involving the spinal column, special attention should be paid to actions of the gluteal and other muscles which work in cooperation with the erector spinae.

In connection with molding of an ideal exercise posture, let us discuss a little further why Mongoloids (including Japanese) and nonathletic people take a forward leaning posture.

A forward leaning posture seems to be attributable to two factors. For one, as mentioned earlier, while Mongoloids perform exercise or activity, their erector spinae is less sensitive to the exercise and the gravity than the trapezius which moves the upper limbs. For another, a muscle group for supporting and assisting the erector spinae, i.e. gluteal muscles (particularly, gluteus maximus), does not work well. In keeping the body balanced, absence of muscle tone of the erector spinae disables any upper limb movement. To avoid this, they seem to increase muscle tone of the entire back muscle group by leaning forward. (This is also the case with nonathletic people. Most of their exercise and muscle activities are concentrated on stabilizing the center of gravity by keeping the body balanced. In contrast, athletically skilled people and Latin Americans generate a power for assisting extension of the trunk, which is one of the gluteus maximus actions. Owing to this power, their erector spinae is more active than that of nonathletic people.)

The same is true for nonathletic people. Characteristically, their activity rarely involves dynamic motions, making it difficult to develop muscles at the trunk. Moreover, for most exercise, they strongly tend to rely on extensor groups of the lower limbs. (In order to maintain the balance of the whole body under the ankle strategy-based manner of exercise, they must be constantly able to keep the neutral state (in the sense of the ankle strategy-based manner of exercise), i.e. a forward leaning posture. Otherwise, they lose balance so much that they cannot even stand by themselves, let alone continuing exercise.) Under such circumstances, the extensor groups which constitute the lower limbs must constantly keep high muscle tone, which aggravates a forward leaning posture.

What is most required in this situation is assistance by monoarticular muscle groups around the knees and the ankles (assistance by the three vastus muscles of the quadriceps femoris which locate in the lower parts of the thighs). In an attempt to create a fixed surface and to stabilize the body, those who are in the forward leaning posture naturally learn to use the pelvis (as a part of the pelvic girdles) by internally rotating and adducting the hip joints. Hence, among the three vastus muscles in the thighs, they learn to choose, above all, the vastus lateralis as the agonist (the ankle strategy-based manner of exercise). Interestingly, this situation closely resembles the manner of exercise by aged people in that both of them do not possess sufficient muscular power for certain activity (although the degree of activity may not be the same between them). It is beneficial for them to keep the exercise axis itself in a forward leaning position, in order to realize their manner of moving and their muscle activity pattern. As a result, they have no choice but to take a forward leaning posture.

Accordingly, muscles employed in the ankle strategy-based manner of exercise should not be strengthened excessively and, during exercise, such muscles should not be relied on too much as the only major muscles. Thereby, it is possible to align the trunk with a correct axis which tilts somewhat backward. Then, the hip strategy-based manner of exercise is awaken and promoted, encouraging flexor activity, whereby an ideal exercise posture can be molded. This ideal posture can also eliminate troubles at the knees or the like which derive from sole reliance on extensor activity, and can bring about axial activity and muscular activity in a stable manner. As a byproduct, improvement of athletic ability can be expected. Due to these various exercise inhibitory factors, ordinary people are obliged to take a forward leaning posture and become bad at exercise. Namely, in molding an ideal exercise posture and improving athletic ability, the most essential point is to free a person from a forward leaning posture and to correct the posture.

<Molding of Ideal Exercise Posture by Improving Generation/Use of Power in Muscle Activity and by Improving Skill in Muscle Activity>

We herein refer to two types of muscle activities: improvement of power and improvement of skill. In relation to these muscle activities, we should also understand certain factors in exercise activities. The first factor is that different muscle activities generate power in different directions. In 100-meter run, weight lifting, etc., power needs to act only in one direction. In basketball, football, etc., players should quickly switch directions of movements back and forth, side to side, and diagonally, and they should also react against other players. Thus, depending on the type of exercise, muscles need to be stimulated in different manners. Further, let us make a comparison between linear exercise which does not demand complicated body balance and exercise which demands complex body balance. In many cases, muscle activity in the former exerise is simple generation/use of power. On the other hand, muscle activity in the latter exercise involves generation/use of power and also requires skill and subtle control of muscles. Next, turning to the second factor, duration of muscle activity varies with exercise time. For example, muscle activity is not the same during 100-meter run and marathon. With respect to muscle activities in a thigh of a marathon runner, it is known that the anterior part and the posterior part are incessantly turned on and off in an alternate manner. Namely, the agonist and the antagonist get active and take a rest alternately, with only one of them being active at a time. On the contrary, with respect to muscle activities in a thigh of a 100-meter sprinter, the anterior part and the posterior part contract simultaneously during exercise. Thus, depending on whether muscle activities are synchronous or asynchronous, muscle to be facilitated and inhibited are different. The above two factors, (i) necessity of reactive exercise against other players and (ii) time and direction of exercise, call for independent manners of stimulation input: a stimulation method directed to generation/use of muscular power and a stimulation method directed to improvement of skill in muscle activity.

<Point Stimulation and Surface Stimulation (Approaches to Muscle Adjustment)>

As proved by Margaret Rood, when a skin surface is rubbed partly and locally over certain muscles, superficial cutaneous nerves are stimulated. In turn, underlying muscles receive this stimulation and increase their muscle tone. On the other hand, when a skin surface is rubbed entirely and extensively over certain muscles, superficial cutaneous nerves are stimulated. In this case, underlying muscles receive this stimulation and decrease their muscle tone. An additional proposal is made by Rood and others (Stockmeyer S A. An interpretation of the approach of Rood to the treatment of neuromuscular dysfunction. In Bouman H D (ed.). An exploratory and analytical survey of therapeutic exercise: Northwestern University special therapeutic exercise project (pp. 900-956). Baltimore: The Williams & Wilkins Co, 1966.). As mentioned therein, in either case where a functional skin area which corresponds to a dermatome or a myotome is present or absent, if stroking, pressure, vibration, hot/cold stimulation, etc. is directly applied to the skin over a muscle to be facilitated or to the belly of that muscle, such stimulation induces various phenomena such as “pain relief,” “increase of sensitivity in a muscle spindle” and “suppression of perspiration” (Stockmeyer S A. Procedures for improvement of motor control. Unpublished notes from Boston University, PT710, 1978.). In addition to these phenomena, cutaneous stimulation “increases or decreases muscle tone,” “increases blood circulation,” “helps acquisition and consolidation (habitualization) of reflex,” or gives other additional effects. Theoretically, based on combinations of these cutaneous stimulation approaches, local or extensive stimulation of a desired muscle can transform proprioception for perceiving relative positions of body parts, thereby enables acquisition of an ideal exercise posture.

Intensity of the local stimulation (hereinafter simply called “point stimulation”) and the extensive stimulation (hereinafter simply called “surface stimulation”) only needs to be strong enough to be recognized by cutaneous receptors. The types of stimulation may be heat stimulation, mechanical stimulation, electrical stimulation, chemical stimulation, etc. Sensory receptors include Meissner's corpuscles, Merkel's disks, Pacinian corpuscles, Ruffini's corpuscles, Krause's end-bulbs, free nerve endings, etc. These receptors are connected via neurons which include A-fibers for facilitation and C-fibers for inhibition. Accordingly, the point stimulation, which facilitates neurotransmission in muscles, must be generated as a point-like stimulation to be recognized by A-fibers. The surface stimulation, which inhibits neurotransmission in muscles, must be generated as a surface-like stimulation to be recognized by C-fibers.

The range of point stimulation may be an area of about 4 cm.sup.2 designed to give point stimulation. Because a required range varies from muscle to muscle, it is properly determined according to the muscle whose tone should be increased. Insofar as the point stimulation is focused on a predetermined area designed to give point stimulation, both a single large point stimulation and a group of small point stimulations are practicable as the point stimulation. The location of point stimulation is not particularly limited and may be anywhere on a skin surface within an area ranging from the origin to the insertion of the muscle whose tone should be increased. The most preferable location is a skin surface corresponding to the vicinity of a motor point of the desired muscle. On a skin surface within an area ranging from the origin to the insertion of the desired muscle, the point stimulation may be applied to one or more locations.

The location of surface stimulation varies with the muscle whose tone should be decreased, but may be anywhere corresponding to the functional skin area of a muscle whose tone should be decreased. Basically, it is preferable to apply surface stimulation to the entire part of the functional skin area. However, as far as the surface stimulation can induce “closing of the pain gate” as described above, the range of surface stimulation is not strictly limited to the entire part of the functional skin area, but may be focused, for example, on a part corresponding to the belly of a muscle. Insofar as the surface stimulation is focused on a predetermined area designed to give surface stimulation, both a single large surface stimulation and a group of small point stimulations are practicable as the surface stimulation.

Point stimulation or surface stimulation to a skin surface causes transmission of excitation by the simplest reflex arc, namely, from receptors, to afferent (sensory) neurons, to efferent (motor) neurons, to effectors (in this context, muscles), and brings about muscle activity based on spiral reflex. Reflex actions under this situation are classified into stretch reflex and flexion reflex. However, exercise involving the whole body is not so simple as to be performed with these reflex actions alone. Whole body exercise requires other reflex actions based on postural reflex and balance reflex which are related with the brain stem and the cerebellum, respectively. Bearing this in mind, the present invention creates reflexes at a desired part of the body by stimulating cutaneous receptors from various directions and in diverse manners, thereby embodying an ideal exercise posture. Repeated exercise in this exercise posture can intensify extrapyramidal exercise activities, can unconsciously awaken ideal postural and balance reflexes, and can result in activities which unconsciously enable correct, speedy exercises with a little effort.

In increasing or decreasing muscle tone of superficial muscles, stimulation can be applied only to the desired muscles because there is no intervening muscle between the desired muscles and the skin surface. On the other hand, in increasing or decreasing muscle tone of deep muscles, some muscles intervene between the desired muscles and the skin surface. In this connection, it should be understood that exercise is not performed singly by superficial muscles, but rather controlled by cooperation of superficial muscles and underlying deep muscles. Hence, although arbitrary stimulation to the skin surface is said to affect superficial muscles alone, stimulation from the skin surface to superficial muscles can actually stimulate deep muscles coordinately.

<Facilitation by Point Stimulation and Inhibition by Surface Stimulation with Respect to Multiarticular Muscles and Monoarticular Muscles>

In any states indicated in FIGS. 80-87, when point stimulation is applied to low-tone multiarticular muscles and monoarticular muscles, it provides a facilitatory control of these muscles in most cases. When surface stimulation is applied to high-tone multiarticular muscles and monoarticular muscles, it provides an inhibitory control of these muscles in most cases. This combination can correct the muscles and joints toward an ideal posture indicated in FIGS. 88 and 89, and can improve power of muscle activity.

On the contrary, when point stimulation is applied to high-tone multiarticular muscles and monoarticular muscles, it emphasizes a facilitatory control of these muscles in most cases. When surface stimulation is applied to low-tone multiarticular muscles and monoarticular muscles, it emphasizes an inhibitory control of these muscles in most cases. Consequently, the muscles and joints deviate from an ideal posture indicated in FIGS. 88 and 89.

Nevertheless, there are some exceptions to these principles. Medically, the ROM (range of motion) of a joint is defined by physical measurements. In theory, the ROM of any ordinary person should match the ROM as measured. In practice, however, the ADL (activities of daily living) of some people is not as good as the ROM, while the ADL of others are greater than the ROM. Even among those who have sufficient flexibility, it is often the case that the ADL is not as good as the ROM. To give an example, among ballet dancers or the like who have the ability to do a front split and a side split perfectly, only a few of them can move the joints to the limit of the ROM (the range measured during static stretching) during actual performance. This gap is attributable to the gravity, muscular power against the gravity, and the like. Accordingly, if one's ADL is not as good as the ROM or if muscular power is not sufficient against the gravity, point stimulation is applied to a relevant muscle group. Then, the stimulation facilitates the muscle group and enhances the muscle contraction power, thereby bringing the ADL closer to the ROM.

In contrast, some muscles have low muscle tone but lack their own strechability. To make them more flexible, surface stimulation is applied to these low-tone muscles which are antagonistic to agonists. The surface stimulation can weaken antagonistic actions and can encourage agonistic actions, thereby facilitating the agonists.

<Specific Examples of Facilitation of Neurotransmission by Point Stimulation and Inhibition of Neurotransmission by Surface Stimulation>

Specific heat stimulation may be cold stimulation, hot stimulation, and the like. For example, heat stimulation for increasing neuronal excitation includes following methods: hot stimulation by applying BREATHTHERMO to the skin (BREATHTHERMO is a moisture absorbable/releasable heat-generating fiber manufactured by Mizuno Corporation.); cold stimulation by applying a metal to the skin; cold stimulation by letting air in through a stimulation part made of a mesh material; cold stimulation by applying cold spray or ice directly to the skin; hot stimulation by applying a disposable warmer or moxa cautery to the skin; cold stimulation by applying a disposable cooling sheet or coolant to the skin, and the like. It should be understood that these methods are effective in a presupposed temperature condition but may not be effective under the influence of outdoor temperature or other conditions. By way of example, it may be advisable in a cold climate to replace cold stimulation with hot stimulation, and in a moderate climate to replace hot stimulation with cold stimulation. This is due to a phenomenon called “change of muscle tonus”. Namely, the range of stimulation perceivable by human receptors is variable under diverse conditions, and in some cases, applied stimulation may not be properly recognized as such.

It should be also noted that if hot stimulation and cold stimulation are applied during strengthening of muscles, the effect of increasing muscular strength comes later than expected (Chastain P. The effect of deep heat on isometric strength. Phys Ther 58:543-546, 1978. Oliver R A, Johnson D J. The effect of cold water on post treatment leg strength. Phys Sports Med, November 1976. Oliver R A, Johnson D J, Wheelhouse W W, et al. Isometric muscle contraction response during recovery from reduced intramuscular temperature. Arch Phys Med Rehabilitation 60:126-129, 1979.). Insensible heat stimulation around the body temperature has effects of reducing muscle tone and soothing pain or the like. Heat stimulation, as represented by hot stimulation and cold stimulation, is also known to reduce spasms and convulsion in muscles and to be effective in soothing pain and swelling (Rood M. The use of sensory receptors to activate, facilitate, and inhibit motor response, autonomic and somatic, in developmental sequence. In Sattely C (ed.). Approaches to the treatment of patients with neuromuscular dysfunction. Dubuque, Iowa: WMC Brown, 1962.). For these reasons, it should be remembered that the above manners of heat stimulation input to the skin are only applicable to mental/physical relaxation, decrease of muscle tone, pain relief, and other like effects.

Specific physical/mechanical stimulation includes friction, percussion, vibration, tissue pull, pressure), etc. Physical/mechanical stimulation can increase neuronal excitation by applying an item to the skin, including a vibrator, raised cloth or a fabric having a compression-bonded silicone resin projection, a pointed projection made of metal or the like, a self-adhesive element (e.g. self-adhesive bandage), a rough fiber, and the like. Also in this type of stimulation, change of muscle tonus as above is probable as mentioned above. By way of example, for some exercises which involve vibratory stimulation (e.g. tennis and other sports which involve hitting actions), input of vibratory stimulation to the free upper limb and the pelvic girdles may be affected by change of muscle tonus.

Specific electrical stimulation includes low-frequency stimulation, high-frequency stimulation, magnetic stimulation, and the like. Electrical stimulation can be provided by locally applied electrodes, application of a magnetic metal to the skin, and other like manners.

Specific chemical stimulation includes, for example, stimulation sensed on contact with chemical substances. Chemical stimulation can be provided by applying certain substances to the skin, such as volatile chemical substances (e.g. alcohol, eucalyptus oil), so-called warm-up cream which contains capsaicin or citrus extracts (acids), and the like. Preferably, chemical stimulation should not be so intense as to damage the skin and cause pain.

Such point stimulation or surface stimulation can be applied by a combination of two or more methods mentioned above. Examples of point stimulation are illustrated in FIG. 11. Point stimulators 1 of FIG. 11(a) are made of peelable self-adhesive elements 12 (e.g. self-adhesive bandages) which have a circular shape with a diameter of about 2 cm, and their adhesive surfaces are coated with an active ingredient 1a capable of giving chemical stimulation. These point stimulators 1 are thus arranged to provide physical/mechanical stimulation and chemical stimulation. Point stimulators 1 of FIG. 11(b) have magnetic metals 1b mounted on adhesive surfaces of similar self-adhesive elements 12. These point stimulators 1 are thus arranged to provide physical/mechanical stimulation and electrical stimulation. Examples of surface stimulation are illustrated in FIG. 12. A surface stimulator 11 of FIG. 12(a) is made of a peelable self-adhesive element 13 (e.g. a self-adhesive bandage) in strip form, and its adhesive surface is coated with an active ingredient 1a capable of giving chemical stimulation. This surface stimulator 11 is thus arranged to provide physical/mechanical stimulation and chemical stimulation. A surface stimulator 11 of FIG. 12(b) has magnetic metals 1b mounted on an adhesive surface of a rectangular self-adhesive element 14. This surface stimulator 11 is thus arranged to provide physical/mechanical stimulation and electrical stimulation.

Additionally, the following points should be remembered with respect to the stimulation detailed above. First, as taught by Rood, there is a 30-second latency period before stimulation takes effect, and the maximum effect comes after stimulation is applied for 30 to 40 minutes. In other words, for the maximum effect, it is necessary to apply stimulation for 30 to 40 minutes (Rood M. The use of sensory receptors to activate, facilitate, and inhibit motor response, autonomic and somatic, in developmental sequence. In Sattely C (ed.). Approaches to the treatment of patients with neuromuscular dysfunction. Dubuque, Iowa: WMC Brown, 1962.). Hence, continuous input of stimulation is essential. Second, a human being cannot acquire reflex activities unless the person performs exercise continuously for 16 seconds or more without a break (Ito, Masao. Neuronal physiology. Tokyo: Iwanami Shoten, 1976.). Third, sensory receptivity of the human skin or the like is soon accustomed and adapted to such stimulation (Spicer S D, Matyas T A. Facilitation of the TVR by cutaneous stimulation. AMJ Phys Med 59:223-231, 1980. Spicer S D, Matyas T A. Facilitation of the TVR by cutaneous stimulation in hemiplegics. AMJ Phys Med 59:280-287, 1981.).

To address these matters, a point stimulation input should locate in the functional skin area of a desired muscle or over a belly a desired muscle (Rood M. The use of sensory receptors to activate, facilitate, and inhibit motor response, autonomic and somatic, in developmental sequence. In Sattely C (ed.). Approaches to the treatment of patients with neuromuscular dysfunction. Dubuque, Iowa: W MC Brown, 1962.). In addition, it is preferable to satisfy at least one of the following four requirements:

1. The point of stimulation input changes constantly from one location to another over a desired muscle.

2. The manner of stimulation input changes constantly.

3. Information about stimulation input changes constantly (e.g. variation of stimulation intensity).

4. The period of stimulation input changes constantly and continually.

Similarly, to address these matters, a surface stimulation input should be located in the functional skin area of a desired muscle or over a belly of a desired muscle (Rood M. The use of sensory receptors to activate, facilitate, and inhibit motor response, autonomic and somatic, in developmental sequence. In Sattely C (ed.). Approaches to the treatment of patients with neuromuscular dysfunction. Dubuque, Iowa: W MC Brown, 1962.). Besides, the range of stimulation should be wide enough to induce “closing of the pain gate” and to reduce muscle tone. In addition, it is preferable to satisfy at least one of the following four requirements:

1. The surface of stimulation input changes constantly from one location to another over a desired muscle.

2. The manner of stimulation input changes constantly.

3. Information about stimulation input changes constantly (e.g. variation of stimulation intensity).

4. The period of stimulation input changes constantly and continually.

<Point Stimulator (Repositioning Device)>

—Non-Electric Repositioning Device—

To satisfy the above requirements, repositioning devices 1 shown in FIG. 13 are provided. Each of these repositioning devices 1 is composed of a case 2 which is made applicable to the skin surface A of the human body. A hollow chamber 20 of this case 2 contains pieces 3.

Vibrations are generated by collision between the pieces 3 and the inside of the hollow chamber 20. In order to transmit the vibrations to the skin surface A of the human body to which the case 2 is applied, the case 2 is preferably made of rigid materials which have an excellent vibration transmission property (such as metals, minerals, various ceramic materials, and rigid plastic materials). The case 2 should be large enough to facilitate a muscle whose location corresponds to an area where the case 2 is applied to the skin surface A of the human body. If the case 2 is too large, it provides surface stimulation for promoting reduction of muscle tone, and its bulkiness is uncomfortable to a user. Presuming that the case 2 may be applied to the skin surface A at any area of the human body, the case 2 is preferably prepared in a smallest possible size. The external shape of the case 2 is not particularly limited and may be, for example, in various shapes including a sphere, polyhedron, hemisphere, semi-regular polyhedron, cylinder, prism, pyramid, and cone. Likewise, the shape of the hollow chamber 20 is not particularly limited as far as the pieces 3 can readily roll and bounce therein in response to body movement. For example, the hollow chamber 20 may be in various shapes including a sphere, polyhedron, hemisphere, semi-regular polyhedron, cylinder, prism, pyramid, and cone, or other shapes which neither catch the pieces 3 therein nor obstruct their rolling-bouncing movements.

In order that the pieces 3 can hit the inside of the hollow chamber 20 and can thereby make the case 2 vibrate, the pieces 3 are preferably made of rigid materials which have an excellent vibration transmission property (such as metals, minerals, various ceramic materials, and rigid plastic materials). As for the size of the pieces 3, the only requirement is to secure a rolling-bouncing space inside the hollow chamber 20. Specifically speaking, if the hollow chamber 20 is to hold one piece 3 therein, the piece 3 may be large to some extent. On the other hand, if the hollow chamber 20 is to hold more than one pieces 3 therein, they have to be small enough to secure a sufficient space for rolling and bouncing. In addition, if the pieces 3 are too many, they are feared to collide with each other and offset vibrations which have just been generated. Accordingly, the number of pieces 3 is not particularly limited, but preferably about five or less. The shape of the pieces 3 may be in the form of spheres, polyhedrons of various types, randomly crashed granules, or the like. In the above description, the pieces 3 are designed to hit the inside of the hollow chamber 20 and thereby to make the case 2 vibrate. Instead, they may be arranged to simply roll and bounce inside the hollow chamber 20 so that the center of gravity of the case 2 can keep changing all the time. When the center of gravity of the case 2 keeps changing, such changes can be perceived by receptors at the skin surface A of the human body to which the case 2 is applied. As the pieces 3 for changing the center of gravity of the case 2, various types of granules or fluids may be fed, not fully, into the hollow chamber 20.

In use, the thus structured repositioning device 1 is applied to the skin surface A of the human body, specifically within an area ranging from the origin to the insertion of a desired muscle. The repositioning device 1 may locate anywhere from the origin to the insertion, but most preferably near a motor point of a desired muscle. The repositioning device 1 may be applied to the skin surface by following methods. Firstly, as shown in FIG. 13(a), the repositioning device 1 may be adhered to the skin surface A of the human body via an adhesive 15 such as a double-face tape. In order to prevent the repositioning device 1 from peeling off, the repositioning device 1 is preferably flat and smooth on at least a face to be applied to the skin surface A of the human body. Secondly, as shown in FIG. 13(b), the repositioning device 1 applied to the skin surface A of the human body may be covered by a self-adhesive element 12 such as an adhesive plaster. In this case, skin receptors are also stimulated by the self-adhesive element 12 which is adhered to the skin surface A of the human body. Hence, a self-adhesive element 12 with an overly large adhesion area provides surface stimulation for promoting reduction of muscle tone. Anyway, since the method using a self-adhesive element 12 meets none of the four requirements mentioned above, its effect diminishes over time. In addition, for a while after the self-adhesive element 12 is adhered, it rather provides surface stimulation for promoting reduction of muscle tone. Therefore, when the repositioning device 1 is adhered to the skin surface A of the human body by a self-adhesive element 12, its size should preferably be a smallest possible size for adhesion. Thirdly, as shown in FIG. 13(c), the repositioning device 1 may be fixed on the skin side of a garment 100 and applied to the skin surface A of the human body via the garment 100. To fix the repositioning device 1 on the garment 100, a pin (not shown) which projects from the repositioning device 1 is engaged with a clutch 1c, just as a lapel pin is engaged and disengaged. As yet another method, the repositioning device 1 may be directly fixed on the skin side of a garment 100 by bonding, melting, sewing and the like. As still another method, the case 2 may be made of a magnetic material, and the repositioning device 1 disposed on the skin side of a garment may be fixed by a magnet (not shown) disposed on the outside of the garment.

Similar point stimulators 1 which satisfy the above-mentioned requirements may utilize: filaments 1e mounted on a surface of an adhesive-applied base 1d which can adhere to a skin A (FIG. 14); a spring if mounted on a surface of the base 1d (FIG. 15); a projection 1g mounted on a surface of the base 1d (FIG. 16); an aerially swaying member 1h mounted on a surface of the base 1d (FIG. 17); a string 1i mounted on a surface of the base 1d, and a weight 1j attached to the tip of the string 1i (FIG. 18); a fluid pad 1k (like a water bag) mounted on a surface of the base 1d (FIG. 19); and the like. Regarding the point stimulator 1 of FIG. 14 equipped with filaments 1e, the filaments 1e sway irregularly in response to human movement, wind or the like, thereby rubbing the surface of the skin A in various manners. Regarding the point stimulator 1 of FIG. 15 equipped with a spring 1f, the spring if stretches and contracts irregularly in response to human movement, thereby pulling the adhesion surface of the base 1d in various mariners. Regarding the point stimulator 1 of FIG. 16 equipped with a projection 1g, the projection 1g irregularly hits a garment 100 while a person wears it, thereby being pushed back onto the skin A by the garment or pulling the adhesion surface of the base 1d. Regarding the point stimulator 1 of FIG. 17 equipped with an aerially swaying member 1h, the aerially swaying member 1h sways irregularly due to wind or the like, thereby pulling the adhesion surface of the base 1d in various manners. Regarding the point stimulator 1 of FIG. 18 equipped with a weight 1j which is attached to the tip of a string 1i, the weight 1j irregularly hits random positions around the base 1d in response to human movement, thereby stimulating the surface of the skin A in various manners. Regarding the point stimulator 1 of FIG. 19 equipped with a fluid pad 1k, the fluid pad 1k moves irregularly in response to human movement, thereby pulling the adhesion surface of the base 1d in various manners.

—Vibration-Generating Repositioning Device—

A repositioning device 1 illustrated in FIG. 20 can also satisfy the above-mentioned requirements. This repositioning device 1 has a case 2 which encloses a vibration generator 4, a power source 5 and a controller 6.

The case 2 is assembled into a cylinder form (thickness: about 10 mm, diameter: about 25 mm) by combining a pair of semi-closed cylinders 21, 22 made of a nylon resin. The semi-closed cylinders 21, 22 are integrally snapped or screwed into each other via a seal ring 23. The material for the case 2 is not particularly limited unless it causes rashes or allergic reactions or hurts the human skin otherwise. Other than nylon resins, the case 2 may be made of metals, minerals, various ceramic materials, or plastic materials. To be specific, it may be made of ABS resins, polypropylene resins or the like.

The vibration generator 4 may be a piezoelectric unit. This vibration generator 4 is integrated into a hole 24 which is bored in the first semi-closed cylinder 21 of the case 2, such that the vibration generator portion of the case 2 touches the human skin directly.

The power source 5 may be a coin cell battery. The power source 5 is mounted in a power box 25 which is disposed in the second semi-closed cylinder 22 of the case 2. From the power box 25, a pair of parallel electrodes 26 extend with a certain gap therebetween. A dent 27 is formed in an external surface of the second semi-closed cylinder 22 so as to receive a magnet 28. With the magnet 28 fitted in the dent 27, the electrodes 26 are arranged to attract and touch each other by a magnetic force of the magnet 28, thereby turning on the power source 5. Conversely, when the magnet 28 is removed from the dent 27 in the second semi-closed cylinder 22, the power source 5 is turned off.

The circuitry of the controller 6 can be made up of such electric components as CPU, IC, RLC, and Tr. FIG. 21 is a block diagram of the controller 6, in which a control board 61 includes a vibration unit/speed regulation unit 62, a level regulation unit 63, an output control unit 64, and a CPU (timing control) 65. As described earlier, there is a 30-second latency period before stimulation takes effect. In light of this knowledge, the controller 6 needs to control the vibration generator 4 in such a manner as to provide vibratory stimulation for at least 30 seconds or more without a break. Besides, in order to facilitate a muscle by muscle stimulation, it is necessary to generate vibrations in a range of 3 Hz to 5 MHz. For the best effect, it is preferable to generate vibrations from 100 Hz to 200 Hz. Incidentally, suppose that vibratory stimulation is applied by alternating ten seconds of vibratory stimulation and five seconds of rest. In some cases, the human body does not take the five-second rest as a break in the vibratory stimulation, but rather recognizes as if vibratory stimulation was applied incessantly while the vibration-rest pattern is going on. In other cases, the human body precisely distinguishes between the ten-second vibratory stimulation and the five-second rest. It can be understood that the former situation presents no problem, whereas the latter situation cannot satisfy the latency period requirement of 30 seconds or more. Therefore, vibratory stimulation is preferably applied by alternating 30 seconds or more of continuous vibratory stimulation and a desired time of rest. Most preferably, in the case where the vibration stimulation of 30 seconds or more alternates with a desired time of rest, it is advisable to conduct fuzzy control of at least the input time of vibratory stimulation or its intensity, so as to prevent receptors in the human body from getting insensitive to stimulation input.

The control board 61 of the controller 6 for controlling such vibratory stimulation can be embodied in various manners with use of a general logic, a CPU alone, a programmable logic, passive components, or the like. Specifically, the repositioning device may be classified as a general-purpose device or a special-purpose device. A general-purpose repositioning device, whose operation cycle is determined in the design/manufacture stage, is used for general applications as the term suggests. A special-purpose repositioning device can reprogram and rewrite its operation cycle according to the purpose of use, application, etc. A special-purpose repositioning device 1 shown in FIG. 22 allows a write device 7 to reprogram and rewrite, via a write cable 71, the intensity and time of stimulation input whenever desired. Although the repositioning device 1 of FIG. 22 is connected to the write device 7 via the write cable 71, the repositioning device 1 may be directly set on the write device 7 and may thus enable reprogramming. The special-purpose repositioning device 1 can be effectively used in the following cases: when specialized rehabilitation or the like is required after serious injuries such as bone fracture; when temporary muscle weakness, imbalance of muscular power or the like is caused by muscle damages (as represented by bruise, pulled muscle, etc.) and recovery from such symptom needs to be promoted; when moderate (not severe) injuries or potential injuries cause muscle imbalance; for symptoms such as lumbar pain, stiff shoulders, and an abnormal Q angle; and for aged people who requires a higher intensity of stimulation than general people because aging makes facilitation difficult. Particularly, since aged people are less sensitive to stimulation to the skin or the like, it is not rare for them to get injured accidentally by heat stimulation, electrical stimulation and the like. However, this vibration-generating repositioning device 1 can avoid such injuries.

The repositioning device 1 of the above structure is used in combination with a garment 100 (such as a pair of tights or a shirt) which closely fits on the human body. To start with, a person puts on a garment 100, with the repositioning device 1 being applied to a skin surface in an area ranging from the origin to the insertion of a desired muscle. Next, from the outside of the garment 100, the magnet 28 is fitted into the dent 27 which is formed in an external surface of the second semi-closed cylinder 22. With the magnetic force of the magnet 28, the electrodes 26 attract and touch each other, thereby turning on the power source 5 and activating the repositioning device 1. The repositioning device 1 itself is fixed on the garment 100 by holding it between the dent 27 and the magnet 28. Thus, when a person wears the garment 100 and activates the repositioning device 1 for a desired muscle, the muscle is facilitated. Consequently, if the person plays a sport in this facilitated state, he/she can pay attention to the usually less conscious muscle and do workouts in an ideal form. Also in daily activities, this repositioning device can create an ideal body balance by facilitating less conscious muscles which disturb body balance, thereby curing lumbar pain and other symptoms which result from deficit in body balance. Of course, those who do not suffer from such symptoms can also employ the repositioning device and create an ideal body balance and an ideal physique.

The vibration generator 4 of the repositioning device 1 may be those illustrated in FIG. 23. The vibration generators 4 of FIGS. 23(a) and (b) are equipped with cones 41a on a vibration transmission surface 21a of the semi-closed cylinder 21. In these arrangements, vibrations from piezoelectric units 41 are transmitted via the cones 41a to the entire part of the semi-closed cylinder 21, and thereby make the case 2 vibrate as a whole. The vibration generator 4 of FIG. 23(c) is equipped, via a rubber 41b, with a vibration transmission member 41c which is arranged to protrude outwardly from the center of the vibration transmission surface 21a. The vibration transmission member 41c is arranged to vibrate with vibrations of the piezoelectric unit 41 and thereby to generate vibrations at the center of the vibration transmission surface 21a. In the vibration generator 4 of FIG. 23(d), the vibration transmission surface 21a of the semi-closed cylinder 21 is thinner at the center, and the piezoelectric unit 41 is processed in a convex form touching the thinner part. This vibration generator 4 is arranged to transmit vibrations from the piezoelectric unit 41 directly to the thinner part, and thereby to make the thinner part vibrate. The vibration generator 4 of FIG. 23(e) is arranged to be capable of containing granules' 41d such as beads between the vibration transmission surface 21a of the semi-closed cylinder 21 and the piezoelectric unit 41. This vibration generator 4 is arranged to make the granules 41d bounce with vibrations of the piezoelectric unit 41. The vibration generator 4 of FIG. 23(f) includes an air chamber 21b therein, with a hole 24 being bored through the vibration transmission surface 21a of the semi-closed cylinder 21. In this arrangement, vibrations of the piezoelectric unit 41 cause air to come in and out of the air chamber 21b through the hole 24, whereby air vibrations are transmitted to the skin surface A of the human body. The vibration generator 4 of FIG. 23(g) includes an air chamber 21b therein, with a hole 24 being bored through the vibration transmission surface 21a of the semi-closed cylinder 21 and covered with a film 41e. In this arrangement, vibrations of the piezoelectric unit 41 propagate to the film 41e through the air within the air chamber 21b, whereby vibrations of the film 41e are transmitted to the skin surface A of the human body. The vibration generator 4 of FIG. 23(h) has a projection 41f which sticks out through the vibration transmission surface 21a of the semi-closed cylinder 21. Inside the semi-closed cylinder 21, the basal end of the projection 41f is bonded to the piezoelectric unit 41. In this arrangement, vibrations of the piezoelectric unit 41 are transmitted via the projection 41f to the skin surface A of the human body.

Instead of a piezoelectric unit, the vibration generator 4 may utilize a motor, a vibration motor, a solenoid, a vibration module (an electromagnet), a piezoelectric bimorph, and the like, as shown in FIG. 24. The vibration generator 4 of FIG. 24(a) is arranged to generate vibrations when rotation of a motor 42 causes gears 42a to hit a flap 42b. The vibration generator 4 of FIG. 24(b) is arranged to generate vibrations when rotation of a motor 42 causes a weight 42c to hit a flap 42b. In the vibration generator 4 of FIGS. 24(c) and (d), a flap 42b is attached to a shaft 42d of a motor 42, and gears 42a are provided inside the semi-closed cylinder 21. This vibration generator is arranged to generate vibrations when rotation of the motor 42 causes the flap 42b to hit the gears 42a. In the vibration generator 4 of FIG. 24(e), a weight 42c is attached to a shaft 42d of a motor 42. This vibration generator 4 is arranged to generate vibrations when rotation of the motor 42 disturbs the weight balance. The vibration generator 4 of FIG. 24(f) is equipped with a button-shape vibration motor 43 on the inner side of the vibration transmission surface 21a of the semi-closed cylinder 21, and is arranged to vibrate the vibration transmission surface 21a directly. The vibration generator 4 of FIG. 24(g) is arranged to generate vibrations when a plunger 44a of a solenoid 44 hits an obstruction 44b by a push or pull action of the plunger 44a. In the vibration generator 4 of FIG. 24(h), weights 44c are attached to extreme ends of plungers 44a of a solenoid 44. This vibration generator 4 is arranged to generate vibrations when the weights 44c directly hit the inside of the semi-closed cylinder 21 by a push or pull action of the plungers 44a. In the vibration generator 4 of FIG. 24(i), a magnet 45a is attached to an extreme end side of a leaf spring 45. This vibration generator 4 is arranged to move the magnet 45a with a change of the magnetic field, to vibrate the leaf spring 45 and the magnet 45a at a resonance point, and to amplify vibrations with a weight 45b. The vibration generator 4 of FIG. 24(j) is arranged to generate vibrations with stretch and contraction of a piezoelectric ceramic 46.

There is no specific limitation for the types of vibrations generated by these vibration generators 4. A variety of vibrations which can stimulate receptors may be utilized as given in FIG. 25, including flexure vibration 4a, lengthwise vibration 4b, area vibration 4c, longitudinal vibration 4d, thickness-shear vibration 4e, trapped thickness vibration 4f, surface acoustic wave 4g, and so on.

As mentioned earlier, the repositioning device 1 is arranged to turn on the power source 5, by fitting the magnet 28 into the dent 27 formed in the external surface of the second semi-closed cylinder 22 and thereby bringing the electrodes 26 into contact with each other. However, instead of such magnetic contact between the electrodes 26, the power source 5 may be turned on by a push button switch or a slide switch (not shown) which is provided on the case 2.

Also as mentioned earlier, the repositioning device 1 is arranged to be fixed on a garment 100 by holding it between the case 2 and the magnet 28, and to be applied to the skin surface A of the human body via the garment 100. However, instead of holding the garment magnetically, the repositioning device 1 may be fixed by other manners. Referring again to FIG. 13(c), the repositioning device 1 may be fixed like a lapel pin, wherein a pin (not shown) which sticks out from the case 2 is tacked on the garment 100 and received by the clutch 1c. Alternatively, the repositioning device 1 may be directly fixed on the skin side of the garment 100. Furthermore, the repositioning device 1 may be applied to the skin surface A of the human body without using the garment 100. As described with reference to FIGS. 13(a) and (b), the repositioning device 1 may be directly adhered to the skin surface A of the human body by the adhesive 15 such as a double-face tape or the self-adhesive element 12.

Turning next to FIG. 26, the repositioning device 1 may be driven by other means than a coin cell battery. This repositioning device 1 is composed of two separate bodies: a case 2 which contains a vibration generator 4; and a device body 60 which contains a power source 5 and a controller 6. Radio signals are sent from a transmit antenna 66 in the device body 60, received by a receive antenna 40 in the case 2, and transformed into an electric power for generating vibrations at the vibration generator 4. In this structure, the device body 60 may be powered by a battery or a domestic power source at AC 100V.

Referring further to FIG. 27(a), the repositioning device 1 may adopt conductive charging, for which an electric contact 72 is provided in the case 2 and connected to an electric contact 73 in a dedicated charger 70. Alternatively, as shown in FIG. 27(b), the repositioning device 1 may adopt inductive charging, for which a receiver coil 8 is provided in the case 2 and located face to face with a transmitter coil 81 in a dedicated charger 80.

With respect to the repositioning device 1, the case 2 is made by combining a pair of semi-closed cylinders 21, 22. However, instead of the combination of the semi-closed cylinders 21, 22, the case 2 may be composed of a single semi-closed cylinder 21 and a round lid which integrally covers an opening of the semi-closed cylinder 21. The latter structure for the case 2 can be similar to the structure for various cases for wristwatches and the like.

<Surface Stimulator>

To satisfy the above-mentioned requirements for surface stimulation, FIG. 28 shows an example of a surface stimulator 11. In this surface stimulator 11, a plurality of vibrators 1 of FIG. 13 are disposed on a surface of a base 11a whose area is equivalent to a functional skin area of a desired muscle. In daily activities, while the surface stimulator 11 is adhered to the skin A, pieces 3 in each vibrator 1 irregularly hit random positions within the hollow chamber 20 in response to human movement, thereby generating vibrations in various manners. As a result, this surface stimulator can hinder sensory receptivity of the human skin A from getting adapted or unresponsive to stimulation. A variation of the surface stimulator 11 (FIG. 29) may have a plurality of springs if of FIG. 15 mounted on a surface of a base 11a whose area is equivalent to a functional skin area of a desired muscle. Another variation of the surface stimulator 11 (FIG. 30) may have a plurality of projections 1g of FIG. 16 mounted on a surface of a base 11a whose area is equivalent to a functional skin area of a desired muscle. Yet another variation of the surface stimulator 11 (FIG. 31) may have a plurality of aerially swaying members 1h of FIG. 17 mounted on a surface of a base 11a whose area is equivalent to a functional skin area of a desired muscle. Still another variation of the surface stimulator 11 (FIG. 32) may have a fluid pad 1k which is greater than the one of FIG. 19. The fluid pack 1k is mounted entirely across the surface of a base 11a whose area is equivalent to a functional skin area of a desired muscle. A variation of the surface stimulator 11 (FIG. 33) may have a plurality of electric point stimulators 1 of FIG. 20 mounted on a surface of a base 11a whose area is equivalent to a functional skin area of a desired muscle. Regarding the surface stimulator 11 of FIG. 29 equipped with a plurality of springs 1f, each of the springs if stretches and contracts irregularly in response to human movement, thereby pulling the adhesion surface of the base 11a in various manners. Regarding the surface stimulator 11 of FIG. 30 equipped with a plurality of projections 1g, each of the projections 1g irregularly hits a garment 100 while a person wears it, thereby being pushed back onto the skin A by the garment or pulling the adhesion surface of the base 11a. Regarding the surface stimulator 11 of FIG. 31 equipped with a plurality of aerially swaying members 1h, each of the aerially swaying members 1h sways irregularly due to wind or the like, thereby pulling the adhesion surface of the base 11a in various manners. Regarding the surface stimulator 11 of FIG. 32 equipped with a fluid pad 1k, the fluid pad 1k moves irregularly in response to human movement, thereby pulling the adhesion surface of the base 11a in various manners. Regarding the surface stimulator 11 of FIG. 33 equipped with a plurality of electric point stimulators 1, the frequency of each point stimulator 1 changes diversely, thereby stimulating the skin A in various manners.

In the above description, the point stimulators 1 and the surface stimulators 11 are arranged to be directly applied to the human skin A. Additionally, the point stimulators 1 and the surface stimulators 11 may be attached to a garment 100.

<Garment>

As mentioned already, a point stimulation part and a surface stimulation part can be formed on a certain part of a garment in such a manner as to provide point stimulation and surface stimulation to the human body, with a person wearing the garment.

The type of garment is not particularly limited as far as a point stimulation part and a surface stimulation part are arranged to stimulate superficial nerves of the skin. The garments are arranged to fit closely on the skin and include, for example, sports underwear, tights, shorts, swimwear, sports bras, high socks, leg warmers, knee warmers, swimming caps, stockings, general underwear, belly belts, etc. Preferably, seams in these garments are arranged not to stimulate superficial nerves of the skin. Such a consideration is embodied in the following manners. For example, using an automatic circular knitting machine (e.g. circular knitting machine produced by Santoni S.p.A. in Italy, model: SM8), a whole garment can be knitted in a tubular, body-fitting shape with minimum possible seams. In another example, a thermofusible polyurethane film or the like (used for pants hemming, etc.) can be sandwiched between pieces of fabric which need to be stiched together. The thermofusible material is melted under heat, so that the two pieces can be fused together by a seam of hot-melt bonding type. In yet another example, pieces of fabric can be fused at their edges by induction heating using a RF welder. Alternatively, each seam may be designed to locate on a surface stimulation part, on the outside of a garment rather than on the skin side, or on a muscular groove. Even after seam-originated stimulation is eliminated, it is preferred to minimize overall stimulation which results from contact between the garment itself and the skin, in order to emphasize the stimulation given by a point stimulation part and a surface stimulation part.

In the sense of effective application of point stimulation and surface stimulation to the human body, a garment is preferably arranged to fit closely to the skin. Nevertheless, a garment which touch the skin according to wearer's movement (e.g. a T-shirt) may be arranged to stimulate superficial nerves of the skin by a point stimulation part and a surface stimulation part during such movement.

With respect to a base fabric of a garment, yarns may be made of chemical fibers such as synthetic resins (polyesters, nylons, acrylic resins, polypropylenes, polyurethanes, etc.), semisynthetic fibers (diacetates, triacetates, etc.) and regenerated fibers (rayons, polynosic, etc.); natural fibers such as animal fibers (wool, silk, etc.) and plant fibers (cotton, hemp, etc.); or a combination thereof.

In particular, following yarns are advantageous for sport-oriented wear: multilobal polyester yarns for imparting moisture absorbing property and improved perspiration absorbability; hollow yarns for production of light-weight products; polyurethane-blend yarns for stretchability.

The fabric may be made by weft knitting (circular knitting, flat knitting) which makes loops, warp knitting (tricot knitting, raschel knitting, etc.) or weaving of intersecting warp and weft. The fabric may also be a non-woven fabric in which fibers are held together.

Preferably, the point stimulation part and the surface stimulation part to be formed on the garment are as durable as the garment itself and suitable for repeated use. According to claim 18, stimulation is provided by a projection, which may for example be one or more projecting printed dots made of silicone or other resins or may be one or more metal fittings such as rivets. Such projection is formed only at locations corresponding to the point/surface stimulation part on the skin side (the surface to touch the skin) of the garment.

FIG. 34 relates to the use of a hook-and-loop surface tape composed of a hook tape element and a loop tape element. As illustrated, a point stimulator 1 having an area of about 4 cm.sup.2 is made of a hook-and-hook tape, both surfaces of which are hook tape elements. To form a point stimulation part 10a on a garment 100, a first surface 16 of the point stimulator 1 is adhered to a desired position on the skin side (the surface to touch the skin A) of a fabric 10 which constitutes the garment 100. Likewise, a surface stimulator 11 of FIG. 36 is made of a hook-and-hook tape whose size is equivalent to a functional skin area of a desired muscle. To form a surface stimulation part 10b on a garment 100, a first surface 16 of the surface stimulator 11 is adhered to a desired position on the skin side (the surface to touch the skin A) of a fabric 10 which constitutes a garment 100. Such point stimulator 10a and surface stimulator 10b can stimulate the skin surface A by their second surfaces 17.

Referring back to FIG. 35, a point stimulator 1 may be made of a pin 18 and a clutch 19 which are engaged and disengaged like a lapel pin. To form a point stimulation part 10a on a garment 100, the point stimulator 1 fixedly holds a fabric 10 of the garment 100 between the pin 18 and the clutch 19. Likewise, to form a surface stimulation part 10b on a garment 100 (see FIG. 37), a plurality of such point stimulators 1 may be disposed at a suitable interval entirely across the functional skin area of a desired muscle.

Incidentally, the point stimulator 1 and the surface stimulator 11 which are directly adhered to the skin A are caused to move with user's movement. In contrast, the point stimulation part 10a and the surface stimulation part 10b which are formed on the garment 100 move moderately within intended stimulation positions in response to human movement. Therefore, the latter can continue irregular stimulation input at intended positions and can hinder adaptation or unresponsiveness to stimulation. Accordingly, unlike the point stimulator 1 and the surface stimulator 11 which are directly adhered to the skin A, the garment 100 equipped with point stimulation part 10a and/or the surface stimulation part 10b does not need an intentional arrangement for hindering sensory receptivity of the human skin A from getting adapted or unresponsive to stimulation. Nevertheless, incorporation of such an arrangement is more preferable (see FIG. 13(c) and FIG. 20).

By way of example, FIG. 13(c) shows a garment 100 which incorporate such an arrangement. During activities, the garment 100 itself moves moderately within an intended stimulation position in response to wearer's movements, and hinders adaptation or unresponsiveness to stimulation. In the point stimulation part 10a itself, the pieces 3 irregularly hit random positions of the hollow chamber 20, thereby generating vibrations in various manners. Accordingly, with a person wearing this garment 100, it can further hinder sensory receptivity of the human skin A from getting adapted and unresponsive to stimulation. For a surface stimulation part 10b, a plurality of point stimulators 1 shown in FIG. 13(c) are attached to a part of the garment 100 corresponding to the entire functional skin area of a desired muscle.

Regarding claim 19, stimulation is provided by a projecting pattern formed on the inner surface of a fabric, the projecting pattern being formed after the fabric is manufactured. As such, a fabric made by knitting, weaving or the like can be subjected to so-called embossing. For example, recessed pattern is engraved onto a fabric under heat and pressure, whereby a projecting pattern can be formed on the skin side of the fabric. Alternatively, after the making of a fabric composition, only an intended part of the fabric is subjected to a raising process to obtain a raised surface.

Regarding claim 20, heat stimulation and cold stimulation are provided in following manners. To increase neuronal excitation by heat stimulation, a moisture-absorbing, heat-generating fiber can be knitted or woven into the skin side of a fabric composition for a garment, at areas for the point stimulation part or the surface stimulation part (the surface to touch the skin); or a fabric made of this fiber (e.g. “BREATH THERMO” manufactured by Mizuno Corporation) can be sewn, bonded, or attached otherwise onto the point stimulation part or the surface stimulation part. To increase neuronal excitation by cold stimulation, a highly heat-conductive fiber (e.g. ethylene vinyl alcohol fiber) can be similarly knitted or woven into the skin side of a fabric composition for a garment; or a fabric made of this fiber (e.g. “ICE TOUCH” manufactured by Mizuno Corporation) can be sewn, bonded, or attached otherwise onto the point stimulation part or the surface stimulation part. Additionally, in the point stimulation part or the surface stimulation part, portions to touch the skin may be made of a fiber which readily holds moisture (e.g. natural cotton fiber, superabsorbent polymer fibers). When such a fiber absorbs sweat during exercise, the moisture can induce cold stimulation. Furthermore, the fabric composition at a stimulating portion may be a mesh weave. The mesh weave exposes the skin to outside air, and effectively provides cold stimulation by air cooling.

Regarding claim 21, stimulation is provided by a fabric composition. As such, a stimulating portion on the fabric may be made in a projecting pattern and allowed to touch the skin surface. This can be done by using a pile fabric (including imitation pile, boa, and the like) at an area to be stimulated. Alternatively, the point stimulation part and the surface stimulation part may be made in float stitch which involves circular knitting of a knit fabric or in plate stitch by which one of yarns forms a projecting pattern on the skin/back side). As a woven fabric, a double weave fabric may be employed at a stimulating portion.

Regarding claim 22, stimulation is provided by a combination of different fibers. Combinations among synthetic fibers include the following. First, provided that yarns have a same thickness, a base fabric is made of a high filament count yarn, and the point stimulation part and the surface stimulation part are made of a low filament count yarn. Second, provided that yarns have a same thickness and a same filament count, a base part is made of a low elastic fiber, and the point stimulation part and the surface stimulation part are made of a high elastic fiber. Third, the point stimulation part and the surface stimulation part are made of filaments, and the base part is made of staples which are prepared by cutting the filaments short. Fourth, a base part is made of a grey yarn as spinned, and the point stimulation part and the surface stimulation part are made of a grey yarn subjected to false twisting. Combinations including natural fibers may be: a fiber which strongly stimulates the skin (e.g. wool) and a fiber which usually stimulates the skin less strongly (e.g. cotton); and a synthetic fiber and a natural fiber which are different in texture. Additionally, it is effective to use a yarn which strongly stimulates the skin (e.g. a fancy twist yarn made by twisting a yarn) at an area where surface stimulation is desired.

<Specific Embodiments of Garments>

### Garments for Applying Point Stimulation and Surface Stimulation (Symmetrical Arrangement)

FIG. 38 shows a pair of high-waist shorts 101. The locations of point stimulation parts 10a correspond to motor points of the erector spinae, the serratus posterior inferior, the lower abdominal muscles, the gluteus maximus, and the biceps femoris. The locations of surface stimulation parts 10b correspond to functional skin areas of muscles which need to be inhibited when the tensor fasciae latae act as hip joint flexors and internal rotators. The base fabric for the shorts 101 is made of a polyester yarn 78 dtex/36 f and a polyurethane elastane yarn 44 dtex, and knitted in a half tricot pattern (blend ratio: polyester 85% and polyurethane 15%). The surface stimulation parts 10b are made of a polyester yarn 78 dtex/36 f and a polyurethane elastane yarn 78 dtex, and knitted in a half tricot pattern (blend ratio: polyester 75% and polyurethane 25%). The surface stimulation parts 10b have a greater tightening power than the base fabric. While a person is wearing the garment, the garment fits the body closely, with the surface stimulation parts 10b giving a higher clothing pressure than any other part of the garment. The point stimulation parts 10a are made of a hook tape element of a hook-and-loop surface tape. Regarding the shorts 101, a point stimulation part 10a at the lower abdominal muscles corrects an anteriorly tilted pelvis. In cooperation with this action, point stimulation parts 10a at the gluteus maximus exhibit their effect. (Contraction of the lower abdominal muscles brings the pelvis to an upright position, thereby increasing muscle tone of the gluteus maximus.) In response to these muscle activities, the erector spinae (a trunk extensor) increases muscle tone and extends the trunk. (Increase of muscle tone at the gluteus maximus raises muscle tone of the erector spinae. Thus, stimulation to the gluteus maximus activates itself and the erector spinae.) In cooperation with this stimulation, point stimulation parts 10a at the erector spinae and the serratus posterior inferior help stable extension of the trunk. These three specified stimulations enhance balance ability and support ability of the trunk. In addition, the three specified stimulations define a supporting surface (serving as an application point of force and a fulcrum). Owing to the function of this supporting surface, point stimulation parts 10a at the biceps femoris allow generation of a strong power for extending the hip joints. During running, this extension power is converted to a powerful propelling force. Muscle activities emphasized by the above point stimulation realize more efficient balance in the exercise posture. In addition, surface stimulation is provided at the tensor fasciae latae which are antagonistic to the gluteus maximus (hip joint extensors) and at the rectus femoris which are antagonistic to the biceps femoris (hip joint extensors). Such surface stimulation promotes reduction of muscle tone in the stimulated muscles and powerfully assists exercise activities of their antagonists. Eventually, the surface stimulation ensures excellent exercise control ability at the hip joints and realizes safer, more efficient performance in exercise.

FIG. 39 shows a pair of exercise tights 102. The locations of point stimulation parts 10a correspond to motor points of the lower abdominal muscles, the gluteus maximus, the biceps femoris, the thigh adductors, the vastus medialis of the quadriceps femoris, and the tibialis anterior. The locations of surface stimulation parts 10b correspond to functional skin areas of multiarticular muscles which are located in the free lower limb and the pelvic girdles and which are involved in extension of the knee joints. The tights 102 are made of a yarn which is obtained by paralleling nylon yarns (thickness 78 dtex/48 f) and of a single covered yarn in which a 44-dtex-thick polyurethane elastane yarn core is covered with a nylon yarn (thickness 56 dtex/48 f). The tights 102 are knitted in plain stitch. The point stimulation parts 10a and the surface stimulation parts 10b are made in plate stitch by which a polyester yarn (thickness 78 dtex/36 f) forms a projecting pattern on the skin/back side. Regarding the tights 102, a point stimulation part 10a at the lower abdominal muscles corrects an anteriorly tilted pelvis. In cooperation with this action, point stimulation parts 10a at the gluteus maximus exhibit their effect. (Contraction of the lower abdominal muscles brings the pelvis to an upright position, thereby increasing muscle tone of the gluteus maximus.) In response to these muscle activities, the erector spinae (a trunk extensor) increases muscle tone and extends the trunk. (Increase of muscle tone at the gluteus maximus raises muscle tone of the erector spinae. Thus, stimulation to the gluteus maximus activates itself and the erector spinae.) These muscle activities help stable extension of the trunk. These two specified stimulations enhance balance ability and support ability of the trunk. In addition, the two specified stimulations define a supporting surface (serving as an application point of force and a fulcrum). Owing to the function of this supporting surface, point stimulation parts 10a at the biceps femoris allow generation of a strong power for extending the hip joints. During running, this extension power is converted to a powerful propelling force. Muscle activities emphasized by the above point stimulation realize more efficient balance in the exercise posture. In addition, surface stimulation is provided at the tensor fasciae latae which are antagonistic to the gluteus maximus (hip joint extensors) and at the rectus femoris which are antagonistic to the biceps femoris (hip joint extensors). Such surface stimulation promotes reduction of muscle tone in the stimulated muscles and powerfully assists exercise activities of their antagonists. Eventually, the surface stimulation ensures excellent exercise control ability at the hip joints and realizes safer, more efficient performance in exercise. Moreover, these muscle activities are corrected, coordinated, strengthened, and integrated according to exercise conditions which involve an ideal body balance (the hip strategy-based manner of exercise). Referring to the lower legs, point stimulation to the tibialis anterior and surface stimulation to the posterior muscle group smoothly control muscle activities in the lower legs, and enable a toe-up position which is an ideal lower leg movement during running. Since these muscle activities reduce a drag force and a deceleration force during running, the lower legs become capable of serving as a supporting surface for generating a powerful propelling force. Besides, as the lower leg exercise cooperates with muscle activities created in the upper part (the hip strategy-based manner of exercise), a propelling force generated at the hip joints can be transmitted to the base of exercise without a loss. Consequently, it is possible to enhance exercise performance during running.

FIG. 40 shows a seagull (half-sleeve, long-leg) swimsuit 103. The locations of point stimulation parts 10a correspond to motor points of the latissimus dorsi, the erector spinae, the serratus posterior inferior, the lower abdominal muscles, the gluteus maximus, the biceps femoris, the thigh adductors, the vastus medialis of the quadriceps femoris, and the tibialis anterior. The locations of surface stimulation parts 10b correspond to functional skin areas of the trapezius, the pectoralis minor, and the upper abdominal muscles including the external oblique and the upper rectus abdominis, and also correspond to functional skin areas of multiarticular muscles which are located in the free lower limb and the pelvic girdles and which are involved in extension of the knee joints. The base fabric for the swimsuit 103 is made of a polyester yarn 44 dtex/36 f and a polyurethane elastane yarn 44 dtex, and knitted in a half tricot pattern (blend ratio: polyester 85% and polyurethane 15%). The surface stimulation parts 10b are made of a polyester yarn 44 dtex/36 f and a polyurethane elastane yarn 78 dtex, and knitted in a half tricot pattern (blend ratio: polyester 70% and polyurethane 30%). The surface stimulation parts 10b have a greater tightening power than the base fabric. While a person is wearing the garment, the garment fits the body closely, with the surface stimulation parts 10b giving a higher clothing pressure than any other part of the garment. Each point stimulation part 10a is composed of a plurality of projecting printed dots made of silicone resin. Regarding the swimsuit 103, a point stimulation part 10a at the lower abdominal muscles corrects an anteriorly tilted pelvis. In cooperation with this action, point stimulation parts 10a at the gluteus maximus exhibit their effect. (Contraction of the lower abdominal muscles brings the pelvis to an upright position, thereby increasing muscle tone of the gluteus maximus.) In response to these muscle activities, the erector spinae (a trunk extensor) increases muscle tone and extends the trunk. (Increase of muscle tone at the gluteus maximus raises muscle tone of the erector spinae. Thus, stimulation to the gluteus maximus activates itself and the erector spinae.) In cooperation with this stimulation, point stimulation parts 10a at the erector spinae and the serratus posterior inferior help stable extension of the trunk. These three specified stimulations enhance balance ability and support ability of the trunk. In addition, the three specified stimulations define a supporting surface (serving as an application point of force and a fulcrum). Owing to the function of this supporting surface, point stimulation parts 10a at the biceps femoris allow generation of a strong power for extending the hip joints. During swimming, this extension power is converted to a powerful propelling force. Muscle activities emphasized by the above point stimulation realize more efficient balance in the exercise posture. (The body floats parallel to the water surface and is oriented straight in the forward direction, with a minimum surface being subjected to the resistance of water, i.e. with a minimum water contact surface.) In addition, surface stimulation is provided at the tensor fasciae latae which are antagonistic to the gluteus maximus (hip joint extensors) and at the rectus femoris which are antagonistic to the biceps femoris (hip joint extensors). Such surface stimulation promotes reduction of muscle tone in the stimulated muscles and powerfully assists exercise activities of their antagonists. Eventually, the surface stimulation ensures excellent exercise control ability at the hip joints and realizes more efficient performance in exercise. Moreover, these muscle activities are corrected, coordinated, strengthened, and integrated according to exercise conditions which involve an ideal body balance (the hip strategy-based manner of exercise). Referring to the lower legs, point stimulation to the tibialis anterior and surface stimulation to the posterior muscle group smoothly control muscle activities in the lower legs, and enable a flexible whipping kick motion (e.g. dolphin kicks, etc.) which is an ideal lower leg movement during swimming. During swimming, an unstable base of exercise makes joint actions uncertain. (Abscence of a solid base of exercise reduces neuronal excitation in response to PNF, namely, reduces a feedback power from the base of exercise to the muscular nerves, so that joint angles are caused to change.) The above-mentioned lower leg muscle activities can correct such uncertain joint actions and can give a supporting surface (a surface to catch the water) for generating a powerful propelling force. Besides, as the lower leg muscle exercise cooperates with muscle activities created in the upper part (the hip strategy-based manner of exercise), a propelling force generated at the hip joints can be transmitted without a loss. Consequently, it is possible to transform the base of exercise from an unstable one to a stable one on which the power of exercise acts, and eventually to enhance exercise performance during swimming. Apart from the stimulation mentioned above, let us further discuss the point stimulation and the surface stimulation to the upper body. For generation of a principal propelling force during swimming (a rotational power generated at the shoulder joints), it is necessary to ensure flexibility, ability to act cooperatively, and a strong ability to support exercise (as a fulcrum for efficient axial rotation around the shoulder joints) at the shoulder joints and the scapulothoracic joints. With this requirement in mind, the point stimulation and the surface stimulation to be described next can be defined as stimulation for triggering reduction of muscle tone around the shoulder joints and for ensuring assistant exercise activities which bring about better exercise efficiency. Specifically speaking, surface stimulation to the trapezius reduces muscle tone of the trapezius which pulls the scapulae toward the head. Surface stimulation to the pectoralis minor corrects and controls forward/upward displacement of the scapulae and the shoulder joints which could be induced by hypertonicity in the trapezium. Thereby, the respective stimulation realizes axial rotation around the shoulder joints in a smooth flexible manner. Point stimulation to the latissimus dorsi activates a movement of pushing water behind (a propelling force in swimming) which is a movement resulting from coordinated exercise activities by the latissimus dorsi and the free upper limb/the shoulder girdles. These muscle activities tie up and cooperate with a propelling force of kicks generated in the lower body, thereby producing a stronger propelling force in swimming. Surface stimulation to the upper abdominal muscles and the external oblique not only assists and emphasizes smooth activities of antagonistic trunk extensors, but also assists respiratory muscles. All of the above assistances and corrections in exercise activities are effected in a coordinated and controlled manner, and further enhance performance in exercise.

FIG. 41 shows a pair of knee high socks 104. The locations of point stimulation parts 10a correspond to motor points of the tibialis anterior, the peroneus tertius, and the flexor digitorum brevis/the adductor hallucis. The locations of surface stimulation parts 10b correspond to functional skin areas of the gastrocnemius and the plantaris/plantar aponeurosis. The knee high socks 104 are made of an acrylic cotton blended yarn (English cotton count 32/1) and of a FTY (fiber twisted yarn) in which a polyurethane elastane yarn 10 dtex and a nylon yarn 78 dtex/48 f are twisted. The knee high socks 104 are knitted in plain stitch. Each point stimulation part 10a is composed of a plurality of projecting printed dots made of silicone resin. The surface stimulation parts 10b are made of a fancy twist yarn (a nylon acrylic blend, metrical count 30/1). Regarding the knee high socks 104, point stimulation parts 10a at the tibialis anterior encourage these muscles to act as antagonists of the posterior lower leg muscles (the gastrocnemius) and to generate a strong coordination power, thereby reducing muscle tone of the posterior lower leg muscles (the gastrocnemius). As a result, injuries to the posterior lower leg muscle group caused by hypertonicity occur less frequently. Point stimulation parts 10a at the peroneus tertius increase muscle tone and impart a strong coordination power such that the peroneus tertius can act as antagonists of the tibialis anterior, one of whose muscle activities is inversion of the ankle joints. As for the gastrocnemius which is antagonistic to these muscle groups, surface stimulation thereto assists and emphasizes smooth performance of muscle activities triggered by the above-mentioned two specified stimulations. The three muscle activities stabilize the ankle joints along a transverse axis and improve their plantarflexion and dorsiflexion. Since the former two specified stimulations give a stabilizer effect to the ankle joints, the ankle joints acquire optimum exercise efficiency and can perform smooth plantarflexion thereof (activities of the extensor groups), thereby enhancing a wearer's performance. These functions decrease injuries to lower leg muscles. The three specified stimulations can also alleviate fatigue in muscles and proprioceptive nerves and can delay occurrence of movement transmission dysfunction at the ankle joints due to such fatigue, so that a safe exercise condition can be maintained for a longer time. Additionally, in marathon or the like, reduced muscle tone by surface stimulation and smooth movement lead to increase of blood circulation and hence alleviation of fatigue around the ankle joints (e.g. the gastrocnemius). As for the toes, inherent movements of the toes (open-close movements) are usually restricted while the toes are covered by tube-like items such as shoes and socks. Point stimulation parts 10a at the flexor digitorum brevis/the adductor hallucis alleviate such restriction and allow smooth toe movements. For example, with the toes open, one can execute a toe pivot smoothly. With the toes closed, the feet can grip a supporting surface of exercise (e.g. the ground) more firmly. Accordingly, even if an exercise surface is unconditioned and cannot provide a secure foothold, the soles can keep enhanced sensitivity and can create sensitive and stable supporting surfaces (the soles). In combination with this point stimulation, surface stimulation to the plantaris/plantar aponeurosis decreases muscle tone, thereby enhancing sensory receptivity at the soles and creating a secure base of exercise. An advanced muscle controllability imparted by the point stimulation and the surface stimulation mentioned above enables creation of a better basal/supporting surface of execise. Hence, it is possible to assist body balance positively, even though body balance changes constantly according to the ground or the like.

### Garments for Applying Point Stimulation (Symmetrical Arrangement)

FIG. 42 shows a men's long john swimsuit 105. The locations of stimulation parts 10a correspond to motor points of the erector spinae, the serratus posterior inferior, the lower abdominal muscles, the gluteus maximus, the thigh adductors, the biceps femoris, the vastus medialis of the quadriceps femoris, and the tibialis anterior. This swimsuit 105 is made of a polyester yarn 44 dtex/36 f and a polyurethane elastane yarn 56 dtex, and knitted in a half tricot pattern (blend ratio: polyester 80% and polyurethane 20%). Each stimulation part 10a is composed of a plurality of projecting printed dots made of silicone resin. Pieces of fabrics for the swimsuit 105 are not sewn together but fused by hot-melt bonding, with a thermofusible polyurethane film sandwiched between the pieces of fabrics and melted under heat and pressure. Regarding the swimsuit 105, a stimulation part 10a at the lower abdominal muscles corrects an anteriorly tilted pelvis. In cooperation with this action, stimulation parts 10a at the gluteus maximus exhibit their effect. (Contraction of the lower abdominal muscles brings the pelvis to an upright position, thereby increasing muscle tone of the gluteus maximus.) In response to these muscle activities, the erector spinae (a trunk extensor) increases muscle tone and extends the trunk. (Increase of muscle tone at the gluteus maximus raises muscle tone of the erector spinae. Thus, stimulation to the gluteus maximus activates itself and the erector spinae.) In cooperation with this stimulation, stimulation parts 10a at the erector spinae and the serratus posterior inferior help stable extension of the trunk. These three specified stimulations enhance balance ability and support ability of the trunk and realize a more efficient exercise posture. In this context, the most efficient exercise posture for swimming is to keep the maximum possible part of the whole body above the water level (typical to the breaststroke and the crawl) so as to minimize water resistance (because the resistance increases in proportion to the water contact area.). Therefore, taking resistance of water or the like into consideration, the swimsuit guides the body to the most efficient exercise posture (with a minimum possible water contact area) during extension of the trunk. Besides, the swimsuit hinders sidewise sway of the trunk and enhances exercise efficiency for the above reason. Furthermore, for convertion of a correct and efficient (in terms of exercise efficiency) axial rotation (such as an axial movement of the trunk) into a propelling force, it is also possible to enhance relevant muscle activities. Under the influence of a support axis created by the above three specified stimulations (With the hip joints being the center of movement, the application points of force, the fulcrums, and the points of action are defined clearly.), point stimulation parts at the biceps femoris lead the body to the hip strategy-based manner of exercise which can improve extension of the hip joints. Thereby, during swimming, kicks can give a greater propelling force. Point stimulation to the thigh adductors not only controls abduction of the legs but also alleviates water resistance to the legs. Point stimulation to the vastus medialis of the quadriceps femoris encourages extension of the knees and controls excessive flexion of the knees in kicking motions, so that a propelling force can be generated by smooth kicks. Stimulation to the tibialis anterior provides an antagonistic control to posterior lower leg extensors and inhibits excessive extension of the ankle joints, thereby ensuring smooth movements as above.

FIG. 43 shows a high-waist brief 106. The locations of stimulation parts 10a correspond to motor points of the erector spinae, the serratus posterior inferior, the lower abdominal muscles, and the gluteus maximus. The brief 106 is made of a cotton yarn 40/1 and a polyurethane yarn 10 dtex, and knitted in plain stitch (blend ratio: cotton 90% and polyurethane 10%). The stimulation parts 10a are made of a hook tape element of a hook-and-loop surface tape. Regarding the brief 106, a stimulation part 10a at the lower abdominal muscles corrects an anteriorly tilted pelvis. In cooperation with this action, stimulation parts 10a at the gluteus maximus exhibit their effect. (Contraction of the lower abdominal muscles brings the pelvis to an upright position, thereby increasing muscle tone of the gluteus maximus.) In response to these muscle activities, the erector spinae (a trunk extensor) increases muscle tone and extends the trunk. (Increase of muscle tone at the gluteus maximus raises muscle tone of the erector spinae. Thus, stimulation to the gluteus maximus activates itself and the erector spinae.) In cooperation with this stimulation, stimulation parts 10a at the erector spinae and the serratus posterior inferior help stable extension of the trunk. These three specified stimulations enhance balance ability and support ability of the trunk and realize a more efficient exercise posture.

FIG. 44 shows a pair of exercise tights 107. The locations of stimulation parts 10a correspond to motor points of the lower abdominal muscles, the gluteus maximus, the biceps femoris, the thigh adductors, and the tibialis anterior. The tights 107 are made of a yarn which is obtained by paralleling nylon yarns (thickness 78 dtex/48 f) and of a single covered yarn in which a 44-dtex-thick polyurethane elastane yarn core is covered with a nylon yarn (thickness 56 dtex/48 f). The tights 107 are knitted in plain stitch. The stimulation parts 10a are made in plate stitch by which a polyester yarn (thickness 78 dtex/36 f) forms a projecting pattern on the skin/back side. Regarding the tights 107, a stimulation part 10a at the lower abdominal muscles corrects an anteriorly tilted pelvis. In cooperation with this action, stimulation parts 10a at the gluteus maximus exhibit their effect. (Contraction of the lower abdominal muscles brings the pelvis to an upright position, thereby increasing muscle tone of the gluteus maximus.) In response to these muscle activities, the erector spinae (a trunk extensor) increases muscle tone and extends the trunk. (Increase of muscle tone at the gluteus maximus raises muscle tone of the erector spinae. Thus, stimulation to the gluteus maximus activates itself and the erector spinae.) Such point stimulation cooperates with spinal muscles and causes a more stable extension of the trunk. These two specified stimulations enhance balance ability and support ability of the trunk and realize a more efficient exercise posture. Under the influence of a supporting surface in the trunk (With the hip joints being the center of movement, the application points of force, the fulcrums, and the points of action are defined clearly.), stimulation parts 10a for increasing muscle tone of the biceps femoris lead the body to the hip strategy-based manner of exercise which can improve extension of the hip joints. Stimulation to the thigh adductors improves a support power in exercise and establishes an axis for assisting and emphasizing efferent muscle activities (an axis for stabilizing the hip strategy-based manner of exercise), thereby enabling a more efficient axial rotation. Stimulation to the tibialis anterior provides an antagonistic control over lower leg extensors. This stimulation enables stable landing with the entire sole of each foot (i.e. three-point landing with the big toe, the little toe and the heel), as represented by a toe-up position which is required in running. Besides, while the lower leg extensors generate a drag force on the ground, the stimulation to the tibialis anterior reduces generation of the drag force to a least possible level and thereby increases a propelling force.

FIG. 45 shows a pair of knee high socks 108. The locations of stimulation parts 10a correspond to motor points of the tibialis anterior (TA), the peroneus tertius (PTert), and the flexor digitorum brevis (FDB)/the adductor hallucis (AH). The knee high socks 108 are made of an acrylic cotton blended yarn (English cotton count 32/1) and of a FTY (fiber twisted yarn) in which a polyurethane elastane yarn 10 dtex and a nylon yarn 78 dtex/48 f are twisted. The knee high socks 108 are knitted in plain stitch. Each stimulation part 10a is composed of a plurality of projecting printed dots made of silicone resin. Regarding the knee high socks 108, stimulation parts 10a at the tibialis anterior encourage these muscles to act as antagonists of the posterior lower leg muscles (the gastrocnemius) and to generate a strong coordination power, thereby reducing muscle tone of the posterior lower leg muscles (the gastrocnemius). As a result, hypertonicity-induced injuries to the posterior lower leg muscle group occur less frequently. Stimulation parts 10a at the peroneus tertius increase muscle tone and impart a strong coordination power such that the peroneus tertius can act as antagonists of the tibialis anterior, one of whose muscle activities is inversion of the ankle joints. The two muscle activities strongly stabilize the ankle joints along a transverse axis and enable smooth plantarflexion of the ankle joints (activities of the extensor groups). These functions decrease injuries to lower leg muscles as mentioned above. This stimulation can also alleviate fatigue in muscles and proprioceptive nerves and can delay occurrence of movement transmission dysfunction at the ankle joints due to such fatigue, so that a safe exercise condition can be maintained for a longer time. As for the toes, inherent movements of the toes (open-close movements) are usually restricted while the toes are covered by tube-like items such as shoes and socks. Stimulation parts 10a at the flexor digitorum brevis/the adductor hallucis alleviate such restriction and allow smooth toe movements. For example, with the toes open, one can execute a toe pivot smoothly. With the toes closed, the feet can grip a support surface of exercise (e.g. the ground) more firmly. Accordingly, even if an exercise surface is unconditioned and cannot provide a secure foothold, the soles can keep enhanced sensitivity and can create sensitive and stable supporting surfaces (the soles).

### Garments for Applying Surface Stimulation (Symmetrical Arrangement)

FIG. 46 shows a pair of exercise tights 109. The locations of surface stimulation parts 10b correspond to functional skin areas of multiarticular muscles which are located in the free lower limb and the pelvic girdles and which are involved in extension of the knee joints. The tights 109 are made of a yarn which is obtained by paralleling nylon yarns (thickness 78 dtex/48 f) and of a single covered yarn in which a 44-dtex-thick polyurethane elastane yarn core is covered with a nylon yarn (thickness 56 dtex/48 f). The surface stimulation parts 10b are made in plate stitch by which a polyester yarn (thickness 78 dtex/36 f) forms a projecting pattern on the skin/back side. Regarding the tights 109, surface stimulation parts at the anterior and lateral thighs (the quadriceps femoris, the tensor fasciae latae, etc.) inhibit their activity for extending the knee joints, thereby strengthening and assisting muscle activity of hip joint extensors in the posterior thighs. In addition, surface stimulation to the posterior lower leg muscle group inhibits their activity for extending the ankle joints, thereby strengthening and assisting muscle activity of ankle joint flexors in the anterior lower legs. The respective muscle activities enhance exercise efficiency by activating extension of the hip joints and inhibiting extension of the ankle joints. In the case of running, inhibitory control over anterior/lateral thigh muscles and posterior lower leg extensors decreases a drag force on the ground, stimulates activity of extensors at the hip joints, and turns their muscle activities into a propelling force in running.

FIG. 47 shows a pair of shorts 110. The locations of surface stimulation parts 10b correspond to functional skin areas of muscles which need to be inhibited when the tensor fasciae latae act as hip joint flexors and internal rotators. The base fabric for the shorts 110 is made of a polyester yarn 44 dtex/36 f and a polyurethane elastane yarn 44 dtex, and knitted in a half tricot pattern (blend ratio: polyester 85% and polyurethane 15%). The surface stimulation parts 10b are made of a polyester yarn 44 dtex/36 f and a polyurethane elastane yarn 78 dtex, and knitted in a half tricot pattern (blend ratio: polyester 75% and polyurethane 25%). The surface stimulation parts have a greater tightening power than the base fabric. While a person is wearing the garment, the garment fits the body closely, with the surface stimulation parts giving a higher clothing pressure than any other part of the garment. The tensor fasciae latae group acts to bend and internally rotate the hip joints and, as one of its functions, represses a function of the gluteus maximus of pulling lower legs behind. Regarding the shorts 110, surface stimulation parts at the tensor fasciae latae group inhibit the bending/internally rotating activities and reduce the ability of repressing the gluteus maximus function, thereby promoting and enhancing the activity of lower leg extensors at the hip joints. This function realizes a more efficient exercise.

FIG. 48 shows an exercise T-shirt 111. The locations of surface stimulation parts 10b correspond to functional skin areas of the trapezius, the pectoralis minor, and the upper abdominal muscles including the external oblique and the upper rectus abdominis. The T-shirt 111 is made of a polyester yarn 40/1 and a polyurethane yarn 10 dtex, and knitted in plain stitch (blend ratio: polyester 90% and polyurethane 10%). The surface stimulation parts 10b are made of a hook tape element of a hook-and-loop surface tape. The trapezius, the pectoralis minor and the upper pectoralis major emphasize a forward leaning posture (a forward head posture) in which both scapulae are displaced to a forward/upward position. Regarding the T-shirt 111, a surface stimulation part 10b across these muscles decreases their muscle tone and corrects the scapulae to a backward/downward position. In addition, reduction of muscle tone of these muscles assists and promotes the action of the latissimus dorsi which is their antagonist in a superior/posterior relationship. As a result, the upper part of the trunk is pulled upwardly and backwardly to correct the forward leaning posture. In cooperation with these functions, the anteriorly tilted pelvis is corrected to an upright position. (Backward extension of the trunk promotes facilitation of the gluteus maximus which is activated cooperatively. The resulting action of the gluteus maximus brings the pelvis to an upright position.) Turning next to the upper rectus abdominis and the external oblique, they increase muscle tone in cooperation with the trapezius, the pectoralis minor, and the upper pectoralis major mentioned above. A surface stimulation part 10b across the upper rectus abdominis and the external oblique (an area innervated by Th7-12 and L1-2) reduces their muscle tone and serves to transform a forward leaning posture into a backward leaning one. In the case of a forward leaning posture, the whole body is brought to a backward leaning posture by reducing muscle tone of the upper rectus abdominis and the external oblique which play a supportive role at the anterior part of the trunk. The above-mentioned surface stimulation encourages activity of the gluteus maximus, so that a person can shift to an ideal manner of exercise, the hip strategy-based manner of exercise.

FIG. 49 shows a pair of knee high socks 112. The locations of surface stimulation parts 10b correspond to functional skin areas of the gastrocnemius and the plantaris/plantar aponeurosis. The knee high socks 112 are made of an acrylic cotton blended yarn (English cotton count 32/1) and of a FTY (fiber twisted yarn) in which a polyurethane elastane yarn 10 dtex and a nylon yarn 78 dtex/48 f are twisted. The knee high socks 112 are knitted in plain stitch. The surface stimulation parts 10b are made of a fancy twist yarn (a nylon acrylic blend, metrical count 30/1). Regarding the knee high socks 112, surface stimulation parts 10b at the gastrocnemius reduce muscle tone of the gastrocnemius which is the largest extensor (plantarflexor) around the ankle joints. Although the posterior lower leg muscles of the Mongoloids and nonathletic people are extremely hypertonic, such surface stimulation reduces the muscle tone and ensures safe and smooth muscle activity for a long time. Furthermore, concerning the fact that fatigue in the posterior lower leg muscle group increases muscle tone at the soles, surface stimulation to the plantaris/plantar aponeurosis decreases muscle tone at the soles by supporting and relaxing the medial arch of each foot. Since activity of the soles is coordinated with that of the posterior lower leg muscle group, fatigue in the posterior lower leg muscle group can be alleviated as well. Smooth muscle activity at the medial arch of each foot serves to absorb and relieve the impact from the base of exercise, decreasing shaking or repulsive stimulation to joints thereabove (knees, etc.). Accordingly, at the upper joints, injuries due to a vertical load can be reduced during exercise.

### Garments for Applying Point Stimulation and Surface Stimulation (Asymmetrical Arrangement)

FIG. 50 shows a pair of tights 113 designed for the right-handed. The locations of point stimulation parts 10a (approximately 2 cm.sup.2 each) correspond to motor points of the center of the lower rectus abdominis (LRA), the left internal oblique (IO), the left gluteus maximus (GMax), the right gluteus medius/minimus (GMed/GMin), the right semitendinosus/semimembranosus (ST/SM), the left biceps femoris (BF), the left vastus lateralis of the quadriceps femoris (VL), the right vastus medialis of the quadriceps femoris (VM), the right sartorius (SAR), the left tibialis anterior (TA), the left medial gastrocnemius (MG), and the right peroneus tertius (PTert). For the thighs, the location of a surface stimulation part 10b corresponds to a functional skin area of muscles which need to be inhibited when the right tensor fasciae latae (TFL) acts as a hip joint flexor and internal rotator. For the lower legs, the locations of surface stimulation parts 10b correspond to functional skin areas of muscles which need to be inhibited when the right medial gastrocnemius (MG) and the left lateral gastrocnemius (LG) act as knee joint flexors and ankle joint extensors. The base fabric for the tights 113 is made of a polyester yarn 56 dtex/36 f and a polyurethane elastane yarn 44 dtex, and knitted in a half tricot pattern (blend ratio: polyester 80% and polyurethane 20%). The surface stimulation parts 10b are made of a polyester yarn 56 dtex/36 f and a polyurethane elastane yarn 56 dtex, and knitted in a half tricot pattern (blend ratio: polyester 75% and polyurethane 25%). The surface stimulation parts 10b have a greater tightening power than the base fabric. While a person is wearing the garment, the garment fits the body closely, with the surface stimulation parts 10b giving a higher clothing pressure than any other part of the garment. Each point stimulation part 10a is composed of a plurality of projecting printed dots made of silicone resin. Seams (not shown) in the tights 113 are designed to align with muscular grooves as best as possible.

Regarding the tights 113, a point stimulation part 10a at the center of the lower rectus abdominis corrects an anteriorly tilted pelvis. In cooperation with this action, a point stimulation part 10a at the left gluteus maximus exhibits its effect (Contraction at the center of the lower rectus abdominis brings the pelvis to an upright position, thereby increasing muscle tone of the gluteus maximus). In response to these muscle activities, the erector spinae (a trunk extensor) increases muscle tone and extends the trunk. (Increase of muscle tone at the gluteus maximus raises muscle tone of the erector spinae. Thus, stimulation to the gluteus maximus activates itself and the erector spinae.) Also stimulated is the left iliopsoas which is antagonistic to the gluteus maximus and which is antagonistically involved in flexion of the hip joint. This stimulation cooperates with the other stimulations mentioned earlier, allowing the trunk to extend in a more stable manner. Next, a point stimulation part 10a at the right gluteus medius/minimus hinders sidewise sway (in adduction-abduction directions) at the hip joint and improves a support power in exercise. These three specified stimulations enhance balance ability and support ability of the trunk. In addition, two of these specified stimulations (the center of the lower rectus abdominis and the right gluteus medius/minimus) define a supporting surface (serving as an application point of force and a fulcrum). Owing to the function of this supporting surface, a point stimulation part 10a at the right semitendinosus/semimembranosus allows generation of a strong power for extending the hip joint. During running, this extension power is converted to a powerful propelling force. With respect to the gluteal muscles, the right gluteus maximus is more active than the left one, but the left gluteus medius/minimus are less so than the left one. Hence, even though a strong extension power is generated at the hip joint, the fulcrum is not strong enough to convert this extension power into a linear backward propelling force. In this respect, the point stimulation part 10a at the right gluteus medius/minimus hinders the sidewise sway at the hip joint as mentioned above, thereby assisting and promoting the right biceps femoris and the right semitendinosus/semimembr—anosus to work with higher exercise efficiency. The right semitendinosus/semimembranosus, which is less active than the right biceps femoris, tends to orient and waste its power in the abduction direction. To correct this, the point stimulation part 10a at the right semitendinosus/semimembranosus veers the power to a neutral direction and realizes efficient backward extension of the hip joint. The point stimulation part 10a at the left gluteus maximus assists and corrects unbalanced activities of the left gluteus muscles (The left gluteus maximus is less active than the left gluteus medius/minimus.), and strongly affects extension of the hip joint. (Prominent contraction of the gluteus maximus produces a strong forward propelling force.) Coordination between the point stimulation part 10a at the left gluteus maximus and the one at the left biceps femoris makes this function more efficient. The point stimulation part 10a at the left biceps femoris also controls excessive muscle activity of the semitendinosus/semimembranosus in the left posterior thigh. When the hip joint is extended, power at the hip joint tends to be lost in the abduction direction. However, this stimulation part orients the power from the abduction direction to the adduction direction, thereby promoting smoother extension of the hip joint and generation of a greater forward propelling force. Having said that, generation of the forward propelling force at the left lower limb and the left pelvic girdle involves not only generation of a strong propelling force of action but also generation of a strong force of reaction (a forward-dragging forward-shearing force which involves rotational movements at the left pelvis, the lumbar lordosis, and the sacral cornu). Hence, a point stimulation part 10a at the left internal oblique suppresses the force of reaction and permits the left pelvis, the lumbar lordosis, and the sacral cornu to work as a support base of exercise. (If the effect of this point stimulation part is insufficient or absent, the power generated at the right lower limb and the right pelvic girdle is oriented and wasted in the forward direction. Furthermore, the extreme forward-shearing force and the extreme rotatory power may cause damage to joints in the lower lumbar vertebrae and the sacral vertebrae.) Incidentally, if the left internal oblique weakens or if there is no effect of the point stimulation part, the trunk becomes unstable. Presumably, such instability is compensated by improper fixation (as called in chiropractics, etc.) of the left sacroiliac joint. It is confirmed and reported that this improper action causes the gastrocnemius to be hypertonic in the left lower leg. Curing of this improper action will reduce and alleviate damage to the left lower leg muscles (gastrocnemius strain, Achilles tendon rupture, etc.). The six specified point stimulations emphasize respective muscle activities and thereby realize more efficient balance in the exercise posture.

While the gluteus maximus serves as a hip joint extensor, the tensor fasciae latae acts as its antagonist. On the lateral part of the right thigh, a surface stimulation part 10b at the tensor fasciae latae promotes reduction of muscle tone of muscles around the right hip joint and powerfully assists exercise activities of their antagonists. As a result, the hip joint can exhibit better exercise control ability and realize safer, more efficient performance in exercise.

At the right hip joint, an axis of exercise is notably and excessively oriented to a certain exercise direction (a direction for flexion, abduction, and internal rotation of the hip joint). Point stimulation parts 10a at the right vastus medialis of the quadriceps femoris and at the right sartorius change this axis along the correct gravity axis of the body, thereby modifying the flow of generated power. The vastus medialis of the quadriceps femoris has a remarkably strong support ability around the knee joints. However, for right-handed people, the right vastus medialis is developed less than the left one, so that the exercise axis and the support base are displaced further outwardly. Therefore, the exercise axis and the support base need to be corrected inwardly by these point stimulation parts 10a at the right vastus medialis of the quadriceps femoris and the right sartorius. Further, after such correction, because abduction is dominant at the right hip joint, the gluteus medius/minimus needs to be stimulated and facilitated in the manner described above. Nevertheless, merely by this facilitatory stimulation to the gluteus medius/minimus, it is difficult to correct an internal twist at the knee. The point stimulation part 10a at the right sartorius promotes and improves coordination with the point stimulation part 10a at the right gluteus medius/minimus, thereby correcting the twist at the knee joint.

At the left hip joint, an axis of exercise is notably and excessively oriented to a certain exercise direction (a direction for flexion, adduction, and external rotation of the hip joint). A point stimulation part 10a at the left vastus lateralis of the quadriceps femoris changes this axis along the central axis of the body, thereby modifying the flow of generated power. For right-handed people, the vastus medialis around the left knee is more active than the one around the right knee. However, because the left gluteus maximus of the left leg is not active enough, the exercise direction is often wastefully oriented to the one for abduction and internal rotation during its extention. This necessitates facilitation of not only the left gluteus maximus but also the left vastus lateralis of the quadriceps femoris. The point stimulation part 10a at the left vastus lateralis, together with the one at the left biceps femoris, enables more efficient generation/use of power in a smooth and coordinated manner.

With a point stimulation part 10a at the left medial gastrocnemius, the direction of power acting at the left ankle joint is corrected from the eversion direction to the inversion direction along a proper axis of exercise. As for posterior muscles at the left lower leg of right-handed people, because a power generated by the upper joints or the like is oriented outwardly, the posterior part of the left lower leg attempts to force that power into an inward direction by making the lateral part more active than the medial part. Suppose that the direction of power is corrected at the upper joints but not at the left lower leg, the power will be oriented further inwardly at the posterior part of the left lower leg. This activity has to be corrected by the point stimulation part 10a at the left medial gastrocnemius. In the opposed right lower leg, prominent muscle activities are exactly opposite (The power acts in the inversion direction.), which necessitates stimulation and facilitation in an opposite pattern. Thus, muscle activity of the right lower leg is corrected by a point stimulation part 10a at the right peroneus tertius.

Evidently, the lower legs have a smaller amount of muscles than other parts of the lower limbs (muscle groups as represented by the anterior and posterior thigh muscles). In inverse proportion to the amount of muscles, the lower legs are used more frequently and produce a greater force of action during exercise, which makes them prone to stress and injuries. If the lower leg muscles are simply facilitated by point stimulation, they may be activated too much and may even cause injuries. To prevent this, extreme generation of power should be controlled in muscle groups (the right medial gastrocnemius and the left lateral gastrocnemius) which are opposed to the point stimulation parts 10a. Thus, the respective muscles (the right medial gastrocnemius and the left lateral gastrocnemius) require surface stimulation parts 10b for reducing muscle tone, and have their muscle activities controlled.

However, in controlling eversion at the left ankle joint, facilitatory point stimulation to the left medial gastrocnemius is not perfect by itself. For an additional facilitatory element, a point stimulation part 10a is required at the left tibialis anterior which acts to orient the ankle joint to the inversion direction.

In addition, it should be understood that a force deriving from muscular power involves not only a force of action but also a force of reaction which returns from a location where the force of action is applied, and that these forces act in three-dimensionally twisted directions. At the respective hip joints, if exercise activity is performed in the above-mentioned exercise directions (a direction for flexion, adduction and external rotation of the left hip joint, and a direction for flexion, abduction and internal rotation of the right hip joint), the force of action is responded to not by a proper force of reaction but by a deviated force of reaction. Exercise activity involving a three-dimensionally twisted force (whether proper or deviated) imposes a heavier burden on joints and can be a primary cause of injuries. Hence, exercise activity involving a three-dimensionally twisted force should be eliminated (if the exercise direction is deviated) or should be controlled and restricted ideally (if the exercise direction is proper) as much as possible. For example, exercise activity of the knee joints should be discussed in consideration of rotational exercise activity of the upper joints (the hip joints), as mentioned above. Likewise, exercise activity of the ankle joints, which is affected by the upper joints (the knee and hip joints), should be discussed along with exercise activity of the upper joints. Thus, the upper joints should be asymmetrically supported in consideration of directions of their exercise axes, with adequate modifications to the manner of support. Furthermore, muscles have to be facilitated by point stimulation in such a way as to realize the hip-strategy based manner of exercise. Take the biceps femoris as an example of multiarticular muscles which contain a monoarticular muscle portion. In this case, it is especially necessary to facilitate one of its multiarticular muscle functions, i.e. extension of the hip joint. On the contrary, suppose that a monoarticular muscle function of the biceps femoris is facilitated, flexion of the knee joint stands out so much as to prevent smooth extension of the hip joint.

FIG. 51 shows a full suit 114 designed for the right-handed, which can be used in sports which involve symmetrical upper limb movements, such as track and field, swimming (butterfly and breaststroke), skating, cycling, and skiing. The locations of point stimulation parts 10a (approximately 2 cm.sup.2 each) correspond to motor points of the right sternocleidomastoid (SCM), the right supraspinatus (SS), the right infraspinatus (IS), the middle part of the left erector spinae (ESMid)/the left rhomboideus major (RMa), the left latissimus dorsi (LD), the lower part of the right erector spinae (ESLo)/the right serratus posterior inferior (SPI), the bottommost part of the left erector spinae (ESBtm)/the left quadratus lumborum (QL), the right gluteus medius/minimus (GMed/GMin), the left gluteus maximus (Gmax), the left biceps femoris (BF), the right semitendinosus/semimembranosus (ST/SM), the left medial gastrocnemius (MG), the right lateral soleus (LSOL), the left internal oblique (IO), the center of the lower rectus abdominis (LRA), the right sartorius (SAR), the right vastus medialis of the quadriceps femoris (VM), the left vastus lateralis of the quadriceps femoris (VL), the left tibialis anterior (TA), the right peroneus tertius (PTert), the medial/lateral heads (MH/LH) of the left and right triceps brachii (TB), the left and right supinator (SUP), and the left and right extensor carpi radialis longus (ECRL). The locations of surface stimulation parts 10b correspond to functional skin areas of the left upper trapezius (UTP), the right latissimus dorsi (LD), the left gluteus medius/minimus (GMed/GMin), the right gluteus maximus (GMax), the right biceps femoris (BF), the left semitendinosus/semimembranosus (ST/SM), the right medial gastrocnemius (MG), the left lateral gastrocnemius (LG), the left and right pectoralis minor (PMi), the upper rectus abdominis (URA), the right tensor fasciae latae (TFL), the right rectus femoris of the quadriceps femoris (RF), the left sartorius (SAR), the right tibialis anterior (TA), the left and right biceps brachii (BB), and the left and right pronator teres (PRT). The full suit 114 is made of a yarn which is obtained by paralleling nylon yarns (thickness 78 dtex/48 f) and of a single covered yarn in which a 44-dtex-thick polyurethane elastane yarn core is covered with a nylon yarn (thickness 56 dtex/48 f). The full suit is knitted in plain stitch. The point stimulation parts 10a and the surface stimulation parts 10b are made in plate stitch by which a polyester yarn (thickness 78 dtex/36 f) forms a projecting pattern on the skin/back side. Seams (not shown) in the full suit 114 are sewn flat so as to avoid stimulation to the skin, and are designed to align with muscular grooves as best as possible.

Regarding the full suit 114, a point stimulation part 10a at the center of the lower rectus abdominis corrects an anteriorly tilted pelvis. In cooperation with this action, a point stimulation part 10a at the left gluteus maximus exhibits its effect. (Contraction of the lower rectus abdominis brings the pelvis to an upright position, thereby increasing muscle tone of the gluteus maximus.) In response to this, the lower part of the right erector spinae (a trunk extensor)/the right serratus posterior inferior and the bottommost part of the left erector spinae (a trunk extensor)/the left quadratus lumborum develop muscle tone and extend the trunk. (Increase of muscle tone at the gluteus maximus raises muscle tone of the erector spinae. Thus, stimulation to the gluteus maximus activates itself and the erector spinae.) The left gluteus maximus is also stimulated with antagonistic flexion of the hip joint by the left iliopsoas. This stimulation cooperates with the other stimulations mentioned earlier, allowing the trunk to extend in a more stable manner. Next, a point stimulation part 10a at the right gluteus medius/minimus hinders sidewise sway (in adduction-abduction directions) at the hip joint and improves a support power in exercise. These six specified stimulations enhance balance ability and support ability of the trunk. In addition, two of these specified stimulations (the lower rectus abdominis and the left gluteus maximus) define a supporting surface (serving as an application point of force and a fulcrum). Owing to the function of this supporting surface, a point stimulation part 10a at the left biceps femoris allows generation of a strong power for extending the hip joint. During running, this extension power is converted to a powerful propelling force. With respect to the gluteal muscles, the left gluteus medius/minimus is more active than the left one, but the left gluteus maximus are less so than the right one. Hence, even though a strong extension power is generated at the hip joint, the fulcrum is not strong enough to convert this extension power into a linear backward propelling force. In this respect, the point stimulation part 10a at the right gluteus medius/minimus hinders the sidewise sway at the hip joint as mentioned above, thereby assisting and promoting the right biceps femoris and the right semitendinosus/semimembranosus to work with higher exercise efficiency. The right semitendinosus/semimembranosus, which is less active than the right biceps femoris, tends to orient and waste its power in the abduction direction. To correct this, the point stimulation part 10a at the right semitendinosus/semimembranosus veers the power to a neutral direction and realizes efficient backward extension of the hip joint. The point stimulation part 10a at the left gluteus maximus assists and corrects unbalanced activities of the left gluteus muscles (The left gluteus maximus is less active than the left gluteus medius/minimus.), and strongly affects extension of the hip joint. (Prominent contraction of the gluteus maximus produces a strong forward propelling force.) Coordination between the point stimulation part 10a at the left gluteus maximus and the one at the left biceps femoris makes this function more efficient. The point stimulation part 10a at the left biceps femoris also controls hyperactivity of the semitendinosus/semimembranosus in the left posterior thigh. When the hip joint is extended, power at the hip joint tends to be lost in the abduction direction. However, this stimulation part orients the power from the abduction direction to the adduction direction, thereby promoting smoother extension of the hip joint and generation of a greater forward propelling force. Having said that, generation of the forward propelling force at the left lower limb and the left pelvic girdle involves not only generation of a strong propelling force of action but also generation of a strong force of reaction (a forward-dragging forward-shearing force which involves rotational movements at the left pelvis, the lumbar lordosis, and the sacral cornu). Hence, a point stimulation part 10a at the left internal oblique suppresses the force of reaction and permits the left pelvis, the lumbar lordosis, and the sacral cornu to work as a support base of exercise. (If the effect of this point stimulation part is insufficient or absent, the power generated at the right lower limb and the right pelvic girdle is oriented and wasted in the forward direction. Furthermore, the extreme forward-shearing force of action and the extreme rotatory power may cause damage to joints in the lower lumbar vertebrae and the sacral vertebrae.) The nine specified point stimulations emphasize respective muscle activities and thereby realize more efficient balance in the exercise posture.

The hip joints are ball-and-socket joints and have as high as three degrees of freedom. Hence, coordinated muscle activities at these joints are heavily affected by muscle groups which act very dominantly. (For example, activities of the hip joints such as flexion/extension, abduction/adduction, external rotation/internal rotation are performed by coordinated activities of muscles around the hip joints as represented by the gluteus maximus/medius/minimus, the iliopsoas, the rectus femoris, the sartorius, the tensor fasciae latae, etc.) Under such circumstances, if some muscles act so strongly as to disturb the coordination, they obstruct the ability of smooth adduction/abduction and rotation at the ball-and-socket joints such as the hip joints. Therefore, it is inevitable to reduce muscle tone of hyperactive muscle groups and to inhibit them, thereby inducing a smoother, more efficient joint activity. Among the muscle groups for moving the hip joints, prominently active muscles to be controlled include the left gluteus medius/minimus, the right gluteus maximus, the right biceps femoris, the left semitendinosus/semimembranosus, the right tensor fasciae latae, the right rectus femoris of the quadriceps femoris, and the left sartorius. This is why it is crucial to provide surface stimulation parts 10b at functional skin areas of those muscles. With respect to gluteal muscle activities at the right hip joint, the gluteus maximus are more active than the gluteus medius/minimus, which hampers smooth adduction/abduction and rotation at the right hip joint. As a remedy to this, the point stimulation part 10a at the right gluteus medius/minimus promotes facilitation of the right gluteus medius/minimus, whereas the surface stimulation part 10b at the right gluteus maximus inhibits activities of the right gluteus maximus. Such stimulation enhances the ability to stretch and externally rotate the right hip joint in a proper direction. With respect to the left hip joint, the gluteus medius/minimus is more active than the gluteus maximus, which also hampers smooth adduction/abduction and rotation at the left hip joint. As a remedy to this, stimulation must be applied oppositely relative to the right gluteus maximus (i.e. point stimulation to the left gluteus maximus, and surface stimulation to the left gluteus medius/minimus). Such stimulation reduces sidewise sway at the left hip joint and stabilizes an exercise axis at the left hip joint, making its movement smoother and its athletic ability more efficient. Further, activities of these posterior muscle groups at the hip joints must coordinately cooperate with the point stimulation to the posterior thighs as mentioned earlier. Before application of the thus specified stimulation, these inactive muscle groups (the gluteus medius/minimus at the right hip joint, and the gluteus maximus at the left hip joint) cause certain muscles (the right biceps femoris and the left semitendinosus/semimembranosus) to act strongly in order to compensate for and assist the inactive muscle groups during exercise. Now that the dormant muscle groups are adjusted, the right biceps femoris and the left semitendinosus/semimembranosus should also have their activities controlled. For this purpose, surface stimulation parts 10b are required at locations corresponding to functional skin areas of the right biceps femoris and the left semitendinosus/semimembranosus.

For smooth joint activity of the right hip joint, muscles at the anterior and lateral parts of the right hip joint need to be controlled as well. In this regard, surface stimulation is applied to the anterior and lateral parts of the right thigh over the rectus femoris of the quadriceps femoris and the tensor fasciae latae which are antagonistic to the gluteus maximus (a hip joint extensor). At the right hip joint, such surface stimulation promotes reduction of muscle tone in the stimulated muscles and powerfully assists exercise activities of their antagonists. Eventually, the surface stimulation ensures excellent exercise control ability at the right hip joint and realizes safer, more efficient performance in exercise. Likewise, for smooth joint activity of the left hip joint, muscles at the anterior and medial parts of the left hip joint need to be controlled as well. In this regard, surface stimulation is applied to the left sartorius which acts in coordination with the left tensor fasciae latae (a hip joint flexor/abductor). At the left hip joint, this surface stimulation promotes reduction of muscle tone in the stimulated muscle and powerfully assists exercise activities of its antagonist. Just as at the right hip joint, the stimulation ensures excellent exercise control ability at the left hip joint and can realize superior performance in exercise.

At the right hip joint, an axis of exercise is notably and excessively oriented to a certain exercise direction (a direction for flexion, abduction, and internal rotation of the hip joint). Point stimulation parts 10a at the right vastus medialis of the quadriceps femoris and the right sartorius change this axis along the correct gravity axis of the body, thereby modifying the flow of generated power. The vastus medialis of the quadriceps femoris has a remarkably strong support ability around the knee joints. However, for right-handed people, the right vastus medialis is developed less than the left one, so that the exercise axis and the support base are displaced further outwardly. Therefore, the exercise axis and the support base need to be corrected inwardly by these point stimulation parts 10a at the right vastus medialis of the quadriceps femoris and the right sartorius. Further, after such correction, because abduction is dominant at the right hip joint, the gluteus medius/minimus needs to be stimulated and facilitated in the manner described above. Nevertheless, merely by this facilitatory stimulation to the gluteus medius/minimus, it is difficult to correct an external twist at the knee. The point stimulation part 10a at the right sartorius promotes and improves coordination with the point stimulation part 10a at the right gluteus medius/minimus, thereby correcting the twist at the knee joint.

At the left hip joint, an axis of exercise is notably and excessively oriented to a certain exercise direction (a direction for flexion, adduction, and external rotation of the hip joint). A point stimulation part 10a at the left vastus lateralis of the quadriceps femoris changes this axis along the central axis of the body, thereby modifying the flow of generated power. For right-handed people, the vastus medialis around the left knee is more active than the one around the right knee. However, because the left gluteus maximus of the left leg is not active enough, the exercise direction is often wastefully oriented to the one for abduction and internal rotation during its extension. This necessitates facilitation of not only the left gluteus maximus but also the left vastus lateralis of the quadriceps femoris. The point stimulation part 10a at the left vastus lateralis, together with the one at the left biceps femoris, enables more efficient generation/use of power in a smooth and coordinated manner.

With a point stimulation part 10a at the left medial gastrocnemius, the direction of power acting at the left ankle joint is corrected from the eversion direction to the inversion direction along a proper axis of exercise. As for posterior muscles at the left lower leg of right-handed people, because a power generated by the upper joints or the like is oriented outwardly, the posterior part of the left lower leg attempts to force that power into an inward direction by making the lateral part more active than the medial part. Suppose that the direction of power is corrected at the upper joints but not at the left lower leg, the power is oriented further inwardly at the posterior part of the left lower leg. To correct this activity, the point stimulation part 10a is provided at the left medial gastrocnemius. In the opposed right lower leg, prominent muscle activities are exactly opposite (The power acts in the inversion direction.), which necessitates stimulation and facilitation in an opposite pattern. Thus, muscle activity of the right lower leg is corrected by a point stimulation part 10a at the right peroneus tertius. However, it is difficult to correct the muscle activity only by this point stimulation part 10a at the right peroneus tertius. As a complement, a surface stimulation part 10b at the right tibialis anterior inhibits a strong inversion action at the right ankle joint, thereby correcting the muscle activity. Evidently, the lower legs have a smaller amount of muscles than other parts of the lower limbs (muscle groups as represented by the anterior and posterior thigh muscles). In inverse proportion to the amount of muscles, the lower legs are used more frequently and produce a greater force of action during exercise, which makes them prone to stress and injuries. If the lower leg muscles are simply facilitated by point stimulation, they may be activated too much and may even cause injuries. To prevent this, extreme generation of power should be controlled in muscle groups (the right medial gastrocnemius and the left lateral gastrocnemius) which are opposed to the point stimulation parts 10a. Thus, the respective muscles (the right medial gastrocnemius and the left lateral gastrocnemius) require surface stimulation parts 10b for reducing muscle tone, and have their muscle activities controlled.

However, in controlling eversion at the left ankle joint, facilitatory point stimulation for medially guiding the ankle joint, which is applied to the left medial gastrocnemius, is not perfect by itself. For an additional facilitatory element, a point stimulation part 10a is required at the left tibialis anterior which acts to orient the ankle joint to the inversion direction.

In addition, it should be understood that a force deriving from muscular power involves not only a force of action but also a force of reaction which returns from a location where the force of action is applied, and that these forces act in three-dimensionally twisted directions. At the respective hip joints, if exercise activity is performed in the above-mentioned exercise directions (a direction for flexion, adduction and external rotation of the left hip joint, and a direction for flexion, abduction and internal rotation of the right hip joint), the force of action is responded to not by a proper force of reaction but by a deviated force of reaction. Exercise activity involving a three-dimensionally twisted force (whether proper or deviated) imposes a heavier burden on joints and can be a primary cause of injuries. Hence, exercise activity involving a three-dimensionally twisted force should be eliminated (if the exercise direction is deviated) or should be controlled and restricted ideally (if the exercise direction is proper) as much as possible. For example, exercise activity of the knee joints should be discussed in consideration of rotational exercise activity of the upper joints (the hip joints), as mentioned above. Likewise, exercise activity of the ankle joints, which is affected by the upper joints (the knee and hip joints), should be discussed along with exercise activity of the upper joints. Thus, the upper joints should be asymmetrically supported in consideration of directions of their exercise axes, with adequate modifications to the manner of support. Furthermore, muscles have to be facilitated by point stimulation in such a way as to realize the hip-strategy based manner of exercise. Take the biceps femoris as an example of multiarticular muscles which contain a monoarticular muscle portion. In this case, it is especially necessary to facilitate one of its multiarticular muscle functions, i.e. extension of the hip joint. On the contrary, suppose that a monoarticular muscle function of the biceps femoris is facilitated, flexion of the knee joint stands out so much as to prevent smooth extension of the hip joint.

The description made hitherto relates to adjustment of the lower body, according to the hip strategy-based manner of exercise. Furthermore, in order to realize the hip strategy-based manner of exercise, it is inevitable to adjust and coordinate activities in the upper body which is opposed to the lower body. In the case of Japanese and nonathletic people, a particular attention should be paid to hypertonicity in the upper abdominal muscles and the trapezium. Therefore, the manner of facilitating the upper body should be primarily focused on reduction of muscle tone in these muscles, and should further allow for coordination between lower body activities and upper body activities.

With respect to right-handed people, muscles in the left half of the back are awfully underdeveloped and poorly facilitated, partly because this section locates on the side of the non-dominant hand. Further, with respect to Japanese and nonathletic people, the trapezius is prominently active and constitutes the core of their manner of exercise. Accordingly, with a proviso that the left half of the back is divided into an upper section (around the trapezius) and a lower section (around the latissimus dorsi), the lower section is less good at effective exercise than the upper section. These factors prevent muscle development of the left latissimus dorsi.

In this regard, a point stimulation part 10a at the left latissimus dorsi plays an important role in correcting the hyperactive right latissimus dorsi and also in correcting the entire left half of the back whose activity is unbalanced and dependent on the left trapezium. In the case of right-handed people, the right latissimus dorsi is prominently active and developed well, so that it pulls down the right shoulder and causes a right shoulder-dropped, tilted posture. The first function of this point stimulation part 10a is to modify the tilted posture in a pelvis-based, balanced manner. Its second function is to correct excessive exercise activity in the upper left section of the back (around the trapezius). Nevertheless, with this point stimulation part 10a alone, it is difficult to correct the left half of the back as a whole. Thus, the point stimulation part 10a at the left latissimus dorsi needs to be coordinated with and assisted by a point stimulation part 10a at the middle part of the left erector spinae/the left rhomboideus major and a point stimulation part 10a at the bottommost part of the left erector spinae. This combination can create a symmetrical exercise posture which is centered on the waist part and aligned with the gravity axis for exercise. Having said that, the unbalanced muscle activities have their own merits. The underdeveloped latissimus dorsi, originating from the pelvis which provides a solid support base, has a poor ability to hold the shoulder joint which is a highly mobile ball-and-socket joint with three degrees of freedom. At the left shoulder joint, its poor ability is compensated by advanced development of inner muscles (the supraspinatus, the infraspinatus, the teres major, the teres minor, and the subscapularis). Conversely, at the right shoulder joint of right-handed people, a muscle group surrounding inner muscles develops so well as to obstruct facilitation and activity of the inner muscles. Hence, point stimulation parts 10a at the right supraspinatus and at the right infraspinatus are required to enhance the ability to support the shoulder joint. Although underdevelopment of the right inner muscles severely limits the range of mobility of the right shoulder joint, these two specified point stimulations enhance and cure flexibility at the shoulder joint. However, if the right inner muscles are activated, muscle activity becomes more dominant in the right half of the back than in the left half. Thus, merely by facilitating muscles in the left half of the back with the above point stimulation, it is difficult to adjust muscle activities in the back as a whole. For adjustment of the entire back part, a surface stimulation part 10b is required at a location corresponding to the functional skin area of the right latissimus dorsi. For the same reason, a surface stimulation part 10b is required with respect to the left trapezius which acts excessively together with the right latissimus dorsi.

As explained above, because Japanese and nonathletic people show prominent muscle activity of the trapezius, a surface stimulation part 10b must be also provided at a functional skin area across the left and right pectoralis minor which are accessory muscles acting to assist the trapezium. Part of the muscle activities of the pectoralis minor is to pull the scapulae forwardly and upwardly, to hamper their movement relative to the trunk, and thereby to restrict upper limb movements. Thus, activity of the free upper limb/the shoulder girdles and that of the upper trunk are not coordinated with each other. In this respect, the surface stimulation to the pectoralis minor can adjust such activities and can realize shoulder joint-centered, coordinated activities between these parts. Incidentally, when Japanese and nonathletic people feel mental pressure during a game, match or the like, the trapezius acts radically and has extreme muscle tone, making one's movement unnatural. Besides, the shoulder part as a whole limits actions of respiratory muscles, causing shallow breathing. Thankfully, the above surface stimulation can alleviate these symptoms, can eliminate “performance anxiety” resulting from such symptoms, and can eventually ensure smoother performance of exercise under pressure.

Concerning nonathletic people, let us now concentrate on exercise performance in the upper body, particularly in the free upper limb and the shoulder girdles. With respect to the upper arm, the biceps brachii (a flexor) acts dominantly over the triceps brachii, due to their imperfect ability to learn athletic skills.

On birth, baby's body and limbs are bent and curled in. To put it simply, most of the joints which are capable of internal/external rotation and flexion are pronated and adducted. In the course of physical growth, the human being acquires athletic skill learning ability for orienting a flow of power externally.

Regrettably, it can be said that nonathletic people and Japanese do not follow this growth process properly, because advanced convenient civilization hampers development and evolution of athletic skill learning ability while they grow up. In performing exercise, their joints are neither in a supinated position nor in an abducted position, but are rather in pronated and adducted positions which are advantageous for internally directed, closed movements. In contrast, joints of athletically skilled people have a wide range of mobility and a great exercise performing ability, and their movements are externally oriented.

As compared with nonathletic people, athletically skilled people clearly distinguish the roles of muscles between multiarticular ones and monoarticular ones and between extensors and flexors, and they properly use their muscles as such. Conversely, muscle activities of nonathletic people are mostly concentrated on postural control, which brings about unwanted hypertonicity and useless generation of power during exercise. Besides, upper body movements of nonathletic people are dominated by flexors, whereas their lower body movements are dominated by extensors. This is because they have not acquired perfect body balance for exercise, and, what is worse, because the joints themselves have established inadequate manners of exercise. For these reasons and owing to the difference in exercise directions (internal/external as described above), athletically skilled people perform exercise in a more dynamic and stable manner than the others.

In view of the above, it is essential to provide point stimulation parts 10a at the triceps brachii so as to make its muscle activity dominant, and also to provide surface stimulation parts 10b at the biceps brachii so as to inhibit or control its activity.

Similar immaturity of athletic performance ability is seen in the forearms, as a result of which the forearms tend to be flexed and pronated. Hence, the exercise axes should be corrected by point stimulation to extensor carpi muscles and supinators in the forearms. As mentioned, muscle activity at the forearm joints is dominated by flexion and pronation. Therefore, while point stimulation is applied to the extensors and the supinators, it is necessary to inhibit and control pronators and flexors by surface stimulation. For these reasons, point stimulation 10a and surface stimulation 10b are applied to the respective acting muscles.

The brain orders asymmetrical muscle activities in the free lower limb/the pelvic girdles and symmetrical muscle activities in the free upper limb/the shoulder girdles. Hence, muscle activities of the latter have to be symmetrical, unlike in the other parts of the body. Nevertheless, this is not necessarily applicable if an exercise specially employs a limb on one side of the body (as represented by tennis and baseball). In addition, muscle activities in the free lower limb/the pelvic girdles are in contrast with those in the free upper limb/the shoulder girdles in that the former muscle activities are reciprocal. Therefore, muscle adjustment by an asymmetrical approach is particularly effective in the free lower limb and the pelvic girdles.

FIG. 52 shows a baseball undershirt 115 designed for the right-handed. The locations of point stimulation parts 10a (approximately 2 cm.sup.2 each) correspond to motor points of the right sternocleidomastoid (SCM), the right supraspinatus (SS), the right infraspinatus (IS), the middle part of the left erector spinae (ESMid)/the left rhomboideus major (RMa), the left latissimus dorsi (LD), the lower part of the right erector spinae (ESLo)/the right serratus posterior inferior (SPI), the bottommost part of the left erector spinae (ESBtm)/the left quadratus lumborum (QL), the right pectoralis major (PMa), the left serratus anterior (SA), the medial/lateral heads (MH/LH) of the right triceps brachii (TB), the right extensor carpi radialis longus/brevis (ECRL/ECRB), the right supinator (SUP), the right flexor carpi radialis (FCR), the left biceps brachii (BB), the left flexor carpi ulnaris (FCU), and the left extensor carpi ulnaris (ECU). The locations of surface stimulation parts 10b correspond to functional skin areas of the left upper trapezius (UTP), the right latissimus dorsi (LD), the left pectoralis minor (PMi), the upper rectus abdominis (URA), the right serratus anterior (SA), the right biceps brachii (BB), the right flexor carpi ulnaris (FCU), the right extensor carpi ulnaris (ECU), the medial/lateral heads (MH/LH) of the left triceps brachii (TB), the left supinator (SUP), the left extensor carpi radialis longus/brevis (ECRL/ECRB), and the left flexor carpi radialis (FCR). The undershirt 115 is made of a polyester yarn (thickness 56 dtex/48 f) and a single covered yarn in which a 10-dtex-thick polyurethane elastane yarn core is covered with a polyester yarn (thickness 33 dtex/10 f). The undershirt is knitted in plain stitch. The point stimulation parts 10a and the surface stimulation parts 10b are made in plate stitch by which a polyester yarn (thickness 56 dtex/36 f) forms a projecting pattern on the skin/back side. Seams (not shown) in the undershirt 115 are designed to locate not on the skin side but on the outer side and to align with muscular grooves as best as possible.

One of the vital factors for production of the baseball undershirt 115 is to enable smooth rotational movements at the joints. For example, rotational movements in the trunk are effected around the trunk axis (to rotate the hip, the neck, etc.) and can be roughly classified into two different types. The first type of rotation is axial exercise during which the left or right side of the body looks fixed (like a common swing door). The axis of this rotation is either one leg, and the exercise is principally led by the lower body. The second type is a symmetrical rotation around the spine which constitutes the core of the trunk (like a revolving door), with the hip joints bearing a load in a substantially symmetrical manner. In contrast to the first type of rotation in which the axis is offset to one side and dependent on the lower body, the second type of rotation has an axis centered along the spine and mobilizes the left and right parts of the whole body equally. As a result, the latter rotation is less prone to sway, and is able to realize a most compact rotation axis and speedier movements. In particular, these two types of rotation are noticeable in batting forms of Japanese (nonathletic people) and those of Latin Americans and athletically skilled people. When a Japanese batter who adopts the first type of rotation takes a swing, he imagines a virtual wall built at a front leg which faces the pitcher (e.g. A right-handed batter has this wall to the left of the body.) and attempts to stop the axis of rotation against the wall. This motion is translation rather than rotation. On the other hand, a Latin American batter who adopts the second type of rotation has an established support axis (Imagine a spinning top rotating at high speed.) and tries to hit a ball by originating a rotation from the core of the body. Judging from the facts that many constant long hitters adopt the latter type of rotation and non-Japanese long hitters (above all, Latin Americans) boast of amazing ball distances, it is apparent to tell which batter is superior in today's baseball. Although this symmetrical muscle activity seems simple enough at a glance, we can easily envisage a heavy influence of handedness (as represented by right-handedness and left-handedness) and the like. Referring particularly to the right-handed Japanese (Mongoloids), muscles in the left half of the back are awfully underdeveloped and poorly facilitated, partly because this section locates on the side of the non-dominant hand. Further, with respect to Japanese and nonathletic people, the trapezius is prominently active and constitutes the core of their manner of exercise. Accordingly, with a proviso that the left half of the back is divided into an upper section (around the trapezius) and a lower section (around the latissimus dorsi), the lower section is less good at effective exercise than the upper section. These factors prevent muscle development of the left latissimus dorsi. Due to an attempt to adjust and rectify such inherent imbalance of the back muscles, muscles around the abdomen sacrifice a considerable part of their rotational power, which hampers more efficient rotational activity at the trunk. Moreover, with respect to various reflex reactions, we should note significant involvement of the neck reflex. Broadly speaking, the neck reflex activity means tonic neck reflex for adjusting muscle tone of the limbs so as to hold the posture. To be a little more specific, the tonic neck reflex encompasses two major categories: symmetrical tonic neck reflex and asymmetrical tonic neck reflex. According to typical motional reactions in the symmetrical tonic neck reflex, neck flexion increases muscle tone in upper limb flexors and lower limb extensors; and neck extension increases muscle tone in upper limb extensors and lower limb flexors. Such motions are frequently seen in Sumo wrestling, powerlifting, etc. When a person stands up with a heavy item held in the hands, the person tucks the chin in strongly and bends the neck more deeply, thus trying to encourage extension of the lower limbs. Further, as frequently seen in baseball or the like, a defensive player stretches the neck and activates lower limb flexors in order to keep a low posture. On the other hand, the asymmetrical tonic neck reflex concerns rotations around the trunk, such rotation making up a significant part of exercise activity on a horizontal plane (as observed in baseball, tennis and other like sports). According to this reflex, head rotation to one side increases muscle tone in upper/lower limb extensors on the jaw side, and increases muscle tone in upper/lower limb flexors on the head side. Needless to say, these two neck reflexes have a great influence on muscle asymmetry in the body, as we mentioned heretofore. In baseball, these reflex activities occur in order to improve efficiency of batting, pitching and other motions. Beneficially, these various reflex activities raise the level of completion in exercise. It is also true, however, these reflex activities affect laterality (dominant hand, dominant leg, etc.), resulting in unbalanced muscle development of muscles and inadequate exercise.

In this regard, a point stimulation part 10a at the left latissimus dorsi plays an important role in correcting the hyperactive right latissimus dorsi and in correcting the entire left half of the back whose activity is unbalanced and dependent on the left trapezium. In the case of right-handed people, the right latissimus dorsi is prominently active and developed well, so that it draws down the right shoulder and causes a right shoulder-dropped, tilted posture. The first function of this point stimulation part 10a is to modify the tilted posture in a pelvis-based, balanced manner. Its second function is to correct excessive exercise activity in the upper left section of the back (around the trapezius). Nevertheless, with this point stimulation part 10a alone, it is difficult to correct the left half of the back as a whole. Thus, the point stimulation part 10a at the left latissimus dorsi needs to be coordinated with and assisted by a point stimulation part 10a at the middle part of the left erector spinae/the left rhomboideus major and a point stimulation part 10a at the bottommost part of the left erector spinae. This combination can create a symmetrical exercise posture which is centered on the waist part and aligned with the gravity axis for exercise. Having said that, the unbalanced muscle activities have their own merits. The underdeveloped latissimus dorsi, originating from the pelvis which provides a solid support base, has a poor ability to hold the shoulder joint which is a highly mobile ball-and-socket joint with three degrees of freedom. At the left shoulder joint, its poor ability is compensated by advanced development of inner muscles (the supraspinatus, the infraspinatus, the teres major, the teres minor, and the subscapularis). Conversely, at the right shoulder joint of right-handed people, a muscle group surrounding inner muscles develops so well as to obstruct facilitation and activity of the inner muscles. Hence, point stimulation parts 10a at the right supraspinatus and at the right infraspinatus are required to enhance the ability to support the shoulder joint. Although underdevelopment of the right inner muscles severely limits the range of mobility of the right shoulder joint, these two specified point stimulations enhance and cure flexibility at the shoulder joint. However, if the right inner muscles are activated, muscle activity becomes more dominant in the right half of the back than in the left half. Thus, merely by facilitating muscles in the left half of the back with the above point stimulation, it is difficult to adjust muscle activities in the back as a whole. For adjustment of the entire back part, a surface stimulation part 10b is required at a location corresponding to the functional skin area of the right latissimus dorsi. For the same reason, a surface stimulation part 10b is required with respect to the left trapezius which acts excessively together with the right latissimus dorsi.

As explained above, because Japanese and nonathletic people show prominent muscle activity of the trapezius (particularly in the left half of the back), a surface stimulation part 10b must be also provided at a functional skin area of the left pectoralis minor which is an accessory muscle acting to assist the left trapezium. Part of the muscle activities of the left pectoralis minor is to pull the left scapula upwardly and forwardly, to hamper its movement relative to the trunk, and thereby to restrict upper limb movements. Thus, activity of the free upper limb/the shoulder girdle and that of the upper trunk are not coordinated with each other. In this respect, the surface stimulation to the left pectoralis minor can adjust such activities and can realize shoulder joint-centered, coordinated activities between these parts. Incidentally, when Japanese and nonathletic people feel mental pressure during a game, match or the like, the trapezius acts radically and has extreme muscle tone, making one's movement unnatural. Besides, the shoulder part as a whole limits actions of respiratory muscles, causing shallow breathing. Thankfully, the above surface stimulation can alleviate these symptoms, can eliminate “performance anxiety” resulting from such symptoms, and can eventually ensure smoother performance of exercise under pressure. In addition to the above-described adjustment of the muscle groups in the posterior part of the body, it is also necessary to adjust those in the anterior part of the body. As mentioned, part of the activities of the pectoralis minor is to pull the scapulae forwardly and upwardly, and thus to assist and strengthen the trapezius activity. The surface stimulation part 10b at the left pectoralis minor restrains this activity, making inhibition of the left upper trapezius easier.

The right half of the back shows strong muscle activities as a whole, and causes a posture in which the right shoulder is drawn slightly backward. In this respect, we focus on the pectoralis major, one of whose activities is to pull shoulders forwardly. Input of point stimulation to the right pectoralis major guides the shoulder joint to an anteroposteriorly symmetrical, efficient position. Meanwhile, movement of the right scapula is hampered by prominent actions of the right latissimus dorsi and others. In order to alleviate this condition, surface stimulation is applied to the right serratus anterior which acts to hamper scapula movement, thereby inhibiting and controlling the muscle tone and improving the right scapula function. On the other hand, the left scapula needs an external and downward displacement because it is fixed at a raised position due to high muscle tone of the trapezius, the pectoralis minor, etc. For such improvement, a point stimulation part 10a at the left serratus anterior is provided to make use of its muscle activity, abduction of the scapula. Additionally, the neck activity of right-handed people is characterized in that the face turns easily to the right but awkwardly to the left. To improve this condition, a point stimulation part 10a is provided at the right sternocleidomastoid. The above-mentioned stimulation input methods stabilize the trunk and enable smooth rotation.

Concerning nonathletic people, let us now concentrate on exercise performance in the upper body, particularly in the free upper limb and the shoulder girdles. With respect to the upper arm, the biceps brachii (a flexor) acts dominantly over the triceps brachii, due to their imperfect ability to learn athletic skills.

On birth, baby's body and limbs are bent and curled in. To put it simply, most of the joints which are capable of internal/external rotation and flexion are pronated and adducted. In the course of physical growth, the human being acquires athletic skill learning ability for orienting a flow of power externally.

Regrettably, it can be said that nonathletic people and Japanese do not follow this growth process properly, because advanced convenient civilization hampers development and evolution of athletic skill learning ability while they grow up. In performing exercise, their joints are neither in a supinated position nor in an abducted position, but are rather in pronated and adducted positions (an anteriorly overtwisted state) which are advantageous for internally directed, closed movements. In contrast, joints of athletically skilled people have a wide range of mobility and a great exercise performing ability, and their movements are externally oriented (a state of normal joint mobility).

As compared with nonathletic people, athletically skilled people clearly distinguish the roles of muscles between multiarticular ones and monoarticular ones and between extensors and flexors, and they properly use their muscles as such. Conversely, muscle activities of nonathletic people are mostly concentrated on postural control, which brings about unwanted hypertonicity and useless generation of power during exercise. Besides, upper body movements of nonathletic people are dominated by flexors, whereas their lower body movements are dominated by extensors (under the influence of neck reflex, etc.). This is because they have not acquired perfect body balance for exercise, and, what is worse, because the joints themselves have established inadequate manners of exercise. For these reasons and owing to the difference in exercise directions (internal/external as described above), athletically skilled people perform exercise in a more dynamic and stable manner than the others.

In view of the above, it is essential to apply point stimulation to the triceps brachii so as to make its muscle activity dominant, and also to apply surface stimulation to biceps brachii so as to inhibit or control its activity.

Similar immaturity of athletic performance ability is seen in the forearms, as a result of which the forearms tend to be flexed and pronated. Hence, the exercise axes should be corrected by point stimulation to extensor carpi muscles and a supinator in the forearms. As mentioned, muscle activity at the forearm joints is dominated by flexion and pronation. Therefore, while point stimulation is applied to the extensors and the supinator, it is necessary to inhibit and control pronators and flexors by surface stimulation. For these reasons, point stimulation 10a and surface stimulation 10b are applied to the respective acting muscles.

In addition to the above issues, we should also understand offset of angular momentum, which is an advanced exercise performance involved in batting and pitching motions. For a simple explanation, imagine a person walking. When the right leg swings forward, the left arm swings forward in the upper body. At the same time, the other leg (the left one) is pulled backward and so is the other arm (the right one). This rotatory balance exercise in the upper body and the lower body is the most important factor for correct rotation of the trunk. In particular, this action is observed well in a pitching motion. When a right-handed pitcher winds up, he raises his right arm and swings down his left arm. (The respective powers pull each other and offset their angular momentum, thereby establishing balance and accelerating the rotational speed.) Later, the right leg makes a forward stride, and the left leg acts as a brake. The sudden change of exercise directions produces a rotational power in the lower body. This power is transmitted to the upper body and realizes speedier performance. Harmonization of these compound activities at the joints (internal/external rotation, flexion and extension) gives us a more complex and advanced exercise technique, which is what we actually long for.

Having said that, the brain orders asymmetrical muscle activities in the free lower limb/the pelvic girdles and symmetrical muscle activities in the free upper limb/the shoulder girdles. Hence, muscle activities of the latter have to be symmetrical, unlike in the other parts of the body. Nevertheless, as mentioned above, this is not necessarily applicable if an exercise specially employs a limb on one side of the body (as represented by tennis and baseball). In this case, in order to enhance efficiency of actions on the one side, a surface stimulation part 10b is provided at the right biceps brachii so as to inhibit and control flexion ability of the elbow joint. Point stimulation parts 10a are provided at the medial/lateral heads of the right triceps brachii, so that the elbow joint can acquire an ability to extend more smoothly. For smoother execution of this movement, the angular momentum needs to be offset between the right and left upper arms which are opposed to each other. In this respect, a point stimulation part 10a at the left biceps brachii enhances elbow flexion ability, and a surface stimulation part 10b across the medial/lateral heads of the left triceps brachii helps elbow flexion ability. The asymmetrical angular momentum and actions between the left and right upper arms enable smoother trunk rotation and ensure stable and speedier actions during exercise. Furthermore, the left and right forearms are affected by the upper arms and the trunk which are discussed earlier. Hence, a point stimulation part 10a at the right supinator is employed to increase supination power in the right forearm, and point stimulation 10a is provided for the right extensor carpi radialis longus/brevis whose action is to assist and enhance the action of the right triceps brachii. In order to further emphasize the action of the right extensor carpi radial is longus/brevis, surface stimulation 10b is provided at the right extensor carpi ulnaris and at the right flexor carpi ulnaris, thereby inhibiting and controlling their hyperactivity. In addition, the action of the right flexor carpi radialis is further emphasized by point stimulation 10a. Although the action of Japanese and nonathletic people tends to depend on ulnar flexors, this point stimulation leads their action to a radial flexor-dependent one, thereby realizing stable wrist extension/flexion and forearm rotation. This stimulation input approach can alleviate elbow injuries (baseball elbow and tennis elbow) attributable to pitching motions, tennis strokes, or other like motions. Besides, similar improvements are required in the left forearm, which acts in an opposed manner to the right forearm in order to offset the angular momentum. Accordingly, the manner for improving the left forearm is also opposite to the manner for the right forearm, and employs a surface stimulation part 10b for the left supinator, the surface stimulation part 10b for the left flexor carpi radialis, a surface stimulation part 10b for the left extensor carpi radialis longus/brevis, a point stimulation part 10a for the left extensor carpi ulnaris, and a point stimulation part 10a for the left flexor carpi ulnaris. Owing to the asymmetrical stimulation input to the left and right upper limbs, it is possible to offset the angular momentum in the free upper limb and the shoulder girdles and to improve the trunk rotation ability as intended. Lastly, let us mention that the muscle activities resulting from the above asymmetrical stimulation input stabilizes the trunk more prominently in the free lower limb and the pelvic girdles. Muscle activities in the free lower limb/the pelvic girdles are in contrast with those in the free upper limb/the shoulder girdles in that the former muscle activities are reciprocal. Therefore, muscle adjustment by an asymmetrical approach is particularly effective in the free lower limb and the pelvic girdles.

### Garments for Applying Point Stimulation (Asymmetrical Arrangement)

FIG. 53 shows a pair of tights 116 designed for the right-handed. The locations of stimulation parts 10a (approximately 3 cm.sup.2 each) correspond to motor points of the center of the lower rectus abdominis (LRA), the left internal oblique (IO), the left gluteus maximus (GMax), the right gluteus medius/minimus (GMed/GMin), the right semitendinosus/semimembranosus (ST/SM), the left biceps femoris (BF), the left vastus lateralis of the quadriceps femoris (VL), the right vastus medialis of the quadriceps femoris (VM), the right sartorius (SAR), the left tibialis anterior (TA), the left medial gastrocnemius (MG), the right peroneus tertius (PTert), and the right lateral soleus (LSOL). The base fabric for the tights 116 is made of a polyester yarn 56 dtex/36 f and a polyurethane elastane yarn 44 dtex, and knitted in a half tricot pattern (blend ratio: polyester 80% and polyurethane 20%). Each stimulation part 10a is composed of a plurality of projecting printed dots made of silicone resin. Seams (not shown) in the tights 116 are designed to align with muscular grooves as best as possible.

Regarding the tights 116, a stimulation part 10a at the center of the lower rectus abdominis corrects an anteriorly tilted pelvis. In cooperation with this action, a stimulation part 10a at the left gluteus maximus exhibits its effect (Contraction at the center of the lower rectus abdominis brings the pelvis to an upright position, thereby increasing muscle tone of the gluteus maximus). In response to these muscle activities, the erector spinae (a trunk extensor) increases muscle tone and extends the trunk. (Increase of muscle tone at the gluteus maximus raises muscle tone of the erector spinae. Thus, stimulation to the gluteus maximus activates itself and the erector spinae.) Also stimulated is the left iliopsoas which is antagonistic to the left gluteus maximus and which is antagonistically involved in flexion of the hip joint. This stimulation cooperates with the other stimulations mentioned earlier, allowing the trunk to extend in a more stable manner. Next, a stimulation part 10a at the right gluteus medius/minimus hinders sidewise sway (in adduction-abduction directions) at the hip joint and improves a support power in exercise. These three specified stimulations enhance balance ability and support ability of the trunk. In addition, two of these specified stimulations (the center of the lower rectus abdominis and the left gluteus maximus) define a supporting surface (serving as an application point of force and a fulcrum). Owing to the function of this supporting surface, a stimulation part 10a at the left biceps femoris allows generation of a strong power for extending the hip joint. During running, this extension power is converted to a powerful propelling force. With respect to the gluteal muscles, the right gluteus maximus is more active than the left one, but the right gluteus medius/minimus are less so than the left one. Hence, even though a strong extension power is generated at the hip joint, the fulcrum is not strong enough to convert this extension power into a linear backward propelling force. In this respect, the stimulation part 10a at the right gluteus medius/minimus hinders the above-mentioned sidewise sway at the hip joint, thereby assisting and promoting the right biceps femoris and the right semitendinosus/semimembranosus to work with higher exercise efficiency. The right semitendinosus/semimembranosus, which is less active than the left biceps femoris, tends to orient and waste its power in the abduction direction. To correct this, the stimulation part 10a at the right semitendinosus/semimembranosus veers the power to a neutral direction and realizes efficient backward extension of the hip joint. The stimulation part 10a at the left gluteus maximus assists and corrects unbalanced activities of the left gluteus muscles (The left gluteus maximus is less active than the left gluteus medius/minimus.), and strongly affects extension of the hip joint. (Prominent contraction of the gluteus maximus produces a strong forward propelling force.) Coordination between the stimulation part 10a at the left gluteus maximus and the one at the left biceps femoris makes this function more efficient. The stimulation part 10a at the left biceps femoris also controls hyperactivity of the left semitendinosus/semimembranosus in the left posterior thigh. During extension of the left hip joint, power at the hip joint tends to be lost in the adduction direction. Under such circumstances, this stimulation part orients the power from the adduction direction to the abduction direction, thereby promoting smoother extension of the hip joint and generation of a greater forward propelling force. Having said that, generation of the forward propelling force at the left lower limb and the left pelvic girdle involves not only generation of a strong propelling force of action but also generation of a strong force of reaction (a forward-dragging forward-shearing force which involves rotational movements at the left pelvis, the lumbar lordosis, and the sacral cornu). Hence, a stimulation part 10a at the left internal oblique suppresses the force of reaction and permits the left pelvis, the lumbar lordosis, and the sacral cornu to work as a support base of exercise. (If the effect of this stimulation part is insufficient or absent, the power generated at the right lower limb and the right pelvic girdle is oriented and wasted in the forward direction. Furthermore, the extreme forward-shearing force and the extreme rotatory power may cause damage to joints in the lower lumbar vertebrae and the sacral vertebrae.) Incidentally, if the left internal oblique weakens or if there is no effect of the stimulation part, the trunk becomes unstable. Presumably, such instability is compensated by improper fixation (as called in chiropractics, etc.) of the left sacroiliac joint. It is confirmed and reported that this improper action causes the gastrocnemius to be hypertonic in the left lower leg. Curing of this improper action will be able to alleviate and cure damage to the left lower leg muscles (gastrocnemius strain, Achilles tendon rupture, etc.). The six specified stimulations emphasize respective muscle activities and thereby realize more efficient balance in the exercise posture.

At the right hip joint, an axis of exercise is notably and excessively oriented to a certain exercise direction (a direction for flexion, abduction, and internal rotation of the hip joint). Stimulation parts 10a at the right vastus medialis of the quadriceps femoris and at the right sartorius change this axis along the correct gravity axis of the body, thereby modifying the flow of generated power. The vastus medialis of the quadriceps femoris has a remarkably strong support ability around the knee joints. However, for right-handed people, the right vastus medialis is developed less than the left one, so that the exercise axis and the support base are displaced further outwardly. Therefore, the exercise axis and the support base need to be corrected inwardly by these stimulation parts 10a at the right vastus medialis of the quadriceps femoris and the right sartorius. Further, after such correction, because abduction is dominant at the right hip joint, the gluteus medius/minimus needs to be stimulated and facilitated in the manner described above. Nevertheless, merely by this facilitatory stimulation to the gluteus medius/minimus, it is difficult to correct an external twist at the knee. The stimulation part 10a at the right sartorius promotes and improves coordination with the stimulation part 10a at the right gluteus medius/minimus, thereby correcting the twist at the knee joint.

At the left hip joint, an axis of exercise is notably and excessively oriented to a certain exercise direction (a direction for flexion, adduction, and external rotation of the hip joint). A stimulation part 10a at the left vastus lateralis of the quadriceps femoris changes this axis along the central axis of the body, thereby modifying the flow of generated power. For right-handed people, the vastus medialis around the left knee is more active than the one around the right knee. However, because the left gluteus maximus of the left leg is not active enough, the exercise direction is often wastefully oriented to the one for abduction and internal rotation during its extention. This necessitates facilitation of not only the left gluteus maximus but also the left vastus lateralis of the quadriceps femoris. The stimulation part 10a at the left vastus lateralis, together with the one at the left biceps femoris, enables more efficient generation/use of power in a smooth and coordinated manner.

With a stimulation part 10a at the left medial gastrocnemius, the direction of power acting at the left ankle joint is corrected from the eversion direction to the inversion direction along a proper axis of exercise. As for posterior muscles at the left lower leg of right-handed people, because a power generated by the upper joints or the like is oriented outwardly, the posterior part of the left lower leg attempts to force that power into an inward direction by making the lateral part more active than the medial part. Suppose that the direction of power is corrected at the upper joints but not at the left lower leg, the power is oriented further inwardly at the posterior part of the left lower leg. To correct this activity, the stimulation part 10a is provided at the left medial gastrocnemius. In the opposed right lower leg, prominent muscle activities are exactly opposite (The power acts in the inversion direction.), which necessitates stimulation and facilitation in an opposite pattern. Thus, muscle activity of the right lower leg is corrected by stimulation parts 10a at the right peroneus tertius and at the right lateral soleus. They also reduce sway to the inversion direction at the right ankle.

However, in controlling eversion at the left ankle joint, facilitatory stimulation to the left medial gastrocnemius is not perfect by itself. For an additional facilitatory element, a stimulation part 10a is required at the left tibialis anterior which acts to orient the ankle joint to the inversion direction.

In addition, it should be understood that a force deriving from muscular power involves not only a force of action but also a force of reaction which returns from a location where the force of action is applied, and that these forces act in three-dimensionally twisted directions. At the respective hip joints, if exercise activity is performed in the above-mentioned exercise directions (a direction for flexion, adduction and external rotation of the left hip joint, and a direction for flexion, abduction and internal rotation of the right hip joint), the force of action is responded to not by a proper force of reaction but by a deviated force of reaction. Exercise activity involving a three-dimensionally twisted force (whether proper or deviated) imposes a heavier burden on joints and can be a primary cause of injuries. Hence, exercise activity involving a three-dimensionally twisted force should be eliminated (if the exercise direction is deviated) or should be controlled and restricted ideally (if the exercise direction is proper) as much as possible. For example, exercise activity of the knee joints should be discussed in consideration of rotational exercise activity of the upper joints (the hip joints), as mentioned above. Likewise, exercise activity of the ankle joints, which is affected by the upper joints (the knee and hip joints), should be discussed along with exercise activity of the upper joints. Thus, the upper joints should be asymmetrically supported in consideration of directions of their exercise axes, with adequate modifications to the manner of support. Furthermore, muscles have to be facilitated by point stimulation in such a way as to realize the hip-strategy based manner of exercise. Take the biceps femoris as an example of multiarticular muscles which contain a monoarticular muscle portion. In this case, it is especially necessary to facilitate one of its multiarticular muscle functions, i.e. extension of the hip joint. On the contrary, suppose that a monoarticular muscle function of the biceps femoris is facilitated, flexion of the knee joint stands out so much as to prevent smooth extension of the hip joint.

FIG. 54 shows a full suit 117 designed for the right-handed, which can be used in sports which involve symmetrical upper limb movements, such as track and field, swimming (butterfly and breaststroke), skating, cycling, and skiing. The locations of stimulation parts 10a correspond to motor points of the right sternocleidomastoid (SCM), the right supraspinatus (SS), the right infraspinatus (IS), the middle part of the left erector spinae (ESMid)/the left rhomboideus major (RMa), the left latissimus dorsi (LD), the lower part of the right erector spinae (ESLo)/the right serratus posterior inferior (SPI), the bottommost part of the left erector spinae (ESBtm)/the left quadratus lumborum (QL), the right gluteus medius/minimus (GMed/GMin), the left gluteus maximus (GMax), the left biceps femoris (BF), the right semitendinosus/semimembra-nosus (ST/SM), the left medial gastrocnemius (MG), the right lateral soleus (LSOL), the left internal oblique (IO), the center of the lower rectus abdominis (LRA), the right sartorius (SAR), the right vastus medialis of the quadriceps femoris (VM), the left vastus lateralis of the quadriceps femoris (VL), the left tibialis anterior (TA), the right peroneus tertius (PTert), the medial/lateral heads (MH/LH) of the left and right triceps brachii (TB), the left and right supinator (SUP), and the left and right extensor carpi radialis longus (ECRL). This full suit 117 is made of a yarn which is obtained by paralleling nylon yarns (thickness 78 dtex/48 f) and of a single covered yarn in which a 44-dtex-thick polyurethane elastane yarn core is covered with a nylon yarn (thickness 56 dtex/48 f). The full suit is knitted in plain stitch. The stimulation parts 10a (approximately 3 cm.sup.2 each) are made in plate stitch by which a polyester yarn (thickness 78 dtex/36 f) forms a projecting pattern on the skin/back side. Seams (not shown) in the full suit 117 are sewn flat so as to avoid stimulation to the skin, and are designed to align with muscular grooves as best as possible.

The full suit 117 is intended to improve power of muscle activity by giving point stimulation. A stimulation part 10a at the center of the lower rectus abdominis corrects an anteriorly tilted pelvis. In cooperation with this action, a stimulation part 10a at the left gluteus maximus exhibits its effect. (Contraction of the lower rectus abdominis brings the pelvis to an upright position, thereby increasing muscle tone of the gluteus maximus.) In response to this, the lower part of the right erector spinae (a trunk extensor)/the right serratus posterior inferior and the bottommost part of the left erector spinae (a trunk extensor)/the left quadratus lumborum develop muscle tone and extend the trunk. (Increase of muscle tone at the gluteus maximus raises muscle tone of the erector spinae. Thus, stimulation to the gluteus maximus activates itself and the erector spinae.) The left gluteus maximus is also stimulated with antagonistic flexion of the hip joint by the left iliopsoas. This stimulation cooperates with the other stimulations mentioned earlier, allowing the trunk to extend in a more stable manner. Moreover, a stimulation part 10a at the right gluteus medius/minimus hinders sidewise sway (in adduction-abduction directions) at the hip joint and improves a support power in exercise. These six specified stimulations enhance balance ability and support ability of the trunk. In addition, two of these specified stimulations (the lower rectus abdominis and the right gluteus medius/minimus) define a supporting surface (serving as an application point of force and a fulcrum). Owing to the function of this supporting surface, a stimulation part 10a at the right biceps femoris allows generation of a strong power for extending the hip joint. During running, this extension power is converted to a powerful propelling force. With respect to the gluteal muscles, the right gluteus maximus is more active than the left one, but the right gluteus medius/minimus are less so than the left one. Hence, even though a strong extension power is generated at the hip joint, the fulcrum is not strong enough to convert this extension power into a linear backward propelling force. In this respect, the stimulation part 10a at the right gluteus medius/minimus hinders the above-mentioned sidewise sway at the hip joint, thereby assisting and promoting the right biceps femoris and the right semitendinosus/semimembranosus to work with higher exercise efficiency. The right semitendinosus/semimembranosus, which is less active than the right biceps femoris, tends to orient and waste its power in the abduction direction. To correct this, the stimulation part 10a at the right semitendinosus/semimembranosus veers the power to a neutral direction and realizes efficient backward extension of the hip joint. The stimulation part 10a at the left gluteus maximus assists and corrects unbalanced activities of the left gluteus muscles (The left gluteus maximus is less active than the left gluteus medius/minimus.), and strongly affects extension of the hip joint. (Prominent contraction of the gluteus maximus produces a strong forward propelling force.) Coordination between the stimulation part 10a at the left right gluteus maximus and the one at the left biceps femoris makes this function more efficient. The stimulation part 10a at the left biceps femoris also controls hyperactivity of the semitendinosus/semimembranosus in the left posterior thigh. During extension of the right hip joint, power at the hip joint tends to be lost in the adduction direction. Under such circumstances, the stimulation part orients the power from the adduction direction to the abduction direction, thereby promoting smoother extension of the hip joint and generation of a greater forward propelling force. Having said that, generation of the forward propelling force at the right lower limb and the right pelvic girdle involves not only generation of a strong propelling force of action but also generation of a strong force of reaction (a forward-dragging forward-shearing force which involves rotational movements at the left pelvis, the lumbar lordosis, and the sacral cornu). Hence, a stimulation part 10a at the left internal oblique suppresses the force of reaction and permits the left pelvis, the lumbar lordosis, and the sacral cornu to work as a support base of exercise. (If the effect of this stimulation part is insufficient or absent, the power generated at the right lower limb and the right pelvic girdle is oriented and wasted in the forward direction. Furthermore, the extreme forward-shearing force and the extreme rotatory power may cause damage to joints in the lower lumbar vertebrae and the sacral vertebrae.) The nine specified stimulations emphasize respective muscle activities and thereby realize more efficient balance in the exercise posture.

At the right hip joint, an axis of exercise is notably and excessively oriented to a certain exercise direction (a direction for flexion, abduction, and internal rotation of the hip joint). Stimulation parts 10a at the right vastus medialis of the quadriceps femoris and at the right sartorius change this axis along the correct gravity axis of the body, thereby modifying the flow of generated power. The vastus medialis of the quadriceps femoris has a remarkably strong support ability around the knee joints. However, for right-handed people, the right vastus medialis is developed less than the left one, so that the exercise axis and the support base are displaced further outwardly. Therefore, the exercise axis and the support base need to be corrected inwardly by these stimulation parts 10a at the vastus medialis of the quadriceps femoris and the right sartorius. Further, during extension, because abduction is dominant at the left hip joint, the gluteus maximus needs to be stimulated and facilitated in the manner described above. Nevertheless, merely by this facilitatory stimulation to the gluteus maximus, it is difficult to correct an external twist at the knee. The point stimulation part 10a at the left sartorius promotes and improves coordination with the point stimulation part 10a at the left gluteus maximus, thereby correcting the twist at the knee joint.

At the right hip joint, an axis of exercise is notably and excessively oriented to a certain exercise direction (a direction for flexion, abduction, and internal rotation of the hip joint). A stimulation part 10a at the left vastus lateralis of the quadriceps femoris changes this axis along the central axis of the body, thereby modifying the flow of generated power. For right-handed people, the vastus medialis around the left knee is more active than the one around the right knee. However, because the left gluteus maximus of the left leg is not active enough, the exercise direction is often wastefully oriented to the one for abduction and internal rotation. This necessitates facilitation of not only the left gluteus maximus but also the left vastus lateralis of the quadriceps femoris. The stimulation part 10a at the left vastus lateralis, together with the one at the left biceps femoris, enables more efficient generation/use of power in a smooth and coordinated manner.

With a stimulation part 10a at the left medial gastrocnemius, the direction of power acting at the left ankle joint is corrected from the eversion direction to the inversion direction along a proper axis of exercise. As for posterior muscles at the left lower leg of right-handed people, because a power generated by the upper joints or the like is oriented outwardly, the posterior part of the left lower leg attempts to force that power into an inward direction by making the lateral part more active than the medial part. Suppose that the direction of power is corrected at the upper joints, the power is oriented further inwardly at the posterior part of the left lower leg. To correct this activity, the stimulation part 10a is provided at the left medial gastrocnemius. In the opposed right lower leg, prominent muscle activities are exactly opposite (The power acts in the inversion direction.), which necessitates stimulation and facilitation in an opposite pattern. Thus, muscle activity of the right lower leg is corrected by stimulation parts 10a at the right peroneus tertius and at the right lateral soleus. They also reduce sway to the inversion direction at the right ankle.

In addition, it should be understood that a force deriving from muscular power involves not only a force of action but also a force of reaction which returns from a location where the force of action is applied, and that these forces act in three-dimensionally twisted directions. At the respective hip joints, if exercise activity is performed in the above-mentioned exercise directions (a direction for flexion, adduction and external rotation of the left hip joint, and a direction for flexion, abduction and internal rotation of the right hip joint), the force of action is responded to not by a proper force of reaction but by a deviated force of reaction. Exercise activity involving a three-dimensionally twisted force (whether proper or deviated) imposes a heavier burden on joints and can be a primary cause of injuries. Hence, exercise activity involving a three-dimensionally twisted force should be eliminated (if the exercise direction is deviated) or should be controlled and restricted ideally (if the exercise direction is proper) as much as possible. For example, exercise activity of the knee joints should be discussed in consideration of rotational exercise activity of the upper joints (the hip joints), as mentioned above. Likewise, exercise activity of the ankle joints, which is affected by the upper joints (the knee and hip joints), should be discussed along with exercise activity of the upper joints. Thus, the upper joints should be asymmetrically supported in consideration of directions of their exercise axes, with adequate modifications to the manner of support. Furthermore, muscles have to be facilitated by point stimulation in such a way as to realize the hip-strategy based manner of exercise. Take the biceps femoris as an example of multiarticular muscles which contain a monoarticular muscle portion. In this case, it is especially necessary to facilitate one of its multiarticular muscle functions, i.e. extension of the hip joint. On the contrary, suppose that a monoarticular muscle function of the biceps femoris is facilitated, flexion of the knee joint stands out so much as to prevent smooth extension of the hip joint.

The description made hitherto relates to adjustment of the lower body, according to the hip strategy-based manner of exercise. Furthermore, in order to realize the hip strategy-based manner of exercise, it is inevitable to adjust and coordinate activities in the upper body which is opposed to the lower body. In the case of Japanese and nonathletic people, a particular attention should be paid to hypertonicity in the upper abdominal muscles and the trapezium. Therefore, the manner of facilitating the upper body should be primarily focused on reduction of muscle tone in these muscles, and should further allow for coordination between lower body activities and upper body activities.

With respect to right-handed people, muscles in the left half of the back are awfully underdeveloped and poorly facilitated, partly because this section locates on the side of the non-dominant hand. Further, with respect to Japanese and nonathletic people, the trapezius is prominently active and constitutes the core of their manner of exercise. Accordingly, with a proviso that the left half of the back is divided into an upper section (around the trapezius) and a lower section (around the latissimus dorsi), the lower section is less good at effective exercise than the upper section. These factors prevent muscle development of the left latissimus dorsi.

In this regard, a stimulation part 10a at the left latissimus dorsi plays an important role in correcting the hyperactive right latissimus dorsi and in correcting the entire left half of the back whose activity is unbalanced and dependent on the left trapezium. In the case of right-handed people, the right latissimus dorsi is prominently active and developed well, so that it draws down the right shoulder and causes a right shoulder-dropped, tilted posture. The first function of this stimulation part 10a is to modify the tilted posture in a pelvis-based, balanced manner. Its second function is to correct excessive exercise activity in the upper left section of the back (around the trapezius). Nevertheless, with this stimulation part 10a alone, it is difficult to correct the left half of the back as a whole. Thus, the stimulation part 10a at the left latissimus dorsi needs to be coordinated with and assisted by a stimulation part 10a at the middle part of the left erector spinae/the left rhomboideus major and a stimulation part 10a at the bottommost part of the left erector spinae. This combination can create a symmetrical exercise posture which is centered on the waist part and aligned with the gravity axis for exercise. Having said that, the unbalanced muscle activities have their own merits. The underdeveloped latissimus dorsi, originating from the pelvis which provides a solid support base, has a poor ability to hold the shoulder joint which is a highly mobile ball-and-socket joints with three degrees of freedom. At the left shoulder joint, its poor ability is compensated by advanced development of inner muscles (the supraspinatus, the infraspinatus, the teres major, the teres minor, and the subscapularis). Conversely, at the right shoulder joint of right-handed people, a muscle group surrounding inner muscles develops so well as to obstruct facilitation and activity of the inner muscles. Hence, stimulation parts 10a at the right supraspinatus and at the right infraspinatus are required to enhance the ability to support the shoulder joint. Although underdevelopment of the right inner muscles severely limits the range of mobility of the right shoulder joint, the two specified stimulations enhance and cure flexibility at the shoulder joint.

Concerning nonathletic people, let us now concentrate on exercise performance in the upper body, particularly in the free upper limb and the shoulder girdles. With respect to the upper arm, the biceps brachii (a flexor) acts dominantly over the triceps brachii, due to their imperfect ability to learn athletic skills.

On birth, baby's body and limbs are bent and curled in. To put it simply, most of the joints which are capable of internal/external rotation and flexion are pronated and adducted. In the course of physical growth, the human being acquires athletic skill learning ability for orienting a flow of power externally.

Regrettably, it can be said that nonathletic people and Japanese do not follow this growth process properly, because advanced convenient civilization hampers development and evolution of athletic skill learning ability while they grow up. In performing exercise, their joints are neither in a supinated position nor in an abducted position, but are rather in pronated and adducted positions which are advantageous for internally directed, closed movements. In contrast, joints of athletically skilled people have a wide range of mobility and a great exercise performing ability, and their movements are externally oriented.

As compared with nonathletic people, athletically skilled people clearly distinguish the roles of muscles between multiarticular ones and monoarticular ones and between extensors and flexors, and they properly use their muscles as such. Conversely, muscle activities of nonathletic people are mostly concentrated on postural control, which brings about unwanted hypertonicity and useless generation of power during exercise. Besides, upper body movements of nonathletic people are dominated by flexors, whereas their lower body movements are dominated by extensors. This is because they have not acquired perfect body balance for exercise, and, what is worse, because the joints themselves have established inadequate manners of exercise. For these reasons and owing to the difference in exercise directions (internal/external as described above), athletically skilled people perform exercise in a more dynamic and stable manner than the others.

In view of the above, it is essential to provide stimulation parts 10a at the triceps brachii so as to make its muscle activity dominant over the biceps brachii.

Similar immaturity of athletic performance ability is seen in the forearms, as a result of which the forearms tend to be flexed and pronated. Hence, the exercise axes should be corrected by point stimulation to extensor carpi muscles and supinators in the forearms. As mentioned, muscle activity at the forearm joints is dominated by flexion and pronation. Therefore, point stimulation is applied to the extensors and the supinators. For this reason, stimulation 10a is applied to the respective acting muscles.

The brain orders asymmetrical muscle activities in the free lower limb/the pelvic girdles and symmetrical muscle activities in the free upper limb/the shoulder girdles. Hence, muscle activities of the latter have to be symmetrical, unlike in the other parts of the body. Nevertheless, this is not necessarily applicable if an exercise specially employs a limb on one side of the body (as represented by tennis and baseball). In addition, muscle activities in the free lower limb/the pelvic girdles are in contrast with those in the free upper limb/the shoulder girdles in that the former muscle activities are reciprocal. Therefore, muscle adjustment by an asymmetrical approach is particularly effective in the free lower limb and the pelvic girdles.

FIG. 55 shows a baseball undershirt 118 designed for the right-handed. The locations of stimulation parts 10a (approximately 3 cm.sup.2 each) correspond to motor points of the right sternocleidomastoid (SCM), the right supraspinatus (SS), the right infraspinatus (IS), the middle part of the left erector spinae (ESMid)/the left rhomboideus major (RMa), the left latissimus dorsi (LD), the lower part of the right erector spinae (ESLo)/the right serratus posterior inferior (SPI), the bottommost part of the left erector spinae (ESBtm) (the longissimus thoracis)/the left quadratus lumborum (QL), the right pectoralis major (PMa), the left serratus anterior (SA), the medial/lateral heads (MH/LH) of the right triceps brachii (TB), the right extensor carpi radialis longus/brevis (ECRL/ECRB), the right flexor carpi radialis (FCR), the right supinator (SUP), the left biceps brachii (BB), the left flexor carpi ulnaris (FCU), and the left extensor carpi ulnaris (ECU). The undershirt 118 is made of a polyester yarn 33 dtex/48 f and a polyurethane elastane yarn 44 dtex, and knitted in a half tricot pattern (blend ratio: polyester 80% and polyurethane 20%). Each stimulation part 10a is composed of a plurality of projecting printed dots made of silicone resin. Seams (not shown) in the undershirt 118 are designed to locate not on the skin side but on the outer side and to align with muscular grooves as best as possible.

One of the vital factors for production of the baseball undershirt 118 is to enable smooth rotational movements at the joints. For example, rotational movements in the trunk are effected around the trunk axis (to rotate the hip, the neck, etc.) and can be roughly classified into two different types. The first type of rotation is axial exercise during which the left or right side of the body looks fixed (like a common swing door). The axis of this rotation is either one leg, and the exercise is principally led by the lower body. The second type is a symmetrical rotation around the spine which constitutes the core of the trunk (like a revolving door), with the hip joints bearing a load in a substantially symmetrical manner. In contrast to the first type of rotation in which the axis is offset to one side and dependent on the lower body, the second type of rotation has an axis centered along the spine and mobilizes the left and right parts of the whole body equally. As a result, the latter rotation is less prone to sway, and is able to realize a most compact rotation axis and speedier movements. In particular, these two types of rotation are noticeable in batting forms of Japanese (nonathletic people) and those of Latin Americans and athletically skilled people. When a Japanese batter who adopts the first type of rotation takes a swing, he imagines a virtual wall built at a front leg nearer to the pitcher (e.g. A right-handed batter has this wall to the left side of the body.) and attempts to stop the axis of rotation against the wall. This motion is translation rather than rotation. On the other hand, a Latin American batter who adopts the second type of rotation has an established support axis (just as a spinning top rotating at high speed.) and tries to hit a ball by originating a rotation from the core of the body. Judging from the facts that many constant long hitters adopt the latter type of rotation and non-Japanese long hitters (above all, Latin Americans) boast of amazing ball distances, it is apparent to tell which batter is superior in today's baseball. Although this symmetrical muscle activity seems simple enough at a glance, we can easily envisage a heavy influence of handedness (as represented by right-handedness and left-handedness) and the like. Referring particularly to the right-handed Japanese (Mongoloids), muscles in the left half of the back are awfully underdeveloped and poorly facilitated, partly because this section locates on the side of the non-dominant hand. Further, with respect to Japanese and nonathletic people, the trapezius is prominently active and constitutes the core of their manner of exercise. Accordingly, with a proviso that the left half of the back is divided into an upper section (around the trapezius) and a lower section (around the latissimus dorsi), the lower section is less good at effective exercise than the upper section. These factors prevent muscle development of the left latissimus dorsi. Due to an attempt to adjust and rectify such inherent imbalance of the back muscles, muscles around the abdomen sacrifice a considerable part of their rotational power, which hampers more efficient rotational activity at the trunk. Moreover, with respect to various reflex reactions, we should note significant involvement of the neck reflex. Broadly speaking, the neck reflex activity means tonic neck reflex for adjusting muscle tone of the limbs so as to hold the posture. To be a little more specific, the tonic neck reflex encompasses two major categories: symmetrical tonic neck reflex and asymmetrical tonic neck reflex. According to typical motional reactions in the symmetrical tonic neck reflex, neck flexion increases muscle tone in upper limb flexors and lower limb extensors; and neck extension increases muscle tone in upper limb extensors and lower limb flexors. Such motions are frequently seen in Sumo wrestling, powerlifting, etc. When a person stands up with a heavy item held in the hands, the person tucks the chin in strongly and bends the neck more deeply, thus trying to encourage extension of the lower limbs. Further, as frequently seen in baseball or the like, a defensive player stretches the neck and activates lower limb flexors in order to keep a low posture. On the other hand, the asymmetrical tonic neck reflex concerns rotations around the trunk, such rotation making up a significant part of exercise activity on a horizontal plane (as observed in baseball, tennis and other like sports). According to this reflex, head rotation to one side increases muscle tone in upper/lower limb extensors on the jaw side, and increases muscle tone in upper/lower limb flexors on the head side. Needless to say, these two neck reflexes have a great influence on muscle asymmetry in the body, as we mentioned heretofore. In baseball, these reflex activities occur in order to improve efficiency of batting, pitching and other motions. Beneficially, these various reflex activities raise the level of completion in exercise. It is also true, however, these reflex activities affect laterality (dominant hand, dominant leg, etc.), resulting in unbalanced muscle development and inadequate exercise.

In this regard, a stimulation part 10a at the left latissimus dorsi plays an important role in correcting the hyperactive right latissimus dorsi and in correcting the entire left half of the back whose activity is unbalanced and dependent on the left trapezium. In the case of right-handed people, the right latissimus dorsi is prominently active and developed well, so that it draws down the right shoulder and causes a right shoulder-dropped, tilted posture. The first function of this stimulation part 10a is to modify the tilted posture in a pelvis-based, balanced manner. Its second function is to correct excessive exercise activity in the upper left section of the back (around the trapezius). Nevertheless, with this stimulation part 10a alone, it is difficult to correct the left half of the back as a whole. Thus, the stimulation part 10a at the left latissimus dorsi needs to be coordinated with and assisted by a stimulation part 10a at the middle part of the left erector spinae/the left rhomboideus major and a stimulation part 10a at the bottommost part of the left erector spinae. This combination can create a symmetrical exercise posture which is centered on the waist part and aligned with the gravity axis for exercise. Having said that, the unbalanced muscle activities have their own merits. The underdeveloped latissimus dorsi, originating from the pelvis which provides a solid support base, has a poor ability to hold the shoulder joint which is a highly mobile ball-and-socket joints with three degrees of freedom. At the left shoulder joint, its poor ability is compensated by advanced development of inner muscles (the supraspinatus, the infraspinatus, the teres major, the teres minor, and the subscapularis). Conversely, at the right shoulder joint of right-handed people, a muscle group surrounding inner muscles develops so well as to obstruct facilitation and activity of the inner muscles. Hence, stimulation parts 10a at the right supraspinatus and at the right infraspinatus are required to enhance the ability to support the shoulder joint. Although underdevelopment of the right inner muscles severely limits the range of mobility of the right shoulder joint, the two specified stimulations enhance and cure flexibility at the shoulder joint.

The right half of the back shows strong muscle activities as a whole, and causes a posture in which the right shoulder is drawn slightly backward. In this respect, we focus on the pectoralis major, one of whose activities is to pull shoulders forwardly. Input of point stimulation to the right pectoralis major guides the shoulder joint to an anteroposteriorly symmetrical, efficient position. In addition, the left scapula needs an external and downward displacement because it is fixed at a raised position due to high muscle tone of the trapezius, the pectoralis minor, etc. For such improvement, a stimulation part 10a at the left serratus anterior is provided to make use of its muscle activity, abduction of the scapula. Additionally, the neck activity of right-handed people is characterized in that the face turns easily to the right but awkwardly to the left. To improve this condition, a stimulation part 10a is provided at the right sternocleidomastoid. The above-mentioned stimulation input methods stabilize the trunk and enable smooth rotation.

Concerning nonathletic people, let us now concentrate on exercise performance in the upper body, particularly in the free upper limb and the shoulder girdles. With respect to the upper arm, the biceps brachii (a flexor) acts dominantly over the triceps brachii, due to their imperfect ability to learn athletic skills.

On birth, baby's body and limbs are bent and curled in. To put it simply, most of the joints which are capable of internal/external rotation and flexion are pronated and adducted. In the course of physical growth, the human being acquires athletic skill learning ability for orienting a flow of power externally.

Regrettably, it can be said that nonathletic people and Japanese do not follow this growth process properly, because advanced convenient civilization hampers development and evolution of athletic skill learning ability while they grow up. In performing exercise, their joints are neither in a supinated position nor in an abducted position, but are rather in pronated and adducted positions (an anteriorly overtwisted state) which are advantageous for internally directed, closed movements. In contrast, joints of athletically skilled people have a wide range of mobility and a great exercise performing ability, and their movements are externally oriented (a state of normal joint mobility).

As compared with nonathletic people, athletically skilled people clearly distinguish the roles of muscles between multiarticular ones and monoarticular ones and between extensors and flexors, and they properly use their muscles as such. Conversely, muscle activities of nonathletic people are mostly concentrated on postural control, which brings about unwanted hypertonicity and useless generation of power during exercise. Besides, upper body movements of nonathletic people are dominated by flexors, whereas their lower body movements are dominated by extensors (under the influence of neck reflex, etc.). This is because they have not acquired perfect body balance for exercise, and, what is worse, because the joints themselves have established inadequate manners of exercise. For these reasons and owing to the difference in exercise directions (internal/external as described above), athletically skilled people perform exercise in a more dynamic and stable manner than the others.

In view of the above, point stimulation is applied to the triceps brachii so as to make its muscle activity dominant. Further, similar immaturity of athletic performance ability is seen in the forearms, as a result of which the forearms tend to be flexed and pronated. Hence, the exercise axes should be corrected by point stimulation to extensor carpi muscles and a supinator in the forearms. As mentioned, muscle activity at the forearm joints is dominated by flexion and pronation. Therefore, point stimulation is applied to the extensors and the supinator. For this reason, stimulation 10a is applied to the respective acting muscles.

In addition to the above issues, we should also understand offset of angular momentum, which is an advanced exercise performance involved in batting and pitching motions. For a simple explanation, imagine a person walking. When the right leg swings forward, the left arm swings forward in the upper body. At the same time, the other leg (the left one) is pulled backward and so is the other arm (the right one). This rotatory balance exercise in the upper body and the lower body is the most important factor for correct rotation of the trunk. In particular, this action is observed well in a pitching motion. When a right-handed pitcher winds up, he raises his right arm and swings down his left arm. (The respective powers pull each other and offset their angular momentum, thereby establishing balance and accelerating the rotational speed.) Later, the right leg makes a forward stride, and the left leg acts as a brake. The sudden change of exercise directions produces a rotational power in the lower body. This power is transmitted to the upper body and realizes speedier performance. Harmonization of these compound activities at the joints (internal/external rotation, flexion and extension) gives us a more complex and advanced exercise technique, which is what we actually long for.

Having said that, the brain orders asymmetrical muscle activities in the free lower limb/the pelvic girdles and symmetrical muscle activities in the free upper limb/the shoulder girdles. Hence, muscle activities of the latter have to be symmetrical, unlike in the other parts of the body. Nevertheless, as mentioned above, this is not necessarily applicable if an exercise specially employs a limb on one side of the body (as represented by tennis and baseball). In this case, in order to enhance efficiency of actions on the one side, stimulation parts 10a at the medial/lateral heads of the right triceps brachii are provided, so that the elbow joint can acquire an ability to extend more smoothly. For smoother execution of this movement, the angular momentum needs to be offset between the right and left upper arms which are opposed to each other. In this respect, a stimulation part 10a at the left biceps brachii is required to enhance elbow flexion ability. The asymmetrical angular momentum and actions between the left and right upper arms enable smoother trunk rotation and ensure stable and speedier actions during exercise. Furthermore, the left and right forearms are affected by the upper arms and the trunk which are discussed earlier. Hence, a stimulation part 10a at the right supinator is employed to increase the supination power in the right forearm, and a stimulation part 10a is provided at the right extensor carpi radial is longus/brevis whose action is to assist and enhance the action of the right triceps brachii. In addition, Japanese and nonathletic people, who are said to be capable of snapping the wrists only weakly, tend to depend on ulnar flexors. Once the action of the right flexor carpi radialis is emphasized, their action comes to rely on radial flexors, thereby realizing powerful wrist extension/flexion and forearm rotation. This stimulation input approach can alleviate elbow injuries (baseball elbow and tennis elbow) attributable to pitching motions, tennis strokes, or other like motions. Besides, similar improvements are required in the left forearm, which acts in an opposed manner to the right forearm in order to offset the angular momentum. Accordingly, the manner for improving the left forearm is also opposite to the manner for the right forearm, and employs stimulation parts 10a for the left extensor carpi ulnaris and the left flexor carpi ulnaris. Owing to the asymmetrical stimulation input to the left and right upper limbs, it is possible to offset the angular momentum in the free upper limb and the shoulder girdles and to improve the trunk rotation ability as intended. Lastly, let us mention that muscle activities resulting from the above asymmetrical stimulation input stabilizes the trunk more prominently in the free lower limb and the pelvic girdles. Muscle activities in the free lower limb/the pelvic girdles are in contrast with those in the free upper limb/the shoulder girdles in that the former muscle activities are reciprocal. Therefore, muscle adjustment by an asymmetrical approach is particularly effective in the free lower limb and the pelvic girdles.

### Garments for Applying Surface Stimulation (Asymmetrical Arrangement)

FIG. 56 shows a pair of tights 119 designed for the right-handed. The locations of surface stimulation parts 10b correspond to functional skin areas of the left gluteus medius/minimus (GMed/GMin), the right gluteus maximus (GMax), the right biceps femoris (BF), the left semitendinosus/semimembranosus (ST/SM), the right medial gastrocnemius (MG), the left lateral gastrocnemius (LG), the right tensor fasciae latae (TFL), the right rectus femoris of the quadriceps femoris (RF), the left sartorius (SAR), and the right tibialis anterior (TA). The tights 119 are made of a yarn which is obtained by paralleling nylon yarns (thickness 78 dtex/48 f) and of a single covered yarn in which a 44-dtex-thick polyurethane elastane yarn core is covered with a nylon yarn (thickness 56 dtex/48 f). The tights 119 are knitted in plain stitch. The surface stimulation parts 10b are made in plate stitch by which a polyester yarn (thickness 78 dtex/36 f) forms a projecting pattern on the skin/back side. Seams (not shown) in the tights 119 are designed to align with muscular grooves as best as possible.

The tights 119 are intended to improve control ability and skill of muscles by applying surface stimulation. Inherently, right-handed Japanese and nonathletic people are likely to rely on a noticeable body axis in the following manner. As viewed on a frontal plane, the right jaw is higher than the left jaw, the left shoulder is higher than the right shoulder, and the right pelvis is higher than the left pelvis. As viewed on a sagittal plane, the entire abdominal part has low muscle tone, with the lower rectus abdominis facing slightly downward, and the pelvis is tilted anteriorly. Hence, their exercise posture often looks like an angle bracket which bends at the abdomen. In order to stabilize this forward-leaning posture, the hip joints shift to internally rotated positions, causing the entire body to lean forward. Influences of this posture results in the ankle strategy-based manner of exercise described above. To cure the axis of exercise posture, it is necessary to induce hip joint actions as observed during exercise according to the hip strategy-based manner of exercise. In this respect, it should be borne in mind that the ankle strategy-based manner of exercise among right-handed Japanese and nonathletic people involves prominent activities of the right gluteus maximus and the left gluteus medius/minimus. With respect to the left gluteus maximus, its hyperactivity pushes the left pelvis anteriorly and twists the pelvis. Hence, surface stimulation to the right gluteus maximus is required so as to suppress its high muscle tone and to alleviate the displacement of the pelvis, thereby promoting hip joint actions according to the hip strategy-based manner of exercise. Turning next to the left gluteus medius/minimus, they hold the trunk by their abductory action because the trunk tends to tilt to the left, with the right shoulder dropped. Therefore, the left gluteus medius/minimus need to have their high muscle tone suppressed. Since the above-mentioned surface stimulation to the right gluteus maximus displaces the left part of the right pelvis up and the right part down, a surface stimulation part 10b is applied to the left gluteus medius/minimus, thereby inhibiting them and correcting the right pelvis along the center of an exercise axis of the trunk. Eventually, the abductory action of the left gluteus medius/minimus is inhibited, and the role of generating power shifts to the opposite right gluteus medius/minimus. Application of surface stimulation to the two important muscles which act around the hip joints (the left gluteus medius/minimus and the right gluteus maximus) has an effect of improving the skill of these muscle groups, thereby enhancing stability of the trunk and making it easily controllable. Now, let us mention other muscle groups, for example, those in the lower body. The hip joints are ball-and-socket joints and have as high as three degrees of freedom. Hence, coordinated muscle activities at these joints are heavily influenced by muscle groups which act very dominantly. (For example, activities of the hip joints such as flexion/extension, abduction/adduction, external rotation/internal rotation are affected by coordinated activities of muscles around the hip joints as represented by the gluteus maximus/medius/minimus, the iliopsoas, the rectus femoris, the sartorius, the tensor fasciae latae, etc.) Under such circumstances, if some muscles act so strongly as to disturb the coordination, they obstruct the ability of smooth adduction/abduction and rotation at the ball-and-socket joints such as the hip joints. Therefore, it is inevitable to reduce muscle tone of hyperactive muscle groups and to inhibit them, thereby inducing a smoother, more efficient joint activity. Among the muscle groups for moving the hip joints, prominently active muscles include the left gluteus medius/minimus, the right gluteus maximus, the right biceps femoris, the left semitendinosus/semimembranosu-s, the right tensor fasciae latae, the right rectus femoris of the quadriceps femoris, and the left sartorius. Their activity should be intentionally controlled for the purpose of curing such unbalanced actions. This is why it is crucial to provide surface stimulation parts 10b at functional skin areas of those muscle groups. With respect to gluteal muscle activities at the left hip joint, the gluteus medius/minimus are more active than the gluteus maximus, which hampers smooth adduction/abduction and rotation at the left hip joint. A surface stimulation part 10b at the left gluteus medius/minimus inhibits and controls activities of the left gluteus medius/minimus, thereby enhancing the ability to stretch and internally rotate the left hip joint in a proper direction. With respect to the right hip joint, the gluteus maximus is more active than the gluteus medius/minimus, which also hampers smooth adduction/abduction and rotation at the right hip joint. As a remedy to this, stimulation must be applied oppositely relative to the left gluteus maximus (i.e. surface stimulation to the right gluteus maximus). Such stimulation decreases muscle tone, and controls and reduces sidewise sway at the right hip joint. In this manner, the stimulation stabilizes an exercise axis at the right hip joint, making its movement smoother and its athletic ability more efficient. Additionally, before application of the thus specified stimulation, these dormant muscle groups (the gluteus medius/minimus at the right hip joint, and the gluteus maximus at the left hip joint) cause certain muscles (the right biceps femoris and the left semitendinosus/semimembranosus) to act strongly in order to compensate for and assist the dormant muscle groups during exercise. Now that the dormant muscle groups are adjusted, the right biceps femoris and the left semitendinosus/semimembranosus should also have their outstanding activities controlled. For this purpose, surface stimulation parts 10b are required at locations corresponding to functional skin areas of the respective muscle groups.

For smooth joint activity of the right hip joint, muscles at the anterior and lateral parts of the right hip joint need to be controlled as well. In this regard, surface stimulation is applied to the anterior and lateral parts of the right thigh over the rectus femoris of the quadriceps femoris and the tensor fasciae latae which are antagonistic to the gluteus maximus (a hip joint extensor). At the right hip joint, such surface stimulation promotes reduction of muscle tone in the stimulated muscles and powerfully supports exercise activities of their antagonists. Eventually, the surface stimulation ensures excellent exercise control ability at the right hip joint and realizes safer, more efficient performance in exercise. Likewise, for smooth joint activity of the left hip joint, muscles at the anterior and medial parts of the left hip joint need to be controlled as well. In this regard, surface stimulation is applied to the left sartorius which concerns external rotation of the hip joint and which is antagonistic to the left tensor fasciae latae (a hip joint flexor, abductor and, in particular, internal rotator). At the left hip joint, this surface stimulation promotes reduction of muscle tone in the stimulated muscle and powerfully supports exercise activities of its antagonist. Just as at the right hip joint, the stimulation ensures excellent exercise control ability at the left hip joint and can realize superior performance in exercise.

Because the above-mentioned joints and thigh muscles strongly act on joints below them (including the ankle joints and the toe joints) and lower leg muscles, these joints and muscles need inhibitory control as well. In the anterior part of the lower leg, a surface stimulation part 10b at the right tibialis anterior inhibits and cures a strong inversion action at the right ankle joint. Evidently, the lower legs have a smaller amount of muscles than other parts of the lower limbs (muscle groups as represented by the anterior and posterior thigh muscles). In inverse proportion to the amount of muscles, the lower legs are used more frequently and produce a greater force of action during exercise, which makes them prone to stress and injuries. To prevent this, extreme generation of power should be controlled in the lower leg muscle groups, particularly at the right medial gastrocnemius and the left lateral gastrocnemius. Thus, the respective muscles (the right medial gastrocnemius and the left lateral gastrocnemius) require surface stimulation parts 10b for reducing muscle tone, and have their muscle activity regulated and modified to stable one.

In addition, it should be understood that a force deriving from muscular power involves not only a force of action but also a force of reaction which returns from a location where the force of action is applied, and that these forces act in three-dimensionally twisted directions. At the respective hip joints, if exercise activity is performed in the above-mentioned exercise directions (a direction for flexion, adduction and external rotation of the left hip joint, and a direction for flexion, abduction and internal rotation of the right hip joint), the force of action is responded to not by a proper force of reaction but by a deviated force of reaction. Exercise activity involving a three-dimensionally twisted force (whether proper or deviated) imposes a heavier burden on joints and can be a primary cause of injuries. Hence, exercise activity involving a three-dimensionally twisted force should be eliminated (if the exercise direction is deviated) or should be controlled and restricted ideally (if the exercise direction is proper) as much as possible. For example, exercise activity of the knee joints should be discussed in consideration of rotational exercise activity of the upper joints (the hip joints), as mentioned above. Likewise, exercise activity of the ankle joints, which is affected by the upper joints (the knee and hip joints), should be discussed along with exercise activity of the upper joints. Thus, the upper joints should be asymmetrically supported in consideration of directions of their exercise axes, with adequate modifications to the manner of support. Furthermore, muscles have to be inhibited by surface stimulation in such a way as to realize the hip-strategy based manner of exercise. Take the rectus femoris and the three vastus muscles (all being constituents of the quadriceps femoris) as an example. In this case, it is especially necessary to inhibit one of multiarticular functions of these muscles, i.e. flexion of the hip joint by the rectus femoris. If the rectus femoris (a constituent of the quadriceps femoris) does not have one of its multiarticular muscle functions (i.e. flexion of the hip joint) inhibited, flexion of the knee joint (a major muscle activity by Japanese and nonathletic people) stands out so much as to prevent smooth extension of the hip joint.

FIG. 57 shows a full suit 120 designed for the right-handed, which can be used in sports which involve asymmetrical upper limb movements, such as tennis, volleyball, ice hockey, and baseball. The locations of surface stimulation parts 10b correspond to functional skin areas of the left upper trapezius (UTP), the right latissimus dorsi (LD), the left gluteus medius/minimus (GMed/GMin), the right gluteus maximus (GMax), the right biceps femoris (BF), the left semitendinosus/semimembranosus (ST/SM), the right medial gastrocnemius (MG), the left lateral gastrocnemius (LG), the left pectoralis minor (PMi), the center of the upper rectus abdominis (URA), the right serratus anterior (SA), the right tensor fasciae latae (TFL), the right rectus femoris of the quadriceps femoris (RF), the left sartorius (SAR), the right tibialis anterior (TA), the right biceps brachii (BB), the left triceps brachii (TB), the right pronator teres (PRT), the right flexor carpi ulnaris (FCU), the left supinator (SUP), and the left flexor carpi radialis (FCR). The full suit 120 is made of a yarn which is obtained by paralleling nylon yarns (thickness 78 dtex/48 f) and of a single covered yarn in which a 44-dtex-thick polyurethane elastane yarn core is covered with a nylon yarn (thickness 56 dtex/48 f). The full suit is knitted in plain stitch. The surface stimulation parts 10b are made in plate stitch by which a polyester yarn (thickness 78 dtex/36 f) forms a projecting pattern on the skin/back side. Seams (not shown) in the full suit 120 are sewn flat so as to avoid stimulation to the skin, and are designed to align with muscular grooves as best as possible.

The full suit 120 is intended to improve control ability and skill of muscles by applying surface stimulation. A surface stimulation part 10b at the center of the upper rectus abdominis inhibits hyperactivity of the upper rectus abdominis which is typical to Japanese and nonathletic people. Such stimulation ensures not only a uniform muscle activity throughout the rectus abdominis but also an equal distribution of the intra-abdominal pressure. As a result, while the entire rectus abdominis acts as a supportive antagonist, its agonistic muscle groups around the lower thoracic vertebrae, the lumbar vertebrae, and the sacral vertebrae serve more actively as facilitated active agonists, thereby promoting smooth actions of those joints. This is based on a relationship that while an antagonist is relaxed and inhibited to awaken a supportive muscle, an opposed muscle (an agonist) is facilitated under this influence and comes to act agonistically. In response to the actions and facilitation at the lower vertebrae, the left and right gluteus maximus are also facilitated (because the above surface stimulation indirectly facilitates the gluteus maximus, a vertebrae extensor, so that the gluteus maximus comes to act agonistically). However, considering the fact that the activity of the right gluteus maximus among right-handed Japanese and nonathletic people is prominent even without such stimulation, a surface stimulation part 10b is applied to the right gluteus maximus in order to modify and improve its activity in an inhibitory, easily controllable manner. (Because hyperactivity of the gluteus muscle pushes the right pelvis anteriorly and twists the pelvis, its activity should be inhibited.) In addition, for stable trunk activity, the trunk is corrected by a surface stimulation part 10b applied to the right latissimus dorsi which acts too strongly and which causes the trunk to tilt to the right and the right shoulder to drop, thereby correcting the trunk. Further regarding the trunk which tends to tilt to the right, with the right shoulder dropped, the left gluteus medius/minimus usually hold the trunk by their abductory action. Unless muscle tone of the left gluteus medius/minimus is reduced, the right part of the pelvis will rise and the left part will drop significantly. Hence, a surface stimulation part 10b is provided at the left gluteus medius/minimus in order to inhibit these muscles. Eventually, the abductory action of the left gluteus medius/minimus is inhibited, and the role of generating power shifts to the opposite right gluteus medius/minimus. Now, regarding the left half of the back, the left trapezius acts strongly relative to the left latissimus dorsi, being responsible for a posture in which the left shoulder is raised slightly. Inhibition of the left trapezius activity reforms this posture by lowering the left shoulder and promotes smooth activity of the left latissimus dorsi. Thus, inhibition of the two back muscles (the left trapezius and the right latissimus dorsi) and the two important muscles acting around the hip joints (the left gluteus medius/minimus and the right gluteus maximus) has an effect of improving the skill of these muscle groups, thereby enhancing stability of the trunk and making it more relaxed and easily controllable. Now, let us mention other muscle groups, for example, those in the lower body. The hip joints are ball-and-socket joints and have as high as three degrees of freedom. Hence, coordinated muscle activities at these joints are heavily influenced by muscle groups which act very dominantly. (For example, activities of the hip joints such as flexion/extension, abduction/adduction, external rotation/internal rotation are affected by coordinated activities of muscles around the hip joints as represented by the gluteus maximus/medius/minimus, the iliopsoas, the rectus femoris, the sartorius, the tensor fasciae latae, etc.) Under such circumstances, if some muscles act so strongly as to disturb the coordination, they obstruct the ability of smooth adduction/abduction and rotation at the ball-and-socket joints such as the hip joints. Therefore, it is inevitable to reduce muscle tone of hyperactive muscle groups and to inhibit them, thereby inducing a smoother, more efficient joint activity. Among the muscle groups for moving the hip joints, prominently active muscles include the left gluteus medius/minimus, the right gluteus maximus, the right biceps femoris, the left semitendinosus/semimembranosu-s, the right tensor fasciae latae, the right rectus femoris of the quadriceps femoris, and the left sartorius. Their activity should be intentionally controlled for the purpose of curing such unbalanced actions. This is why it is crucial to provide surface stimulation parts 10b at functional skin areas of those muscle groups. With respect to gluteal muscle activities at the left hip joint, the gluteus medius/minimus are more active than the gluteus maximus, which hampers smooth adduction/abduction and rotation at the left hip joint. A surface stimulation part 10b at the left gluteus medius/minimus inhibits and controls activities of the left gluteus medius/minimus, thereby enhancing the ability to stretch and internally rotate the left hip joint in a proper direction. With respect to the right hip joint, the gluteus maximus is more active than the gluteus medius/minimus, which also hampers smooth adduction/abduction and rotation at the right hip joint. As a remedy to this, stimulation must be applied oppositely relative to the left gluteus maximus (i.e. surface stimulation to the right gluteus maximus). Such stimulation decreases muscle tone, and controls and reduces sidewise sway at the right hip joint. In this manner, the stimulation stabilizes an exercise axis at the right hip joint, making its movement smoother and its athletic ability more efficient. Further, activities of these posterior muscle groups at the hip joints must coordinately cooperate with the above-mentioned trunk activity. Additionally, before application of the thus specified stimulation, these dormant muscle groups (the gluteus medius/minimus at the right hip joint, and the gluteus maximus at the left hip joint) cause certain muscles (the right biceps femoris and the left semitendinosus/semimembranosus) to compensate for and assist the dormant muscle groups during exercise. Now that the dormant muscle groups are adjusted, the right biceps femoris and the left semitendinosus/semimembranosus should also have their activities controlled. For this purpose, surface stimulation parts 10b are required at locations corresponding to functional skin areas of the respective muscle groups.

For smooth joint activity of the right hip joint, muscles at the anterior and lateral parts of the right hip joint need to be controlled as well. In this regard, surface stimulation is applied to the anterior and lateral parts of the right thigh over the rectus femoris of the quadriceps femoris and the tensor fasciae latae which are antagonistic to the gluteus maximus (a hip joint extensor). At the right hip joint, such surface stimulation promotes reduction of muscle tone in the stimulated muscles and powerfully supports exercise activities of their antagonists. Eventually, the surface stimulation ensures excellent exercise control ability at the right hip joint and realizes safer, more efficient performance in exercise. Likewise, for smooth joint activity of the left hip joint, muscles at the anterior and medial parts of the left hip joint need to be controlled as well. In this regard, surface stimulation is applied to the left sartorius which acts in coordination with the left tensor fasciae latae (a hip joint flexor/abductor). At the left hip joint, this surface stimulation promotes reduction of muscle tone in the stimulated muscle and powerfully supports exercise activities of its antagonist. Just as at the right hip joint, the stimulation ensures excellent exercise control ability at the left hip joint and can realize superior performance in exercise.

Because the above-mentioned joints and thigh muscles strongly act on joints below them (including the ankle joints and the toe joints) and lower leg muscles, these joints and muscles need inhibitory control as well. In the anterior part of the lower leg, a surface stimulation part 10b at the right tibialis anterior inhibits and cures a strong inversion action at the right ankle joint. Evidently, the lower legs have a smaller amount of muscles than other parts of the lower limbs (muscle groups as represented by the anterior and posterior thigh muscles). In inverse proportion to the amount of muscles, the lower legs are used more frequently and produce a greater force of action during exercise, which makes them prone to stress and injuries. To prevent this, extreme generation of power should be controlled in the lower leg muscle groups, particularly at the right medial gastrocnemius and the left lateral gastrocnemius. Thus, the respective muscles (the right medial gastrocnemius and the left lateral gastrocnemius) require surface stimulation parts 10b for reducing muscle tone, and have their muscle activity regulated and modified to stable one.

In addition, it should be understood that a force deriving from muscular power involves not only a force of action but also a force of reaction which returns from a location where the force of action is applied, and that these forces act in three-dimensionally twisted directions. At the respective hip joints, if exercise activity is performed in the above-mentioned exercise directions (a direction for flexion, adduction and external rotation of the left hip joint, and a direction for flexion, abduction and internal rotation of the right hip joint), the force of action is responded to not by a proper force of reaction but by a deviated force of reaction. Exercise activity involving a three-dimensionally twisted force (whether proper or deviated) imposes a heavier burden on joints and can be a primary cause of injuries. Hence, exercise activity involving a three-dimensionally twisted force should be eliminated (if the exercise direction is deviated) or should be controlled and restricted ideally (if the exercise direction is proper) as much as possible. For example, exercise activity of the knee joints should be discussed in consideration of rotational exercise activity of the upper joints (the hip joints), as mentioned above. Likewise, exercise activity of the ankle joints, which is affected by the upper joints (the knee and hip joints), should be discussed along with exercise activity of the upper joints. Thus, the upper joints should be asymmetrically supported in consideration of directions of their exercise axes, with adequate modifications to the manner of support. Furthermore, muscles have to be inhibited by surface stimulation in such a way as to realize the hip-strategy based manner of exercise. Take the rectus femoris and the three vastus muscles (all being constituents of the quadriceps femoris) as an example. In this case, it is especially necessary to inhibit one of multiarticular functions of these muscles, i.e. flexion of the hip joint. If the rectus femoris (a constituent of the quadriceps femoris) does not have one of its multiarticular muscle functions (i.e. flexion of the hip joint) inhibited, flexion of the knee joint (a major muscle activity by Japanese and nonathletic people) stands out so much as to prevent smooth extension of the hip joint.

The description made hitherto relates to adjustment of the lower body, according to the hip strategy-based manner of exercise. Furthermore, in order to realize the hip strategy-based manner of exercise, it is inevitable to adjust and coordinate activities in the upper body which is opposed to the lower body. In the case of Japanese and nonathletic people, a particular attention should be paid to hypertonicity in the upper abdominal muscles and the trapezius as mentioned above. As already described, such muscle activity should be inhibited. Therefore, the manner of facilitating the upper body should be primarily focused on reduction of muscle tone in these muscles, and should further allow for coordination between lower body activities and upper body activities.

With respect to right-handed people, muscles in the left half of the back are awfully underdeveloped and poorly facilitated, partly because this section locates on the side of the non-dominant hand. Further, with respect to Japanese and nonathletic people, the trapezius is prominently active and constitutes the core of their manner of exercise. Accordingly, with a proviso that the left half of the back is divided into an upper section (around the trapezius) and a lower section (around the latissimus dorsi), the lower section is less good at effective exercise than the upper section. These factors prevent muscle development of the left latissimus dorsi.

Having said that, the unbalanced muscle activities have their own merits. The underdeveloped latissimus dorsi, originating from the pelvis which provides a solid support base, has a poor ability to hold the shoulder joints which are highly mobile ball-and-socket joints with three degrees of freedom. At the left shoulder joint, its poor ability is compensated by advanced development of an inner muscle group (the supraspinatus, the infraspinatus, the teres major, the teres minor, and the subscapularis). Conversely, at the right shoulder joint of right-handed people, a muscle group surrounding inner muscle group develops so well as to obstruct facilitation, activity and cooperability of the inner muscle group. Besides, underdevelopment of the right inner muscle group severely limits the range of mobility of the right shoulder joint. In this respect, the above-mentioned surface stimulation inhibits and controls the outer muscle group. Such surface stimulation enhances flexibility at the shoulder joint, thereby facilitating and improving the right inner muscle group. However, if the right inner muscle group is activated, muscle activity becomes more dominant in the right half of the back than in the left half. Hence, muscle activity of the right latissimus dorsi and the right serratus anterior needs to be adjusted by surface stimulation parts 10b provided at their functional skin areas. (Note that the surface stimulation part for the right latissimus dorsi is mentioned earlier.) Similarly, a surface stimulation part 10b is required at the left trapezius which acts excessively together with the right latissimus dorsi and the right serratus anterior.

As explained above, Japanese and nonathletic people show prominent muscle activity of the trapezium. Muscle activity of the left trapezius is extremely strong relative to the left latissimus dorsi, and should be inhibited in the manner mentioned above. In this connection, a surface stimulation part 10b is also provided at a functional skin area of the left pectoralis minor which assists the left trapezius (The left pectoralis minor pulls the scapula forwardly and upwardly, so that the left shoulder looks displaced forwardly and upwardly), whereby the left shoulder should be adjusted backwardly and downwardly. As previously described, part of the muscle activities of the left pectoralis minor is to pull the scapula forwardly and upwardly. Besides, high muscle tone in the left pectoralis minor hampers scapula movement relative to the trunk and restricts upper limb movements. Thus, activity of the free upper limb/the shoulder girdle and that of the upper trunk are not coordinated with each other. In this respect, the surface stimulation to the left pectoralis minor can correct the scapulae position and can properly realize shoulder joint-centered, coordinated activities between these parts. Incidentally, when Japanese and nonathletic people feel mental pressure during a game, match or the like, the trapezius acts radically and has extreme muscle tone, making one's movement unnatural. Besides, the shoulder part as a whole limits actions of respiratory muscles, causing shallow breathing. Thankfully, the above surface stimulation can alleviate these symptoms, can eliminate “performance anxiety” resulting from such symptoms, and can eventually ensure smoother performance of exercise under pressure.

Concerning nonathletic people, let us now concentrate on exercise performance in the upper body, particularly in the free upper limb and the shoulder girdles. With respect to the upper arm, the right biceps brachii (a multiarticular flexor), among others, acts dominantly over the right triceps brachii, due to their imperfect ability to learn athletic skills.

On birth, baby's body and limbs are bent and curled in. To put it simply, most of the joints which are capable of internal/external rotation and flexion are pronated and adducted. In the course of physical growth, the human being acquires athletic skill learning ability for orienting a flow of power externally.

Regrettably, it can be said that nonathletic people and Japanese do not follow this growth process properly, because advanced convenient civilization hampers development and evolution of athletic skill learning ability while they grow up. In performing exercise, their joints are neither in a supinated position nor in an abducted position, but are rather in pronated and adducted positions which are advantageous for internally directed, closed movements. In contrast, joints of athletically skilled people have a wide range of mobility and a great exercise performing ability, and their movements are externally oriented.

As compared with nonathletic people, athletically skilled people clearly distinguish the roles of muscles between multiarticular ones and monoarticular ones and between extensors and flexors, and they properly use their muscles as such. Conversely, muscle activities of nonathletic people are mostly concentrated on postural control, which brings about unwanted hypertonicity and useless generation of power during exercise. Besides, upper body movements of nonathletic people are dominated by flexors (activities of flexors being particularly prominent on the right anterior part), whereas their lower body movements are dominated by extensors (activities of extensors being particularly prominent on the right anterior part). This is because they have not acquired perfect body balance for exercise, and, what is worse, because the joints themselves have established inadequate manners of exercise. For these reasons and owing to the difference in exercise directions (internal/external as described above), athletically skilled people perform exercise in a more dynamic and stable manner than the others.

In view of the above, it is essential to provide a surface stimulation part 10b at the right biceps brachii so as to inhibit or control its activity.

Similar immaturity of athletic performance ability is seen in the right forearm, as a result of which the right forearm tends to be flexed and pronated. Therefore, the pronator and a flexor of the right forearm need to be inhibited and controlled by surface stimulation. For this reason, surface stimulation is provided at the respective acting muscles.

The brain orders asymmetrical muscle activities in the free lower limb/the pelvic girdles and symmetrical muscle activities in the free upper limb/the shoulder girdles. Hence, muscle activities of the latter have to be symmetrical, unlike in the other parts of the body. Nevertheless, this is not necessarily applicable if an exercise specially employs a limb on one side of the body (as represented by tennis and baseball). In addition, allowing for offset of angular momentum with respect to the upper limbs/the shoulder girdles, the surface stimulation applied to the right upper arm and the right forearm have to be totally reversed in the left upper limb/shoulder girdle. Namely, surface stimulation is applied to the left triceps brachii and the supinator and an extensor of the left forearm so as to inhibit and control these muscles. Lastly, muscle activities in the left and right lower limbs/pelvic girdles are in contrast with those in the free upper limb/the shoulder girdles in that the former muscle activities are reciprocal (e.g. When the right leg makes a forward stride, the left leg is pulled backward at the same time). Therefore, muscle adjustment by an asymmetrical approach is particularly effective in the free lower limb and the pelvic girdles.

FIG. 58 shows a baseball undershirt 121 designed for the right-handed. The locations of surface stimulation parts 10b correspond to functional skin areas of the left upper trapezius (UTP), the left sternocleidomastoid (SCM), the right latissimus dorsi (LD), the left pectoralis minor (PMi), the upper rectus abdominis (URA), the right serratus anterior (SA), the right biceps brachii (BB), the left triceps brachii (TB), the right pronator teres (PRT), the right flexor carpi ulnaris (FCU), the left supinator (SUP), and the left flexor carpi radialis (FCR). The undershirt 121 is made of a yarn which is obtained by paralleling nylon yarns (thickness 78 dtex/48 f) and of a single covered yarn in which a 44-dtex-thick polyurethane elastane yarn core is covered with a nylon yarn (thickness 56 dtex/48 f). The undershirt 121 is knitted in plain stitch. The surface stimulation parts 10b are made in plate stitch by which a polyester yarn (thickness 78 dtex/36 f) forms a projecting pattern on the skin/back side. Seams (not shown) in the undershirt 121 are designed to locate not on the skin side but on the outer side and to align with muscular grooves as best as possible.

The undershirt 121 is intended to improve control ability and skill of muscles by applying surface stimulation. One of the vital factors for production of the undershirt 121 is to enable smooth rotational movements at the joints. For example, rotational movements in the trunk are effected around the trunk axis (to rotate the hip, the neck, etc.) and can be roughly classified into two different types. The first type of rotation is axial exercise during which the left or right side of the body looks fixed (like a common swing door). The axis of this rotation is either one leg, and the exercise is principally led by the lower body. The second type is a symmetrical rotation around the spine which constitutes the core of the trunk (like a revolving door), with the hip joints bearing a load in a substantially symmetrical manner. In contrast to the first type of rotation in which the axis is offset to one side and dependent on the lower body, the second type of rotation has an axis centered along the spine and mobilizes the left and right parts of the whole body equally. As a result, the latter rotation is less prone to sway, and is able to realize a most compact rotation axis and speedier movements. In particular, these two types of rotation are noticeable in batting forms of Japanese (nonathletic people) and those of Latin Americans and athletically skilled people. When a Japanese batter who adopts the first type of rotation takes a swing, he imagines a virtual wall built at a front leg which faces the pitcher (e.g. A right-handed batter has this wall to the left of the body.) and attempts to stop the axis of rotation against the wall. This motion is translation rather than rotation. On the other hand, a Latin American batter who adopts the second type of rotation has an established support axis (just as a spinning top rotating at high speed.) and tries to hit a ball by originating a rotation from the core of the body. Judging from the facts that many constant long hitters adopt the latter type of rotation and that non-Japanese long hitters (above all, Latin Americans) boast of amazing ball distances, it is apparent to tell which batter is superior in today's baseball. Although this symmetrical muscle activity seems simple enough at a glance, we can easily envisage a heavy influence of handedness (as represented by right-handedness and left-handedness) and the like. Referring particularly to the right-handed Japanese (Mongoloids), muscles in the left half of the back are awfully underdeveloped and poorly facilitated, partly because this section locates on the side of the non-dominant hand. Further, with respect to Japanese and nonathletic people, the trapezius is prominently active and constitutes the core of their manner of exercise. Accordingly, with a proviso that the left half of the back is divided into an upper section (around the trapezius) and a lower section (around the latissimus dorsi), the lower section is less good at effective exercise than the upper section. These factors prevent muscle development of the left latissimus dorsi. Due to an attempt to adjust and rectify such inherent imbalance of the back muscles, muscles around the abdomen sacrifice a considerable portion of their rotational power, which hampers more efficient rotational activity at the trunk. Moreover, with respect to various reflex reactions, we should note significant involvement of the neck reflex. Broadly speaking, the neck reflex activity means tonic neck reflex for adjusting muscle tone of the limbs so as to hold the posture. To be a little more specific, the tonic neck reflex encompasses two major categories: symmetrical tonic neck reflex and asymmetrical tonic neck reflex. According to typical motional reactions in the symmetrical tonic neck reflex, neck flexion increases muscle tone in upper limb flexors and lower limb extensors; and neck extension increases muscle tone in upper limb extensors and lower limb flexors. Such motions are frequently seen in Sumo wrestling, powerlifting, etc. When a person stands up with a heavy item held in the hands, the person tucks the chin in strongly and bends the neck more deeply, thus trying to encourage extension of the lower limbs. Further, as frequently seen in baseball or the like, a defensive player stretches the neck and activates lower limb flexors in order to keep a low posture. On the other hand, the asymmetrical tonic neck reflex concerns rotations around the trunk, such rotation making up a significant part of exercise activity on a horizontal plane (as observed in baseball, tennis and other like sports). According to this reflex, head rotation to one side increases muscle tone in upper/lower limb extensors on the jaw side, and increases muscle tone in upper/lower limb flexors on the head side. Needless to say, these two neck reflexes have a great influence on muscle asymmetry in the body, as we mentioned heretofore. In baseball, these reflex activities occur in order to improve efficiency of batting, pitching and other motions. Beneficially, these various reflex activities raise the level of completion in exercise. It is also true, however, these reflex activities affect laterality (dominant hand, dominant leg, etc.), resulting in unbalanced muscle development and inadequate exercise.

The back of the body shows unbalanced muscle activities as a whole, where the right latissimus dorsi is too active and the left trapezius serves as the core of activity in the left half of the back. A surface stimulation part 10b at the right latissimus dorsi is an important element not only for correcting and inhibiting the right latissimus dorsi but also for correcting the imbalance in the entire back. The right latissimus dorsi, which is prominently active and developed well in right-handed people, acts so excessively as to draw down the right shoulder and to cause a right shoulder dropped, tilted posture. Application of surface stimulation to the right latissimus dorsi reduces its muscle tone and modifies this tilted posture to a neutral one in a pelvis-based, balanced manner according to the hip strategy-based manner of exercise, in which the left and right shoulders locating at the same height by slightly lowering the left shoulder. Referring next to the left half of the back, the left shoulder usually tends to rise. (Prominent activities of the right latissimus dorsi and the left trapezius cause this typical posture.) Hence, a surface stimulation part 10b is provided at the left trapezium, in combination with the surface stimulation part for reducing muscle tone at the right latissimus dorsi. Reduction of muscle tone at the left trapezius promotes facilitation of muscle activity of the left latissimus dorsi which is antagonistic to the left trapezius (based on a theory that an agonist is facilitated by inhibition of muscle activity of its antagonist). This combination can create a symmetrical exercise posture which is centered on the waist part and is aligned with the gravity axis for exercise. Having said that, the unbalanced muscle activities have their own merits. Around the left shoulder joint, the underdeveloped latissimus dorsi, originating from the pelvis which provides a solid support base, has a poor ability to hold the shoulder joint which is a highly mobile ball-and-socket joints with three degrees of freedom. At the left shoulder joint, its poor ability is compensated by advanced development of inner muscles (the supraspinatus, the infraspinatus, the teres major, the teres minor, and the subscapularis). In contrast, at the right shoulder joint of right-handed people, a muscle group surrounding inner muscles develops so well as to obstruct facilitation and activity of the inner muscles. The surface stimulation part 10b at the right latissimus dorsi reduces its shoulder joint support ability which derives from its high muscle tone. As a secondary effect, the task of generating a shoulder joint support power shifts to the right inner muscles. Although underdevelopment of the right inner muscles severely limits the range of mobility of the right shoulder joint, the two specified surface stimulations enhance and improve its flexibility by reducing muscle tone of the outer muscles around the shoulder joint.

As explained above, because Japanese and nonathletic people show prominent muscle activity of the trapezius (particularly in the left half of the back), a surface stimulation part 10b must be also provided at a functional skin area of the left pectoralis minor which is an accessory muscle acting to assist the left trapezium. Part of the muscle activities of the left pectoralis minor is to pull the left scapula upwardly and forwardly, to hamper its movement relative to the trunk, and thereby to restrict upper limb movements. Thus, activity of the free upper limb/the shoulder girdle and that of the upper trunk are not coordinated with each other. In this respect, the surface stimulation to the left pectoralis minor can adjust such activities and can realize shoulder joint-centered, coordinated activities between these parts. Incidentally, when Japanese and nonathletic people feel mental pressure during a game, match or the like, the trapezius acts radically and has extreme muscle tone, making one's movement unnatural. Besides, the shoulder part as a whole limits actions of respiratory muscles, causing shallow breathing. Thankfully, the above surface stimulation can alleviate these symptoms, can eliminate “performance anxiety” resulting from such symptoms, and can eventually ensure smoother performance of exercise under pressure. In addition to the above-described adjustment of the muscle groups in the posterior part of the body, it is also necessary to adjust those in the anterior part of the body. As mentioned, part of the activities of the pectoralis minor is to pull the scapulae forwardly and upwardly, and thereby to assist and strengthen the trapezius activity. The surface stimulation part 10b at the left pectoralis minor restrains this activity, making inhibition of the left upper trapezius easier. The right half of the back shows strong muscle activities as a whole, and causes a posture in which the right shoulder is drawn slightly backward. In this respect, surface stimulation is applied to the right serratus anterior, one of whose activities is to abduct the scapula. Input of this stimulation inhibits abduction of the scapula and helps forward and upward movements of the shoulder, thereby guiding the shoulder joint to an anteroposteriorly symmetrical, efficient position. Further, because movement of the right scapula is hampered by prominent actions of the right latissimus dorsi and others, the surface stimulation to the right serratus anterior alleviates and cures the condition.

Additionally, the neck activity of right-handed people is characterized in that the face turns easily to the right but awkwardly to the left. To cure this condition, a surface stimulation part 10b is provided at the left sternocleidomastoid so as to reduce its muscle tone. This stimulation input method stabilizes the trunk and enables smooth rotation.

Concerning nonathletic people, let us now concentrate on exercise performance in the upper body, particularly in the free upper limb and the shoulder girdles. With respect to the upper arm, the biceps brachii (a flexor) acts dominantly over the triceps brachii, due to their imperfect ability to learn athletic skills.

On birth, baby's body and limbs are bent and curled in. To put it simply, most of the joints which are capable of internal/external rotation and flexion are pronated and adducted. In the course of physical growth, the human being acquires athletic skill learning ability for orienting a flow of power externally.

Regrettably, it can be said that nonathletic people and Japanese do not follow this growth process properly, because advanced convenient civilization hampers development and evolution of athletic skill learning ability while they grow up. In performing exercise, their joints are neither in a supinated position nor in an abducted position, but are rather in pronated and adducted positions (an anteriorly overtwisted state) which are advantageous for internally directed, closed movements. In contrast, joints of athletically skilled people have a wide range of mobility and a great exercise performing ability, and their movements are externally oriented (a state of normal joint mobility).

As compared with nonathletic people, athletically skilled people clearly distinguish the roles of muscles between multiarticular ones and monoarticular ones and between extensors and flexors, and they properly use their muscles as such. Conversely, muscle activities of nonathletic people are mostly concentrated on postural control, which brings about unwanted hypertonicity and useless generation of power during exercise. Besides, upper body movements of nonathletic people are dominated by flexors, whereas their lower body movements are dominated by extensors (under the influence of neck reflex, etc.). This is because they have not acquired perfect body balance for exercise, and, what is worse, because the joints themselves have established inadequate manners of exercise. For these reasons and owing to the difference in exercise directions (internal/external as described above), athletically skilled people perform exercise in a more dynamic and stable manner than the others.

In view of the above, it is essential to apply surface stimulation to biceps brachii so as to inhibit or control its activity.

Similar immaturity of athletic performance ability is seen in the forearms, as a result of which the forearms tend to be flexed and pronated. As mentioned, muscle activity at the forearm joints is dominated by flexion and pronation. Hence, a pronator and flexors need to be inhibited and controlled by surface stimulation. For this reason, surface stimulation 10b is provided at the respective acting muscles.

In addition to the above issues, we should also understand offset of angular momentum, which is an advanced exercise performance involved in batting and pitching motions. For a simple explanation, imagine a person walking. When the right leg swings forward, the left arm swings forward in the upper body. At the same time, the other leg (the left one) is pulled backward and so is the other arm (the right one). This rotatory balance exercise in the upper body and the lower body is the most important factor for correct rotation of the trunk. In particular, this action is observed well in a pitching motion. When a right-handed pitcher winds up, he raises his right arm and swings down his left arm. (The respective powers pull each other and offset their angular momentum, thereby establishing balance and accelerating the rotational speed.) Later, the right leg makes a forward stride, and the left leg acts as a brake. The sudden change of exercise directions produces a rotational power in the lower body. This power is transmitted to the upper body and realizes speedier performance. Harmonization of these compound activities at the joints (internal/external rotation, flexion and extension) gives us a more complex and advanced exercise technique, which is what we actually long for.

The brain orders asymmetrical muscle activities in the free lower limb/the pelvic girdles and symmetrical muscle activities in the free upper limb/the shoulder girdles. Hence, muscle activities of the latter have to be symmetrical, unlike in the other parts of the body. Nevertheless, this is not necessarily applicable if an exercise specially employs a limb on one side of the body (as represented by tennis and baseball). In this case, in order to enhance efficiency of actions on the one side, a surface stimulation part 10b is provided at the right biceps brachii so as to inhibit and control flexion ability of the elbow joint, so that the elbow joint can acquire an ability to extend more smoothly. For smoother execution of this movement, the angular momentum needs to be offset between the right and left upper arms which are opposed to each other. In this respect, a surface stimulation part 10b across the medial/lateral heads of the left triceps brachii helps elbow flexion ability. The asymmetrical angular momentum and actions between the left and right upper arms enable smoother trunk rotation and ensure stable and speedier actions during exercise. Furthermore, the left and right forearms are affected by the upper arms and the trunk which are discussed earlier. Hence, in order to further emphasize the action of the right extensor carpi radialis longus/brevis, hyperactivity of the right extensor carpi ulnaris is inhibited and controlled. Although the action of Japanese and nonathletic people tends to depend on ulnar flexors, such inhibition leads their action to a radial flexor-dependent one, thereby realizing stable wrist extension/flexion and forearm rotation. This stimulation input approach can alleviate elbow injuries (baseball elbow and tennis elbow) attributable to pitching motions, tennis strokes, or other like motions. Besides, similar improvements are required in the left forearm, which acts in an opposed manner to the right forearm in order to offset the angular momentum. Accordingly, the manner for improving the left forearm is also opposite to the manner for the right forearm, and employs a surface stimulation part 10b for the left supinator, a surface stimulation part 10b for the left flexor carpi radialis, and a surface stimulation part 10b for the left extensor carpi radialis longus/brevis. Owing to the asymmetrical stimulation input to the left and right upper limbs, it is possible to offset the angular momentum in the free upper limb and the shoulder girdles and to stabilize and improve the trunk rotation ability as intended. Lastly, let us mention that the muscle activities resulting from the above asymmetrical stimulation input stabilizes the trunk more prominently in the free lower limb and the pelvic girdles. Muscle activities in the free lower limb/the pelvic girdles are in contrast with those in the free upper limb/the shoulder girdles in that the former muscle activities are reciprocal. Therefore, muscle adjustment by an asymmetrical approach is particularly effective in the free lower limb and the pelvic girdles.

In the anterior part of the trunk, a surface stimulation part 10b at the upper rectus abdominis inhibits hyperactivity of the upper rectus abdominis which is typical to Japanese and nonathletic people. Such stimulation ensures not only a uniform muscle activity throughout the rectus abdominis but also an equal distribution of the intra-abdominal pressure. As a result, while the entire rectus abdominis acts as a supportive antagonist, its agonistic muscle groups around the lower thoracic vertebrae, the lumbar vertebrae, and the sacral vertebrae serve more actively as facilitated active agonists, thereby promoting smooth actions of those joints. This is based on a relationship that while an antagonist is relaxed and inhibited to awaken a supportive muscle, an opposed muscle (an agonist) is facilitated under this influence and comes to act agonistically. In response to the actions and facilitation at the lower vertebrae, the left and right gluteus maximus are also facilitated. In addition, for stable trunk activity, the trunk is corrected by the surface stimulation part 10b applied to the right latissimus dorsi which acts too strongly as mentioned above and which causes the trunk to tilt to the right and the right shoulder to drop. Regarding the left half of the back, also as mentioned above, the left trapezius acts strongly relative to the left latissimus dorsi, being responsible for a posture in which the left shoulder is raised slightly. Inhibition of the left trapezius activity reforms this posture by lowering the left shoulder and promotes smooth activity of the left latissimus dorsi. Thus, inhibition of the two back muscles (the left trapezius and the right latissimus dorsi) has an effect of improving the skill of these muscle groups. By combining this effect, it is possible to enhance stability and to make it more relaxed and easily controllable.

<Effects of the Repositioning Device and the Garment>

As mentioned earlier, “while sensitivity of a muscle spindle is raised” after stimulation, a person can execute exercise more efficiently. Besides, input of stimulation according to the present invention brings about additional effects such as increase and promotion of blood flow in muscles, better flexibility, better muscle skill, etc., as a part of potential secondary post-stimulation phenomena. It should be noted that these post-stimulation phenomena do not derive from relaxation or support of a muscle. Rather, in the present invention, post-stimulation phenomena are attributable to promotion and facilitation of muscle activities, and result from generation of heat due to a greater energy consumption by muscles, from enhanced neural sensitivity of such muscles, from improved reflexes, and the like. Although various traditional appliances are designed to support a muscle and produce their effects by restricting exercise, input of stimulation according to the present invention gives similar effects by facilitating exercise rather than by restricting exercise. In fact, an exercise facilitation approach enables more efficient exercise than an exercise restriction approach. Further, motor nerves are stimulated in such a way as to promote exercise, thereby giving various effects resulting from a facilitatory/promoting approach. Thus, it is possible to obtain superior body balance and body support ability, thereby maximizing effects of exercise.

To be specific, use of the repositioning device 1 or the garment 10 results in facilitation of neurotransmission in a muscle where the repositioning device 1 or a point stimulation part 10a of the garment 10 locates, thereby increasing awareness of the muscle. On the other hand, neurotransmission is inhibited in a muscle where a surface stimulation part 10b of the garment 10 locates, thereby decreasing awareness of the muscle. Accordingly, among muscle groups of the body, the repositioning device 1 or the garment 10 can be applied to muscles resulting from deficit in body balance, hypoactive muscles, or muscles to be developed or strengthened, thereby conditioning the body as desired.

Moreover, the repositioning device 1 and the garment 10 have a simple mechanism and merely facilitate neurotransmission in a muscle, without causing contraction of the muscle. Hence, a person can casually wear the repositioning device 1 or the garment 10 for a long time and even do workouts while it is put on the body. Accordingly, muscle activity is activated at the location of the repositioning device 1 or a point stimulation part 10a of the garment 10 while we are hardly aware of it. Likewise, muscle activity is inhibited at the location of a surface stimulation part 10b of the garment 10 while we are hardly aware of it. The thus activated or inhibited muscle activity can be easily settled as extrapyramidal exercise which depends on proprioception.

In summary, the repositioning device and the garment intend to facilitate and promote muscle activity of a dormant muscle group by applying point stimulation, and to inhibit and control muscle activity of a hyperactive muscle group by applying surface stimulation. For ideal physical activity, the body is led to an efficient condition (an ideal posture) by utilizing the above-mentioned post-stimulation phenomena. To achieve this efficient condition, we must consider and satisfy the following three requirements.

(1) Increase efficiency of trunk balance, under the influence of angular momentum at the joints (the limbs).

(2) Increase efficiency of trunk balance, under the influence of tonic neck reflex, etc.

(3) Increase efficiency of trunk balance, under the influence of hand dominance, leg dominance, etc.

In addition, the repositioning device and the garment further intend to improve the ADL of muscles and tendons (because the ADL is reduced due to stiffness in the joints and the whole body) and to facilitate motor nerves to a further extent.

### Correction of Posture

The repositioning device 1 or the garment 10 can be applied to a muscle which is responsible for deficit in body balance. In sports or the like, a person's posture can be corrected in a short time to an ideal posture which is free from injuries and suitable for exercise, so that one can exert superior performance during exercise.

The forward head posture, bow legs, knock knees, and other wrong postures can be also corrected properly if the repositioning device 1 or the garment 10 is applied to a muscle responsible for such a wrong posture.

### Improvement and Reinforcement of Functions

Application of the repositioning device 1 or the garment 10 to a hypoactive muscle can improve its function. Hence, concerning the diseases which may result from hypoactivity of certain muscles (e.g. lumbar pain, stiff neck, abnormal Q angle), the symptoms can be alleviated by brief use of the repositioning device 1 or the garment 10 in daily life.

In sports or the like, training combined with use of the repositioning device 1 and the garment 10 is effective because a load can be efficiently imposed on usually less conscious muscles or muscles which cannot be loaded easily. Hence, a competitive athlete can prevent injuries and can work out efficiently in an ideal posture. In competition, the repositioning device 1 and the garment 10 avoid loss of exercise power and ensure an excellent result. Further, improvement of trunk extension ability decreases muscle tone and enhances the respiratory function as well as flexibility of the trunk. Eventually, an athlete can acquire improved mental ability and can perform sufficiently in a real competition.

### Correction of Body Shape

Body shape can be made more attractive by exclusive development of certain muscles. While the repositioning device 1 or the garment 10 is put on casually or during positive training, it can promote development of certain muscles and can improve body shape. For example, the forward head posture, protruding buttocks, thick thighs, thick calves and the like can be fundamentally reformed from the skeleton and musculature.

As explained above, the repositioning device or the garment according to the present invention is capable of creating efficient and superior body balance and body support ability while it is casually applied to the body for some time without doing anything else in particular. Consequently, it is possible to prevent injuries, to correct a posture, to improve body shape and an exercise ability, and to achieve many more.

### Prevention of Injury

Owing to these functional effects, rehabilitation exercise for aged people can be carried out more safely and efficiently. For example, it is possible to alleviate eversion of knees (bow legs) due to knee joint deformation, to alleviate forward leaning posture (hunchback) due to spine deformation, and to improve spinal functions. It is further possible to lighten a load to the toes due to the forward leaning posture and to reduce foot troubles such as hallux valgus. Additionally, since falling and other accidents are caused by decrease of muscular power in the trunk and deterioration of balance ability, the above-mentioned functional effects decrease the probability of injuries.

### EFFECTS OF THE INVENTION

As described above, the present invention can ensure superior body balance and body support ability and can maximize effects of exercise.

In addition, acquisition of superior body balance and body support ability leads to prevention of injuries, correction of a posture, improvement of body shape and exercise ability, and many more effects.

### BRIEF DESCRIPTION OF THE DRAWINGS

FIGS. 1(a)-(c) are a side view, a front view, and a rear view of a human body (a right-handed person in a forward leaning exercise posture), with indication of muscle groups which show high muscle tone during an antigravity exercise.

FIGS. 2(a)-(c) are a side view, a front view, and a rear view of a human body (a right-handed person with a backward leaning exercise posture), with indication of muscle groups which show high muscle tone during an antigravity exercise.

FIG. 3 is a two-dimensional representation of muscle activities.

FIG. 4 is a representation of muscle activities in a femoral region (during extension of a hip joint).

FIG. 5 is a representation of muscle activities in a femoral region (during flexion of a hip joint).

FIG. 6 is a representation of muscle activities around a gluteal region (during extension of a hip joint).

FIG. 7 is a representation of muscle activities around a gluteal region (during flexion of a hip joint).

FIG. 8 explains muscle activities.

FIGS. 9(a) and (b) are schematic illustrations which explain how asymmetry may cause disproportionate muscle development and imbalance of weight.

FIGS. 10(a) and (b) are schematic views which explain a difference between the forward leaning exercise posture and the backward leaning exercise posture.

FIGS. 11(a) and (b) are perspective views showing point stimulators for providing stimulation according to the present invention.

FIGS. 12(a) and (b) are perspective views showing surface stimulators for providing stimulation according to the present invention.

FIG. 13(a) is a cross section of a non-electric point stimulator in use, FIG. 13(b) is a cross section of another non-electric point stimulator in use, and FIG. 13(c) is a cross section of yet another non-electric point stimulator in use.

FIG. 14(a) is a cross section of a different point stimulator for providing point stimulation according to the present invention, and FIGS. 14(b) and (c) are cross sections of this point stimulator in use.

FIG. 15(a) is a cross section of another different point stimulator for providing point stimulation according to the present invention, and FIGS. 15(b) and (c) are cross sections of this point stimulator in use.

FIG. 16(a) is a cross section of another different point stimulator for providing point stimulation according to the present invention, and FIGS. 16(b) and (c) are cross sections of this point stimulator in use.

FIG. 17(a) is a cross section of another different point stimulator for providing point stimulation according to the present invention, and FIGS. 17(b) and (c) are cross sections of this point stimulator in use.

FIG. 18(a) is a cross section of another different point stimulator for providing point stimulation according to the present invention, and FIGS. 18(b) and (c) are cross sections of this point stimulator in use.

FIG. 19(a) is a cross section of another different point stimulator for providing point stimulation according to the present invention, and FIGS. 19(b) and (c) are cross sections of this point stimulator in use.

FIG. 20 is a cross section which schematically shows the entire structure of a vibration-generating point stimulator.

FIG. 21 is a block diagram showing a circuit configuration of a controller which is adopted in the point stimulator illustrated in FIG. 20.

FIG. 22 is a schematic view which shows a different vibration-generating point stimulator.

FIGS. 23(a)-(h) schematically represent structures of various vibration generators to be adopted in a vibration-generating repositioning device.

FIGS. 24(a)-(j) schematically represent other structures of various vibration generators to be adopted in the vibration-generating repositioning device.

FIGS. 25(a)-(g) illustratively relate to the types of vibrations to be generated by the vibration-generating repositioning device.

FIG. 26 schematically shows yet another vibration-generating repositioning device.

FIGS. 27(a) and (b) schematically show yet another vibration-generating repositioning device.

FIG. 28(a) is a cross section of a surface stimulator for providing surface stimulation according to the present invention, and FIG. 28(b) is a partial enlarged cross section thereof.

FIG. 29(a) is a cross section of a different surface stimulator for providing surface stimulation according to the present invention, and FIG. 29(b) is a cross section of this surface stimulator in use.

FIG. 30(a) is a cross section of another different surface stimulator for providing surface stimulation according to the present invention, and FIG. 30(b) is a cross section of this surface stimulator in use.

FIG. 31(a) is a cross section of another different surface stimulator for providing surface stimulation according to the present invention, and FIG. 31(b) is a cross section of this surface stimulator in use.

FIG. 32(a) is a cross section of another different surface stimulator for providing surface stimulation according to the present invention, and FIG. 32(b) is a cross section of this surface stimulator in use.

FIG. 33 is a cross section of another different surface stimulator in use.

FIGS. 34(a) and (b) are partial cross sections which describe an embodiment of a point stimulation part on a garment according to the present invention.

FIGS. 35(a) and (b) are partial cross sections which describe another embodiment of a point stimulation part on a garment according to the present invention.

FIGS. 36(a) and (b) are partial cross sections which describe an embodiment of a surface stimulation part on a garment according to the present invention.

FIGS. 37(a) and (b) are partial cross sections which describe another embodiment of a surface stimulation part on a garment according to the present invention.

FIGS. 38(a)-(c) are a left side view, a front view, and a rear view of a pair of shorts, respectively, as an embodiment of a garment according to the present invention.

FIGS. 39(a)-(c) are a left side view, a front view, and a rear view of a pair of tights, respectively, as an embodiment of a garment according to the present invention.

FIGS. 40(a)-(c) are a left side view, a front view, and a rear view of a seagull (half-sleeve, long leg) swimsuit, respectively, as an embodiment of a garment according to the present invention.

FIGS. 41(a)-(c) are a left side view, a front view, and a rear view of a pair of knee high socks, respectively, as an embodiment of a garment according to the present invention.

FIGS. 42(a)-(c) are a left side view, a front view, and a rear view of a long john swimsuit, respectively, as an embodiment of a garment according to the present invention.

FIGS. 43(a)-(c) are a left side view, a front view, and a rear view of a high-waist brief, respectively, as an embodiment of a garment according to the present invention.

FIGS. 44(a)-(c) are a left side view, a front view, and a rear view of a pair of tights, respectively, as an embodiment of a garment according to the present invention.

FIGS. 45(a)-(c) are a left side view, a front view, and a rear view of a pair of knee high socks, respectively, as an embodiment of a garment according to the present invention.

FIGS. 46(a)-(c) are a left side view, a front view, and a rear view of a pair of tights, respectively, as an embodiment of a garment according to the present invention.

FIGS. 47(a)-(c) are a left side view, a front view, and a rear view of a pair of shorts, respectively, as an embodiment of a garment according to the present invention.

FIGS. 48(a)-(c) are a left side view, a front view, and a rear view of a T-shirt, respectively, as an embodiment of a garment according to the present invention.

FIGS. 49(a)-(c) are a left side view, a front view, and a rear view of a pair of knee high socks, respectively, as an embodiment of a garment according to the present invention.

FIGS. 50(a)-(d) are a right side view, a front view, a left side view, and a rear view of a pair of tights designed for the right-handed, respectively, as an embodiment of a garment according to the present invention.

FIGS. 51(a)-(f) are a right side view, a front view, a left side view, a rear view, and cross sections taken along the lines I-I and II-II in FIG. 51(b), respectively, of a full swimsuit designed for the right-handed, as an embodiment of a garment according to the present invention.

FIGS. 52(a)-(f) are a right side view, a front view, a left side view, a rear view, and cross sections taken along the lines III-III and IV-IV in FIG. 52(b), respectively, of an undershirt designed for the right-handed, as an embodiment of a garment according to the present invention.

FIGS. 53(a)-(d) are a right side view, a front view, a left side view, and a rear view of a pair of tights designed for the right-handed, respectively, as an embodiment of a garment according to the present invention.

FIGS. 54(a)-(f) are a right side view, a front view, a left side view, a rear view, and cross sections taken along the lines V-V and VI-VI in FIG. 54(b), respectively, of a full swimsuit designed for the right-handed, as an embodiment of a garment according to the present invention.

FIGS. 55(a)-(f) are a right side view, a front view, a left side view, a rear view, and cross sections taken along the lines VII-VII and VIII-VIII in FIG. 55(b), respectively, of an undershirt designed for the right-handed, as an embodiment of a garment according to the present invention.

FIGS. 56(a)-(f) are a right side view, a front view, a left side view, a rear view, and cross sections taken along the lines IX-IX and X-X in FIG. 56(b), respectively, of a pair of tights designed for the right-handed, as an embodiment of a garment according to the present invention.

FIGS. 57(a)-(f) are a right side view, a front view, a left side view, a rear view, and cross sections taken along the lines XI-XI and XII-XII in FIG. 57(b), respectively, of a full swimsuit designed for the right-handed, as an embodiment of a garment according to the present invention.

FIGS. 58(a)-(f) are a right side view, a front view, a left side view, a rear view, and cross sections taken along the lines XIII-XIII and XIV-XIV in FIG. 58(b), respectively, of an undershirt designed for the right-handed, as an embodiment of a garment according to the present invention.

FIGS. 59(a)-(c) are a left side view, a front view, and a rear view of a pair of tights in Example 1 according to the present invention, respectively, with the tights put on the body.

FIGS. 60(a)-(c) are a left side view, a front view, and a rear view of a pair of tights in Example 2 according to the present invention, respectively, with the tights put on the body.

FIGS. 61(a)-(c) are a left side view, a front view, and a rear view of a pair of tights in Example 3 according to the present invention, respectively, with the tights put on the body.

FIGS. 62(a)-(c) are a left side view, a front view, and a rear view of a pair of tights in Example 4 according to the present invention, respectively, with the tights put on the body.

FIGS. 63(a)-(c) are a left side view, a front view, and a rear view of a pair of tights in Example 5 according to the present invention, respectively, with the tights put on the body.

FIGS. 64(a)-(c) are a left side view, a front view, and a rear view of a pair of tights in Example 6 according to the present invention, respectively, with the tights put on the body.

FIGS. 65(a)-(f) are a right side view, a front view, a left side view, a rear view, and cross sections taken along the lines XV-XV and XVI-XVI in FIG. 65(b), respectively, of a pair of tights in Example 7 according to the present invention, with the tights put on the body.

FIGS. 66(a)-(f) are a right side view, a front view, a left side view, a rear view, and cross sections taken along the lines XVII-XVII and XVIII-XVIII in FIG. 66(b), respectively, of a pair of tights in Example 8 according to the present invention, with the tights put on the body.

FIGS. 67(a)-(f) are a right side view, a front view, a left side view, a rear view, and cross sections taken along the lines XIX-XIX and XX-XX in FIG. 67(b), respectively, of a pair of tights in Example 9 according to the present invention, with the tights put on the body.

FIGS. 68(a)-(f) are a right side view, a front view, a left side view, a rear view, and cross sections taken along the lines XXI-XXI and XXII-XXII in FIG. 68(b), respectively, of a pair of tights in Example 10 according to the present invention, with the tights put on the body.

FIGS. 69(a)-(f) are a right side view, a front view, a left side view, a rear view, and cross sections taken along the lines XXIII-XXIII and XXIV-XXIV in FIG. 69(b), respectively, of a pair of tights in Example 11 according to the present invention, with the tights put on the body.

FIGS. 70(a)-(f) are a right side view, a front view, a left side view, a rear view, and cross sections taken along the lines XXV-XXV and XXVI-XXVI in FIG. 70(b), respectively, of a pair of tights in Example 12 according to the present invention, with the tights put on the body.

FIGS. 71(a)-(c) are a left side view, a front view, and a rear view of a pair of tights in Comparative Example 1 according to the present invention, respectively, with the tights put on the body.

FIGS. 72(a)-(c) are a left side view, a front view, and a rear view of a pair of tights in Comparative Example 2 according to the present invention, respectively, with the tights put on the body.

FIGS. 73(a)-(c) are a left side view, a front view, and a rear view of a pair of tights in Comparative Example 3 according to the present invention, respectively, with the tights put on the body.

FIGS. 74(a)-(c) are a left side view, a front view, and a rear view of a pair of tights in Comparative Example 4 according to the present invention, respectively, with the tights put on the body.

FIGS. 75(a)-(f) are a right side view, a front view, a left side view, a rear view, and cross sections taken along the lines XXVII-XXVII and XXVIII-XXVIII in FIG. 75(b), respectively, of a pair of tights in Comparative Example 5 according to the present invention, with the tights put on the body.

FIGS. 76(a)-(f) are a right side view, a front view, a left side view, a rear view, and cross sections taken along the lines XXIX-XXIX and XXX-XXX in FIG. 76(b), respectively, of a pair of tights in Comparative Example 6 according to the present invention, with the tights put on the body.

FIGS. 77(a)-(f) are a right side view, a front view, a left side view, a rear view, and cross sections taken along the lines XXXI-XXXI and XXXII-XXXII in FIG. 77(b), respectively, of a pair of tights in Comparative Example 7 according to the present invention, with the tights put on the body.

FIG. 78(a) is a schematic view which illustrates a knit pattern of the tights in Examples 1-12 according to the present invention, and FIGS. 78(b)-(d) show knit patterns for these tights.

FIG. 79 illustrates a knit pattern for a point stimulation part and a surface stimulation part in the tights of Examples 1-12 according to the present invention.

FIG. 80 is a classified list of muscles showing very strong muscle tone or strong muscle tone, with respect to the states of muscle tone during antigravity exercise, in the case of a right-handed person with a forward leaning posture.

FIG. 81 is a classified list of muscles showing weak muscle tone or very weak muscle tone, with respect to the states of muscle tone during antigravity exercise, in the case of a right-handed person with a forward leaning posture.

FIG. 82 is a classified list of muscles showing very strong muscle tone or strong muscle tone, with respect to the states of muscle tone during antigravity exercise, in the case of a left-handed person with a forward leaning posture.

FIG. 83 is a classified list of muscles showing weak muscle tone or very weak muscle tone, with respect to the states of muscle tone during antigravity exercise, in the case of a left-handed person with a forward leaning posture.

FIG. 84 is a classified list of muscles showing weak muscle tone or very weak muscle tone, with respect to the states of muscle tone during antigravity exercise, in the case of a right-handed person with a backward leaning posture.

FIG. 85 is a classified list of muscles showing very strong muscle tone or strong muscle tone, with respect to the states of muscle tone during antigravity exercise, in the case of a right-handed person with a backward leaning posture.

FIG. 86 is a classified list of muscles showing weak muscle tone or very weak muscle tone, with respect to the states of muscle tone during antigravity exercise, in the case of a left-handed person with a backward leaning posture.

FIG. 87 is a classified list of muscles showing very strong muscle tone or strong muscle tone, with respect to the states of muscle tone during antigravity exercise, in the case of a left-handed person with a backward leaning posture.

FIG. 88 is a classified list of human muscle activity observed during antigravity exercise in an ideal posture.

FIG. 89 is a classified list of human joint activity observed during antigravity exercise in an ideal posture.

FIG. 90 shows the test results in Examples 1 and 2, and Comparative Examples 1 and 2.

FIG. 91 shows the test results in Examples 3 and 4, and Comparative Examples 2 and 3.

FIG. 92 shows the test results in Examples 5 and 6, and Comparative Examples 2 and 4.

FIG. 93 shows the test results in Examples 7 and 8, and Comparative Examples 5 and 6.

FIG. 94 shows the test results in Examples 9 and 10, and Comparative Examples 7 and 8.

FIG. 95 shows the test results in Examples 11 and 12, and Comparative Examples 9 and 10.

FIG. 96 shows the test results in Example 13(1).

FIG. 97 shows the test results in Example 13(2).

FIG. 98 shows the test results in Example 13(3).

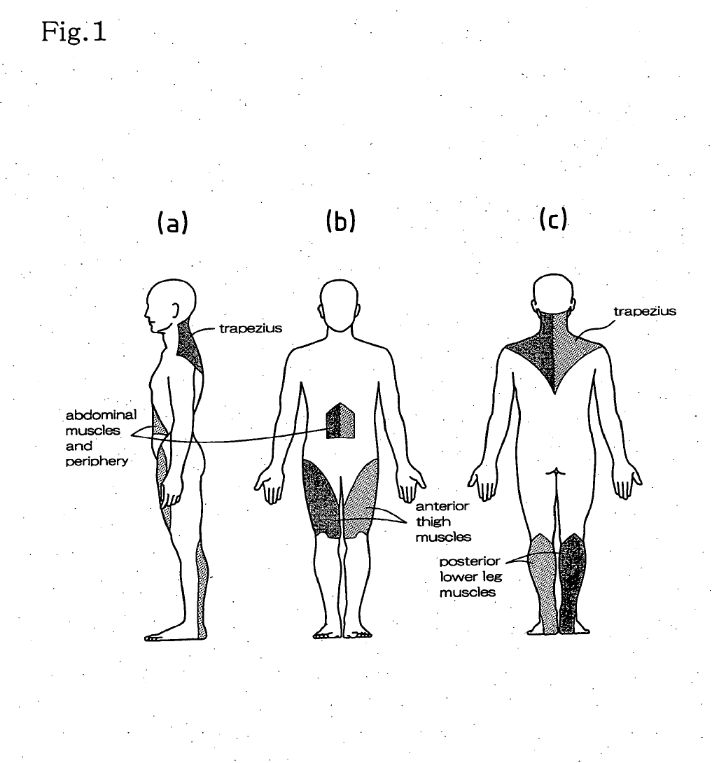

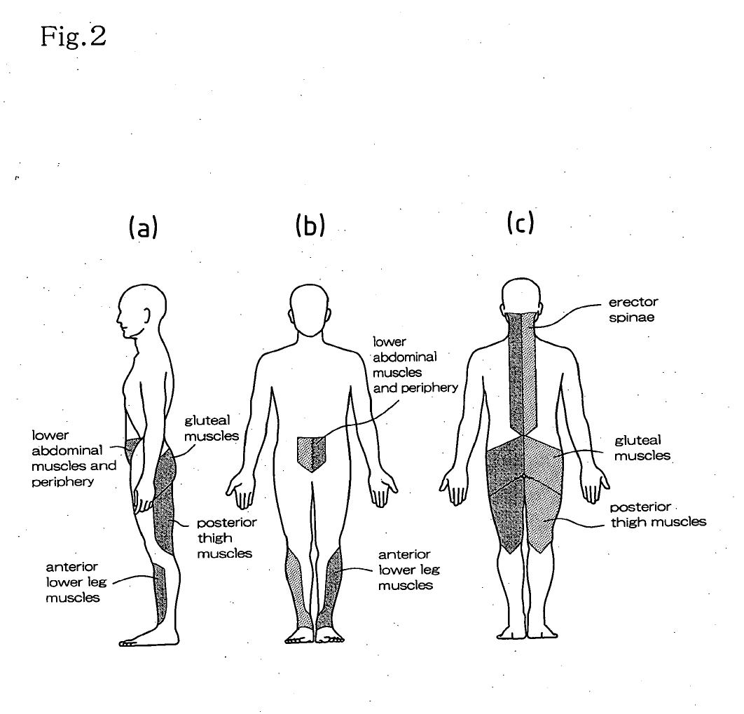

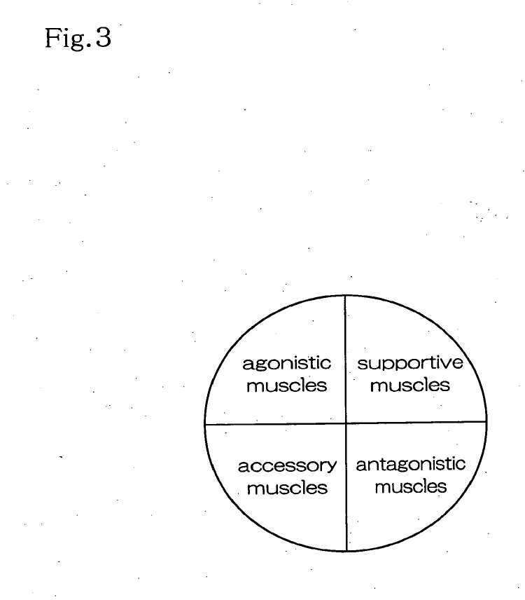

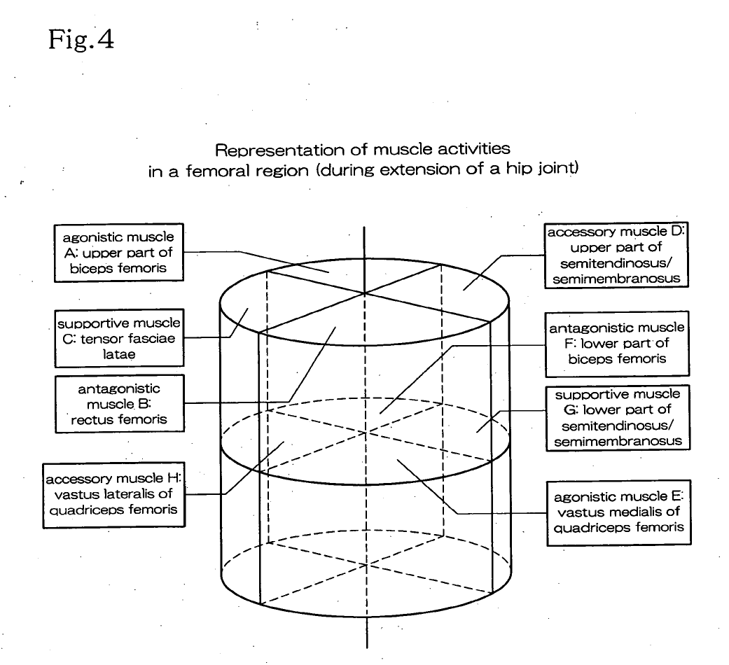

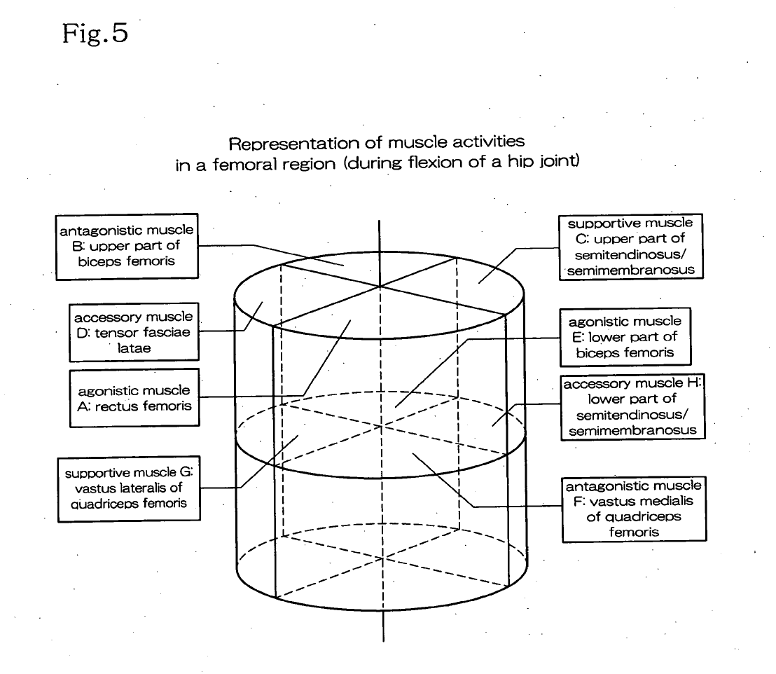

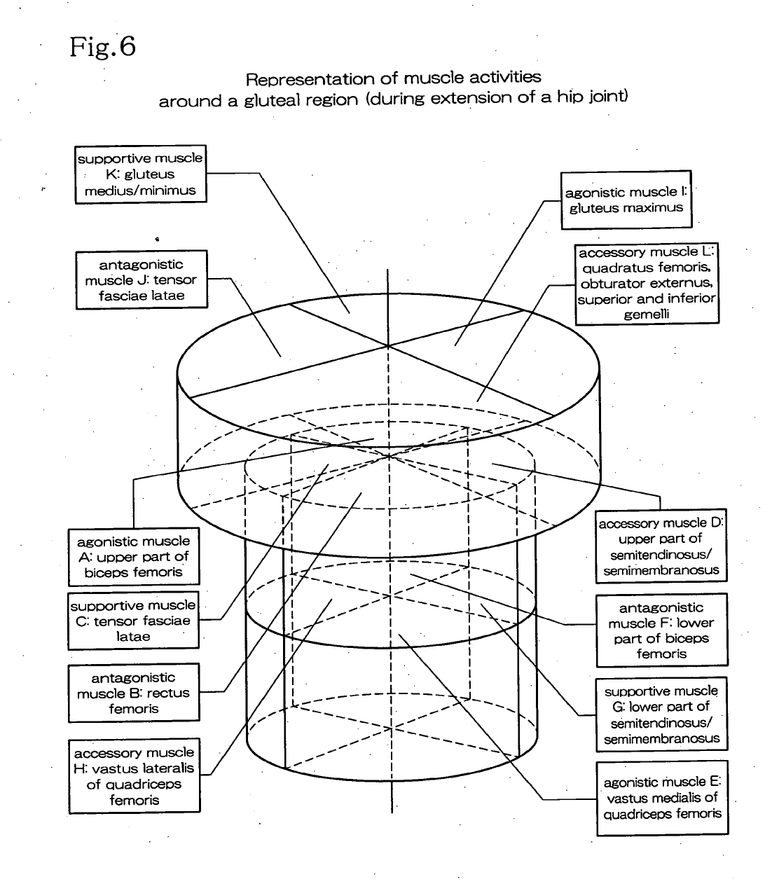

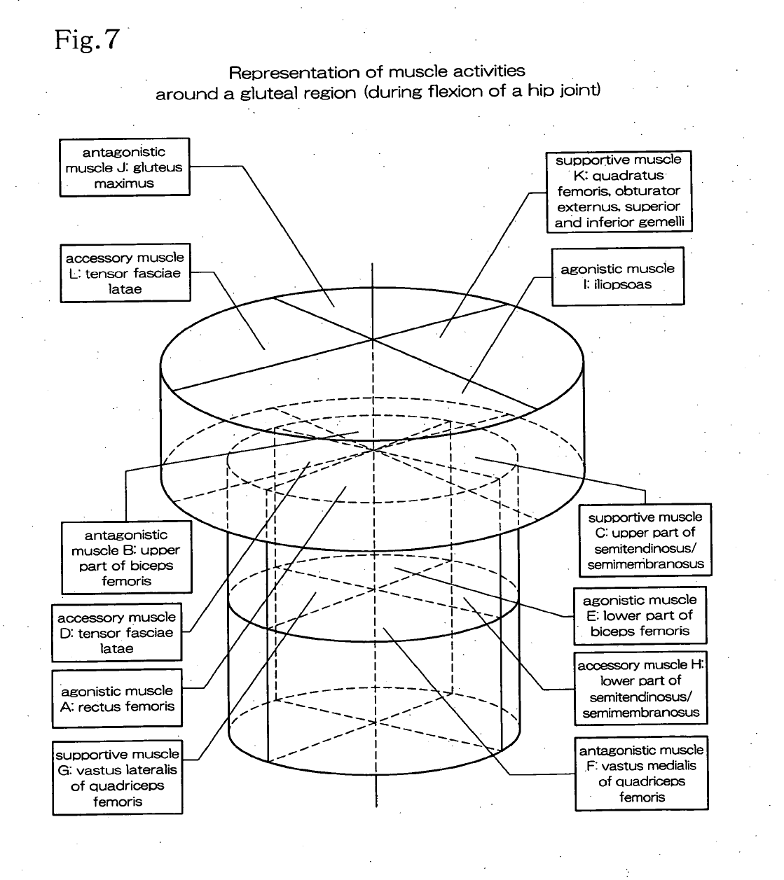

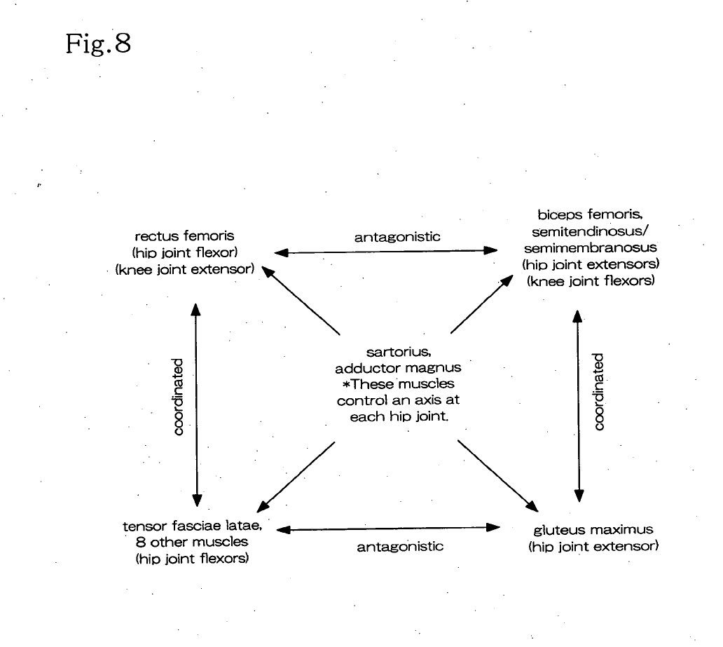

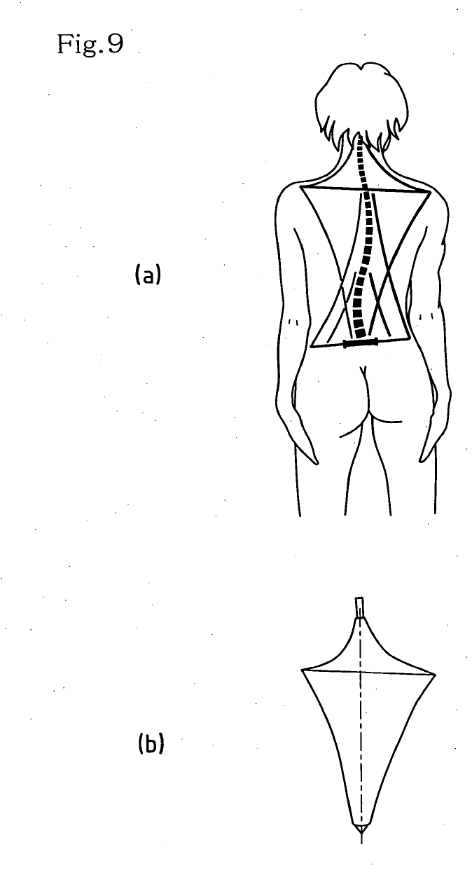

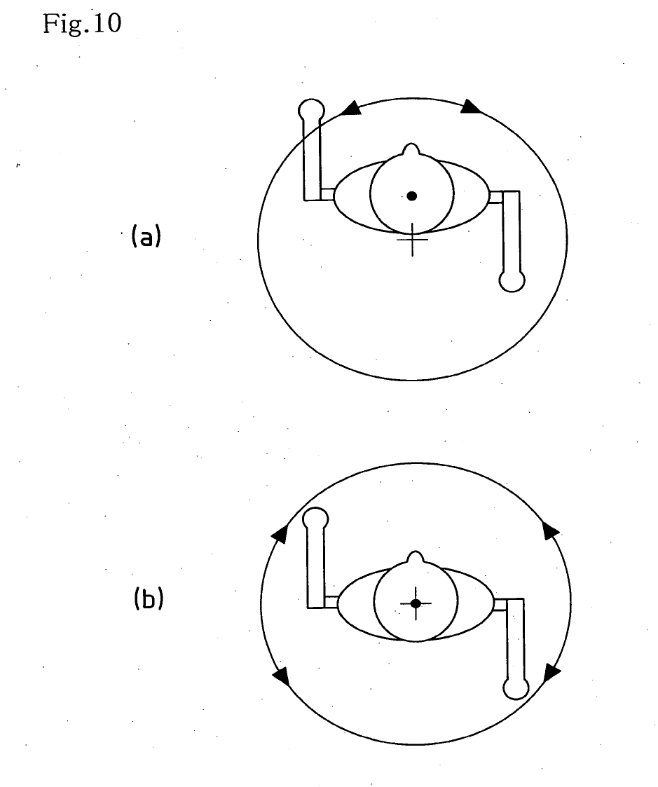

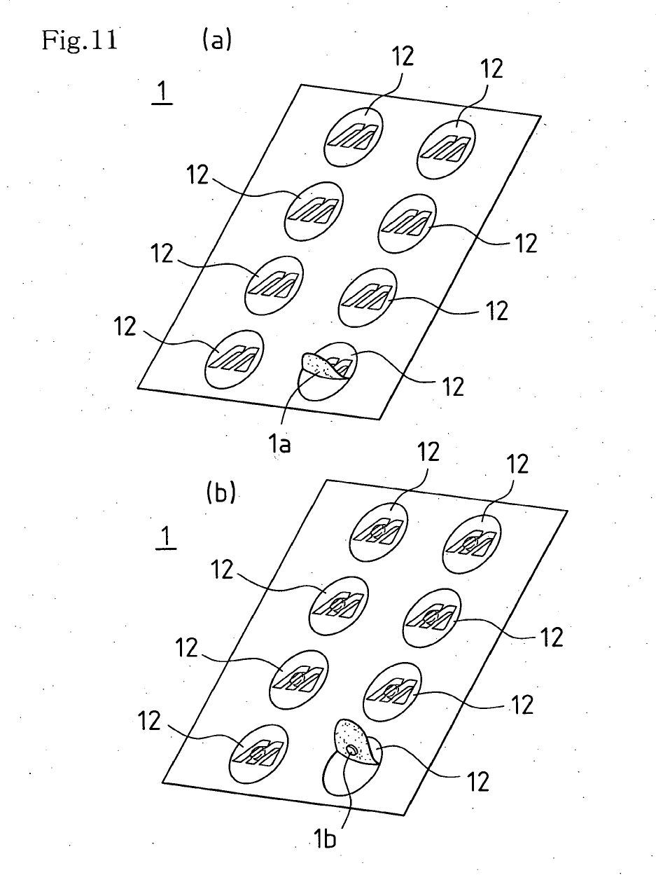

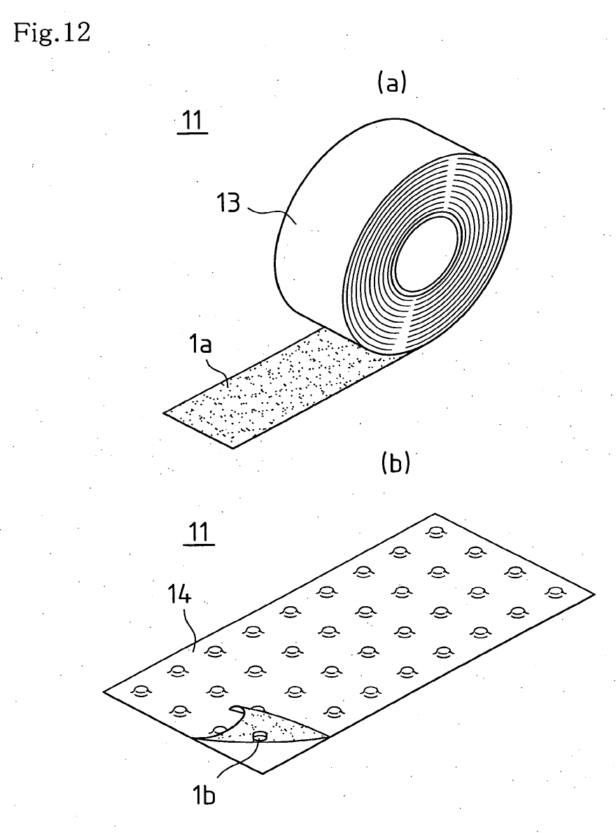

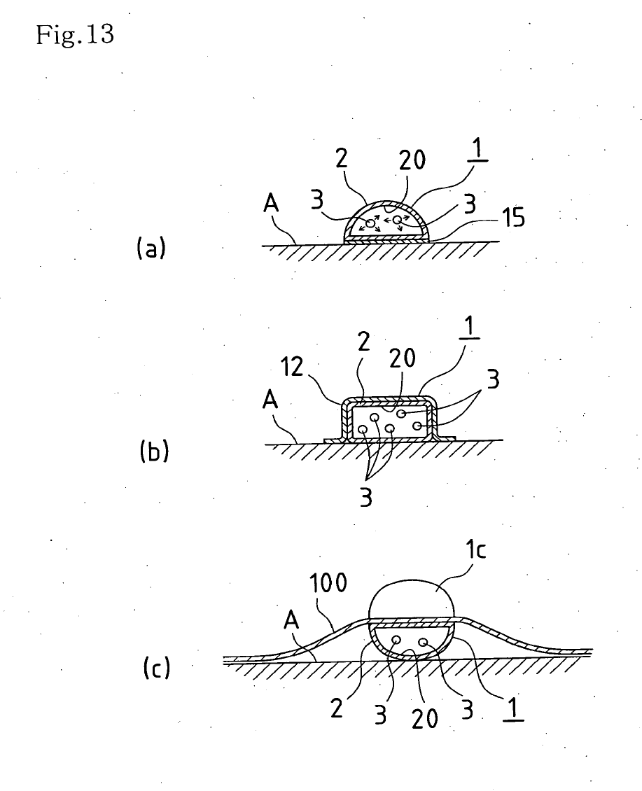

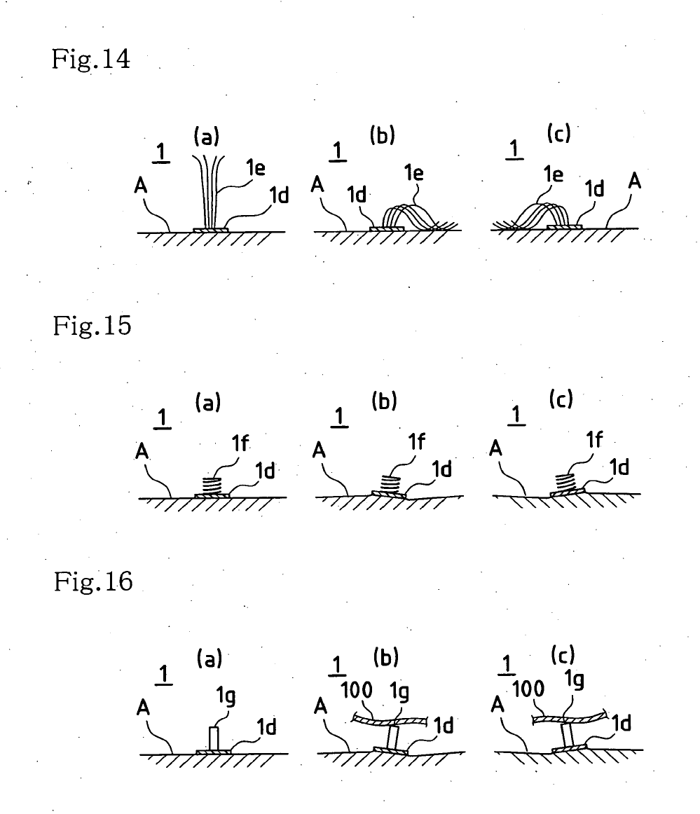

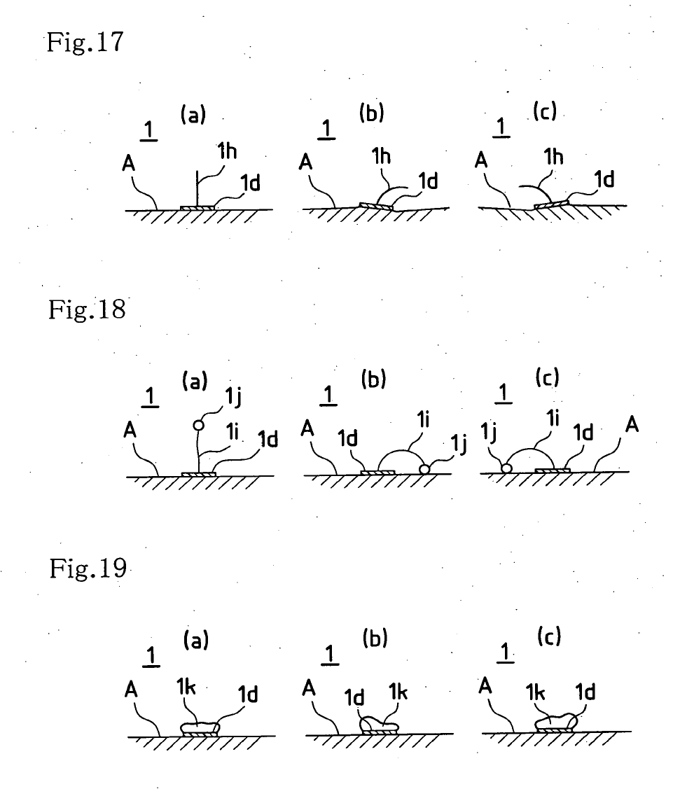

### BEST MODE FOR CARRYING OUT THE INVENTION

### Examples 1-12 & Comparative Examples 1-7

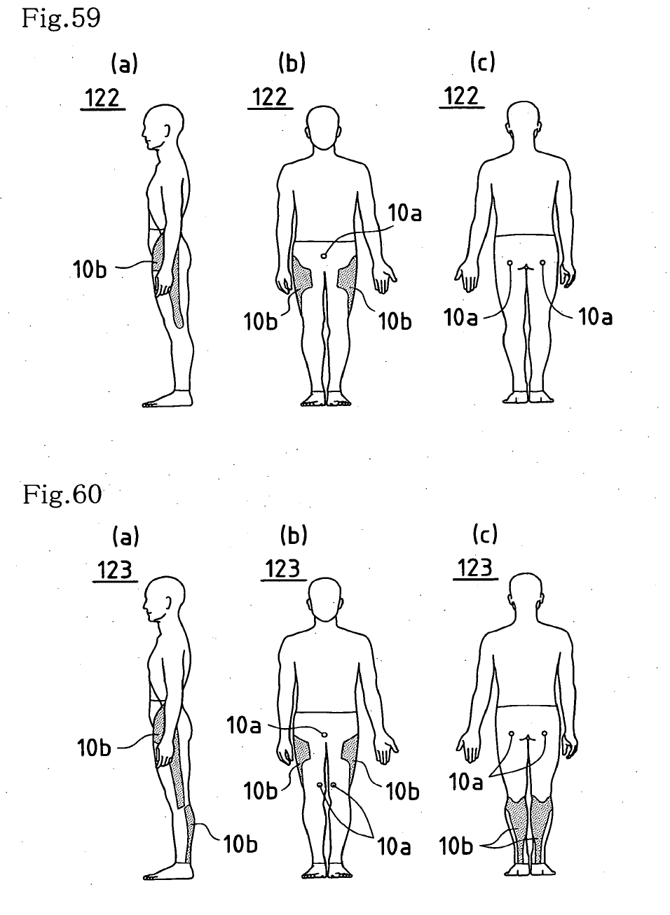

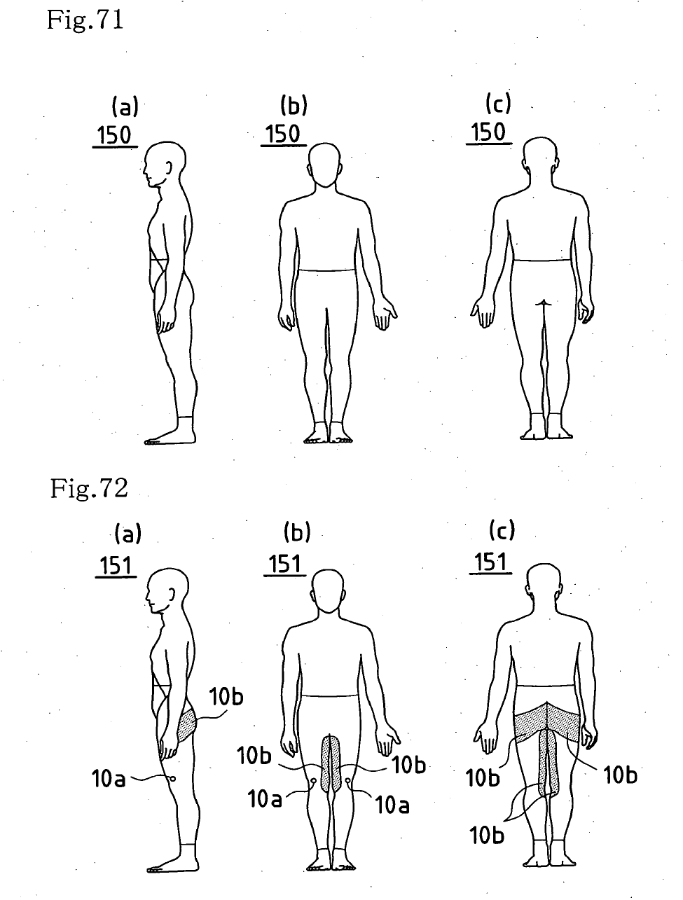

Tights of Examples 1-12 equipped with point stimulation parts 10a and surface stimulation parts 10b were manufactured as shown in FIGS. 59-70, respectively. For comparison, tights of Comparative Examples 1-7 equipped with point stimulation parts 10a and surface stimulation parts 10b were manufactured as indicated in FIGS. 71-77, respectively.

### Manufacture of Tights

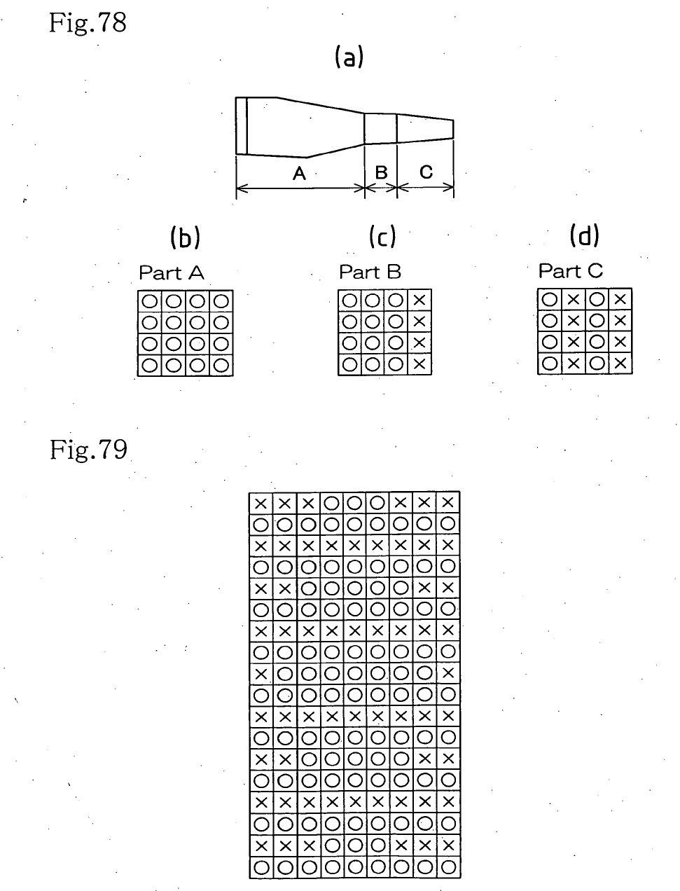

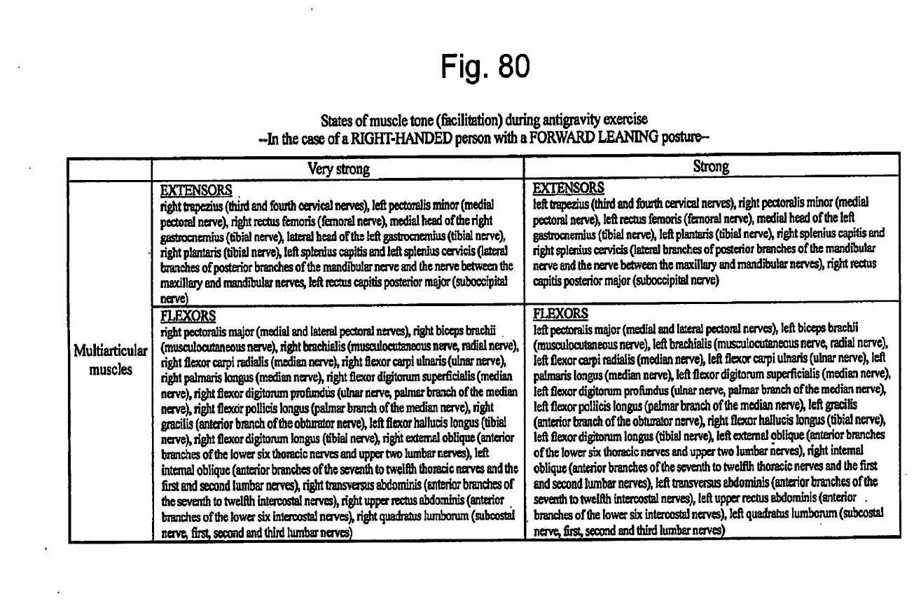

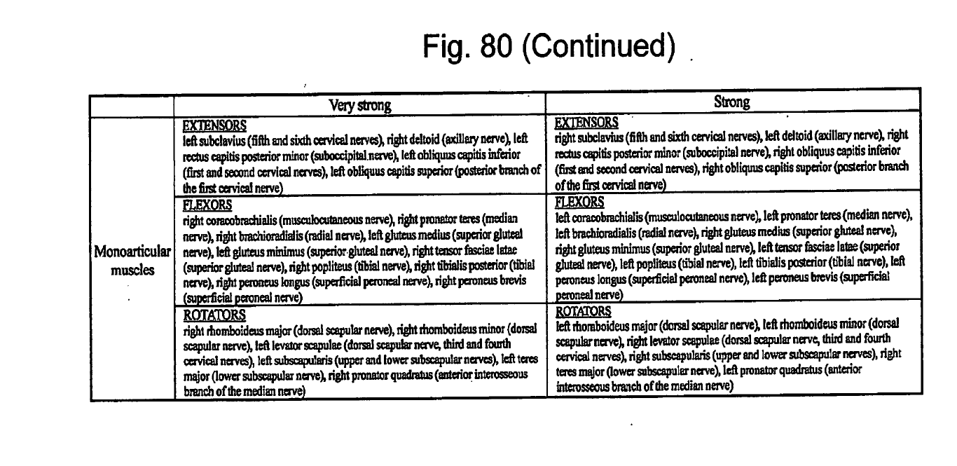

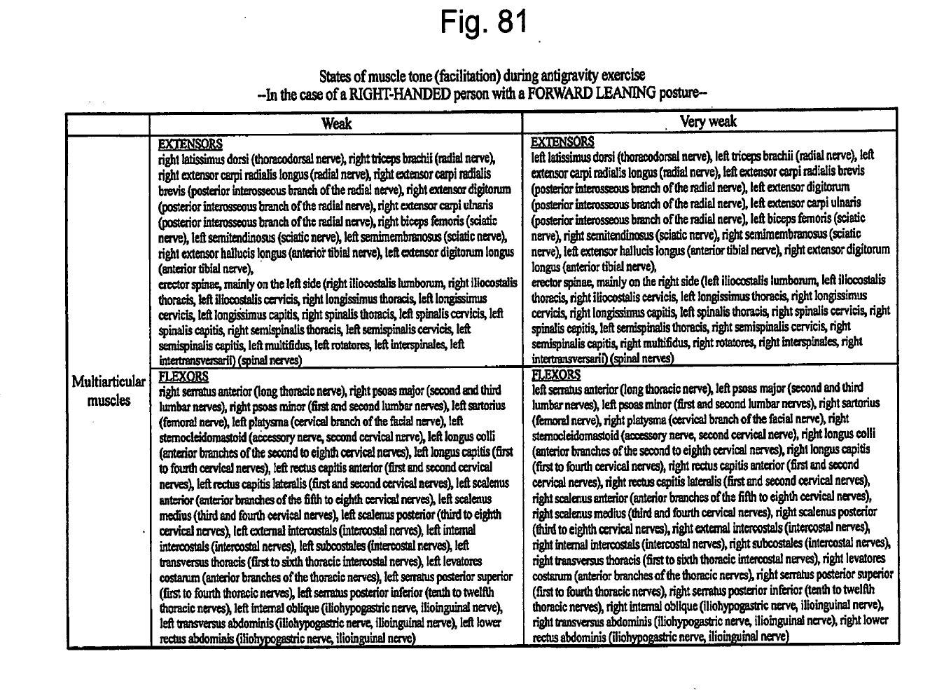

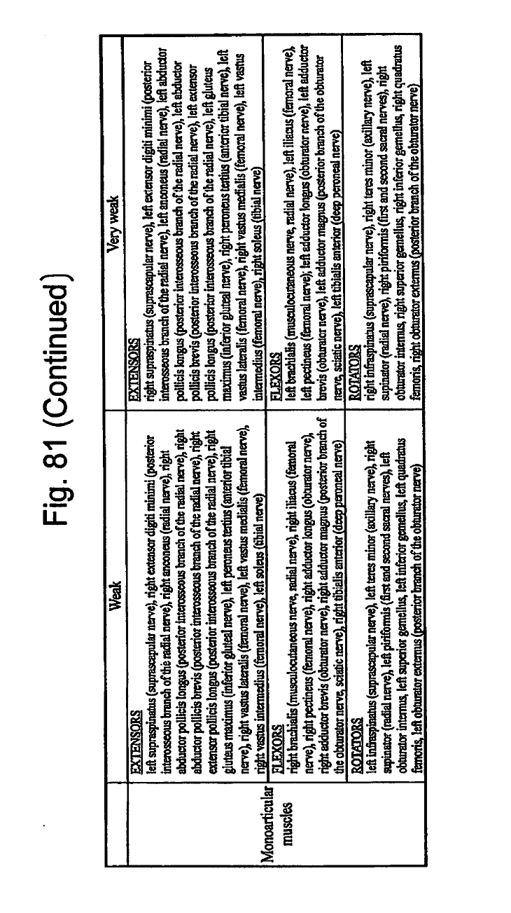

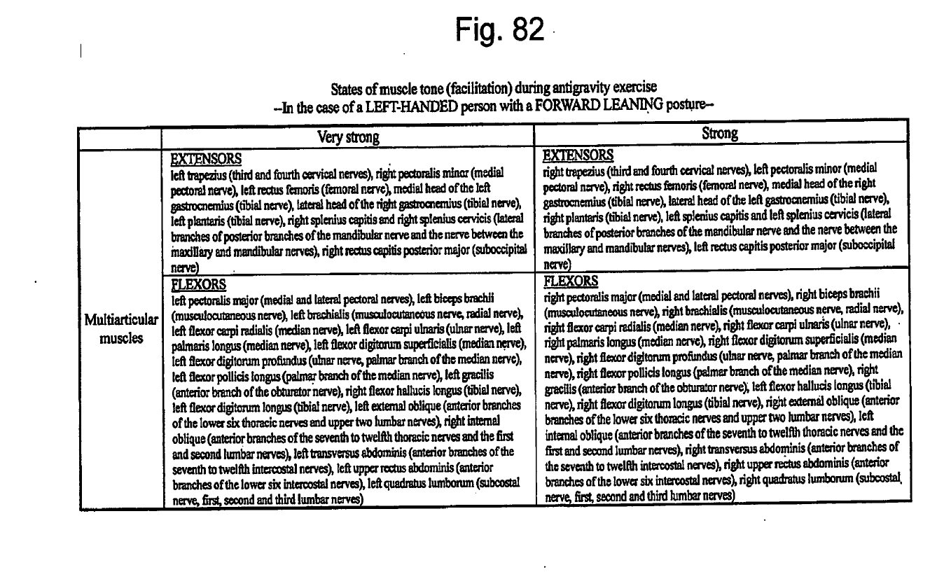

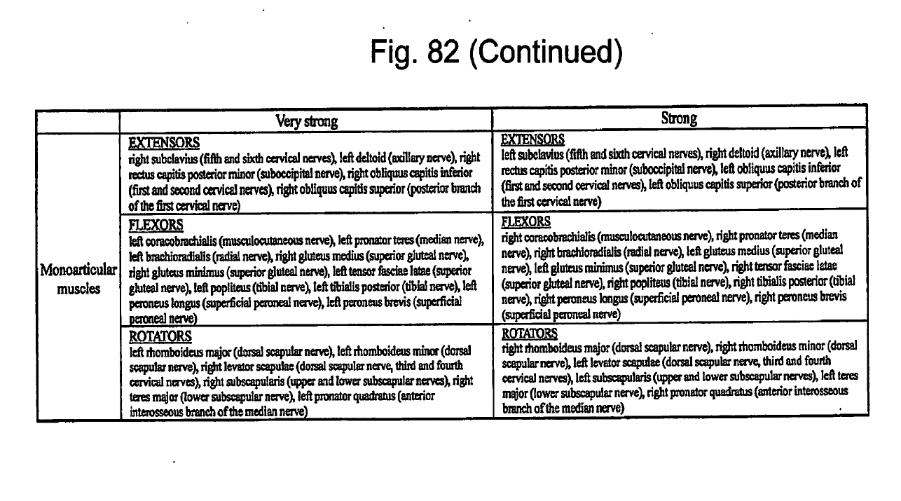

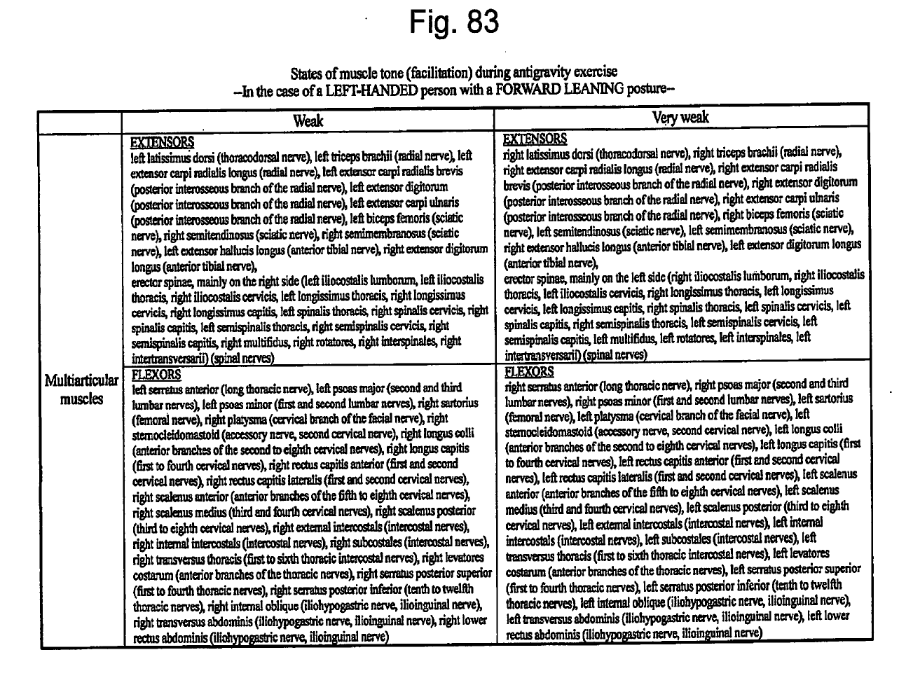

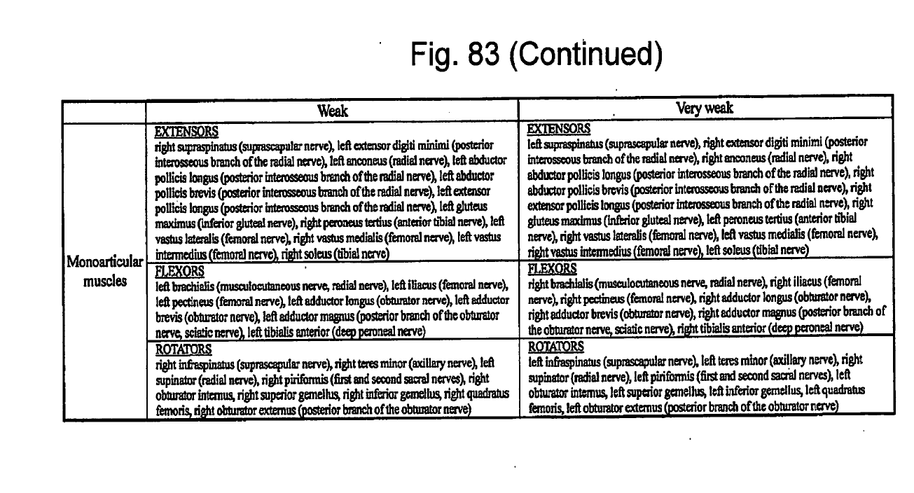

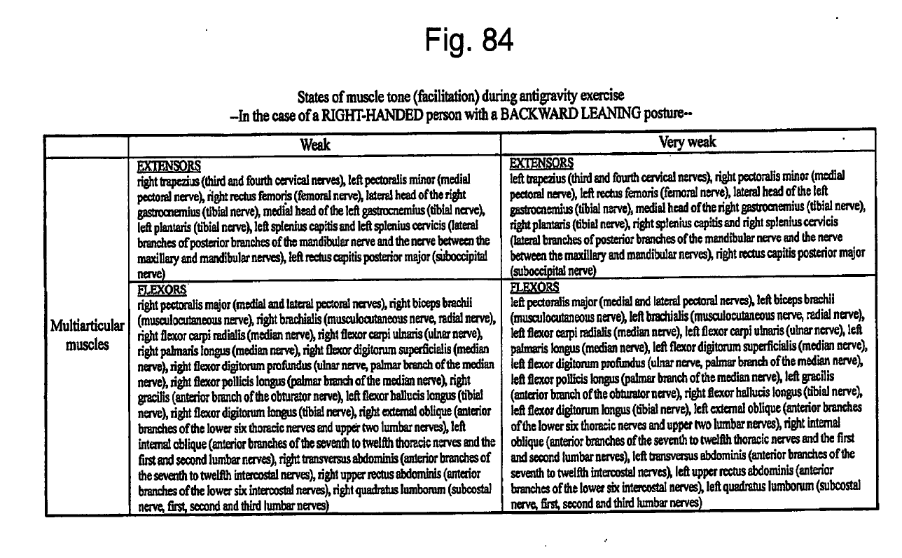

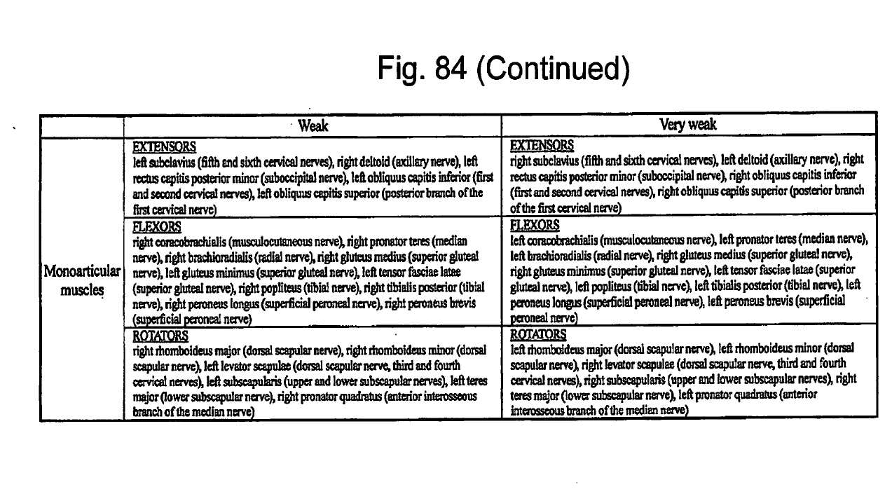

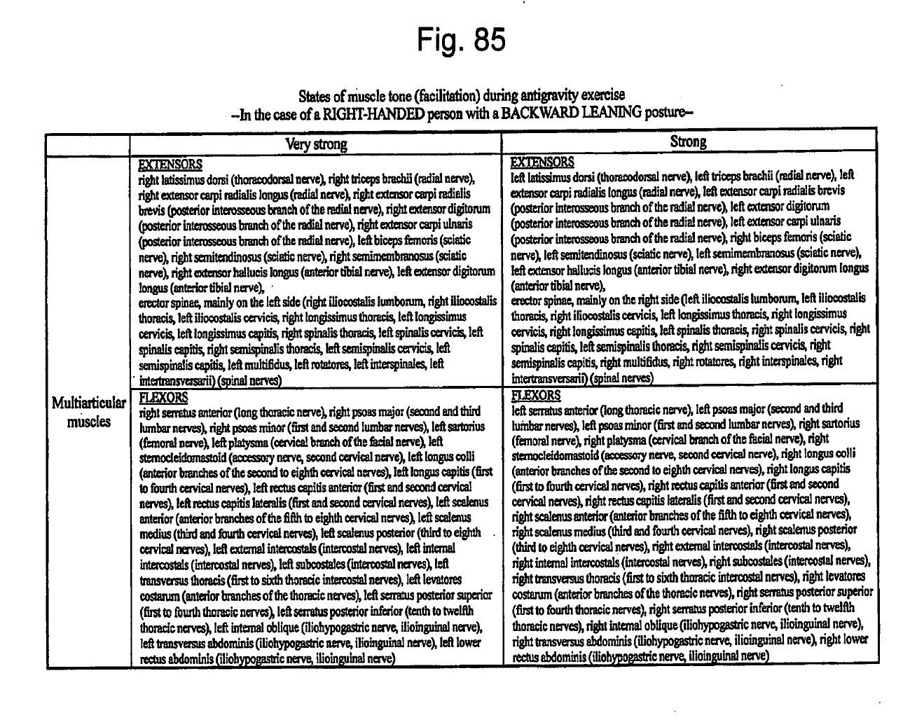

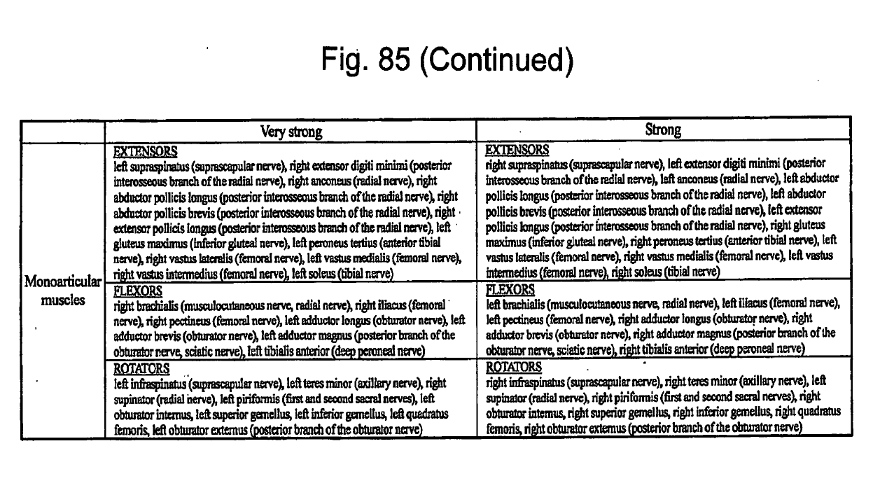

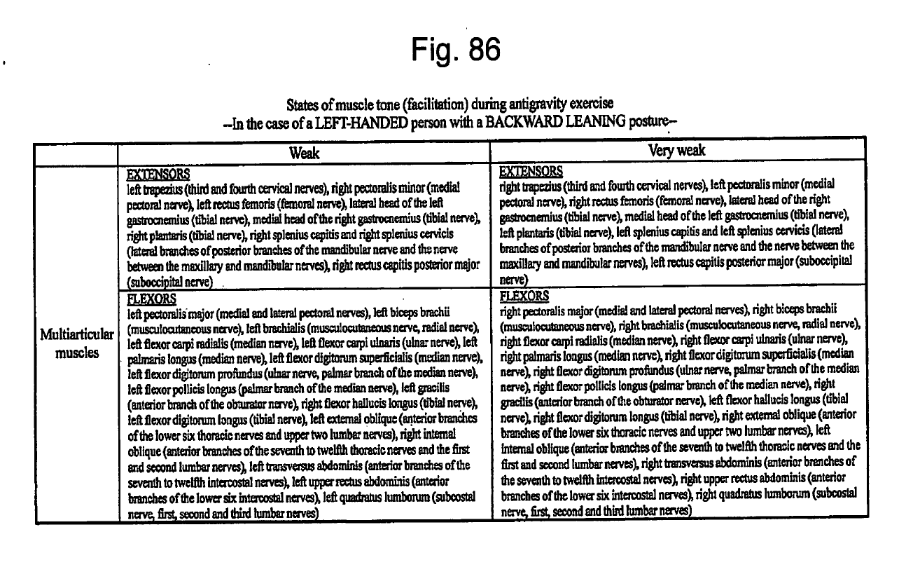

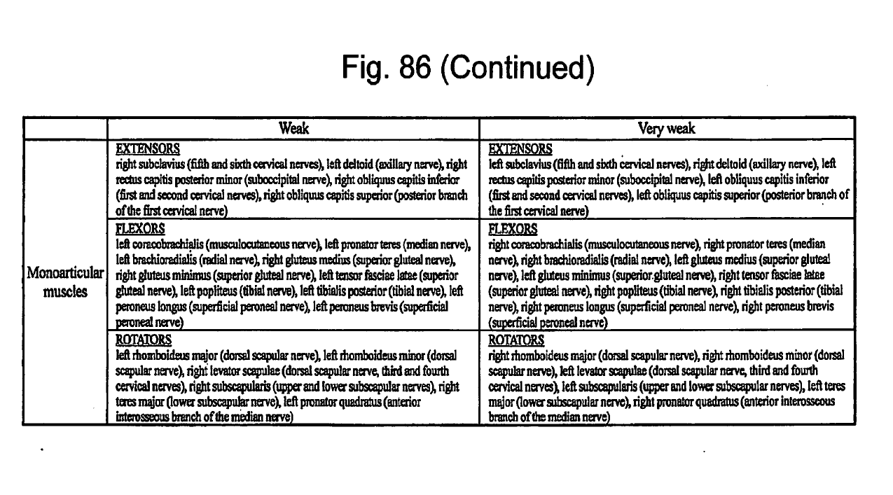

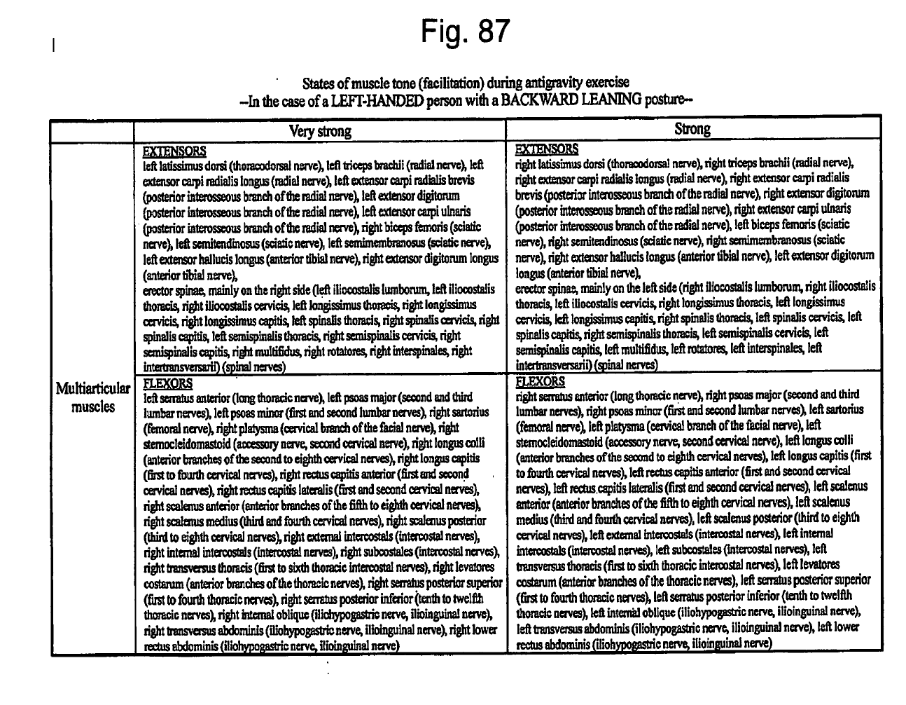

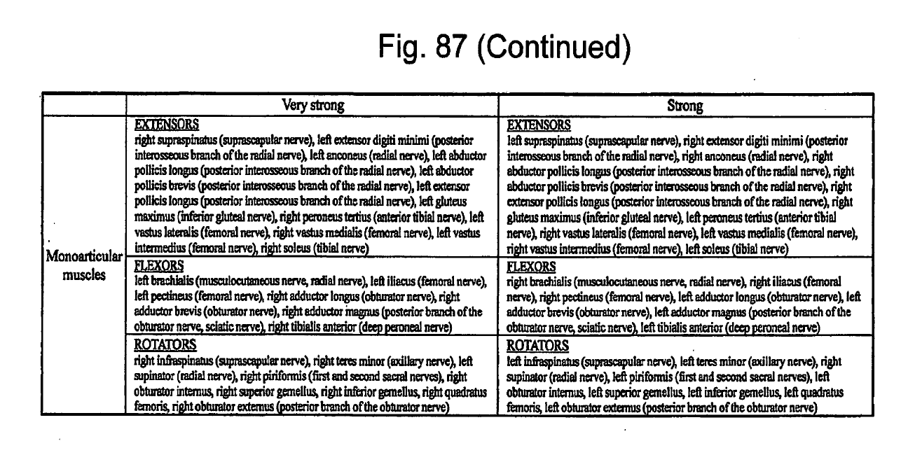

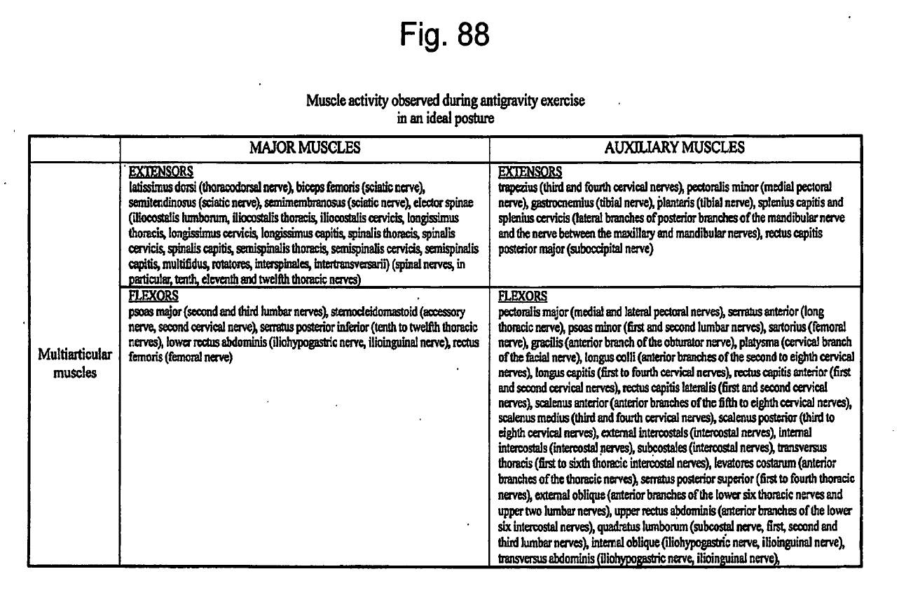

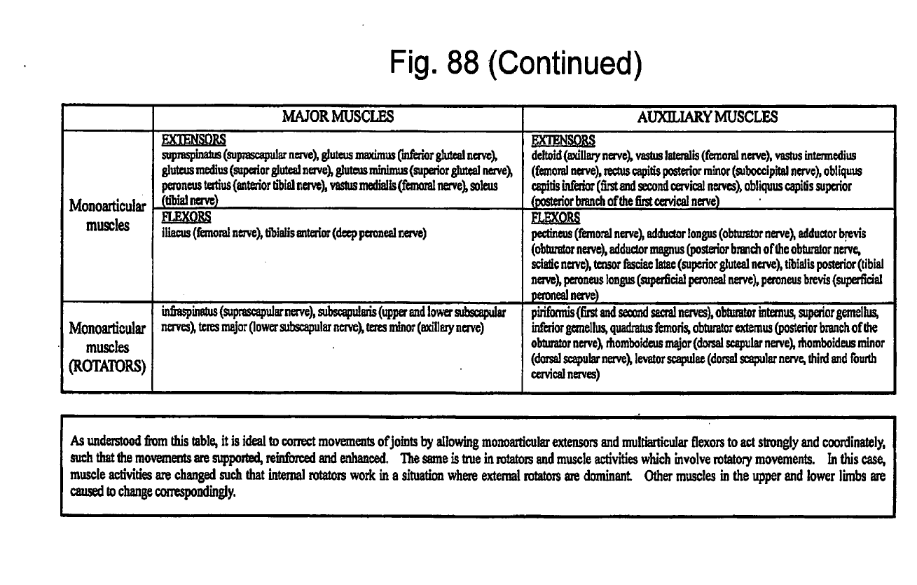

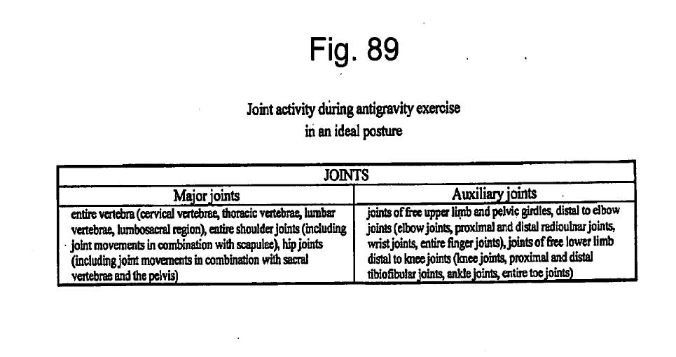

Tights were manufactured by a circular knitting machine produced by Santoni S.p.A. in Italy (tradename: Matec HF70; cylinder diameter 7 inches, 26 gauge). In order to improve the fit to the body, the number of knitting needles in the circumferential direction was varied by three stages as shown in FIG. 78: 572 needles (all needles) for Part A, 429 needles (three-quarters of the needles) for Part B, and 286 needles (half of the needles) for Part C. The knit pattern was basically composed of plain stitches. FIG. 79 shows a knit pattern for a point stimulation part 10a. In FIGS. 78(b)-(d) and 79, the sidewise direction is the wale, and the lengthwise direction is the course. The circles and crosses mean KNIT (to form a loop) and MISS (to omit a loop), respectively. For a surface stimulation part 10b, a plurality of knit patterns for the point stimulation part 10a were formed in continuation.

The entire part of these tights were made of a yarn which was obtained by paralleling nylon yarns (thickness 78 dtex/48 f) and a single covered yarn in which a 44-dtex-thick polyurethane elastane yarn core was covered with a nylon yarn (thickness 56 dtex/48 f).

The point stimulation parts 10a and the surface stimulation parts 10b were made in plate stitch by which a polyester yarn (thickness 78 dtex/36 f) formed a projecting pattern on the skin/back side.

For each pair of tights, a left part and a right part were knitted separately in tube form, in conformity with the shapes of the left and right lower bodies. The left part and the right part were joined by flat sewing along the median line of the body, in such a manner as to minimize stimulation induced by the seam.

### Examples 1 and 2

### Tights for Applying Point Stimulation and Surface Stimulation

### Symmetrical Arrangement

FIG. 59 shows a pair of tights 122. On the skin side of the tights 122 (the surface to touch the skin), point stimulation parts 10a were arranged to locate, with a person wearing the tights, on the skin surface corresponding to the neighborhood of the lower rectus abdominis, and the gluteal muscles (gluteus maximus). A point for the neighborhood of the lower rectus abdominis was optionally selected to give maximum stimulation to the iliohypogastric nerve and the ilioinguinal nerve, and points for the gluteal muscles (gluteus maximus) were optionally selected to give maximum stimulation to the inferior gluteal nerve. Also on the skin side of the tights 122 (the surface to touch the skin), surface stimulation parts 10b were arranged such that, with a person wearing the tights, a plurality of knit patterns shown in FIG. 79 could entirely cover functional skin areas of muscles for extension of the knee joints (including the rectus femoris) and muscles for flexion and internal rotation of the hip joints (the tensor fasciae latae).

FIG. 60 shows a pair of tights 123. On the skin side of the tights 123 (the surface to touch the skin), point stimulation parts 10a were arranged to locate, with a person wearing the tights, on the skin surface corresponding to the neighborhood of the lower rectus abdominis, the gluteal muscles (gluteus maximus), and the vastus medialis of the quadriceps femoris. A point for the neighborhood of the lower rectus abdominis was optionally selected to give maximum stimulation to the iliohypogastric nerve and the ilioinguinal nerve, points for the gluteal muscles (gluteus maximus) were optionally selected to give maximum stimulation to the inferior gluteal nerve, and points for the vastus medialis of the quadriceps femoris were optionally selected to give maximum stimulation to the femoral nerve. Also on the inner side of the tights 123 (the surface to touch the skin), surface stimulation parts 10b were arranged such that, with a person wearing the tights, a plurality of knit patterns shown in FIG. 79 could entirely cover functional skin areas of following multiarticular muscles in the free lower limb and the pelvic girdles: muscles for extension of the knee joints (including the rectus femoris); muscles for extension of the ankle joints (including the gastrocnemius); and muscles for flexion and internal rotation of the hip joints (the tensor fasciae latae).

### Comparative Examples 1 and 2

A pair of tights 150 shown in FIG. 71 were similar to those in Example 1 above, except for omitting point stimulation parts 10a and surface stimulation parts 10b. Turning to a pair of tights 151 of FIG. 72, point stimulation parts 10a were arranged on the vastus lateralis of the quadriceps femoris. Surface stimulation parts 10b were arranged such that a plurality of knit patterns shown in FIG. 79 could entirely cover functional skin areas of the gluteus maximus and the thigh adductors.

### Selection of Subjects

People wearing the tights 150 of Comparative Example 1 were instructed to stand with their eyes closed. Ten of them who took a forward leaning posture (i.e. those who supported their body weight on the toe side) were selected as subjects.

### Tests

The subjects took the following tests, with wearing the tights 151 of Comparative Example 2. During the tests, movements of the subjects were observed also visually.

(a) Measurement of the Center of Gravity in the Soles

The subjects wearing the tights 151 were instructed to stand on the measurement surface of a pressure mat. The positions where the subjects supported their weight load were measured by density of their ink impression.

(b) Vertical Jump Test

The subjects wearing the tights 151 were instructed to jump vertically. The height of the jump was measured.

(c) Sway of the Whole Body During Continuous Jumping

The subjects wearing the tights 151 were instructed to jump continuously on the site, to the beat of a metronome at 100 bpm. While they were jumping, distribution of landing spots was measured. In addition, the height of the jumps was visually observed.

(d) Duration of One-Leg Standing Posture, and Change of Posture Over Time

The subjects wearing the tights 151 were instructed to stand on one leg on the site. The time was counted until the subjects lost their balance and the standing foot moved from the original position.

All the subjects took Tests (a)-(d) in the same manner. During the tests, movements of the subjects were observed also visually.

The subjects wore, in turn, the tights 122 of Example 1, the tights 123 of Example 2, and the tights 150 of Comparative Example 1, and took the same tests as above. During the tests, movements of the subjects were observed also visually.

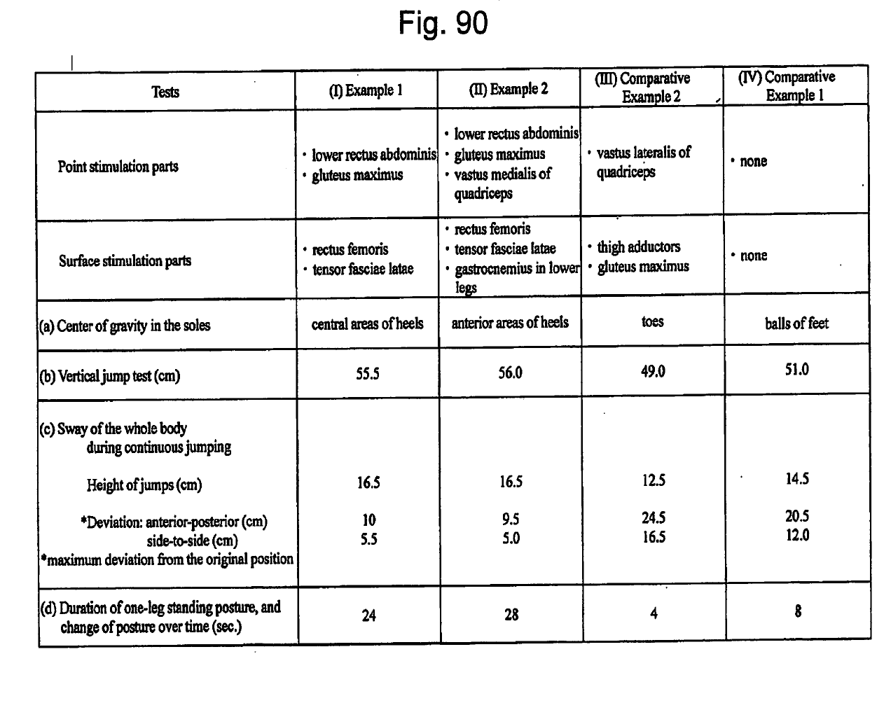

All results are given in FIG. 90.

### Examples 3 and 4

### Tights for Applying Point Stimulation

### Symmetrical Arrangement

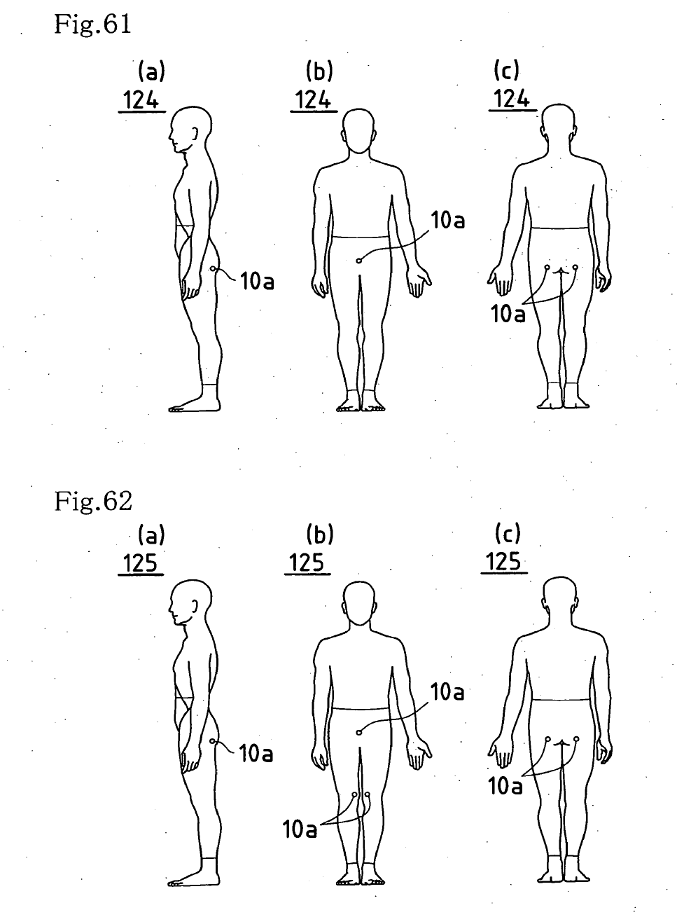

FIG. 61 shows a pair of tights 124. On the skin side of the tights 124 (the surface to touch the skin), point stimulation parts 10a were arranged to locate, with a person wearing the tights, on the skin surface corresponding to the neighborhood of the lower rectus abdominis and the gluteal muscles (gluteus maximus). A point for the neighborhood of the lower rectus abdominis was optionally selected to give maximum stimulation to the iliohypogastric nerve and the ilioinguinal nerve, and points for the gluteal muscles (gluteus maximus) were optionally selected to give maximum stimulation to the inferior gluteal nerve.

FIG. 62 shows a pair of different tights 125. On the skin side of the tights 125 (the surface to touch the skin), point stimulation parts 10a were arranged to locate, with a person wearing the tights, on the skin surface corresponding to the neighborhood of the lower rectus abdominis, the gluteal muscles (gluteus maximus), and the vastus medialis of the quadriceps femoris. A point for the neighborhood of the lower rectus abdominis was optionally selected to give maximum stimulation to the iliohypogastric nerve and the ilioinguinal nerve, points for the gluteal muscles (gluteus maximus) were optionally selected to give maximum stimulation to the inferior gluteal nerve, and points for the vastus medialis of the quadriceps femoris were optionally selected to give maximum stimulation to the femoral nerve.

### Comparative Example 3

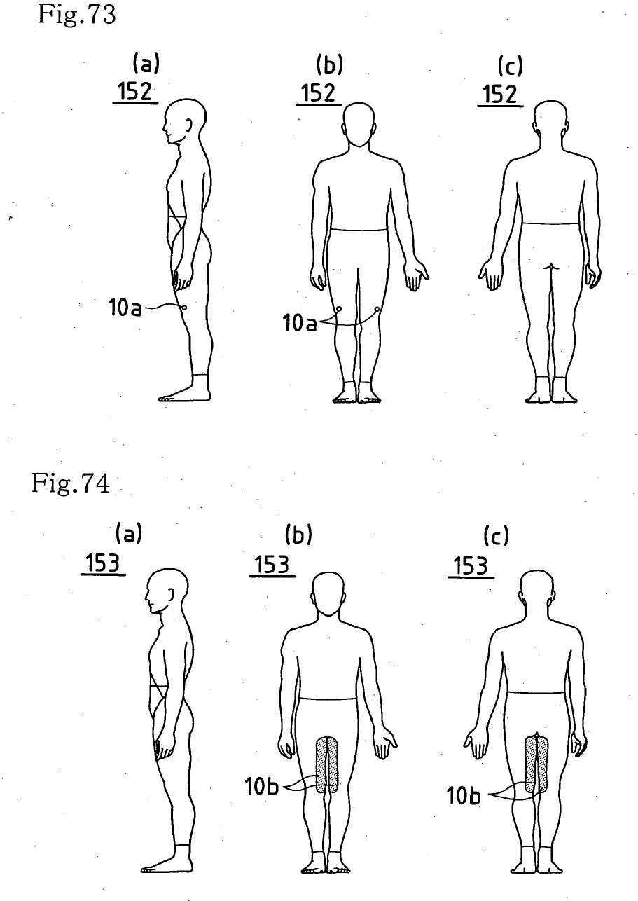

FIG. 73 shows a pair of tights 152, in which point stimulation parts 10a are arranged on the vastus lateralis of the quadriceps femoris.

The subjects wore, in turn, the tights 124 of Example 3, the tights 125 of Example 4, and the tights 152 of Comparative Example 3, and took Tests (a)-(d) in the same manner. During the tests, movements of the subjects were observed also visually.

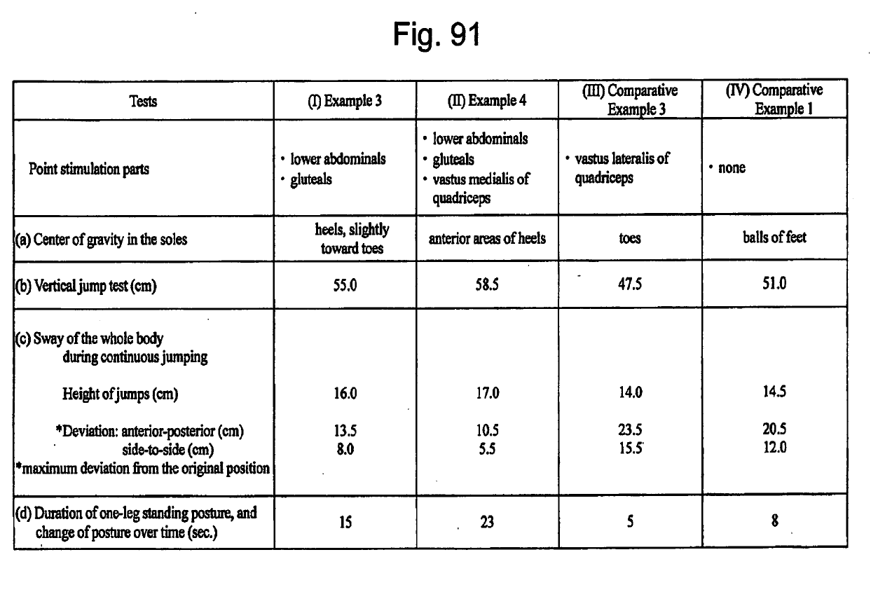

All results are given in FIG. 91.

### Examples 5 and 6

### Tights for Applying Surface Stimulation

### Symmetrical Arrangement

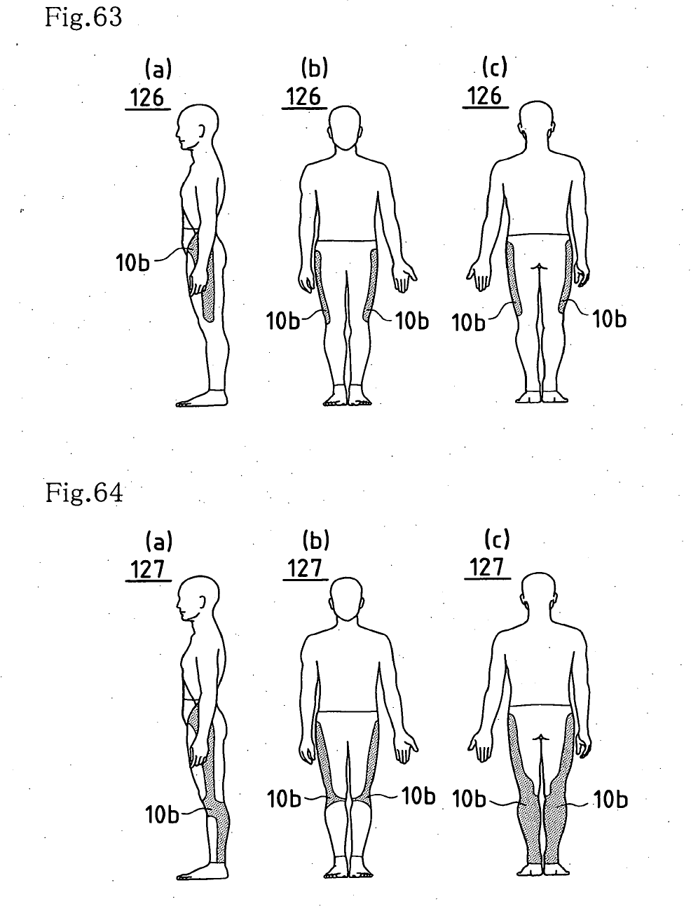

FIG. 63 shows a pair of tights 126. On the skin side of the tights 126 (the surface to touch the skin), surface stimulation parts 10b were arranged such that, with a person wearing the tights, a plurality of knit patterns shown in FIG. 79 could entirely cover functional skin areas of muscles which need to be inhibited when the tensor fasciae latae act as hip joint flexors and internal rotators.

FIG. 64 shows a pair of different tights 127. On the skin side of the tights 127 (the surface to touch the skin), surface stimulation parts 10b were arranged such that, with a person wearing the tights, a plurality of knit patterns shown in FIG. 79 could entirely cover functional skin areas of some multiarticular muscles in the free lower limb and the pelvic girdles whose extension ability needs to be inhibited.

### Comparative Example 4

Regarding a pair of tights 153 of FIG. 74, surface stimulation parts 10b were arranged such that a plurality of knit patterns shown in FIG. 79 could entirely cover the thigh adductors.

The subjects wore, in turn, the tights 126 of Example 5, the tights 127 of Example 6, and the tights 153 of Comparative Example 4, and took Tests (a)-(d) in the same manner. During the tests, movements of the subjects were observed also visually.

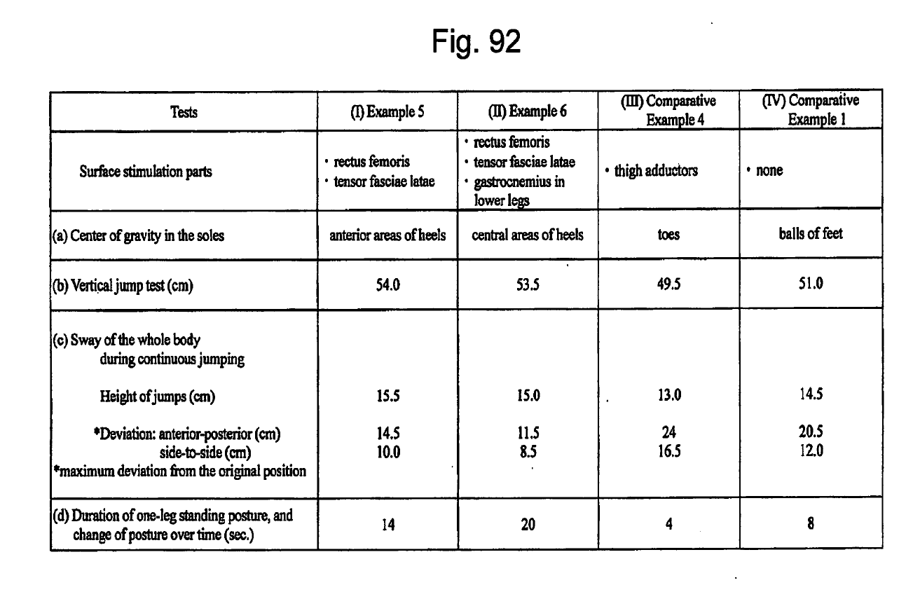

All results are given in FIG. 92.

### Examples 7 and 8

### Tights for Applying Point Stimulation and Surface Stimulation

### Asymmetrical Arrangement

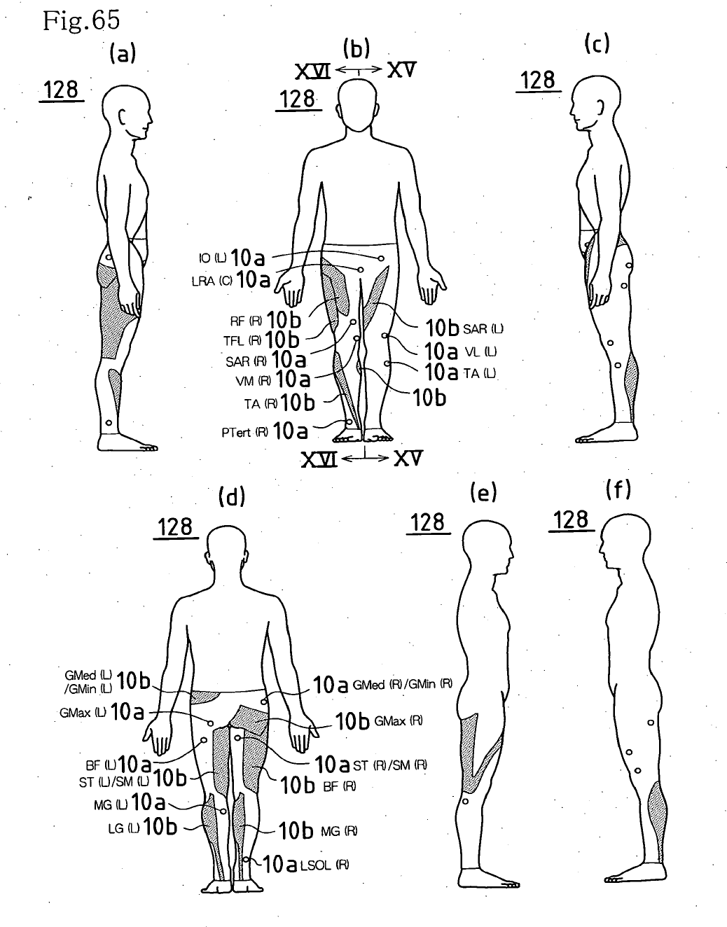

FIG. 65 shows a pair of tights 128. On the skin side of the tights 128 (the surface to touch the skin), point stimulation parts 10a were arranged to locate, with a person wearing the tights, on the skin surface corresponding to motor points of the right gluteus medius/minimus (GMed/GMin), the left gluteus maximus (GMax), the left biceps femoris (BF), the right semitendinosus/semimembranosus (ST/SM), the left medial gastrocnemius (MG), the right lateral soleus (LSOL), the left internal oblique (IO), the center of the lower rectus abdominis (LRA), the right sartorius (SAR), the right vastus medialis of the quadriceps femoris (VM), the left vastus lateralis of the quadriceps femoris (VL), the left tibialis anterior (TA), and the right peroneus tertius (PTert). A point for the center of the lower rectus abdominis was optionally selected to give maximum stimulation to the iliohypogastric nerve and the ilioinguinal nerve, and a point for the gluteal muscle (gluteus maximus) was optionally selected to give maximum stimulation to the inferior gluteal nerve. Also on the skin side of the tights 128 (the surface to touch the skin), surface stimulation parts 10b were arranged such that a plurality of knit patterns shown in FIG. 79 could entirely cover functional skin areas of the left gluteus medius/minimus (GMed/GMin), the right gluteus maximus (GMax), the right biceps femoris (BF), the left semitendinosus/semimembranosus (ST/SM), the right medial gastrocnemius (MG), the left lateral gastrocnemius (LG), the right tensor fasciae latae (TFL), the right rectus femoris of the quadriceps femoris (RF), the left sartorius (SAR), and the right tibialis anterior (TA).

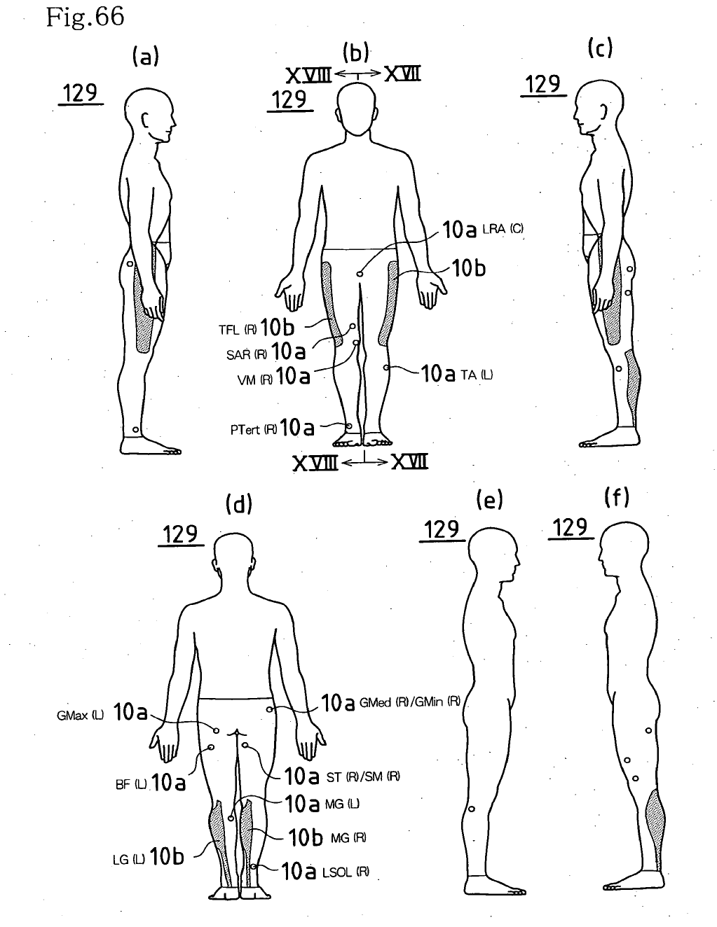

FIG. 66 shows a pair of different tights 129. On the skin side of the tights 129 (the surface to touch the skin), point stimulation parts 10a were arranged to locate, with a person wearing the tights, on the skin surface corresponding to motor points of the center of the lower rectus abdominis (LRA), the left gluteus maximus (GMax), the right gluteus medius/minimus (GMed/GMin), the right semitendinosus/semimembrano-sus (ST/SM), the left biceps femoris (BF), the right vastus medialis of the quadriceps femoris (VM), the right sartorius (SAR), the left tibialis anterior (TA), the left medial gastrocnemius (MG), the right lateral soleus (LSOL), and the right peroneus tertius (PTert). A point for the center of the lower rectus abdominis was optionally selected to give maximum stimulation to the iliohypogastric nerve and the ilioinguinal nerve, a point for the gluteal muscle (gluteus maximus) was optionally selected to give maximum stimulation to the inferior gluteal nerve, and a point for the vastus medialis of the quadriceps femoris was optionally selected to give maximum stimulation to the femoral nerve. Also on the skin side of the tights 129 (the surface to touch the skin), surface stimulation parts 10b were arranged such that, with a person wearing the tights, a plurality of knit patterns shown in FIG. 79 could entirely cover functional skin areas of muscles for flexion and internal rotation of the hip joints (the left and right tensor fasciae latae (TFL)), and lower leg muscles for flexion of the knee joints and extension of the ankle joints (the right medial gastrocnemius (MG) and the left lateral gastrocnemius (LG)).

### Comparative Examples 5 and 6

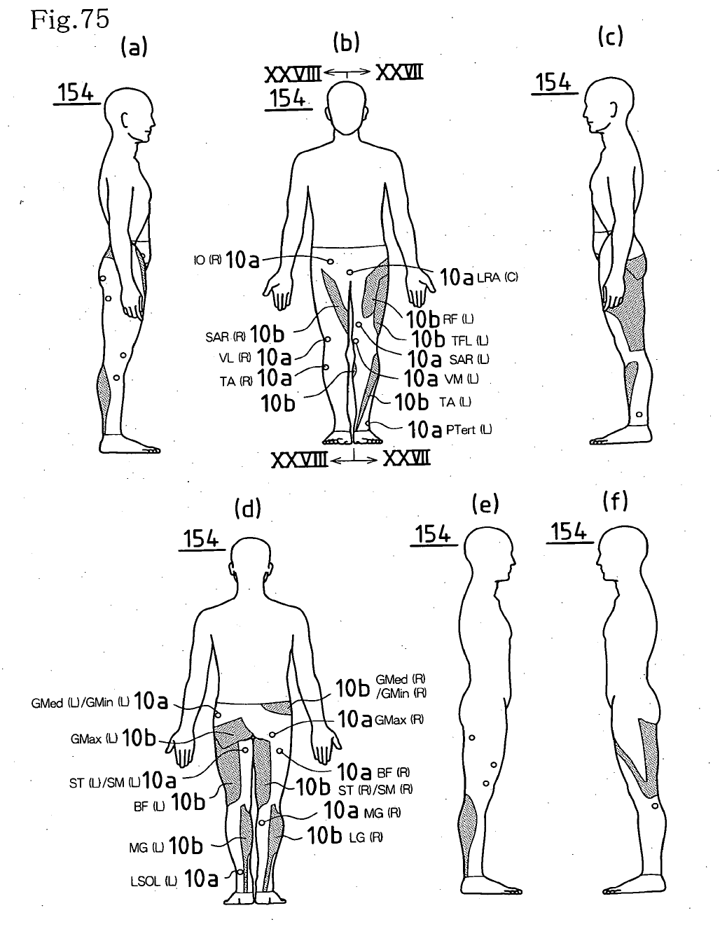

A pair of tights 154 shown in FIG. 75 were similar to those in Example 7 above, except that their point stimulation parts 10a and surface stimulation parts 10b were mirror images of those in the tights 128 of FIG. 65.

The subjects wore, in turn, the tights 128 of Example 7, the tights 129 of Example 8, the tights 154 of Comparative Example 5, and the tights 150 illustrated in FIG. 71, and took Tests (a)-(d) in the same manner. During the tests, movements of the subjects were observed also visually.

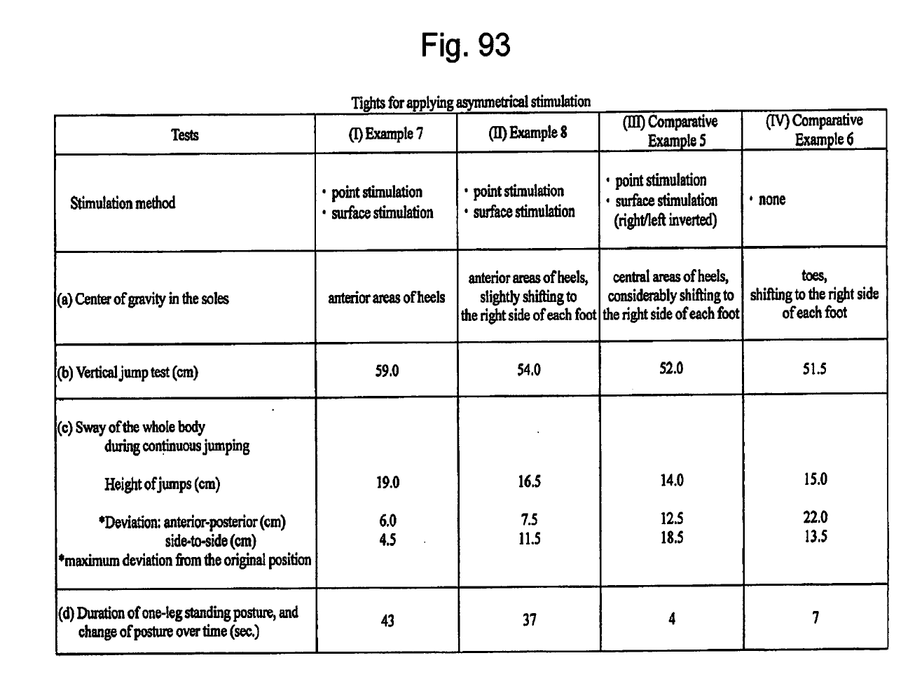

All results are given in FIG. 93.

### Examples 9 and 10

### Tights for Applying Point Stimulation

### Asymmetrical Arrangement

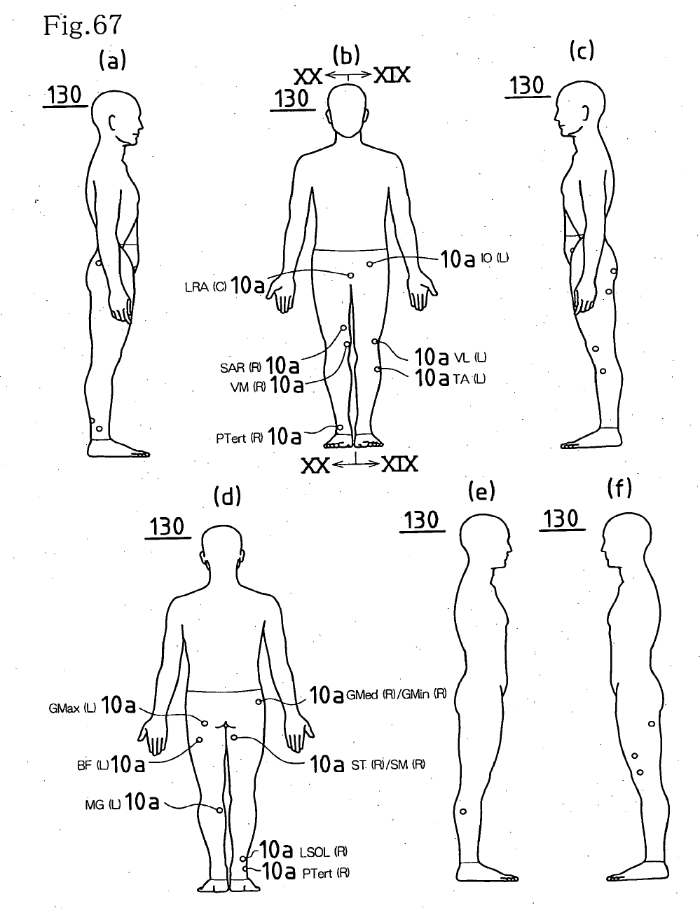

FIG. 67 shows a pair of tights 130. On the skin side of the tights 130 (the surface to touch the skin), point stimulation parts 10a were arranged to locate, with a person wearing the tights, on the skin surface corresponding to motor points of the right gluteus medius/minimus (GMed/GMin), the left gluteus maximus (GMax), the left biceps femoris (BF), the right semitendinosus/semimembranosus (ST/SM), the left medial gastrocnemius (MG), the right lateral soleus (LSOL), the left internal oblique (IO), the center of the lower rectus abdominis (LRA), the right sartorius (SAR), the right vastus medialis of the quadriceps femoris (VM), the left vastus lateralis of the quadriceps femoris (VL), the left tibialis anterior (TA), and the right peroneus tertius (PTert). A point for the center of the lower rectus abdominis was optionally selected to give maximum stimulation to the iliohypogastric nerve and the ilioinguinal nerve, and a point for the gluteal muscle (gluteus maximus) was optionally selected to give maximum stimulation to the inferior gluteal nerve.

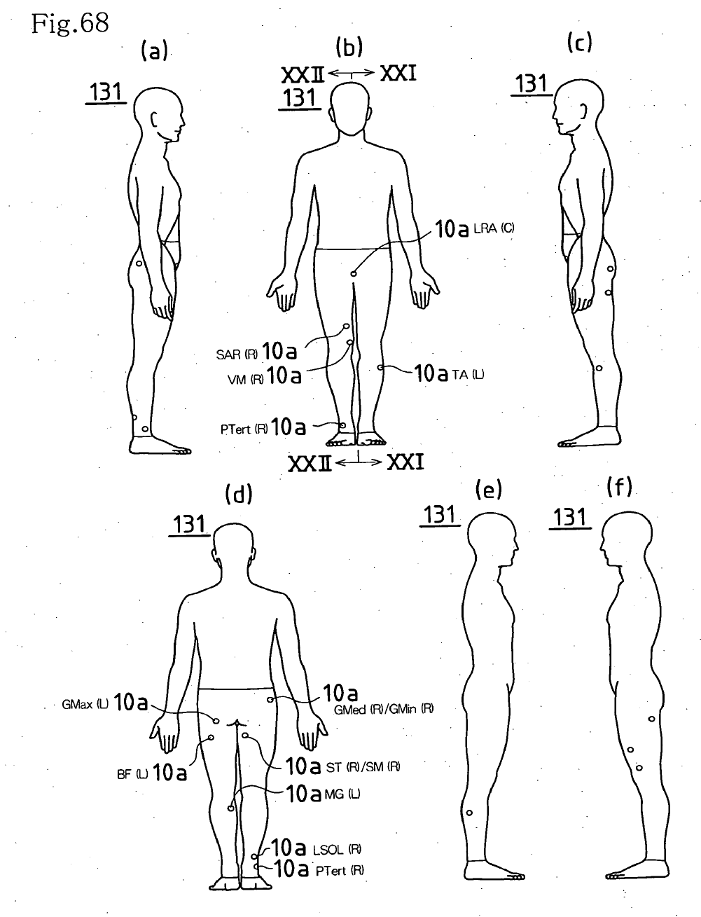

FIG. 68 shows a pair of different tights 131. On the skin side of the tights 131 (the surface to touch the skin), point stimulation parts 10a were arranged to locate, with a person wearing the tights, on the skin surface corresponding to motor points of the center of the lower rectus abdominis (LRA), the left gluteus maximus (GMax), the right gluteus medius/minimus (GMed/GMin), the right semitendinosus/semimembrano-sus (ST/SM), the left biceps femoris (BF), the right vastus medialis of the quadriceps femoris (VM), the right sartorius (SAR), the left tibialis anterior (TA), the left medial gastrocnemius (MG), the right lateral soleus (LSOL), and the right peroneus tertius (PTert). A point for the center of the lower rectus abdominis was optionally selected to give maximum stimulation to the iliohypogastric nerve and the ilioinguinal nerve, a point for the gluteal muscle (gluteus maximus) was optionally selected to give maximum stimulation to the inferior gluteal nerve, and a point for the vastus medialis of the quadriceps femoris was optionally selected to give maximum stimulation to the femoral nerve.

### Comparative Examples 7 and 8

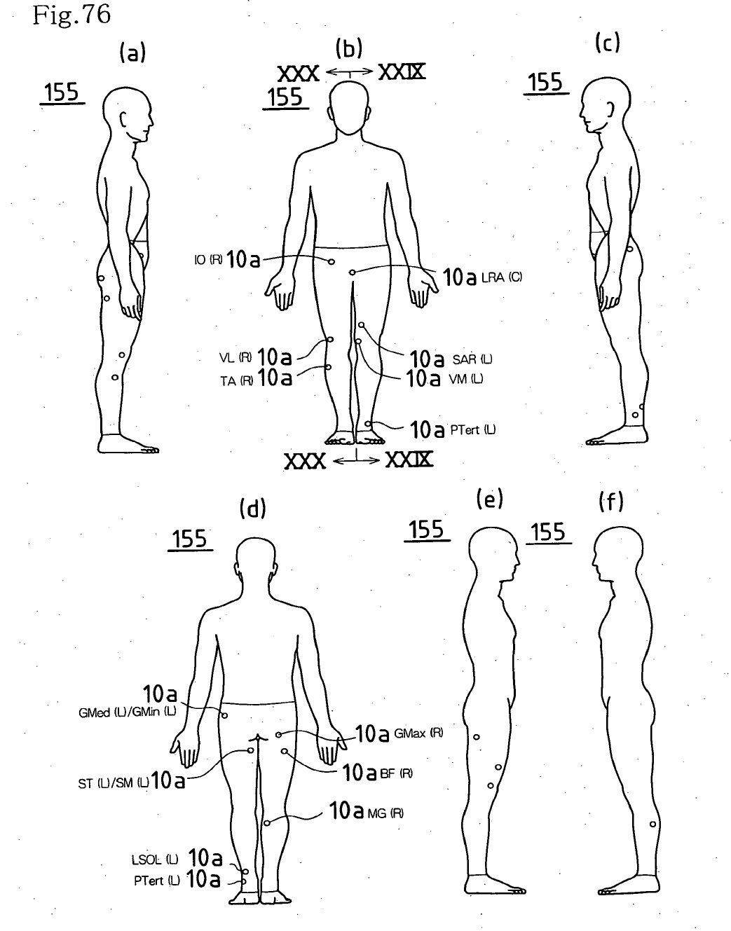

A pair of tights 155 shown in FIG. 76 were similar to those in Example 9 above, except that their point stimulation parts 10a were mirror images of those in the tights 130 of FIG. 67.

The subjects wore, in turn, the tights 130 of Example 9, the tights 131 of Example 10, the tights 155 of Comparative Example 7, and the tights 150 illustrated in FIG. 71, and took Tests (a)-(d) in the same manner. During the tests, movements of the subjects were observed also visually.

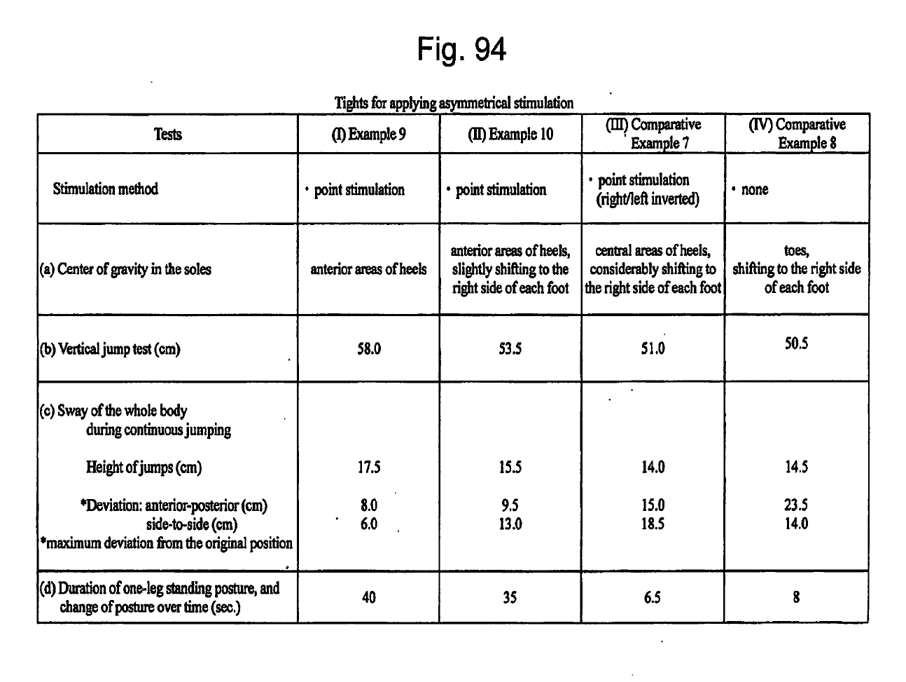

All results are given in FIG. 94.

### Examples 11 and 12

### Tights for Applying Surface Stimulation

### Asymmetrical Arrangement

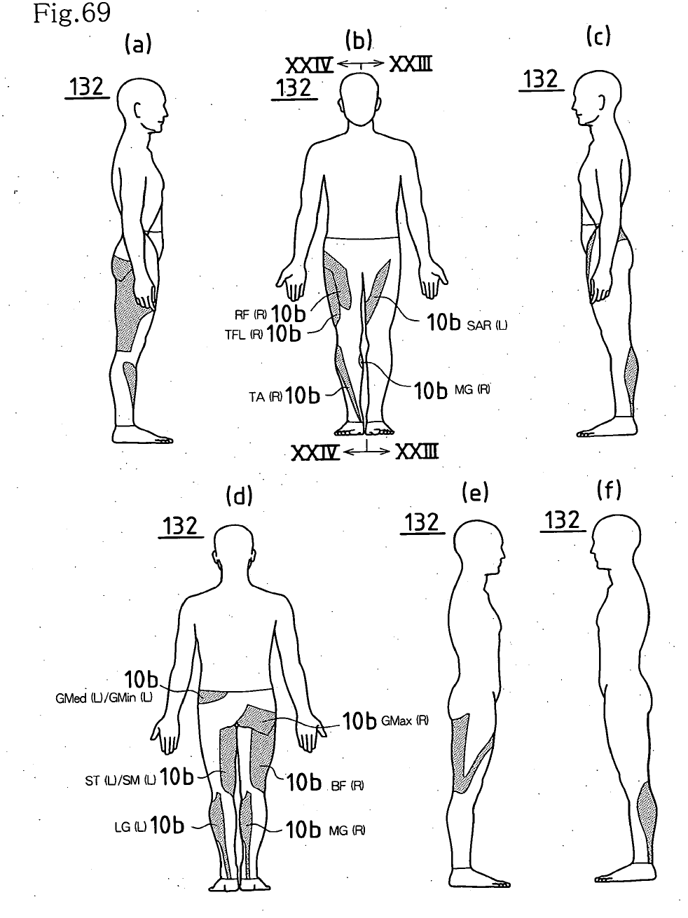

FIG. 69 shows a pair of tights 132. On the skin side of the tights 132 (the surface to touch the skin), surface stimulation parts 10b were arranged such that, with a person wearing the tights, a plurality of knit patterns shown in FIG. 79 could entirely cover functional skin areas of the left gluteus medius/minimus (GMed/GMin), the right gluteus maximus (GMax), the right biceps femoris (BF), the left semitendinosus/semimembra-nosus (ST/SM), the right medial gastrocnemius (MG), the left lateral gastrocnemius (LG), the right tensor fasciae latae (TFL), the right rectus femoris of the quadriceps femoris (RF), the left sartorius (SAR), and the right tibialis anterior (TA).

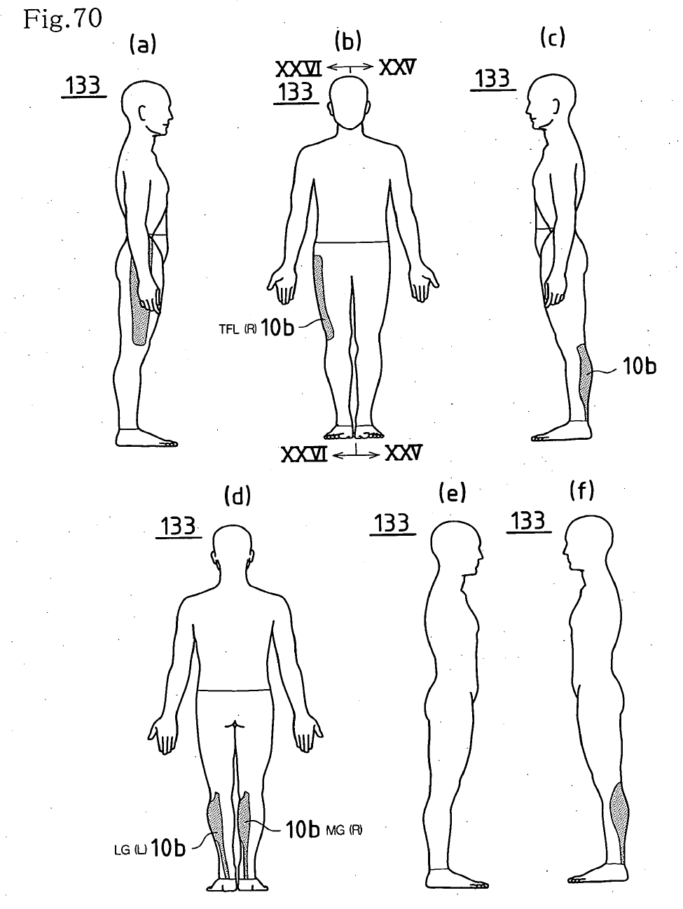

FIG. 70 shows a pair of different tights 133. On the skin side of the tights 133 (the surface to touch the skin), surface stimulation parts 10b were arranged such that, with a person wearing the tights, a plurality of knit patterns shown in FIG. 79 could entirely cover functional skin areas of the right tensor fasciae latae (TFL), the right medial gastrocnemius (MG), and the left lateral gastrocnemius (LG).

### Comparative Examples 9 and 10

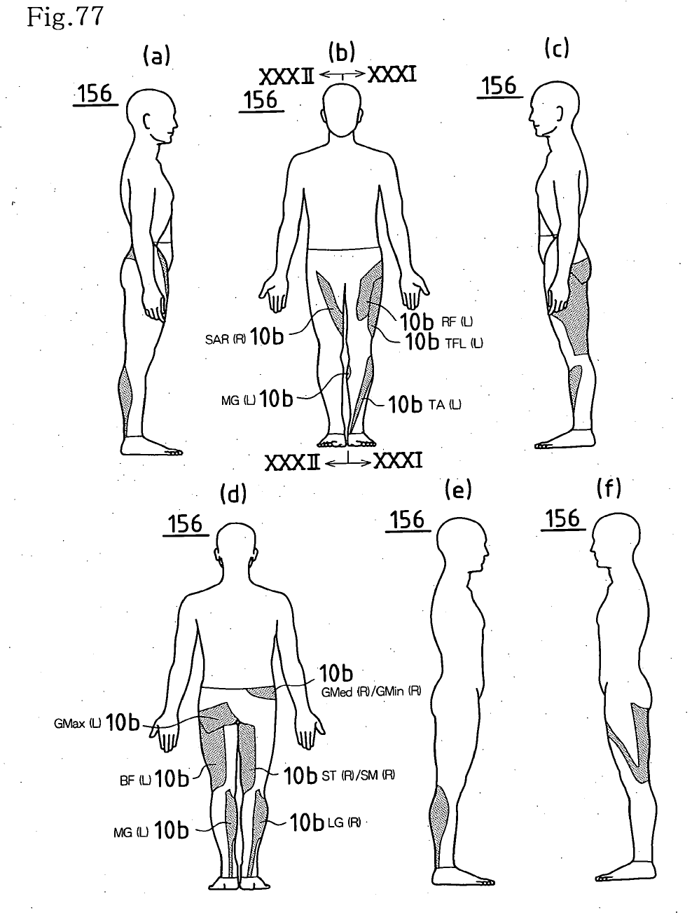

A pair of tights 156 shown in FIG. 77 were similar to those in Example 11 above, except that their surface stimulation parts 10b were mirror images of those in the tights 132 of FIG. 69.

The subjects wore, in turn, the tights 132 of Example 11, the tights 133 of Example 12, the tights 156 of Comparative Example 9, and the tights 150 illustrated in FIG. 71, and took Tests (a)-(d) in the same manner. During the tests, movements of the subjects were observed also visually.

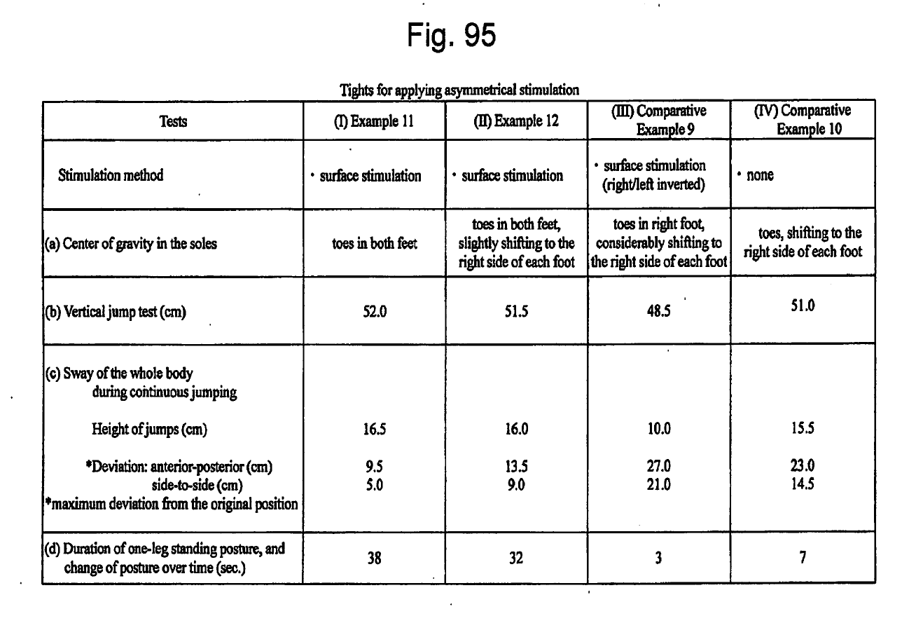

All results are given in FIG. 95.

As understood from FIGS. 90-95, the results of Test (a) showed that the tights according to the present invention could guide the subjects from the forward leaning, right-sided posture to a neutral or slightly backward leaning posture. The results of Test (c) proved decrease of body sway. The results of Test (d) confirmed change and decrease of body sway which was triggered by variation in the base of exercise.

In the vertical jump of Test (b), the subjects showed better results in the tights according to the present invention than in the tights of Comparative Examples. The results of Tests (a) and (b) proved a close relationship between the exercise posture and the power generated in that posture.

Analysis of the subjects' movements during Tests (b) and (c) gave the following findings. While they wore the tights of Comparative Example 1, they mainly relied on the ankle strategy-based manner of exercise. On the other hand, by wearing the tights of Examples 1-12, the subjects had their trunk stabilized and had their manner of exercise transformed into the hip strategy-based one. In addition, as learned from the test results using the tights of Comparative Example 1, the subjects had difficulty in performing stable exercise performance as long as they relied on the ankle strategy-based manner of exercise which was principally led by the knees. Further, let us compare the test results using the tights of Examples 1-12 which supported the trunk firmly with the test results using the tights of Comparative Examples 2, 3, 4, 5, 7 and 9. From this comparison, it was verified that cooperation between the upper and lower limbs had a significant influence on exercise. Furthermore, the test results of Examples 1-12 (the present invention) and Comparative Example 1 confirmed that the hip strategy-based manner of exercise, which could be expected in Examples 1-12, showed greater improvements of athletic ability than the ankle strategy-based manner of exercise which could be expected in Comparative Example 1.

### Example 13

### Repositioning Device

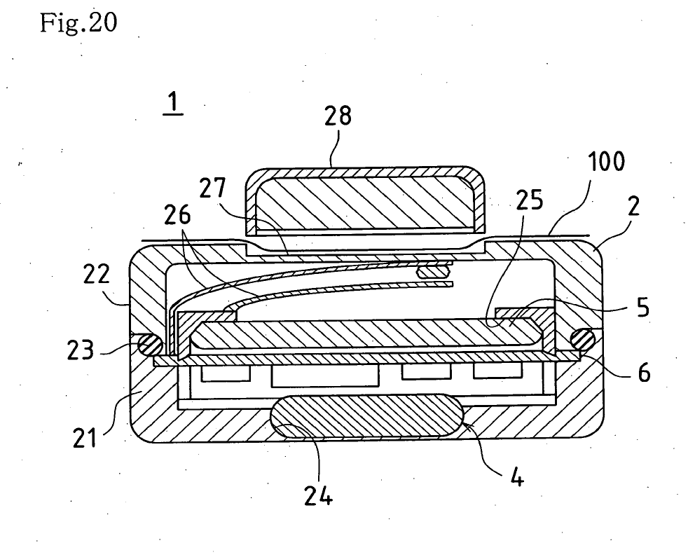

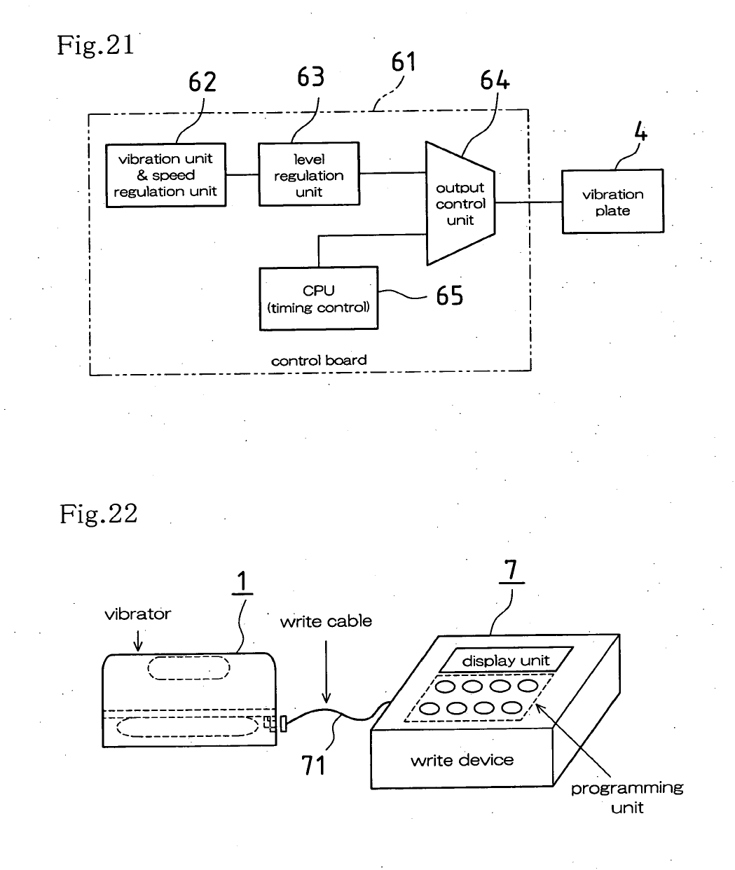

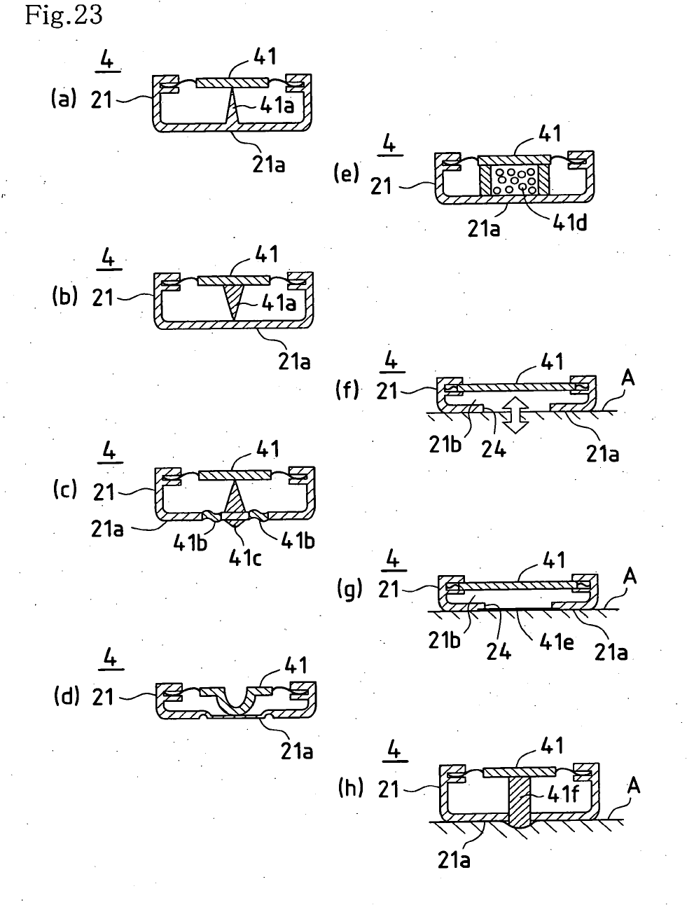

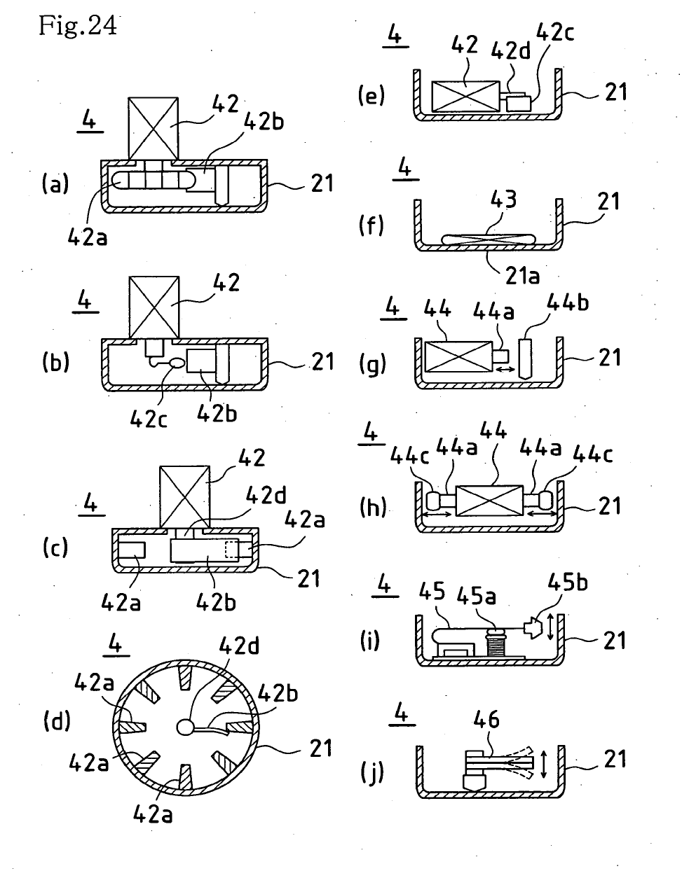

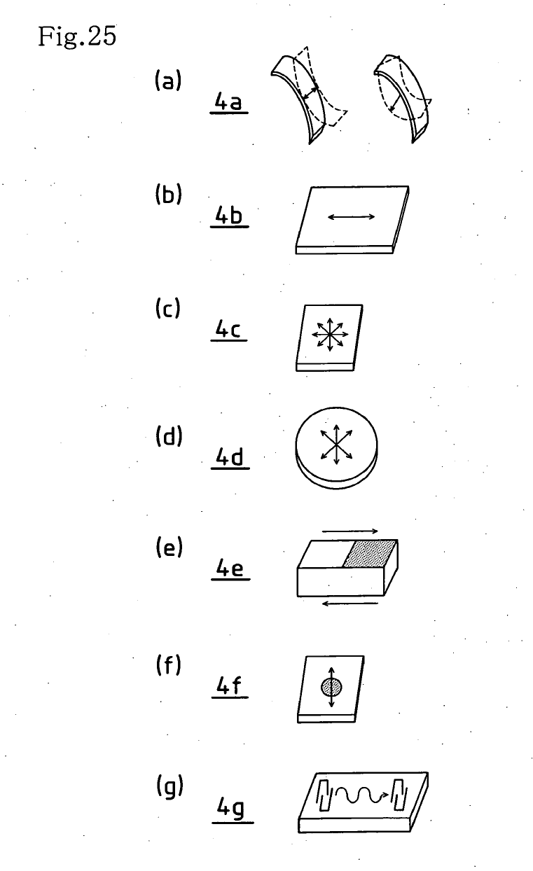

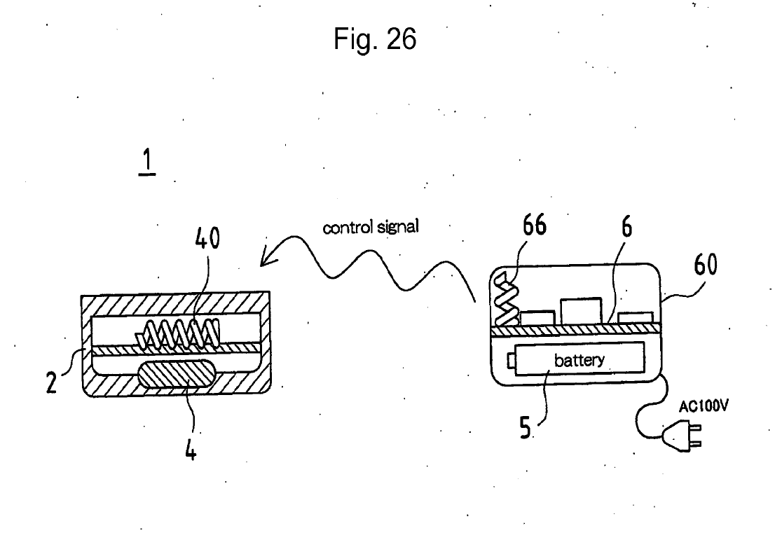

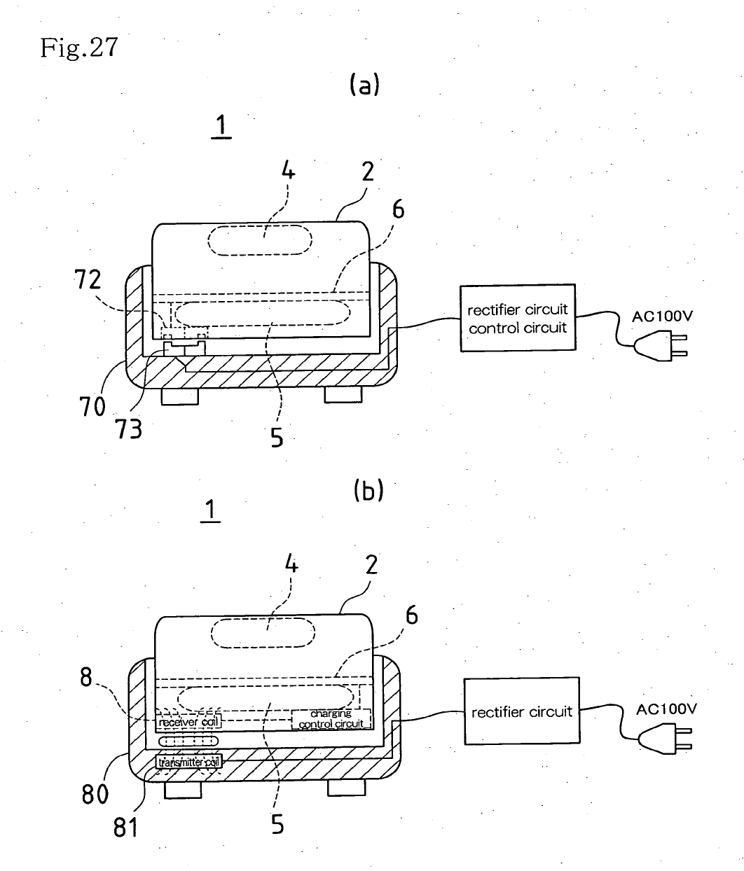

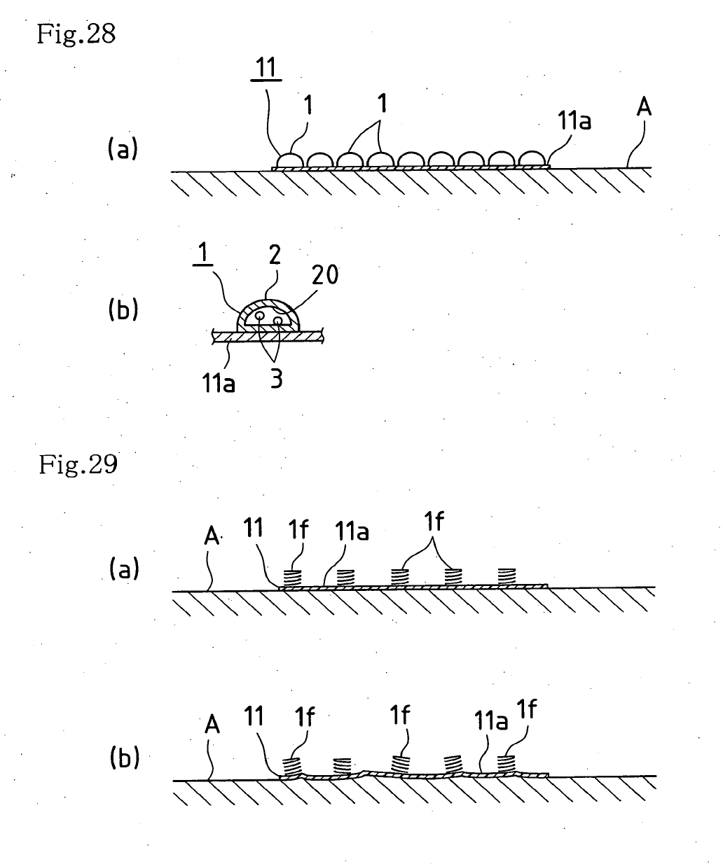

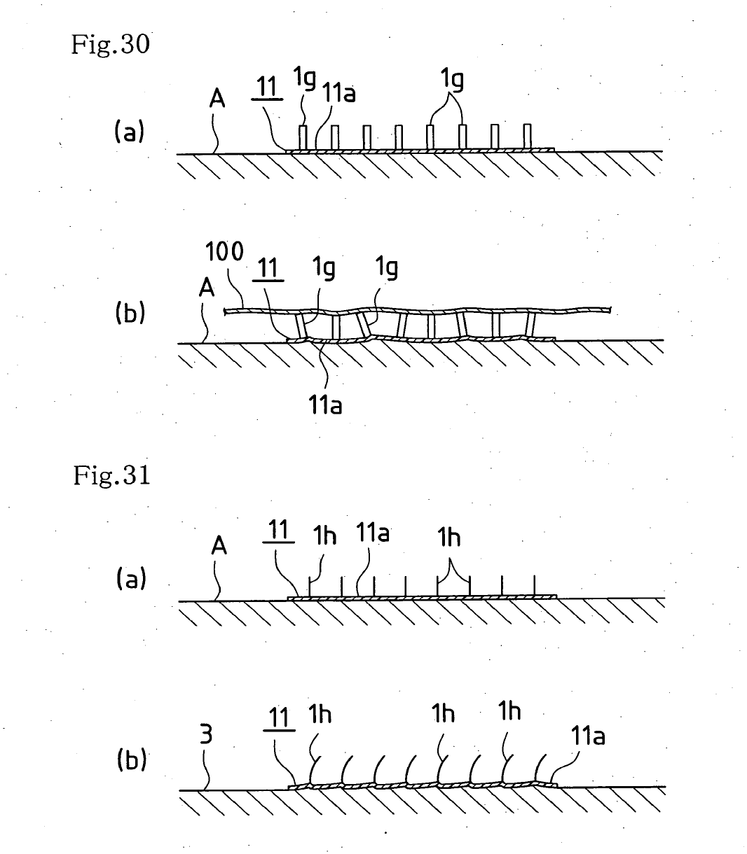

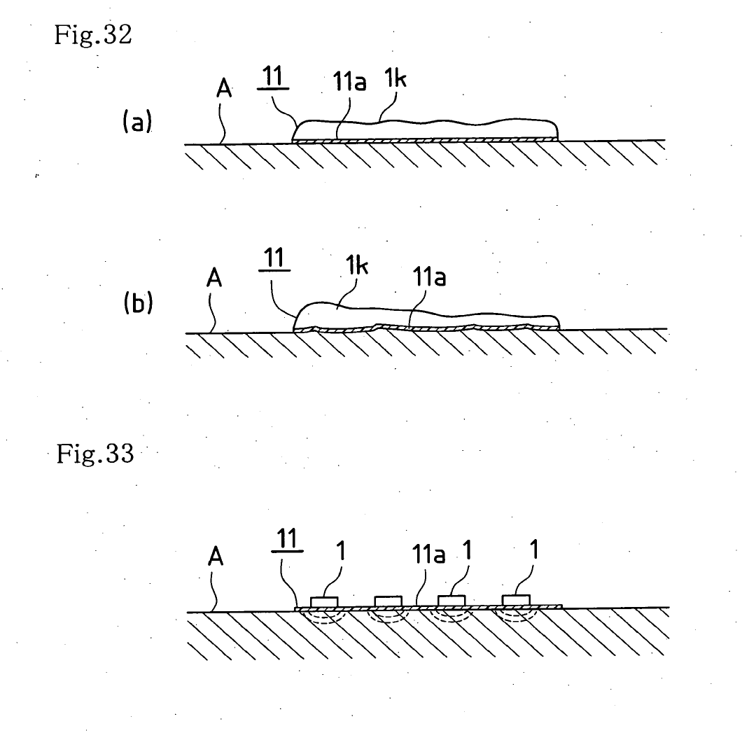

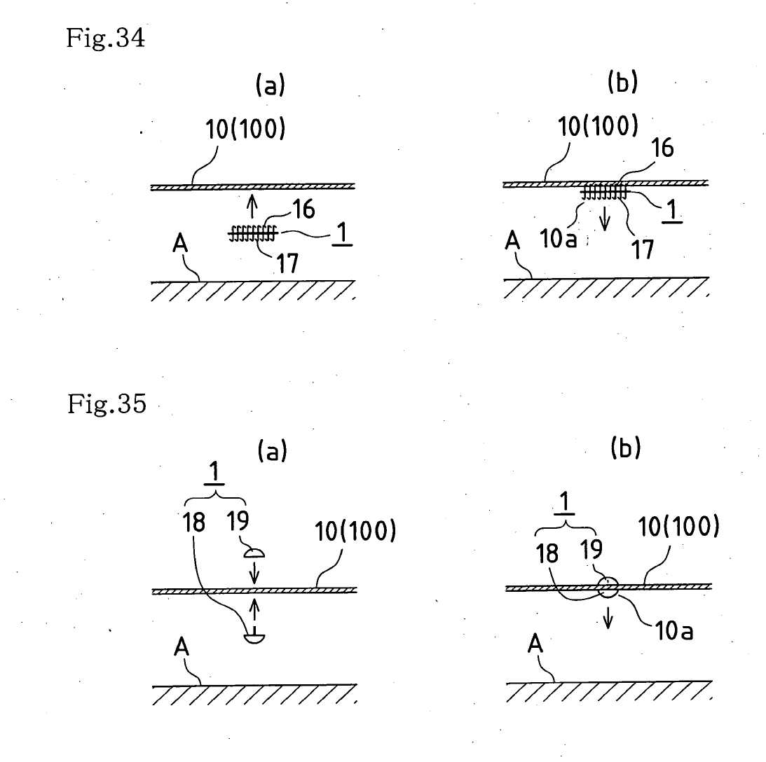

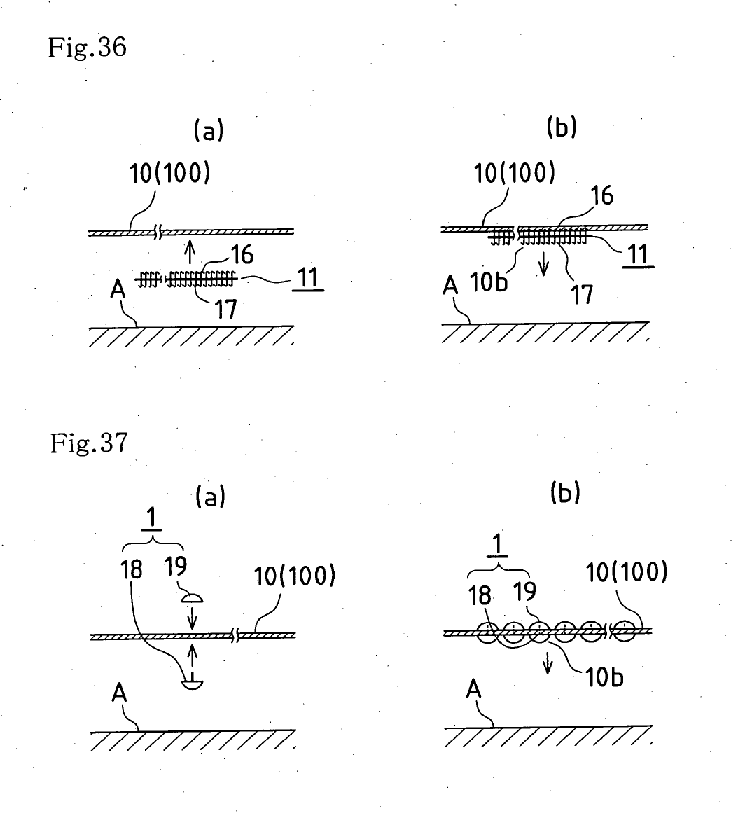

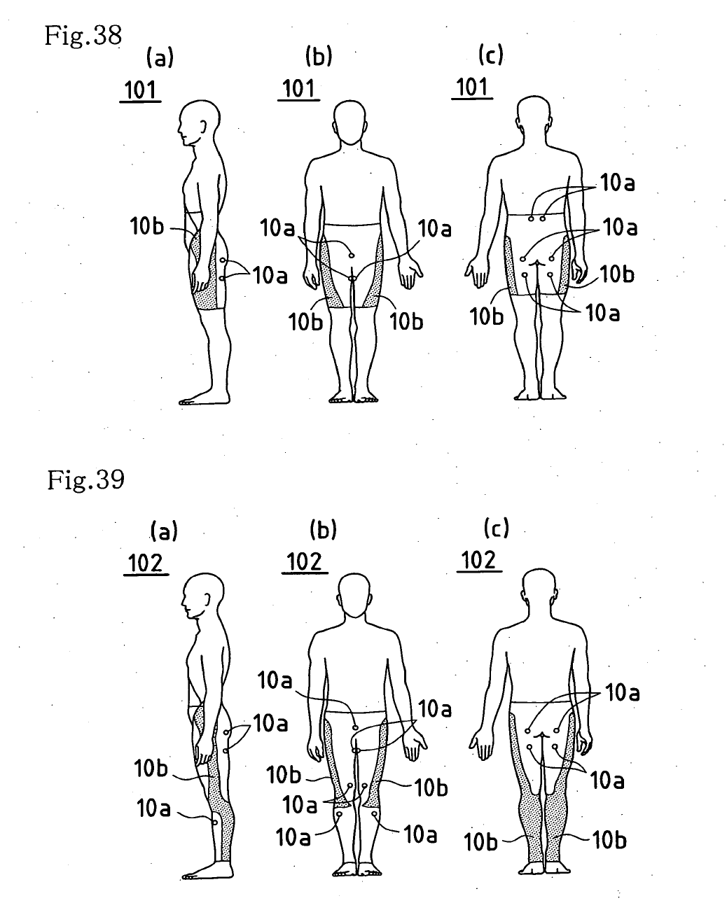

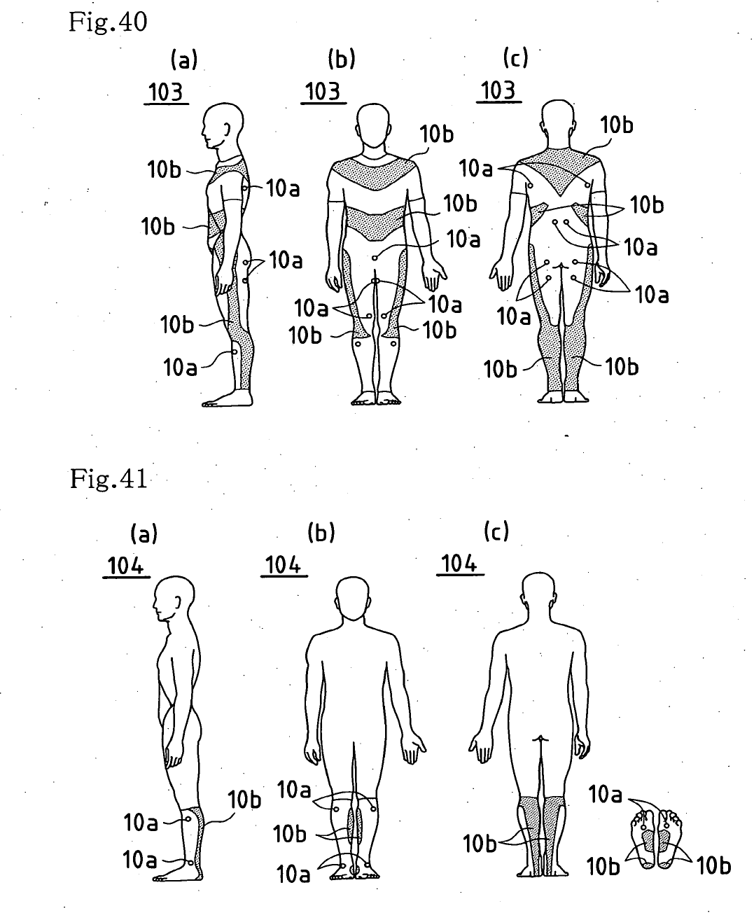

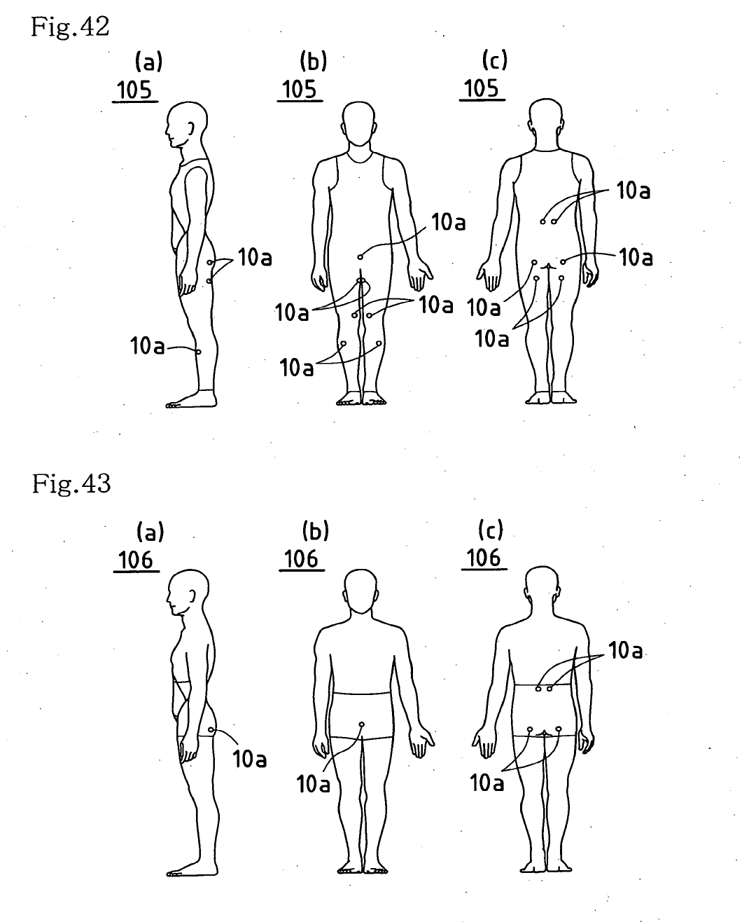

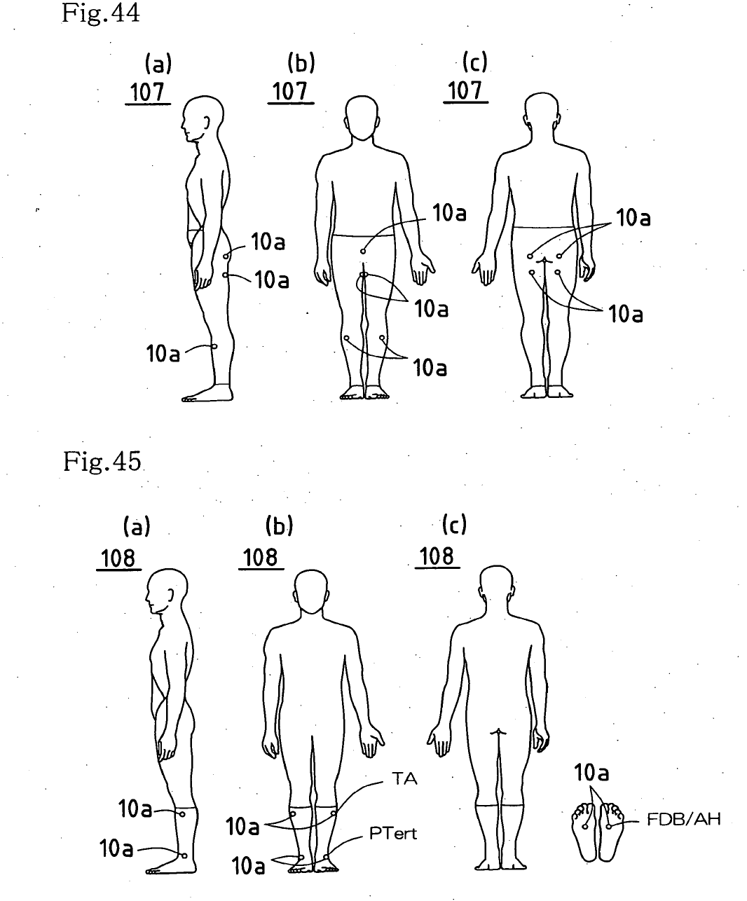

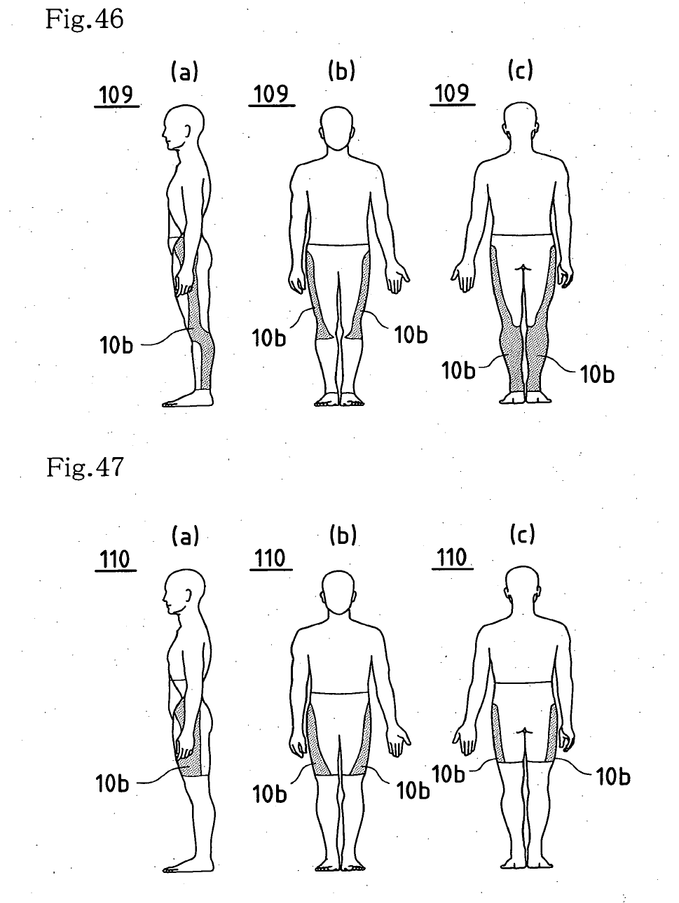

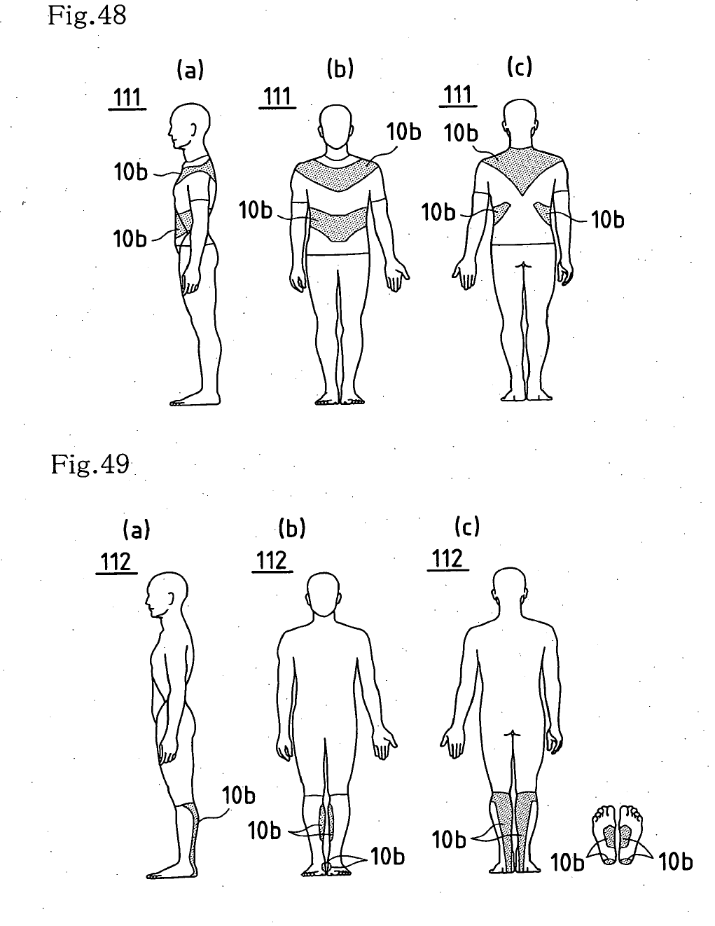

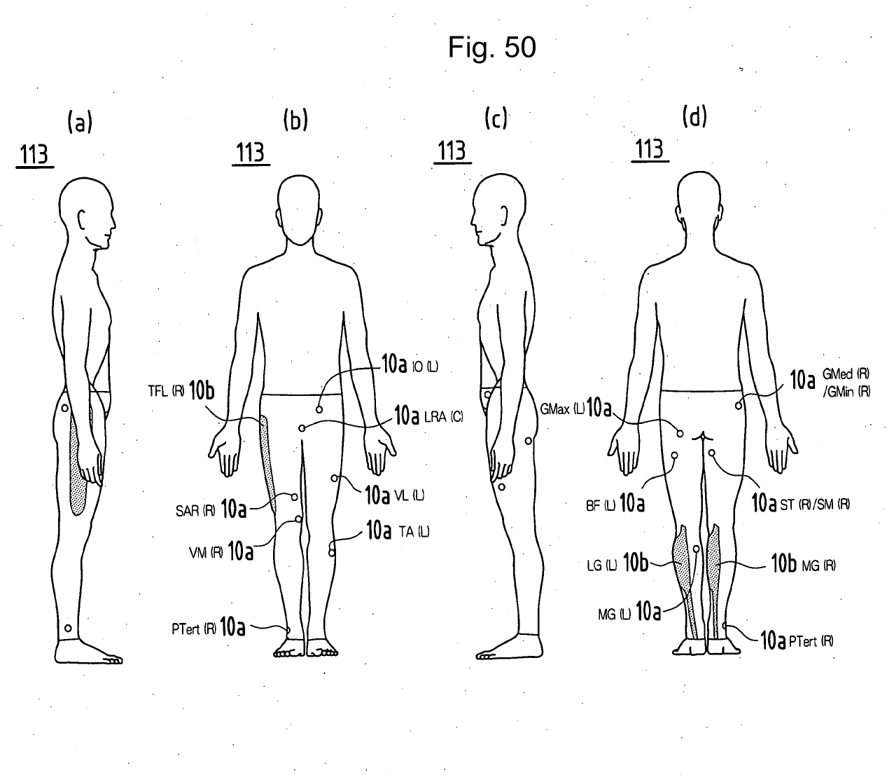

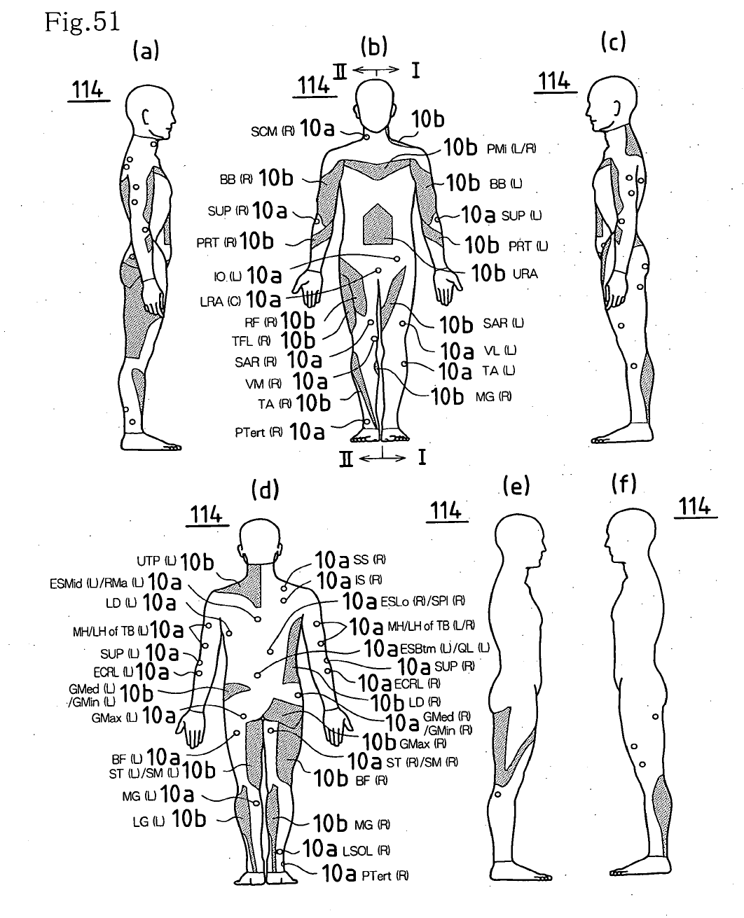

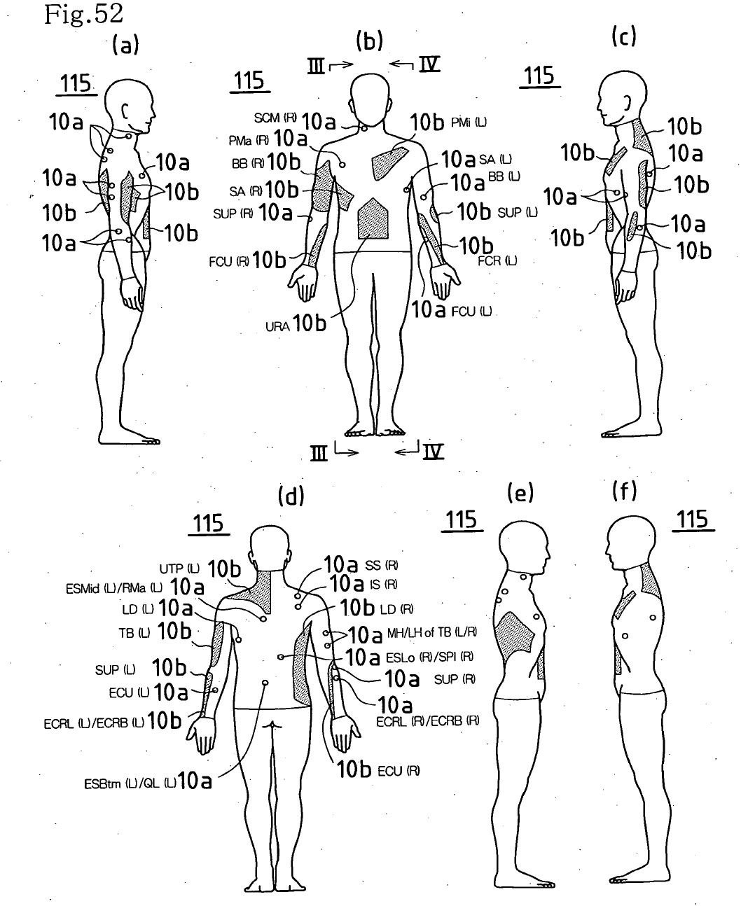

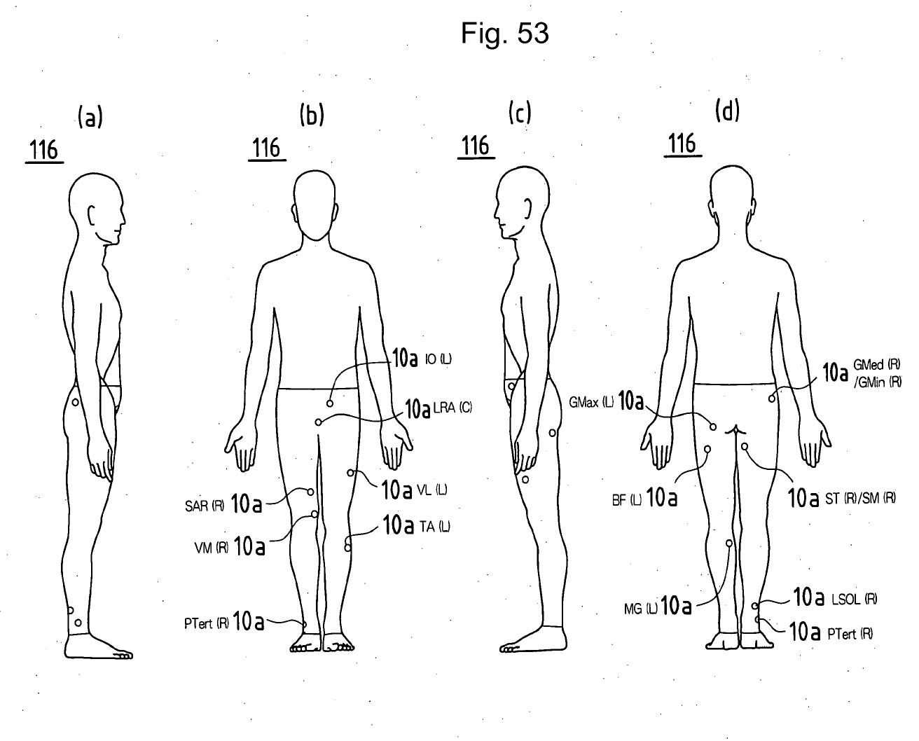

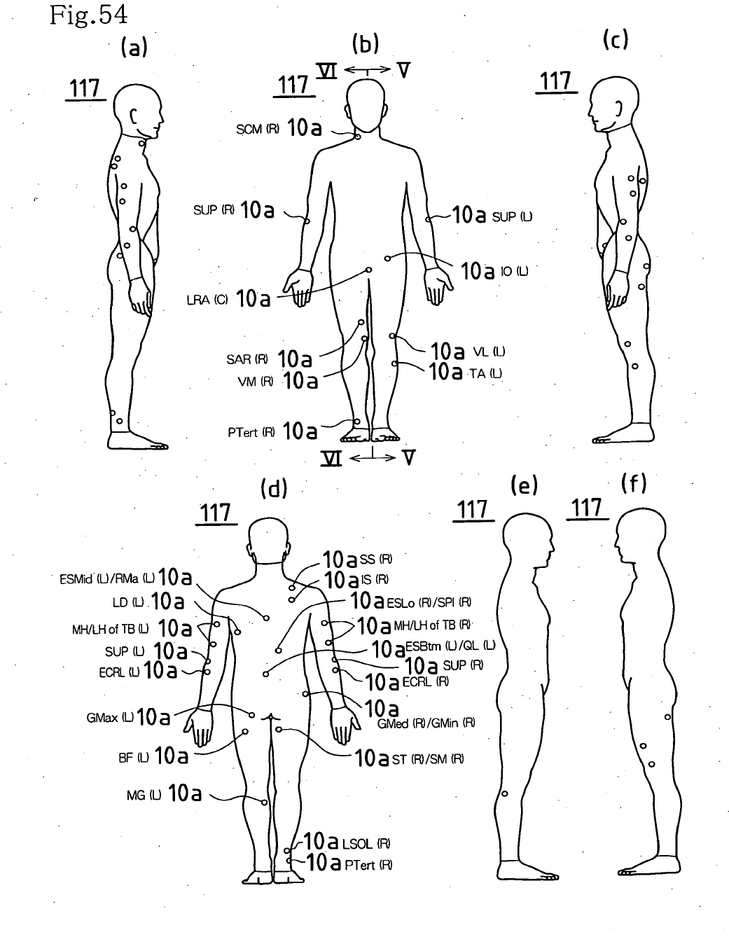

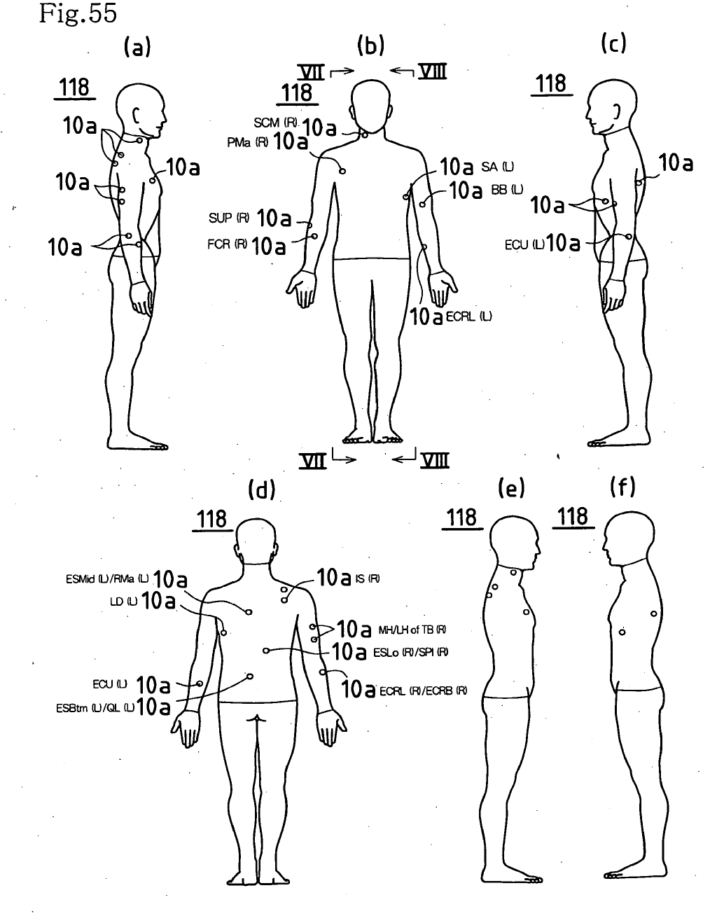

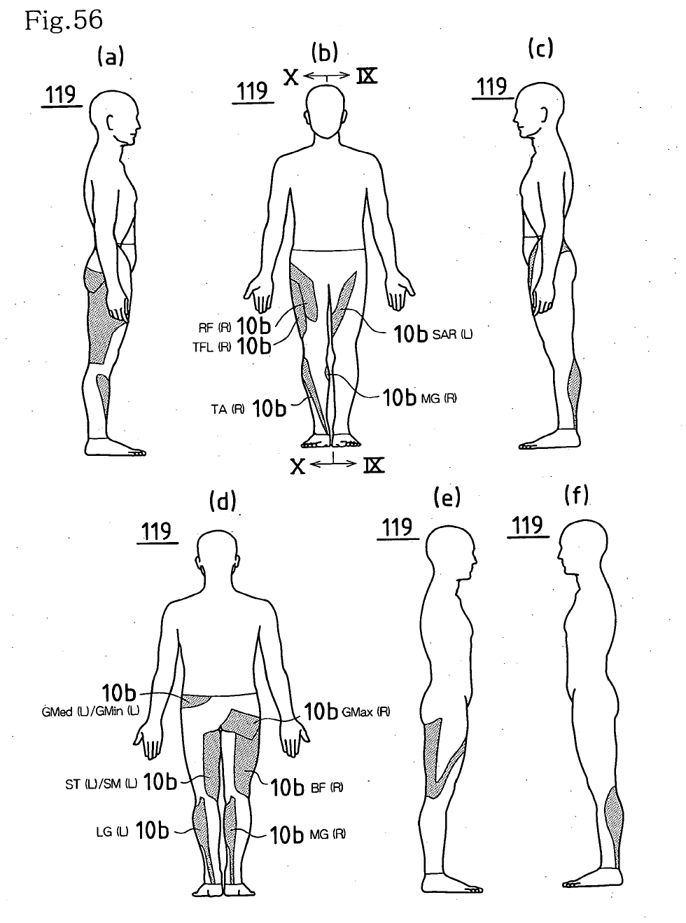

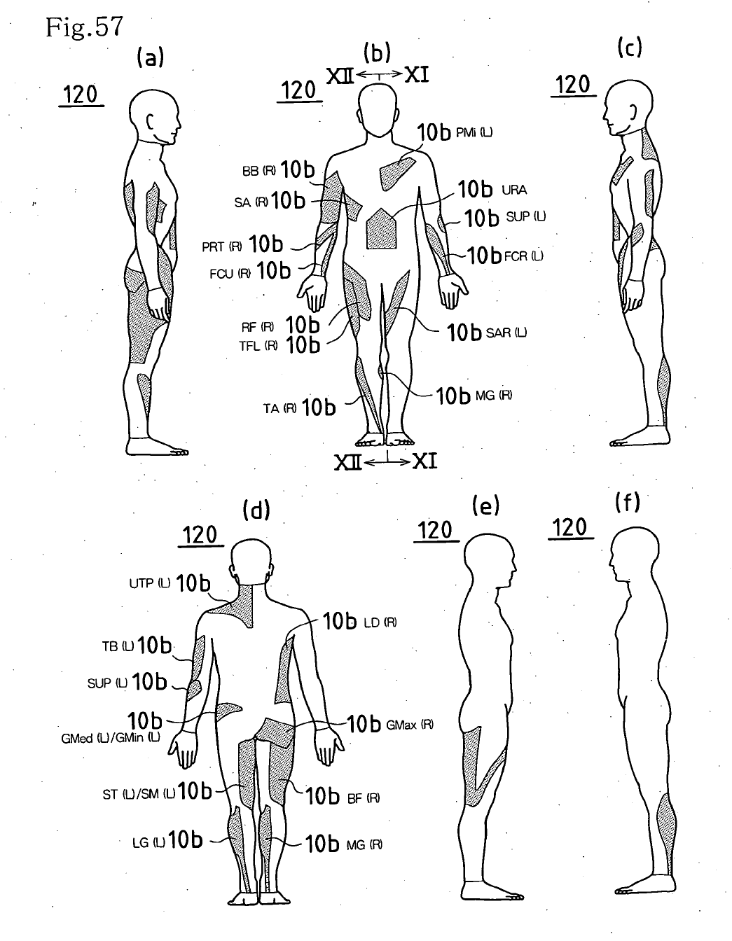

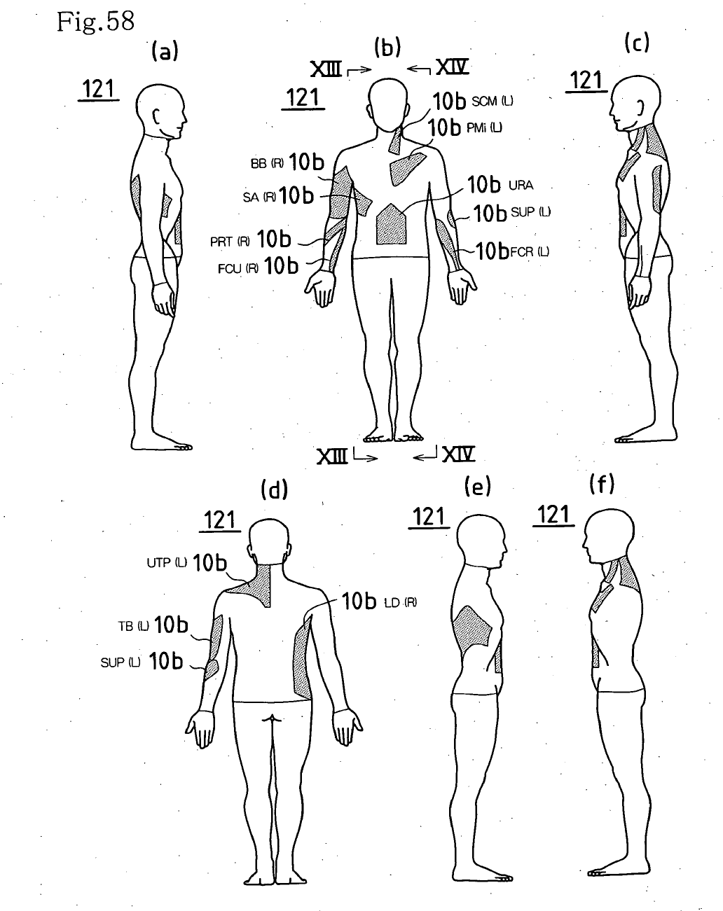

As the repositioning device 1, the vibration-type device illustrated in FIG. 20 was prepared in two types (high-amplitude and low-amplitude) whose frequencies were set in a range of 100 to 200 Hz. The amplitude for the low-amplitude device was set such that the vibration sound was audible in a silent environment but inaudible in a daily living environment. The amplitude for the high-amplitude device was set such that the vibration sound was barely audible in a daily living environment.

<Test Description>

(1) Trunk flexibility was measured by a stand-and-reach test. Subjects were instructed to stand on a stand-and-reach tester and to reach forward. The distance from the fingertip to the finger plate (above or below the plate) was measured in centimeters.

Thereafter, a repositioning device 1 was applied to the lower abdomen, about 40 mm below the umbilical ring. Ten minutes after the device was switched on, the stand-and-reach test was carried out again in the same manner.

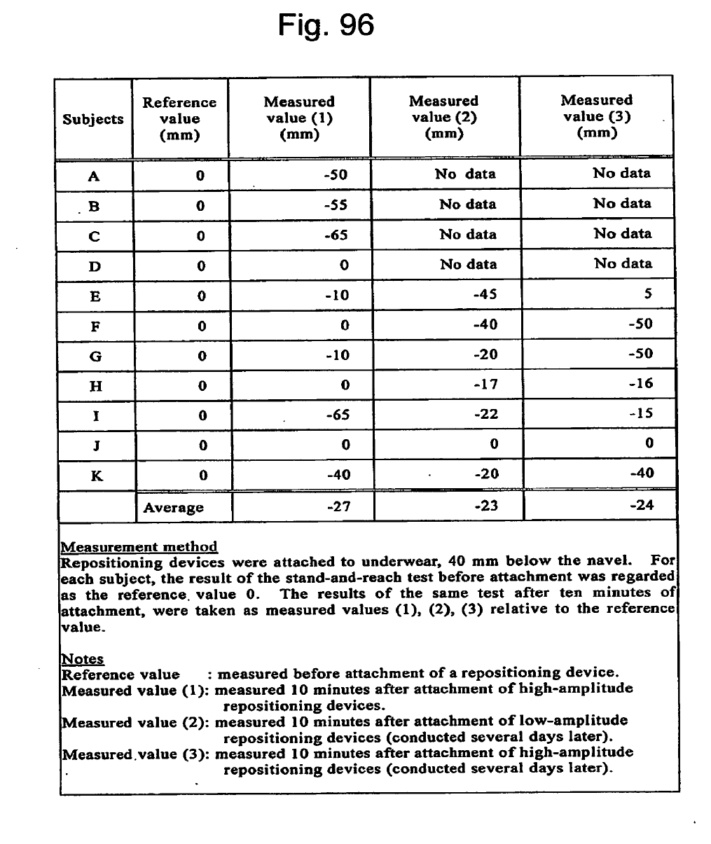

The results are given in FIG. 96.

The results shown in FIG. 96 confirmed that the repositioning device 1 facilitated lower abdominal muscles and improved trunk flexibility.

(2) Subjects were instructed to stand against a flat wall, with the back and the heels touching the wall and the legs closed. In this state, they raised one leg and kept the thigh parallel to the floor. During this one-leg standing, movements of their body were observed. To see body movements, LED lights were put at the left and right anterior superior iliac spine. The subjects were photographed in a dark room, with the shutter kept open for five seconds after they raised a leg. The length of LED light traces was measured for evaluation.

Next, a low-amplitude repositioning device 1 was mounted on the lower abdomen, about 40 mm below the umbilical ring. Body movements were observed in the same manner, immediately after activation of the device and two three minutes later.

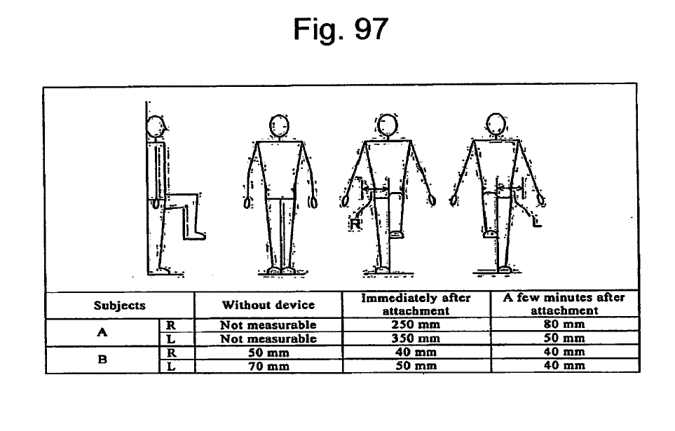

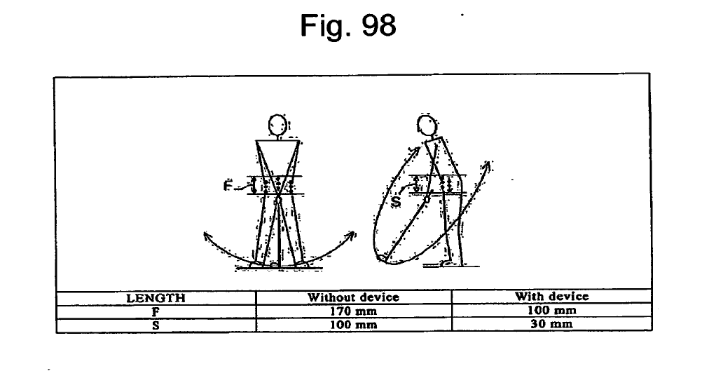

The results are given in FIG. 97.

The results shown in FIG. 97 confirmed that the repositioning device 1 stabilized the subjects' body axis and improved their body balance, permitting smooth weight shift (shift of the body weight and the center of gravity).

(3) Body movements of subjects were measured while they struck a golf ball with a driver. To see body movements, LED lights were put at the left and right anterior superior iliac spine and the navel. While making a swing in a dark room, the subjects were photographed, with the shutter kept open. The length of LED light traces was measured for evaluation.

Next, a low-amplitude repositioning device 1 was mounted on the lower abdomen, about 40 mm below the umbilical ring. Two to three minutes after activation of the device, body movements were observed in the same manner.

The results are given in FIG. 98.

The results shown in FIG. 98 confirmed that the repositioning device 1 stabilized the subject's body axis, and thereby enabled an efficient steady swing.

We claim:

1-39. (canceled)

40. A method for selectively vibrating sensors in the skin of a person exercising, while avoiding closure of a pain gate induced by severe stimulation to skin or muscle, comprising the steps of:
a. providing a weakly vibrating repositioning device comprising a case applicable to a human body surface, a piezoelectric vibration generator arranged within the case to generate vibrations suitable for cutaneous excitation in a range of 3 Hz to 5 MHz via a vibration element a coin battery and a switch within the case for supplying power to the vibration generator, and a controller within the case for controlling the vibration generator, the case having a flat surface of 4 cm² or smaller with the vibration element extending through the case;
b. positioning the flat surface of the repositioning device at a location corresponding to a skin surface over a muscle; and
c. allowing the person to exercise with the repositioning device activated wherein the repositioning device promotes facilitation of neurotransmission in the muscle while decreasing awareness of the muscle via selectively vibrating sensors in the skin while avoiding closure of a pain gate induced by severe stimulation to the muscle.

41. The method of claim 40, wherein the vibration generator generates vibrations in a range of 100 Hz to 200 Hz.

42. The method of claim 40, wherein the controller is adapted to provide at least 30 seconds of continuous vibratory stimulation and controls at least the input time of vibratory stimulation or intensity.

43. The method of claim 40, wherein the flat surface is approximately 3 cm².

44. The method of claim 40, wherein the repositioning device is attached to clothing worn by the person.

45. The method of claim 44, wherein the repositioning device further comprises double-face tape suitable for attaching to the body of the person.

46. The method of claim 44, wherein the repositioning device further comprises a pin and clutch for reversibly attaching the repositioning device to a garment worn by the person.

47. The method of claim 40 wherein the flat surface comprises pointed projections that are positioned to contact the person's body surface.

48. A method for selectively vibrating sensors in the skin of a person exercising, while avoiding closure of a pain gate induced by severe stimulation to skin or muscle, comprising the steps of:
a. providing a weakly vibrating repositioning device comprising a case applicable to a human body surface, a piezoelectric vibration generator arranged within the case to generate vibrations suitable for cutaneous excitation in a range of 3 Hz to 5 MHz, the case having a flat surface of 4 cm² or smaller;
b. positioning the flat surface of the repositioning device at a location corresponding to a skin surface over a muscle; and
c. allowing the person to exercise with the repositioning device activated wherein the repositioning device promotes facilitation of neurotransmission in the muscle while decreasing awareness of the muscle via selectively vibrating sensors in the skin while avoiding closure of a pain gate induced by severe stimulation to the muscle.

49. The method of claim 48, wherein the vibration generator generates vibrations in a range of 100 Hz to 200 Hz.

50. The method of claim 48, wherein the piezoelectric vibration generator is controlled to provide at least 30 seconds of continuous vibratory stimulation.

51. The method of claim 48, wherein the flat surface is approximately 3 cm².

52. The method of claim 48, wherein the repositioning device is attached to clothing worn by the person.

53. The method of claim 52, wherein the repositioning device further comprises double-face tape suitable for attaching to the body of the person.

54. The method of claim 52, wherein the repositioning device further comprises a pin and clutch for reversibly attaching the repositioning device to a garment worn by the person.

55. The method of claim 48 wherein the flat surface comprises pointed projections that are positioned to contact the person's body surface.
